(19) United States
(12) Patent Application Publication
(10) Pub. No.: US 2025/0231531 A1
(43) Pub. Date: Jul. 17, 2025

(54) DISPLAYING BACKGROUND REGIONS FOR TIME USER INTERFACES

(71) Applicant: Apple Inc., Cupertino, CA (US)

(72) Inventors: Diogo Jose DA SILVA VALENTE SOARES, Moss Beach, CA (US); Louis R. MIKOLAY, San Francisco, CA (US); Andrew P. CLYMER, San Jose, CA (US); Vincenzo VUONO, Cupertino, CA (US); Loic A. SANDER, Sunnyvale, CA (US)

(21) Appl. No.: 19/007,277

(22) Filed: Dec. 31, 2024

Related U.S. Application Data
(60) Provisional application No. 63/692,172, filed on Sep. 8, 2024.
(60) Provisional application No. 63/657,281, filed on Jun. 7, 2024.
(60) Provisional application No. 63/645,813, filed on May 10, 2024.
(60) Provisional application No. 63/637,334, filed on Apr. 22, 2024.
(60) Provisional application No. 63/621,471, filed on Jan. 16, 2024.

(51) Int. Cl. G04G 21/00

(52) U.S. Cl. CPC G04G 21/00

(57) ABSTRACT

The present disclosure generally relates to displaying time user interfaces.

### CROSS-REFERENCE TO RELATED APPLICATIONS

This application claims priority to U.S. Provisional Patent Application Ser. No. 63/621,471, filed on Jan. 16, 2024, and titled “DISPLAYING BACKGROUND REGIONS FOR TIME USER INTERFACES”, U.S. Provisional Patent Application Ser. No. 63/637,334, filed on Apr. 22, 2024, and titled “DISPLAYING BACKGROUND REGIONS FOR TIME USER INTERFACES”, U.S. Provisional Patent Application Ser. No. 63/645,813, filed on May 10, 2024, and titled “DISPLAYING BACKGROUND REGIONS FOR TIME USER INTERFACES”, U.S. Provisional Patent Application Ser. No. 63/657,281, filed on Jun. 7, 2024, and titled “DISPLAYING BACKGROUND REGIONS FOR TIME USER INTERFACES”, and U.S. Provisional Patent Application Ser. No. 63/692,172, filed on Sep. 8, 2024, and titled “DISPLAYING BACKGROUND REGIONS FOR TIME USER INTERFACES”, the contents of each of which are hereby incorporated by reference in their entirety.

### FIELD

The present disclosure relates generally to computer user interfaces, and more specifically to displaying background regions for time user interfaces.

### BACKGROUND

Electronic devices include displays that can be used to display various types of content and to provide information to a user. Some electronic devices, such as smartphones and smartwatches, can display an indication of time to provide a user with the current time.

### BRIEF SUMMARY

Some techniques for displaying background regions using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for displaying background regions. Such methods and interfaces optionally complement or replace other methods for displaying background regions. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with a display generation component: displaying, via the display generation component, a time user interface having a first background region and a second background region, wherein the first background region is displayed with a first color and the second background region is displayed with a second color; detecting an update event; and in response to detecting the update event, displaying, via the display generation component, the time user interface with the first background region having the second color.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: displaying, via the display generation component, a time user interface having a first background region and a second background region, wherein the first background region is displayed with a first color and the second background region is displayed with a second color; detecting an update event; and in response to detecting the update event, displaying, via the display generation component, the time user interface with the first background region having the second color.

In accordance with some embodiments, a transitory computer-readable storage medium is described. The transitory computer-readable storage medium stores one or more programs configured to be executed by one or more processors of a computer system that is in communication with a display generation component, the one or more programs including instructions for: displaying, via the display generation component, a time user interface having a first background region and a second background region, wherein the first background region is displayed with a first color and the second background region is displayed with a second color; detecting an update event; and in response to detecting the update event, displaying, via the display generation component, the time user interface with the first background region having the second color.

In accordance with some embodiments, a computer system configured to communicate with a display generation component is described. The computer system comprises: one or more processors; and memory storing one or more programs configured to be executed by the one or more processors, the one or more programs including instructions for: displaying, via the display generation component, a time user interface having a first background region and a second background region, wherein the first background region is displayed with a first color and the second background region is displayed with a second color; detecting an update event; and in response to detecting the update event, displaying, via the display generation component, the time user interface with the first background region having the second color.

In accordance with some embodiments, a computer system configured to communicate with a display generation component is described. The computer system comprises: means for displaying, via the display generation component, a time user interface having a first background region and a second background region, wherein the first background region is displayed with a first color and the second background region is displayed with a second color; means for detecting an update event; and in response to detecting the update event, means for displaying, via the display generation component, the time user interface with the first background region having the second color.

In accordance with some embodiments, a computer program product is described. The computer program product comprises one or more programs configured to be executed by one or more processors of a computer system that is in communication with a display generation component, the one or more programs including instructions for: displaying, via the display generation component, a time user interface having a first background region and a second background region, wherein the first background region is displayed with a first color and the second background region is displayed with a second color; detecting an update event; and in response to detecting the update event, displaying, via the display generation component, the time user interface with the first background region having the second color.

In accordance with some embodiments, a method is described. The method comprises: displaying, via the display generation component, a time user interface including a user interface region that has an appearance that represents a view of a simulated three-dimensional reflective object, the user interface region having a first appearance that is based on simulated light emitted from a simulated light source at a first position relative to the simulated three-dimensional reflective object; detecting an event; and in response to detecting the event, displaying, via the display generation component, the time user interface with the user interface region having a second appearance that is different from the first appearance, wherein the second appearance is based on simulated light emitted from the simulated light source at a second position relative to the simulated three-dimensional reflective object, wherein the second position relative to the simulated three-dimensional reflective object is different from the first position relative to the simulated three-dimensional reflective object.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: displaying, via the display generation component, a time user interface including a user interface region that has an appearance that represents a view of a simulated three-dimensional reflective object, the user interface region having a first appearance that is based on simulated light emitted from a simulated light source at a first position relative to the simulated three-dimensional reflective object; detecting an event; and in response to detecting the event, displaying, via the display generation component, the time user interface with the user interface region having a second appearance that is different from the first appearance, wherein the second appearance is based on simulated light emitted from the simulated light source at a second position relative to the simulated three-dimensional reflective object, wherein the second position relative to the simulated three-dimensional reflective object is different from the first position relative to the simulated three-dimensional reflective object.

In accordance with some embodiments, a transitory computer-readable storage medium is described. The transitory computer-readable storage medium stores one or more programs configured to be executed by one or more processors of a computer system that is in communication with a display generation component, the one or more programs including instructions for: displaying, via the display generation component, a time user interface including a user interface region that has an appearance that represents a view of a simulated three-dimensional reflective object, the user interface region having a first appearance that is based on simulated light emitted from a simulated light source at a first position relative to the simulated three-dimensional reflective object; detecting an event; and in response to detecting the event, displaying, via the display generation component, the time user interface with the user interface region having a second appearance that is different from the first appearance, wherein the second appearance is based on simulated light emitted from the simulated light source at a second position relative to the simulated three-dimensional reflective object, wherein the second position relative to the simulated three-dimensional reflective object is different from the first position relative to the simulated three-dimensional reflective object.

In accordance with some embodiments, a computer system configured to communicate with a display generation component is described. The computer system comprises: one or more processors; and memory storing one or more programs configured to be executed by the one or more processors, the one or more programs including instructions for: displaying, via the display generation component, a time user interface including a user interface region that has an appearance that represents a view of a simulated three-dimensional reflective object, the user interface region having a first appearance that is based on simulated light emitted from a simulated light source at a first position relative to the simulated three-dimensional reflective object; detecting an event; and in response to detecting the event, displaying, via the display generation component, the time user interface with the user interface region having a second appearance that is different from the first appearance, wherein the second appearance is based on simulated light emitted from the simulated light source at a second position relative to the simulated three-dimensional reflective object, wherein the second position relative to the simulated three-dimensional reflective object is different from the first position relative to the simulated three-dimensional reflective object.

In accordance with some embodiments, a computer system configured to communicate with a display generation component is described. The computer system comprises: means for displaying, via the display generation component, a time user interface including a user interface region that has an appearance that represents a view of a simulated three-dimensional reflective object, the user interface region having a first appearance that is based on simulated light emitted from a simulated light source at a first position relative to the simulated three-dimensional reflective object; means for detecting an event; and in response to detecting the event, means for displaying, via the display generation component, the time user interface with the user interface region having a second appearance that is different from the first appearance, wherein the second appearance is based on simulated light emitted from the simulated light source at a second position relative to the simulated three-dimensional reflective object, wherein the second position relative to the simulated three-dimensional reflective object is different from the first position relative to the simulated three-dimensional reflective object.

In accordance with some embodiments, a computer program product is described. The computer program product comprises one or more programs configured to be executed by one or more processors of a computer system that is in communication with a display generation component, the one or more programs including instructions for: displaying, via the display generation component, a time user interface including a user interface region that has an appearance that represents a view of a simulated three-dimensional reflective object, the user interface region having a first appearance that is based on simulated light emitted from a simulated light source at a first position relative to the simulated three-dimensional reflective object; detecting an event; and in response to detecting the event, displaying, via the display generation component, the time user interface with the user interface region having a second appearance that is different from the first appearance, wherein the second appearance is based on simulated light emitted from the simulated light source at a second position relative to the simulated three-dimensional reflective object, wherein the second position relative to the simulated three-dimensional reflective object is different from the first position relative to the simulated three-dimensional reflective object.

In accordance with some embodiments, a method is described. The method comprises: displaying, via the display generation component, a time user interface, the time user interface including: an indication of time that includes one or more numerals representing at least one of an hour and a minute; and a color boundary that represents a number of seconds that have elapsed in a current minute, wherein the color boundary moves over time from a first edge of the time user interface toward a second edge of the time user interface as additional seconds elapse in the current minute.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: displaying, via the display generation component, a time user interface, the time user interface including: an indication of time that includes one or more numerals representing at least one of an hour and a minute; and a color boundary that represents a number of seconds that have elapsed in a current minute, wherein the color boundary moves over time from a first edge of the time user interface toward a second edge of the time user interface as additional seconds elapse in the current minute.

In accordance with some embodiments, a transitory computer-readable storage medium is described. The transitory computer-readable storage medium stores one or more programs configured to be executed by one or more processors of a computer system that is in communication with a display generation component, the one or more programs including instructions for: displaying, via the display generation component, a time user interface, the time user interface including: an indication of time that includes one or more numerals representing at least one of an hour and a minute; and a color boundary that represents a number of seconds that have elapsed in a current minute, wherein the color boundary moves over time from a first edge of the time user interface toward a second edge of the time user interface as additional seconds elapse in the current minute.

In accordance with some embodiments, a computer system configured to communicate with a display generation component is described. The computer system comprises: one or more processors; and memory storing one or more programs configured to be executed by the one or more processors, the one or more programs including instructions for: displaying, via the display generation component, a time user interface, the time user interface including: an indication of time that includes one or more numerals representing at least one of an hour and a minute; and a color boundary that represents a number of seconds that have elapsed in a current minute, wherein the color boundary moves over time from a first edge of the time user interface toward a second edge of the time user interface as additional seconds elapse in the current minute.

In accordance with some embodiments, a computer system configured to communicate with a display generation component is described. The computer system comprises: means for displaying, via the display generation component, a time user interface, the time user interface including: an indication of time that includes one or more numerals representing at least one of an hour and a minute; and a color boundary that represents a number of seconds that have elapsed in a current minute, wherein the color boundary moves over time from a first edge of the time user interface toward a second edge of the time user interface as additional seconds elapse in the current minute.

In accordance with some embodiments, a computer program product is described. The computer program product comprises one or more programs configured to be executed by one or more processors of a computer system that is in communication with a display generation component, the one or more programs including instructions for: displaying, via the display generation component, a time user interface, the time user interface including: an indication of time that includes one or more numerals representing at least one of an hour and a minute; and a color boundary that represents a number of seconds that have elapsed in a current minute, wherein the color boundary moves over time from a first edge of the time user interface toward a second edge of the time user interface as additional seconds elapse in the current minute.

In accordance with some embodiments, a method is described. The method comprises: displaying, via the display generation component, a user interface element in a time user interface that includes a representation of time, including displaying the user interface element aligned with a first portion of a first numeral of the representation of time; detecting a change in time; and in response to detecting the change in time, displaying, via the display generation component, the user interface element aligned with a second portion of a second numeral of the representation of time, wherein the second numeral is different from the first numeral.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: displaying, via the display generation component, a user interface element in a time user interface that includes a representation of time, including displaying the user interface element aligned with a first portion of a first numeral of the representation of time; detecting a change in time; and in response to detecting the change in time, displaying, via the display generation component, the user interface element aligned with a second portion of a second numeral of the representation of time, wherein the second numeral is different from the first numeral.

In accordance with some embodiments, a transitory computer-readable storage medium is described. The transitory computer-readable storage medium stores one or more programs configured to be executed by one or more processors of a computer system that is in communication with a display generation component, the one or more programs including instructions for: displaying, via the display generation component, a user interface element in a time user interface that includes a representation of time, including displaying the user interface element aligned with a first portion of a first numeral of the representation of time; detecting a change in time; and in response to detecting the change in time, displaying, via the display generation component, the user interface element aligned with a second portion of a second numeral of the representation of time, wherein the second numeral is different from the first numeral.

In accordance with some embodiments, a computer system configured to communicate with a display generation component is described. The computer system comprises: one or more processors; and memory storing one or more programs configured to be executed by the one or more processors, the one or more programs including instructions for: displaying, via the display generation component, a user interface element in a time user interface that includes a representation of time, including displaying the user interface element aligned with a first portion of a first numeral of the representation of time; detecting a change in time; and in response to detecting the change in time, displaying, via the display generation component, the user interface element aligned with a second portion of a second numeral of the representation of time, wherein the second numeral is different from the first numeral.

In accordance with some embodiments, a computer system configured to communicate with a display generation component is described. The computer system comprises: means for displaying, via the display generation component, a user interface element in a time user interface that includes a representation of time, including displaying the user interface element aligned with a first portion of a first numeral of the representation of time; means for detecting a change in time; and in response to detecting the change in time, means for displaying, via the display generation component, the user interface element aligned with a second portion of a second numeral of the representation of time, wherein the second numeral is different from the first numeral.

In accordance with some embodiments, a computer program product is described. The computer program product comprises one or more programs configured to be executed by one or more processors of a computer system that is in communication with a display generation component, the one or more programs including instructions for: displaying, via the display generation component, a user interface element in a time user interface that includes a representation of time, including displaying the user interface element aligned with a first portion of a first numeral of the representation of time; detecting a change in time; and in response to detecting the change in time, displaying, via the display generation component, the user interface element aligned with a second portion of a second numeral of the representation of time, wherein the second numeral is different from the first numeral.

In accordance with some embodiments, a method is described. The method comprises: at a computer system that is in communication with one or more display generation components and with one or more one or more input devices: displaying, via the one or more display generation components, a time user interface; while displaying the time user interface with a seconds indicator, detecting, via the one or more input devices, a request to initiate a timer; and in response to detecting the request to initiate the timer, replacing, via the one or more display generation components, the seconds indicator of the time user interface with an indication of timer progress.

In accordance with some embodiments, a non-transitory computer-readable storage medium is described. The non-transitory computer-readable storage medium stores one or more programs configured to be executed by one or more processors of a computer system that is in communication with one or more display generation components and with one or more one or more input devices, the one or more programs including instructions for: displaying, via the one or more display generation components, a time user interface; while displaying the time user interface with a seconds indicator, detecting, via the one or more input devices, a request to initiate a timer; and in response to detecting the request to initiate the timer, replacing, via the one or more display generation components, the seconds indicator of the time user interface with an indication of timer progress.

In accordance with some embodiments, a transitory computer-readable storage medium is described. The transitory computer-readable storage medium stores one or more programs configured to be executed by one or more processors of a computer system that is in communication with one or more display generation components and with one or more one or more input devices, the one or more programs including instructions for: displaying, via the one or more display generation components, a time user interface; while displaying the time user interface with a seconds indicator, detecting, via the one or more input devices, a request to initiate a timer; and in response to detecting the request to initiate the timer, replacing, via the one or more display generation components, the seconds indicator of the time user interface with an indication of timer progress.

In accordance with some embodiments, a computer system is described. The computer system is configured to communicate with one or more display generation components and with one or more one or more input devices, and comprises: one or more processors; and memory storing one or more programs configured to be executed by the one or more processors, the one or more programs including instructions for: displaying, via the one or more display generation components, a time user interface; while displaying the time user interface with a seconds indicator, detecting, via the one or more input devices, a request to initiate a timer; and in response to detecting the request to initiate the timer, replacing, via the one or more display generation components, the seconds indicator of the time user interface with an indication of timer progress.

In accordance with some embodiments, a computer system is described. The computer system is configured to communicate with one or more display generation components and with one or more one or more input devices, and comprises: means for displaying, via the one or more display generation components, a time user interface; means, while displaying the time user interface with a seconds indicator, for detecting, via the one or more input devices, a request to initiate a timer; and means, responsive to detecting the request to initiate the timer, for replacing, via the one or more display generation components, the seconds indicator of the time user interface with an indication of timer progress.

In accordance with some embodiments, a computer program product is described. The computer program product comprises one or more programs configured to be executed by one or more processors of a computer system that is in communication with one or more display generation components and with one or more one or more input devices, the one or more programs including instructions for: displaying, via the one or more display generation components, a time user interface; while displaying the time user interface with a seconds indicator, detecting, via the one or more input devices, a request to initiate a timer; and in response to detecting the request to initiate the timer, replacing, via the one or more display generation components, the seconds indicator of the time user interface with an indication of timer progress.

In accordance with some embodiments, a method is described. The method comprises: at a computer system that is in communication with one or more display generation components and with one or more one or more input devices: detecting, via the one or more input devices, a first user input corresponding to a user request to display a time user interface, wherein the time user interface includes an indication of time and a visual media item; and in response to detecting the first user input corresponding to the user request to display the time user interface, displaying, via the one or more display generation components, the time user interface, including: in accordance with a determination that the visual media item is a first visual media item, concurrently displaying, within the time user interface, the indication of time at a first size and the first visual media item; and in accordance with a determination that the visual media item is a second visual media item different from the first visual media item, concurrently displaying, within the time user interface, the indication of time at a second size different from the first size and the second visual media item.

In accordance with some embodiments, a non-transitory computer-readable storage medium is described. The non-transitory computer-readable storage medium stores one or more programs configured to be executed by one or more processors of a computer system that is in communication with one or more display generation components and with one or more one or more input devices, the one or more programs including instructions for: detecting, via the one or more input devices, a first user input corresponding to a user request to display a time user interface, wherein the time user interface includes an indication of time and a visual media item; and in response to detecting the first user input corresponding to the user request to display the time user interface, displaying, via the one or more display generation components, the time user interface, including: in accordance with a determination that the visual media item is a first visual media item, concurrently displaying, within the time user interface, the indication of time at a first size and the first visual media item; and in accordance with a determination that the visual media item is a second visual media item different from the first visual media item, concurrently displaying, within the time user interface, the indication of time at a second size different from the first size and the second visual media item.

In accordance with some embodiments, a transitory computer-readable storage medium is described. The transitory computer-readable storage medium stores one or more programs configured to be executed by one or more processors of a computer system that is in communication with one or more display generation components and with one or more one or more input devices, the one or more programs including instructions for: detecting, via the one or more input devices, a first user input corresponding to a user request to display a time user interface, wherein the time user interface includes an indication of time and a visual media item; and in response to detecting the first user input corresponding to the user request to display the time user interface, displaying, via the one or more display generation components, the time user interface, including: in accordance with a determination that the visual media item is a first visual media item, concurrently displaying, within the time user interface, the indication of time at a first size and the first visual media item; and in accordance with a determination that the visual media item is a second visual media item different from the first visual media item, concurrently displaying, within the time user interface, the indication of time at a second size different from the first size and the second visual media item.

In accordance with some embodiments, a computer system is described. The computer system is configured to communicate with one or more display generation components and with one or more one or more input devices, and comprises: one or more processors; and memory storing one or more programs configured to be executed by the one or more processors, the one or more programs including instructions for: detecting, via the one or more input devices, a first user input corresponding to a user request to display a time user interface, wherein the time user interface includes an indication of time and a visual media item; and in response to detecting the first user input corresponding to the user request to display the time user interface, displaying, via the one or more display generation components, the time user interface, including: in accordance with a determination that the visual media item is a first visual media item, concurrently displaying, within the time user interface, the indication of time at a first size and the first visual media item; and in accordance with a determination that the visual media item is a second visual media item different from the first visual media item, concurrently displaying, within the time user interface, the indication of time at a second size different from the first size and the second visual media item.

In accordance with some embodiments, a computer system is described. The computer system is configured to communicate with one or more display generation components and with one or more one or more input devices, and comprises: means for detecting, via the one or more input devices, a first user input corresponding to a user request to display a time user interface, wherein the time user interface includes an indication of time and a visual media item; and means for, in response to detecting the first user input corresponding to the user request to display the time user interface, displaying, via the one or more display generation components, the time user interface, including: in accordance with a determination that the visual media item is a first visual media item, concurrently displaying, within the time user interface, the indication of time at a first size and the first visual media item; and in accordance with a determination that the visual media item is a second visual media item different from the first visual media item, concurrently displaying, within the time user interface, the indication of time at a second size different from the first size and the second visual media item.

In accordance with some embodiments, a computer program product is described. The computer program product comprises one or more programs configured to be executed by one or more processors of a computer system that is in communication with one or more display generation components and with one or more one or more input devices, the one or more programs including instructions for: detecting, via the one or more input devices, a first user input corresponding to a user request to display a time user interface, wherein the time user interface includes an indication of time and a visual media item; and in response to detecting the first user input corresponding to the user request to display the time user interface, displaying, via the one or more display generation components, the time user interface, including: in accordance with a determination that the visual media item is a first visual media item, concurrently displaying, within the time user interface, the indication of time at a first size and the first visual media item; and in accordance with a determination that the visual media item is a second visual media item different from the first visual media item, concurrently displaying, within the time user interface, the indication of time at a second size different from the first size and the second visual media item.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying background regions for time user interfaces, thereby increasing the effectiveness, efficiency, and user satisfaction with such devices. Such methods and interfaces may complement or replace other methods for displaying background regions for time user interfaces.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6X illustrate techniques for displaying background regions for time user interfaces, in accordance with some embodiments.

FIG. 7 is a flow diagram illustrating methods for displaying background regions for time user interfaces, in accordance with some embodiments.

FIGS. 7A-7D illustrate example techniques for switching between different time user interfaces, in accordance with some embodiments.

FIGS. 8A-8N illustrate techniques for displaying background regions for time user interfaces, in accordance with some embodiments.

FIG. 9 is a flow diagram illustrating methods for displaying background regions for time user interfaces, in accordance with some embodiments.

FIGS. 10A-ION illustrate techniques for displaying background regions for time user interfaces, in accordance with some embodiments.

FIG. 11 is a flow diagram illustrating methods for displaying background regions for time user interfaces, in accordance with some embodiments.

FIGS. 12A-12T illustrate techniques for displaying background regions for time user interfaces, in accordance with some embodiments.

FIG. 13 is a flow diagram illustrating methods for displaying background regions for time user interfaces, in accordance with some embodiments.

FIGS. 14A-14V illustrate techniques for displaying an indication of timer progress, in accordance with some embodiments.

FIG. 15 is a flow diagram illustrating methods for displaying an indication of timer progress, in accordance with some embodiments.

FIGS. 16A-16AB-3 illustrate techniques for displaying one or more time user interfaces that include one or more visual media items, in accordance with some embodiments.

FIG. 17 is a flow diagram illustrating methods for displaying a time user interface that includes one or more visual media items, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for displaying background regions. In some embodiments, a first background region is displayed having a first color, wherein in response to detecting an update event, the first background region is displayed having a second color. Such techniques can reduce the cognitive burden on a user who uses time user interfaces having background regions, thereby enhancing productivity. Further, such techniques can reduce processor and battery power otherwise wasted on redundant user inputs.

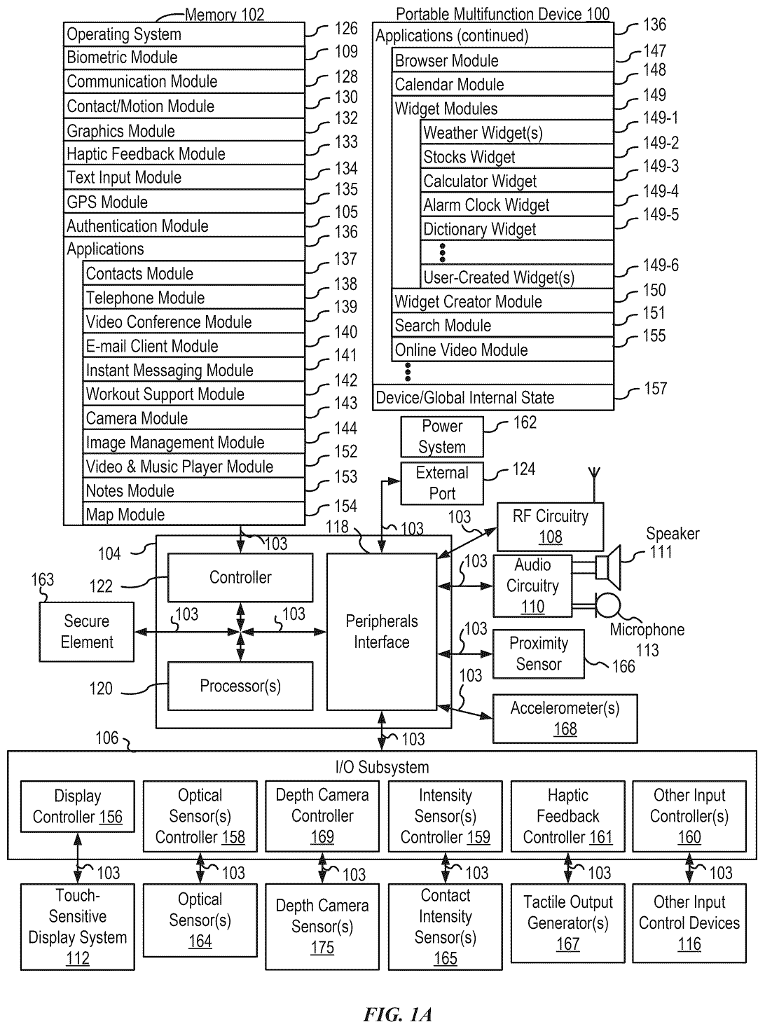

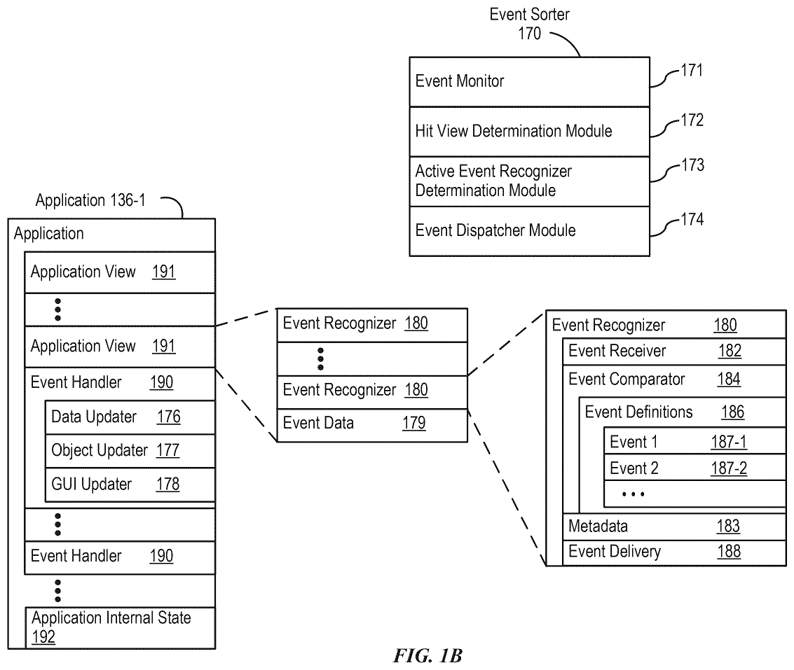

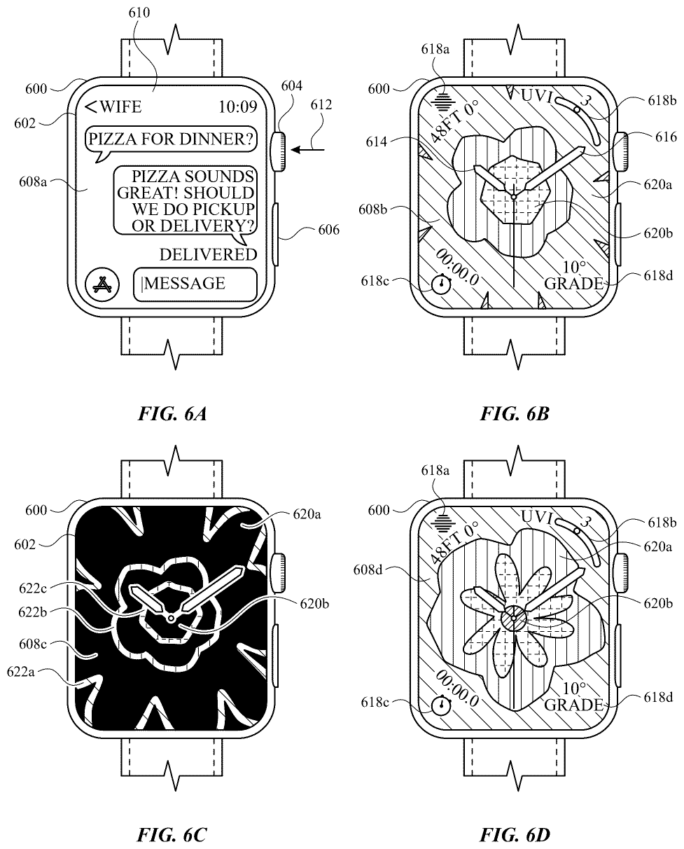

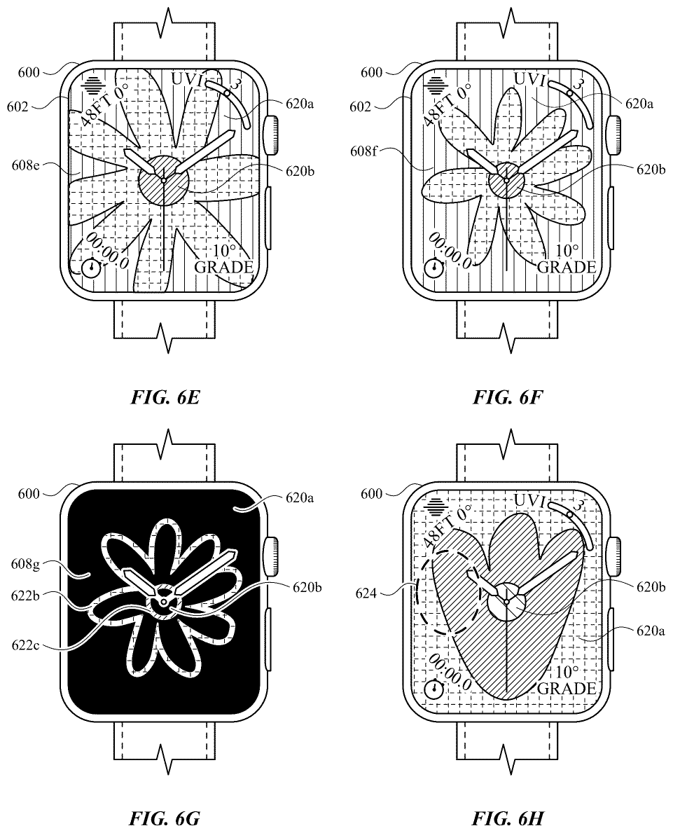

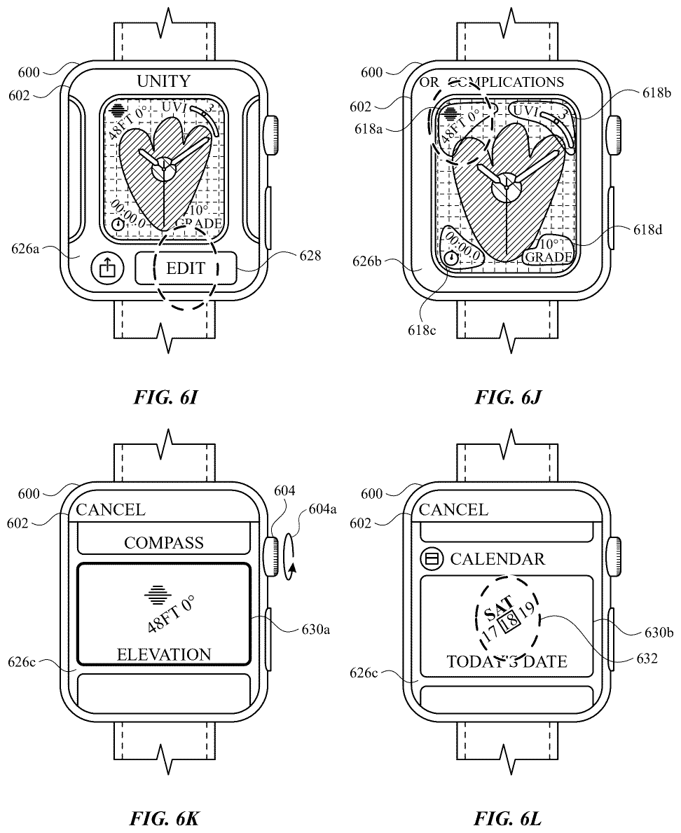

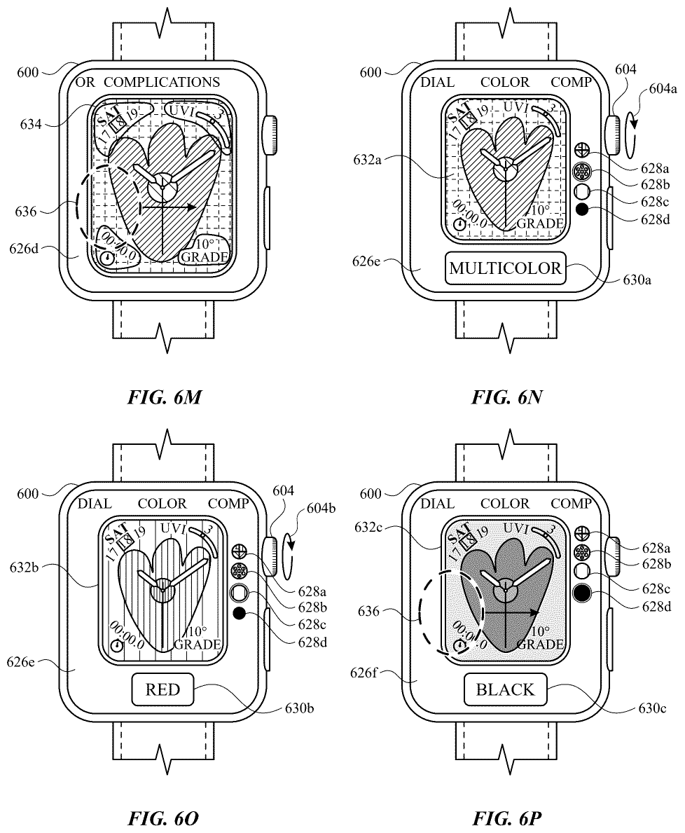

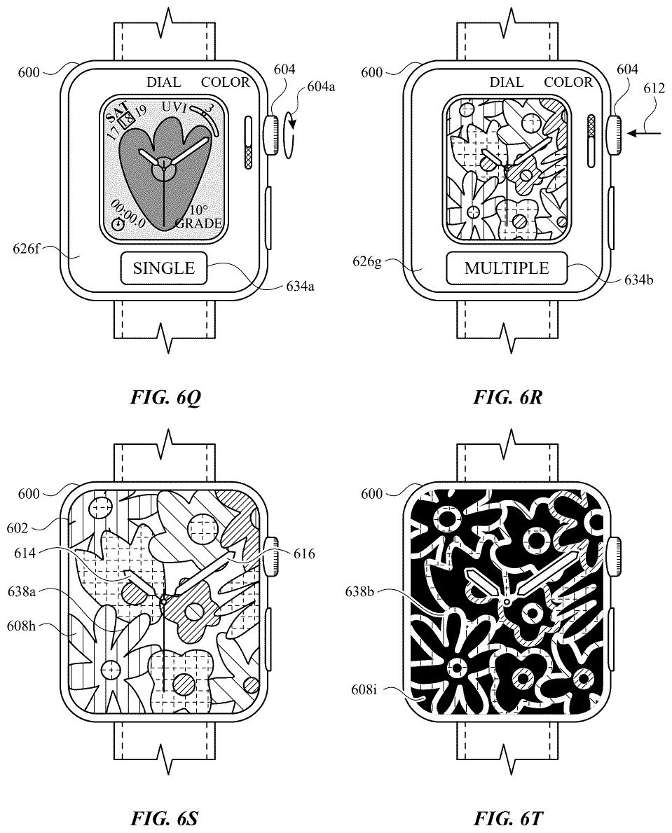

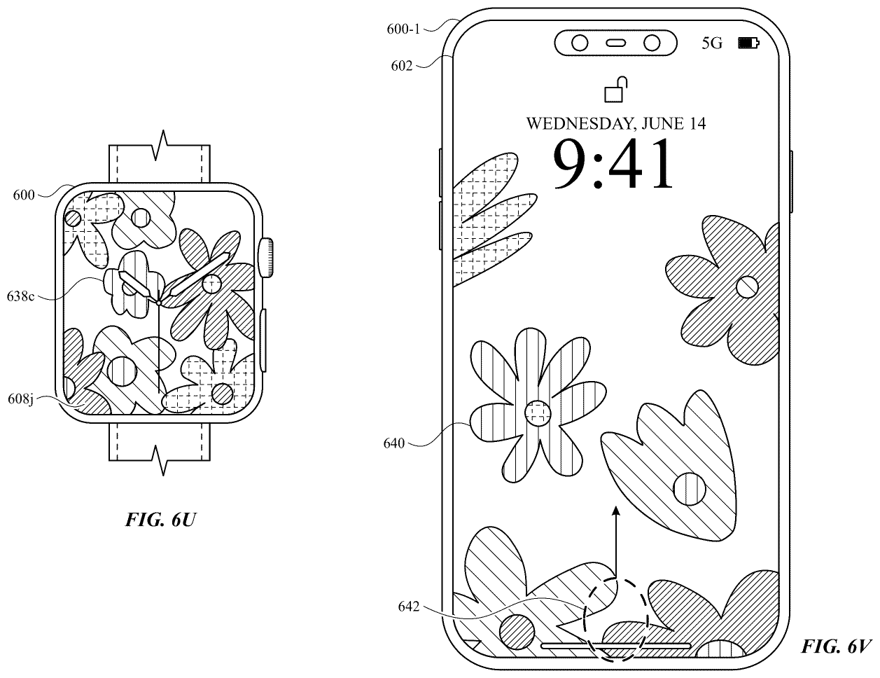

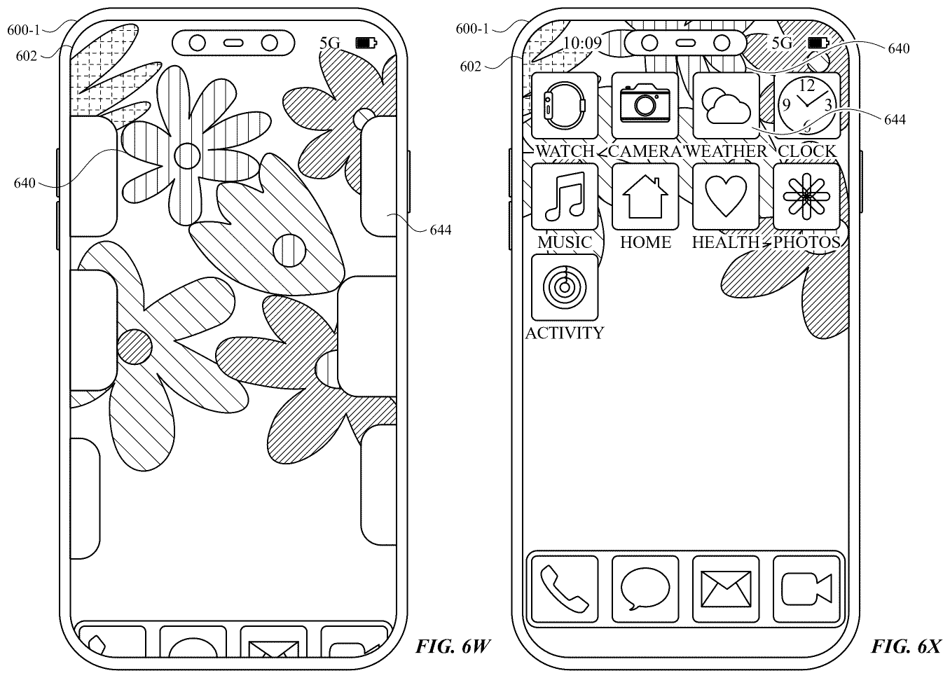

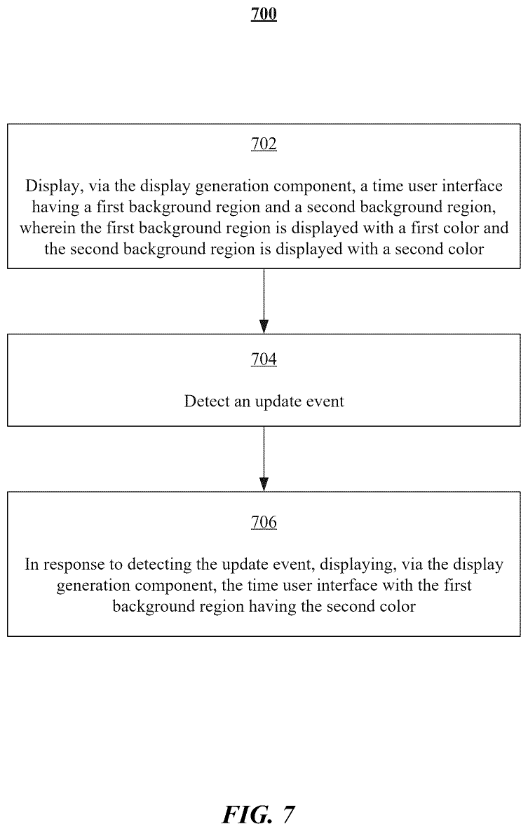

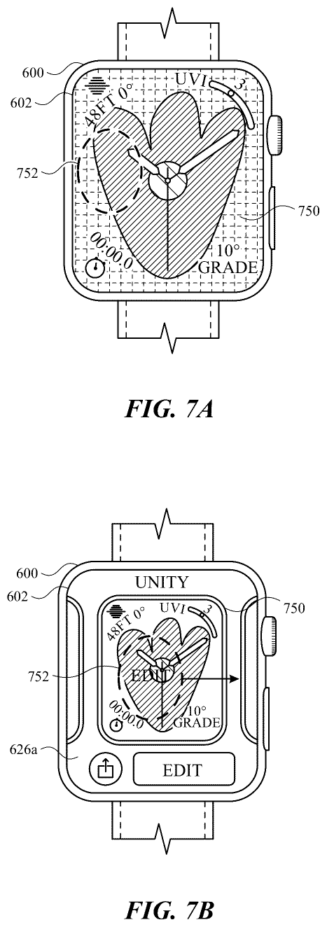

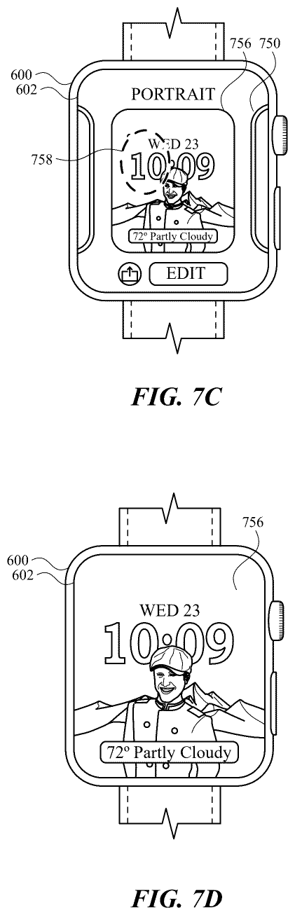

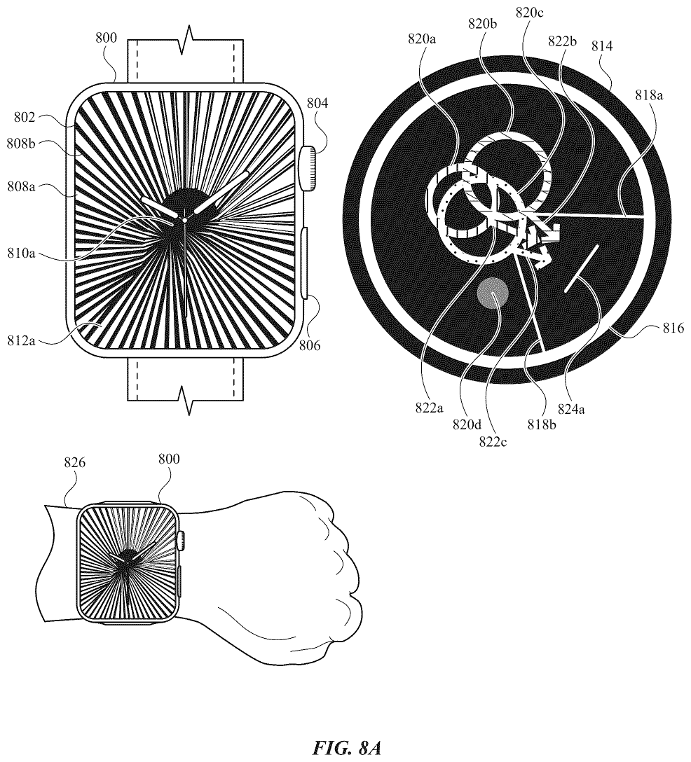

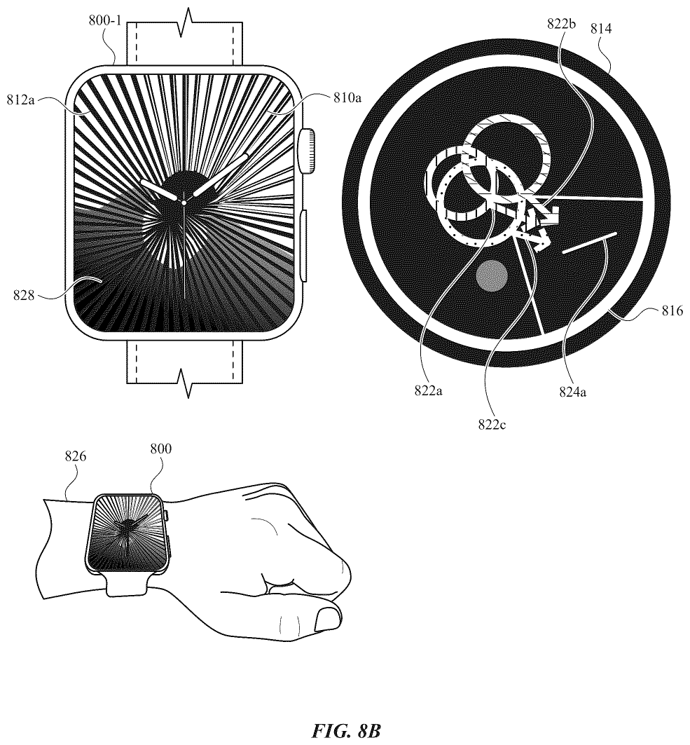

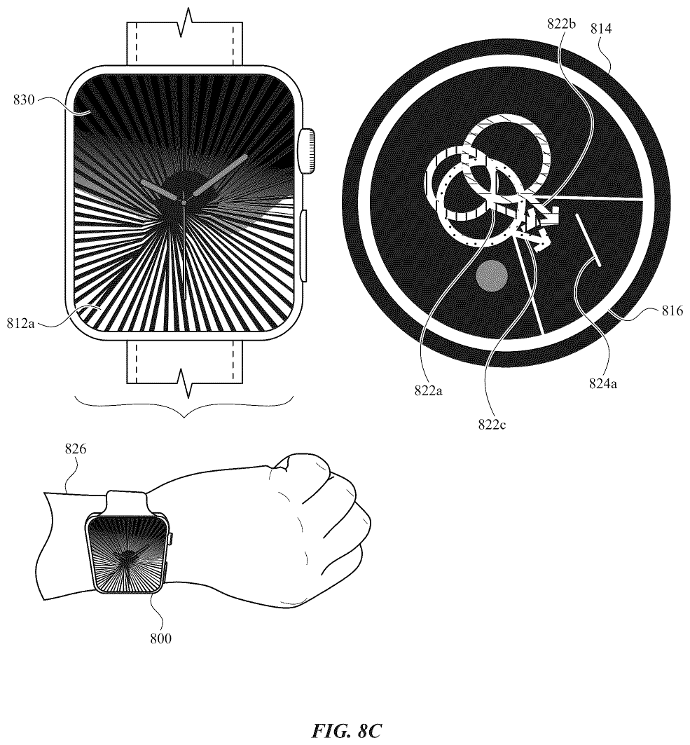

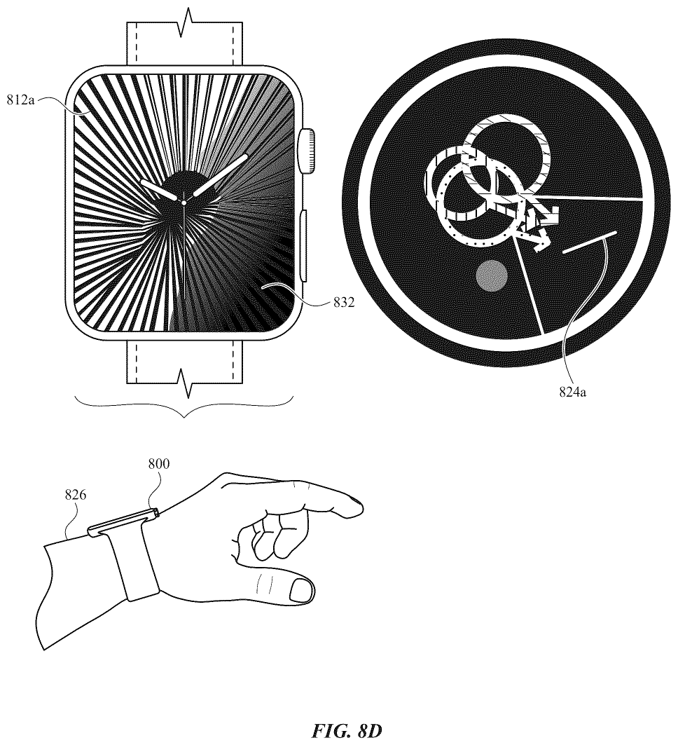

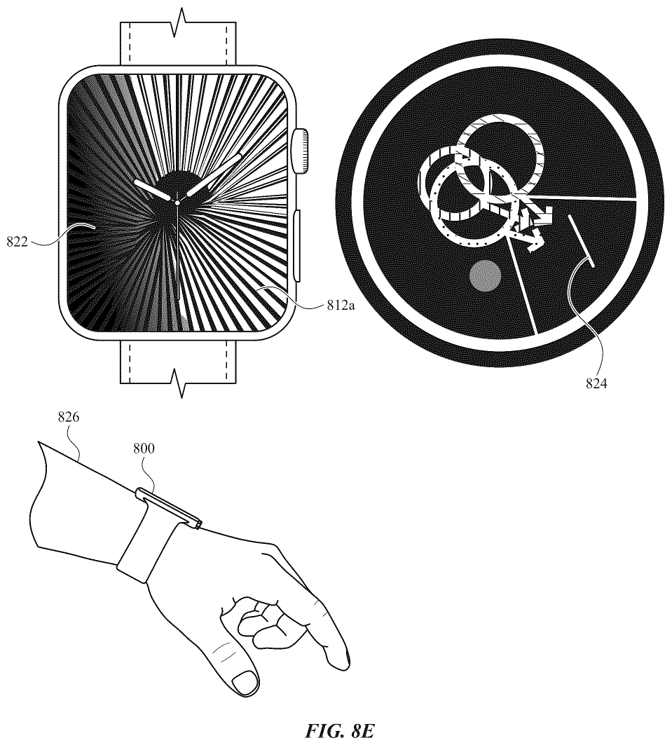

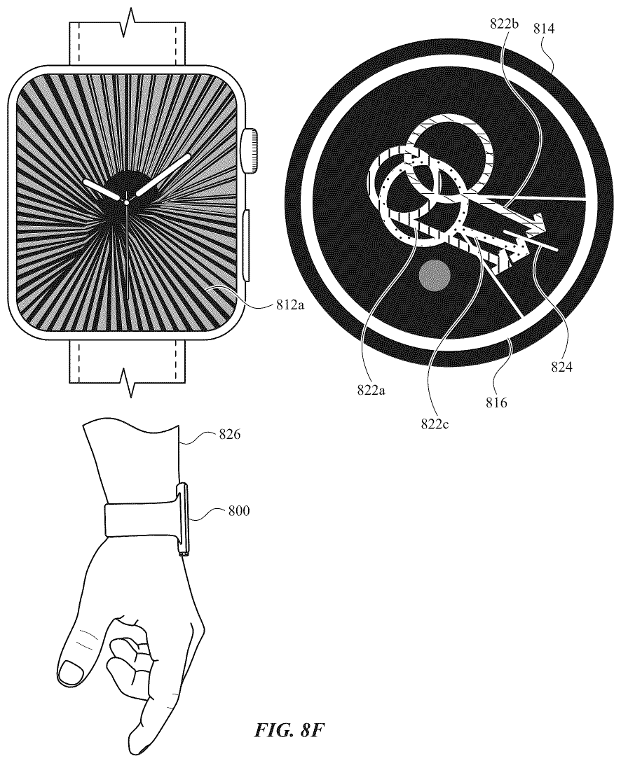

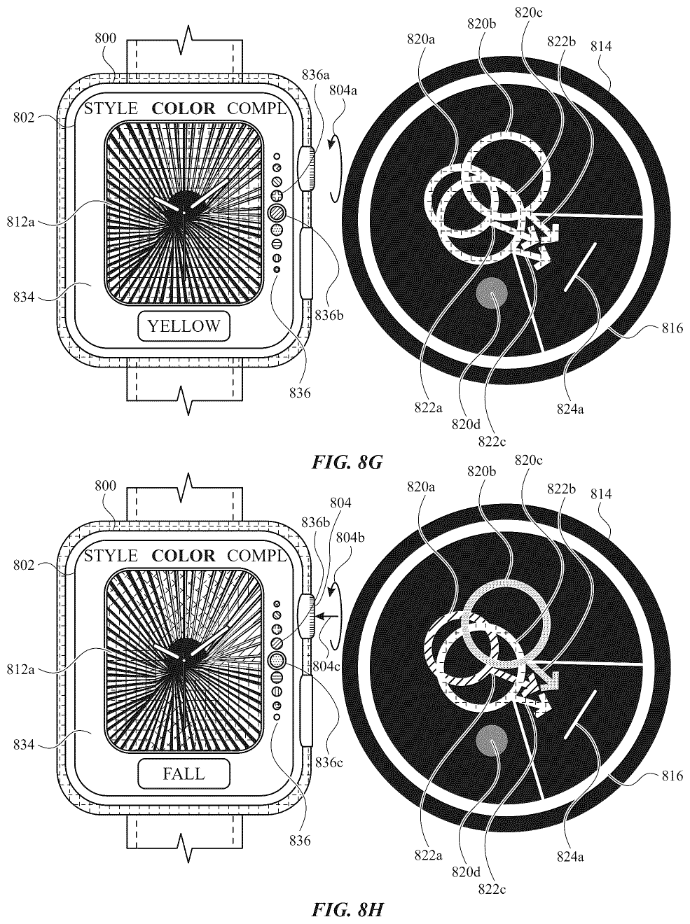

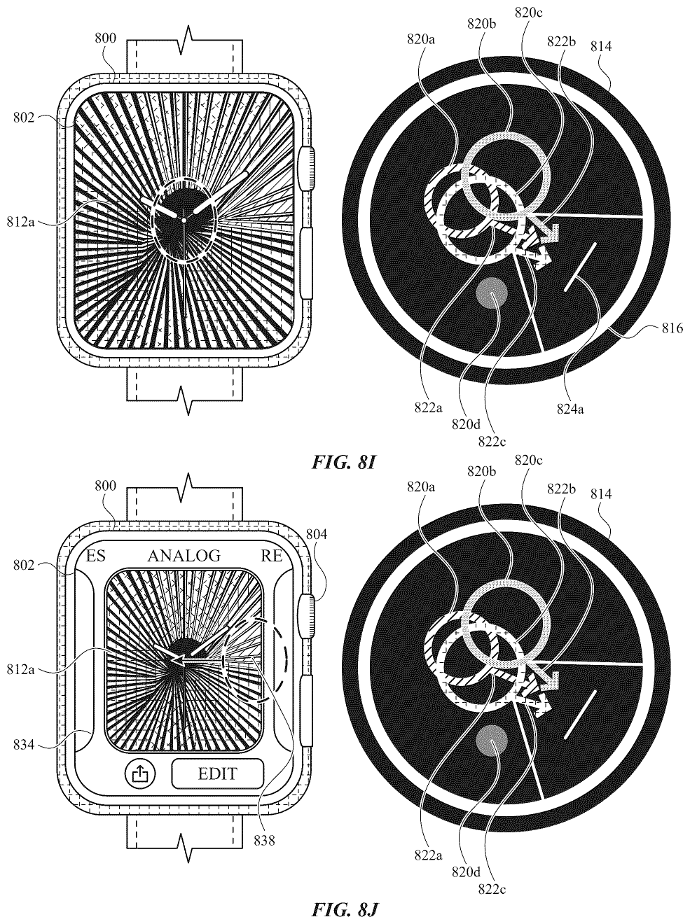

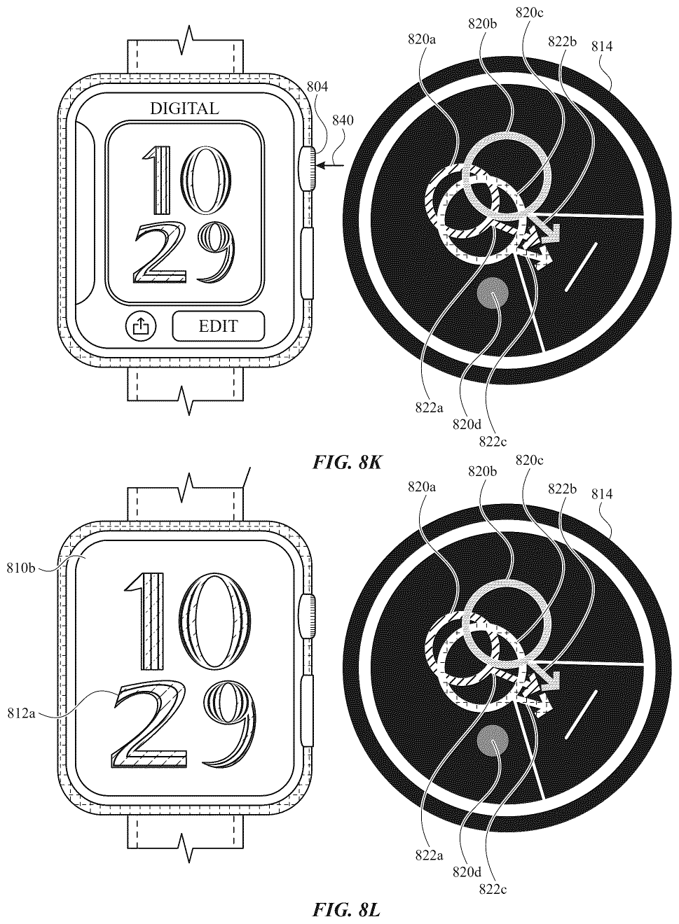

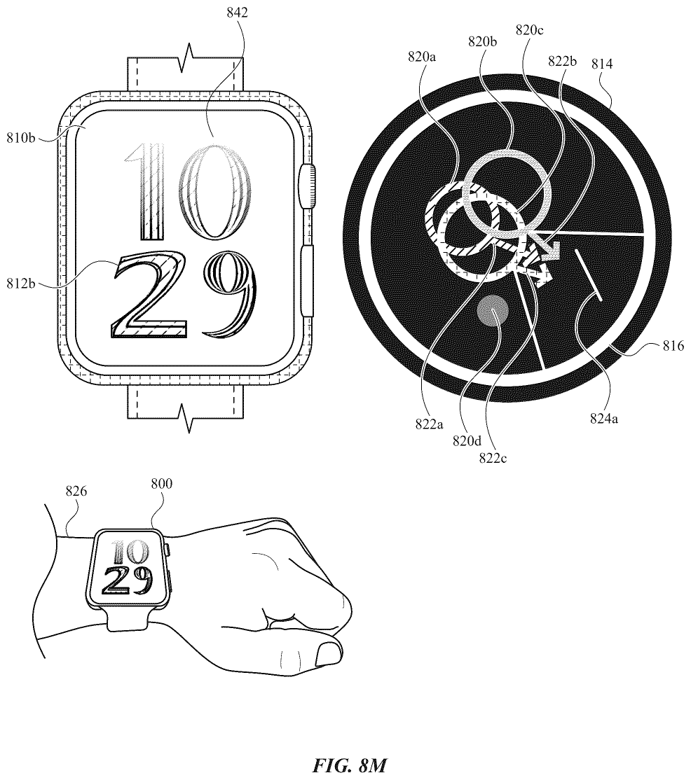

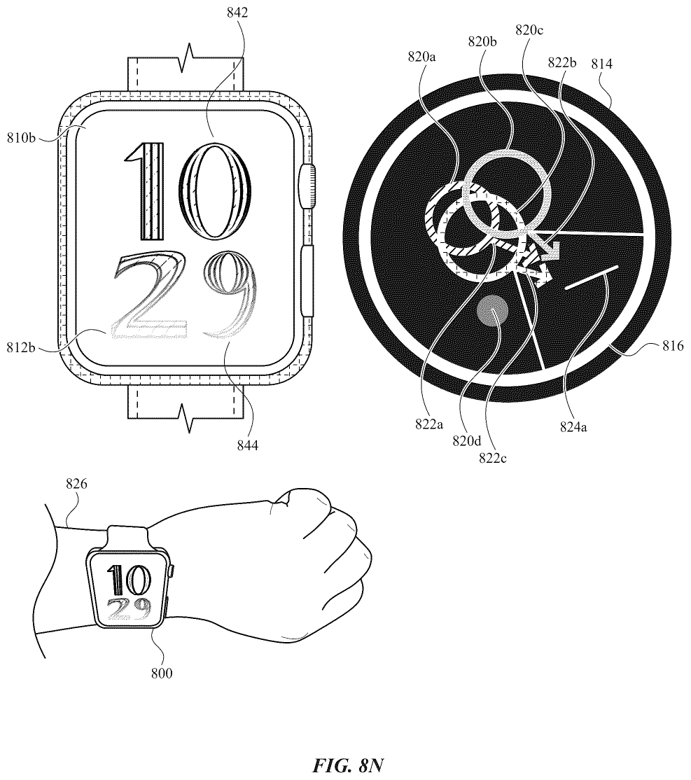

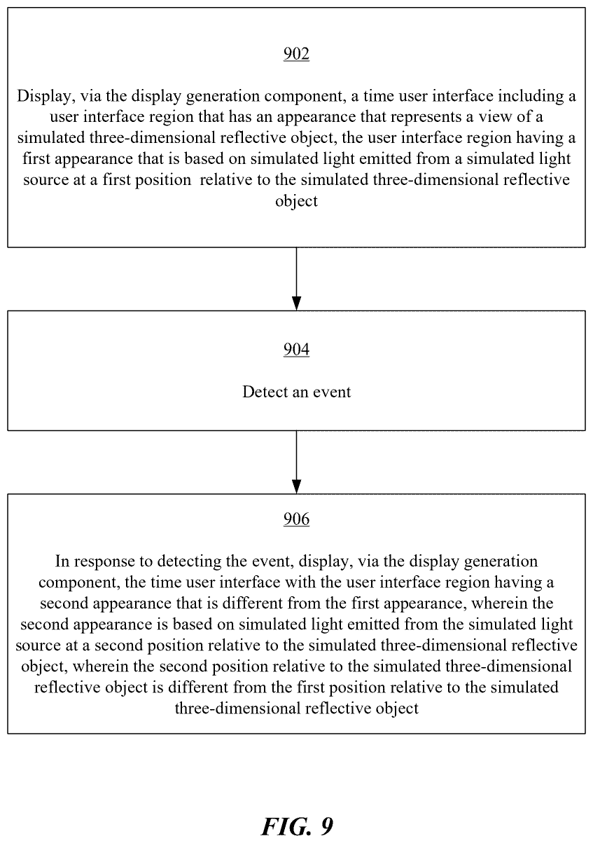

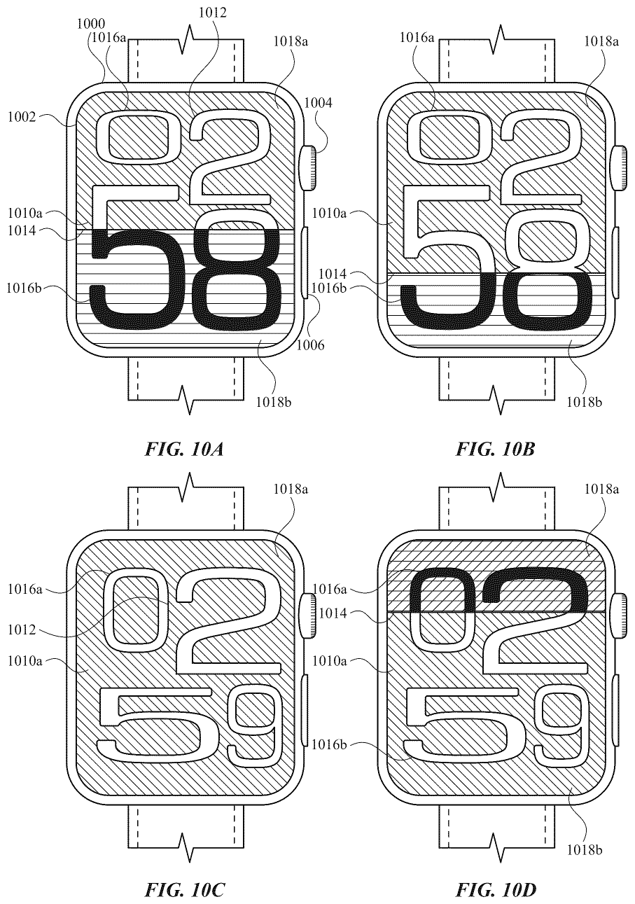

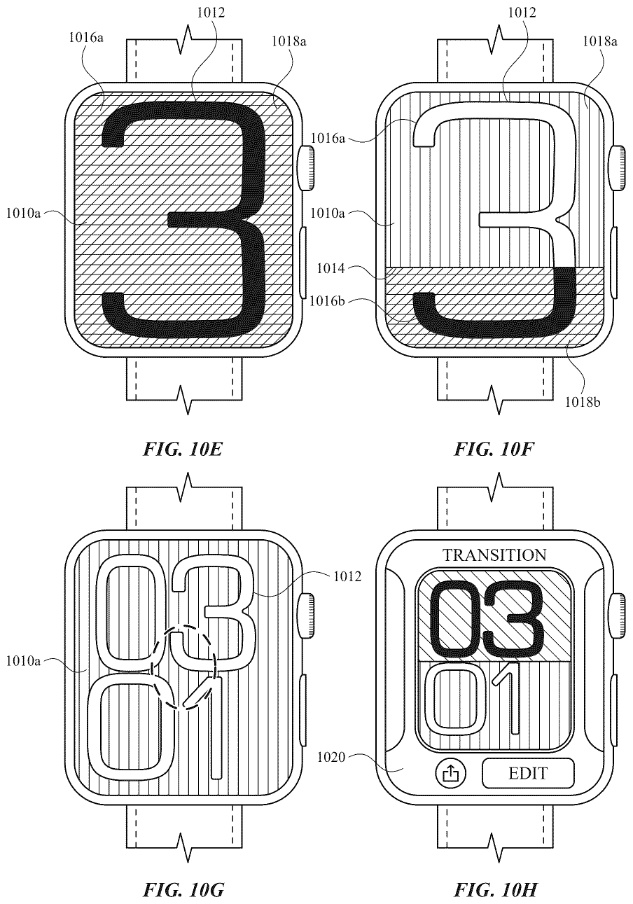

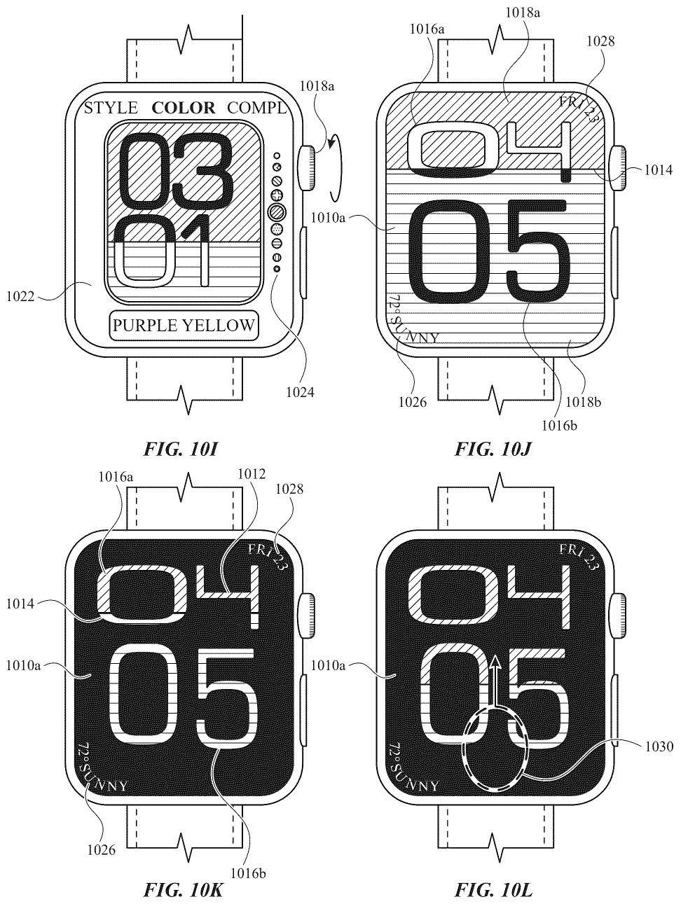

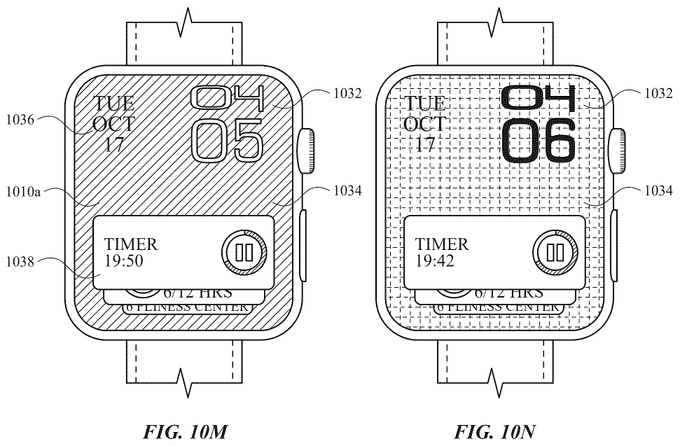

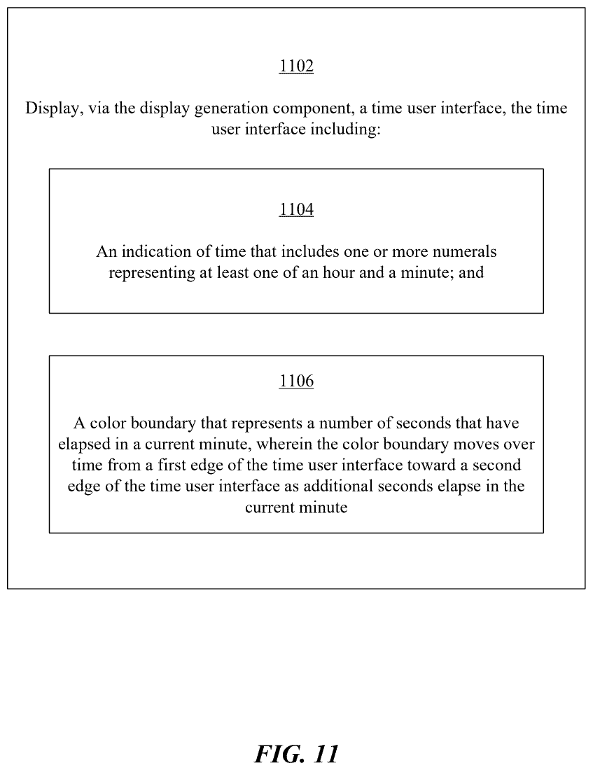

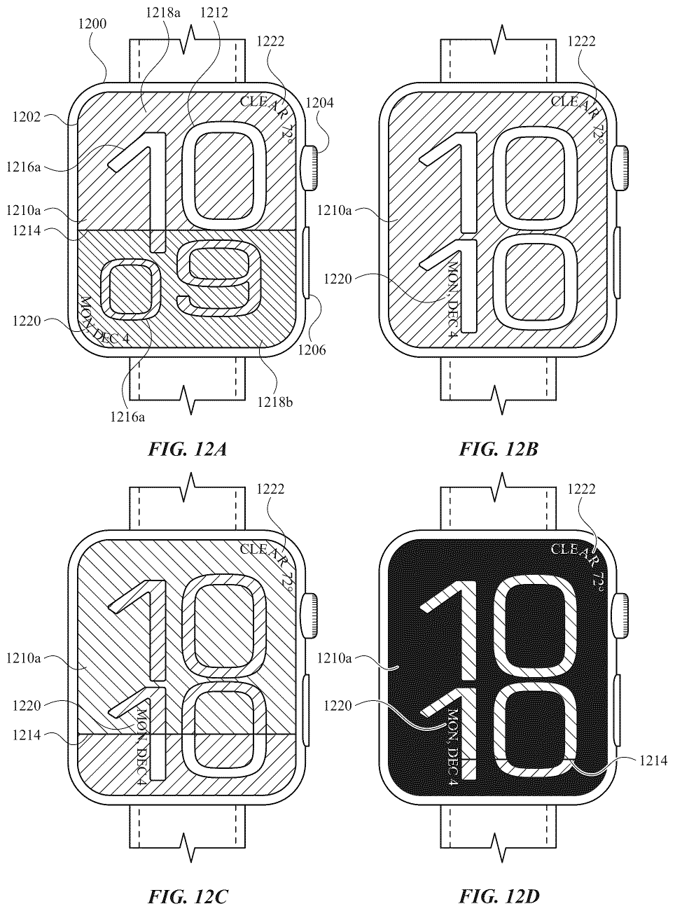

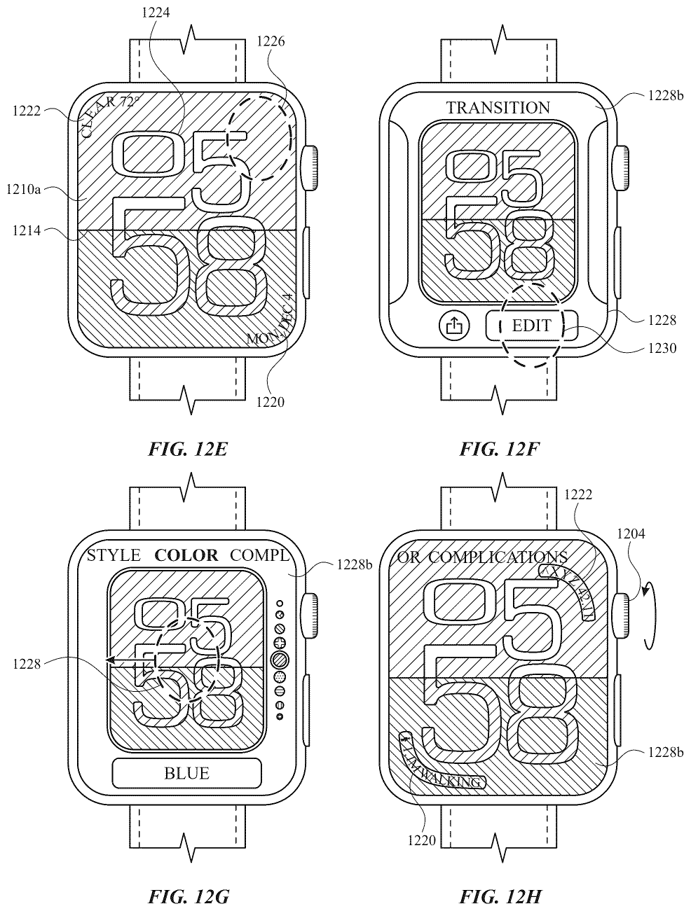

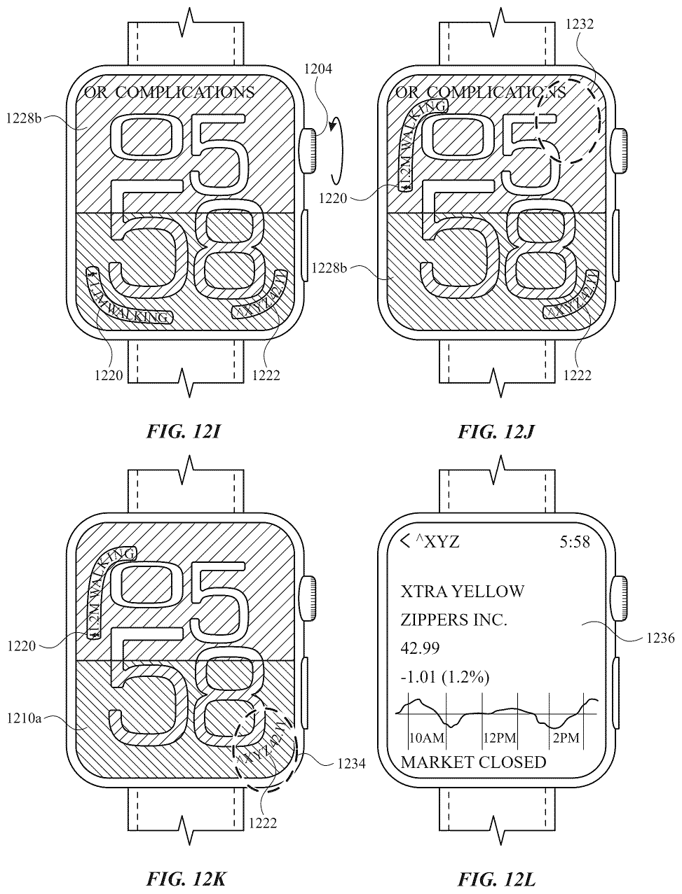

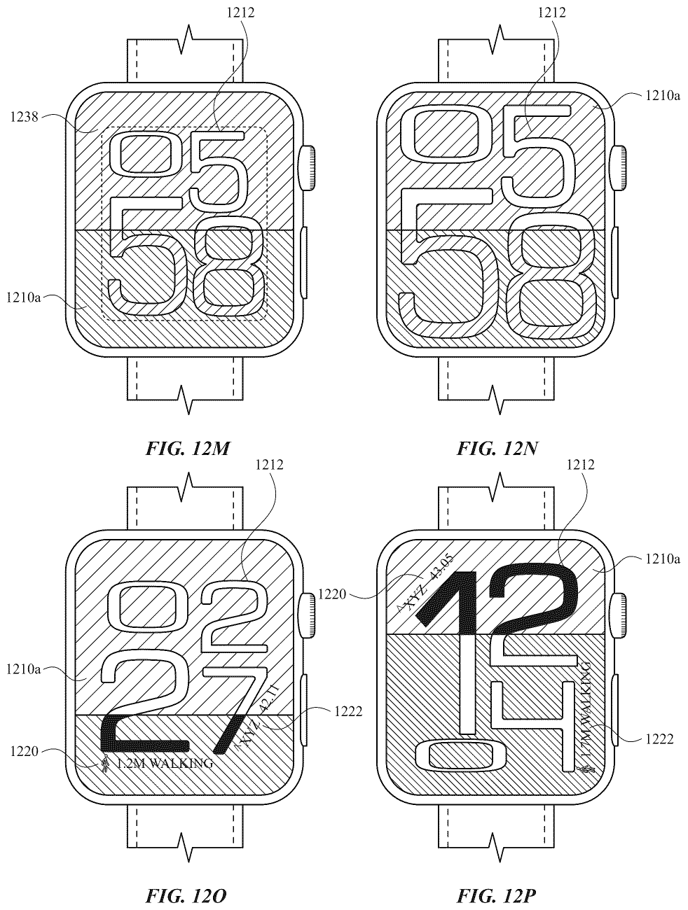

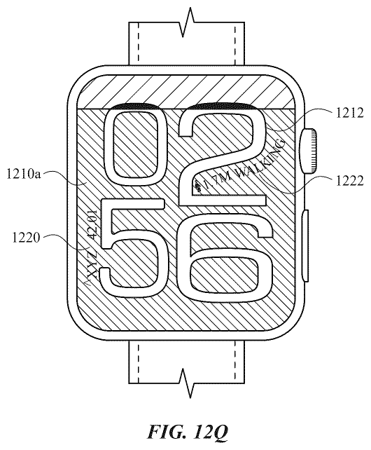

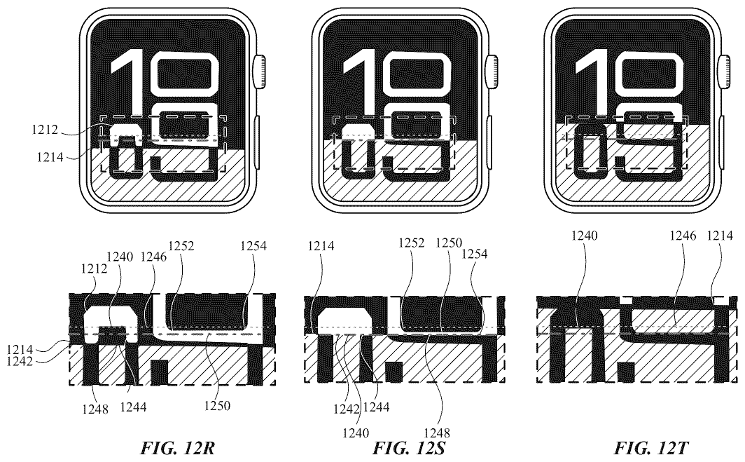

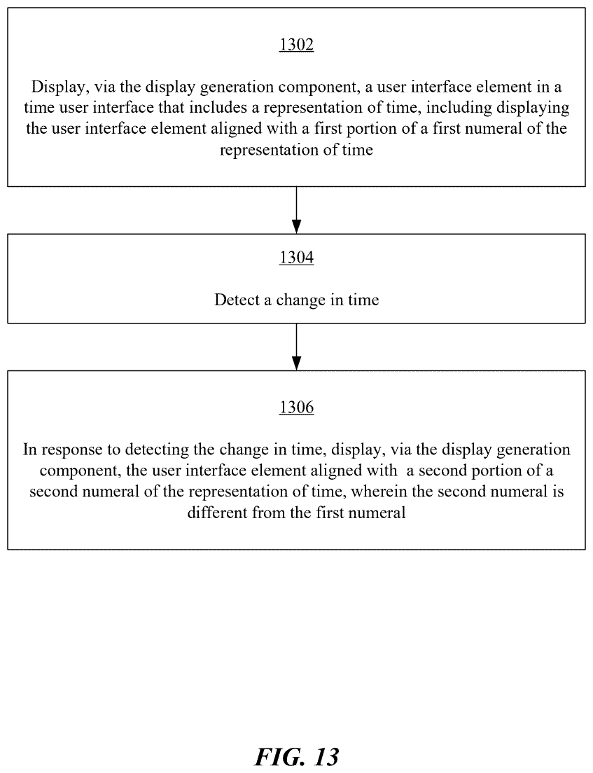

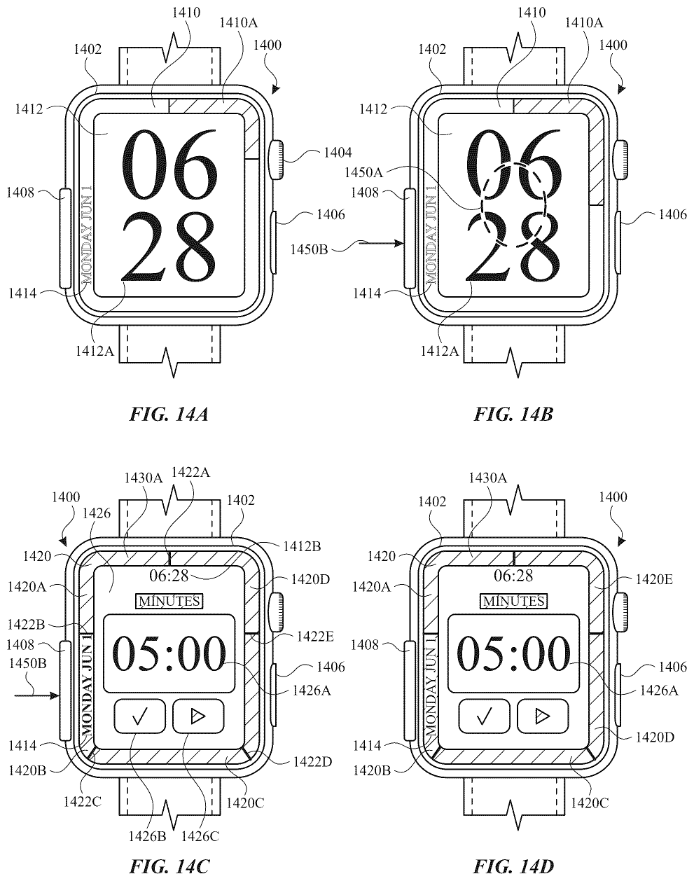

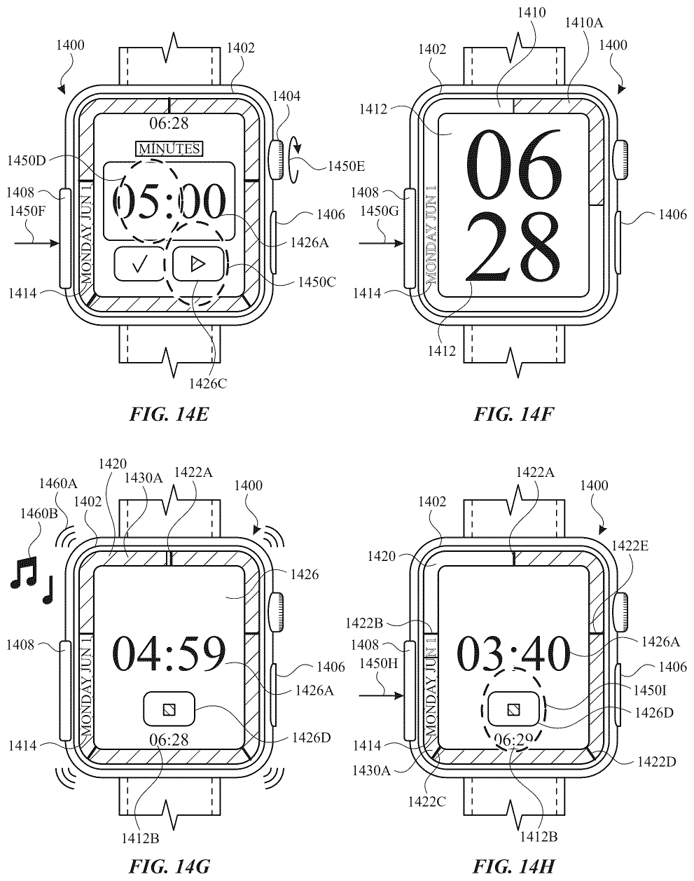

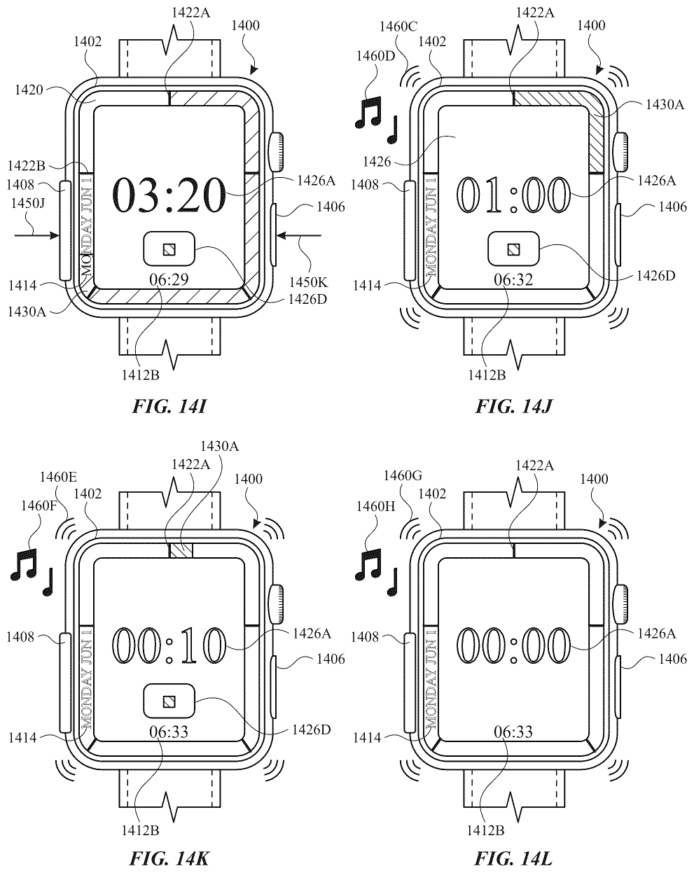

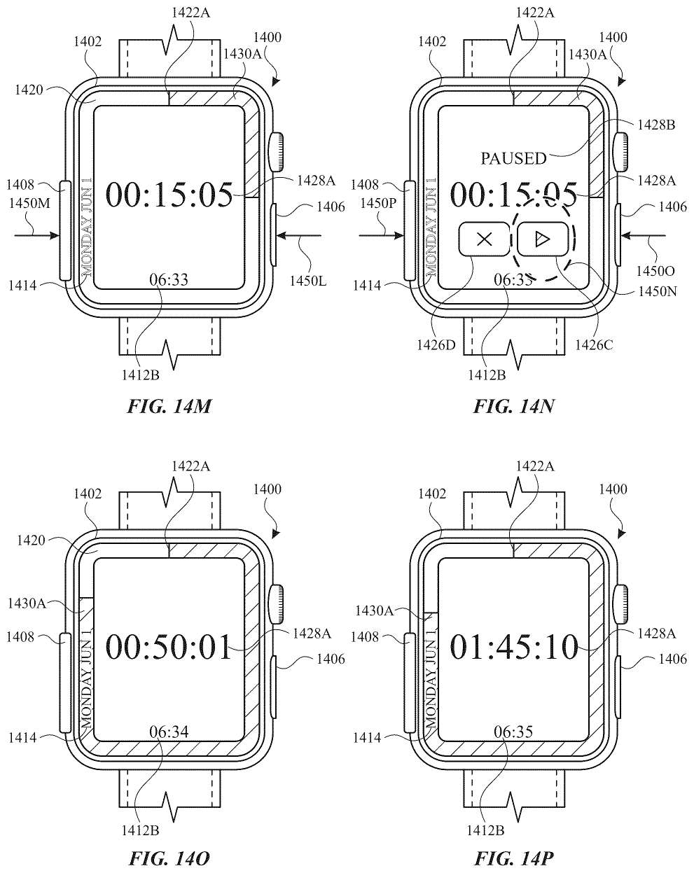

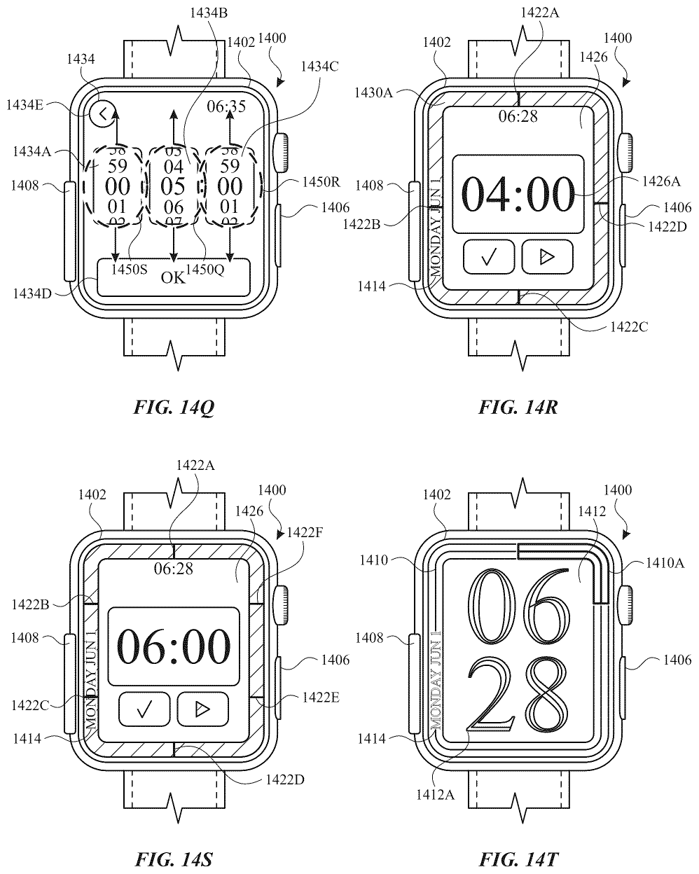

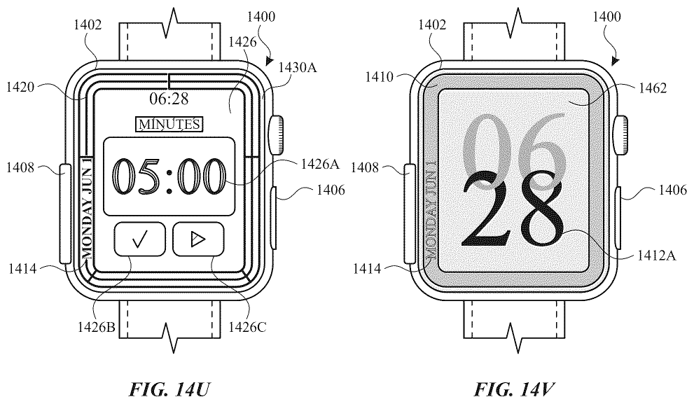

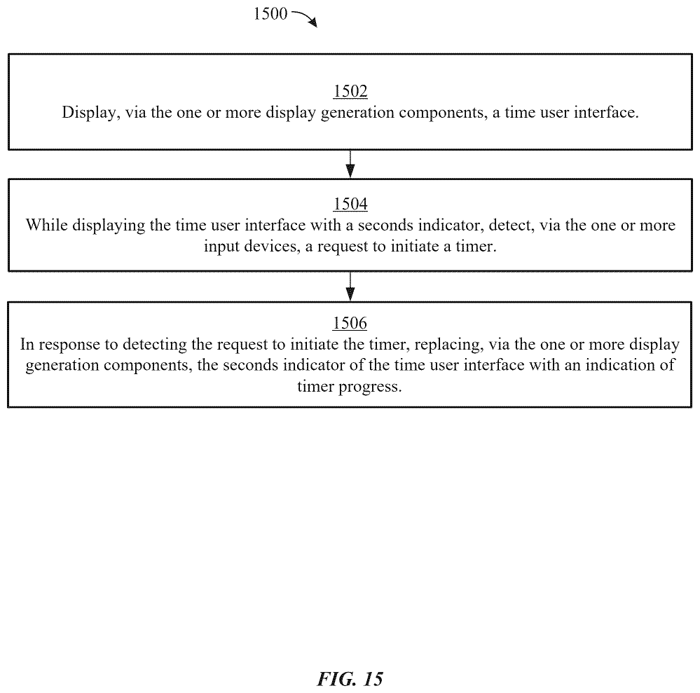

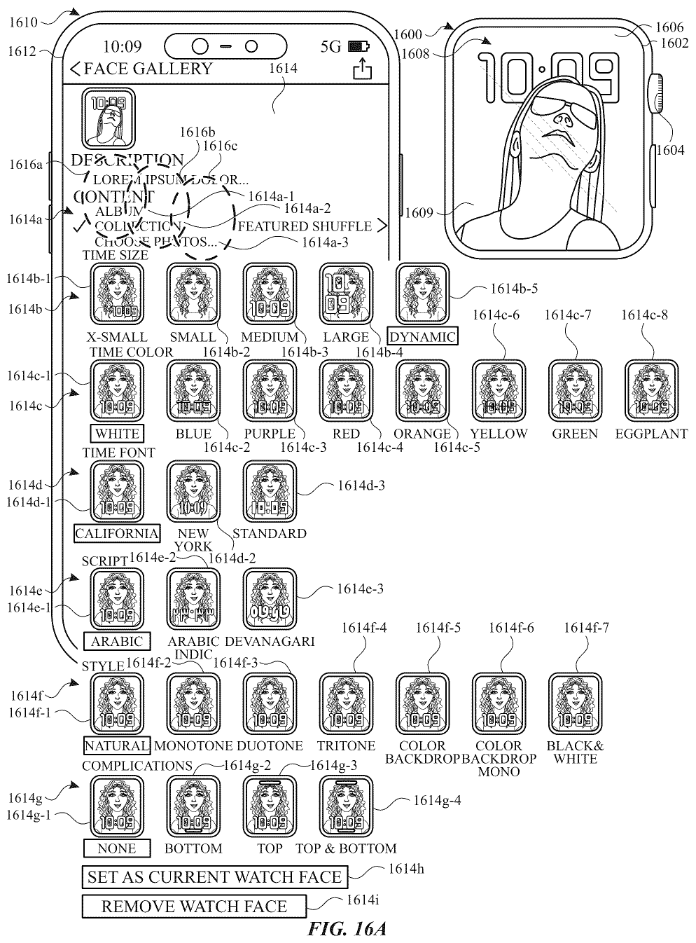

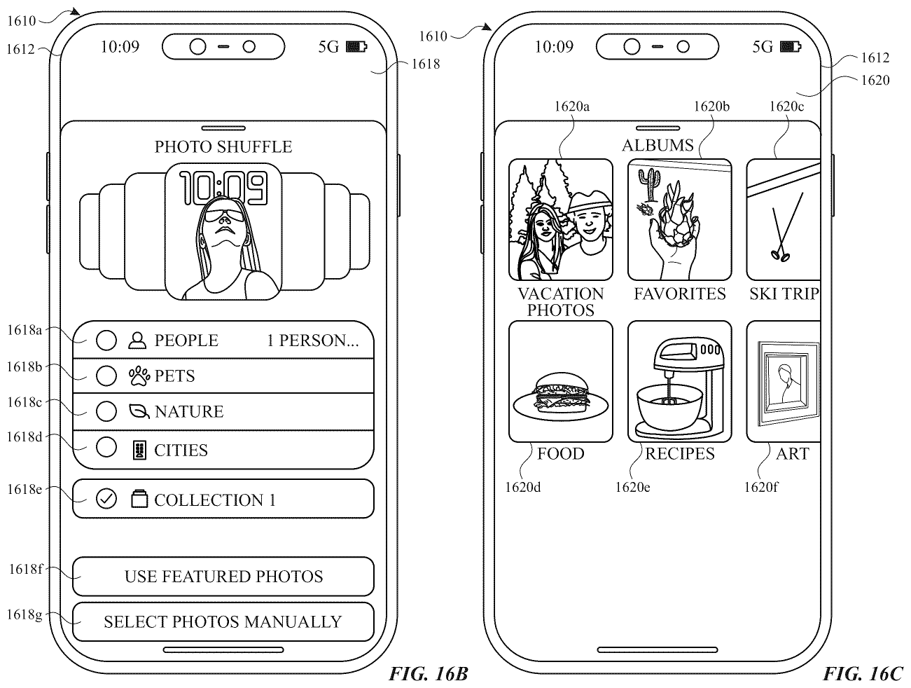

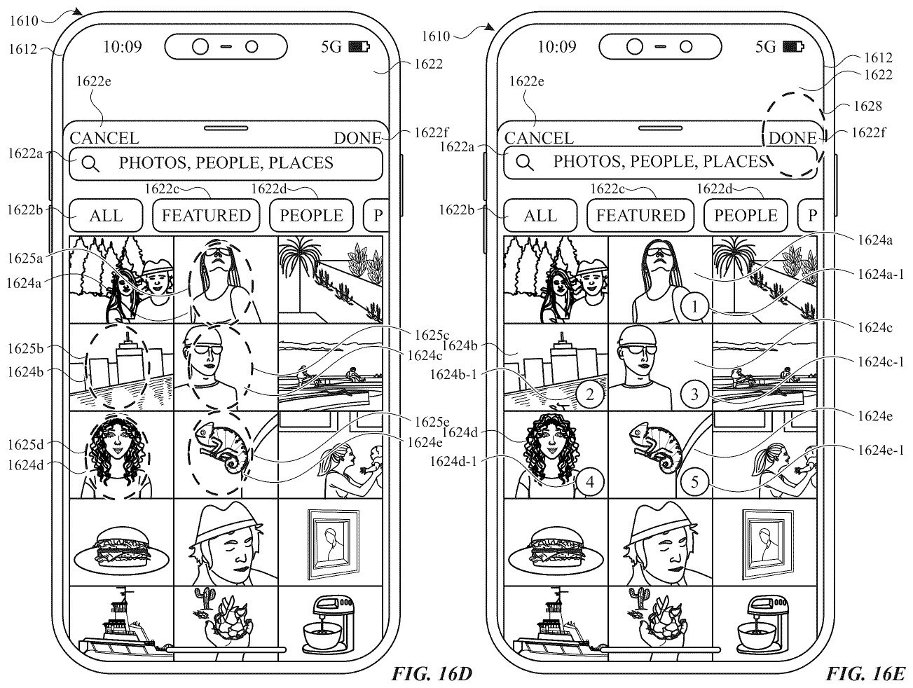

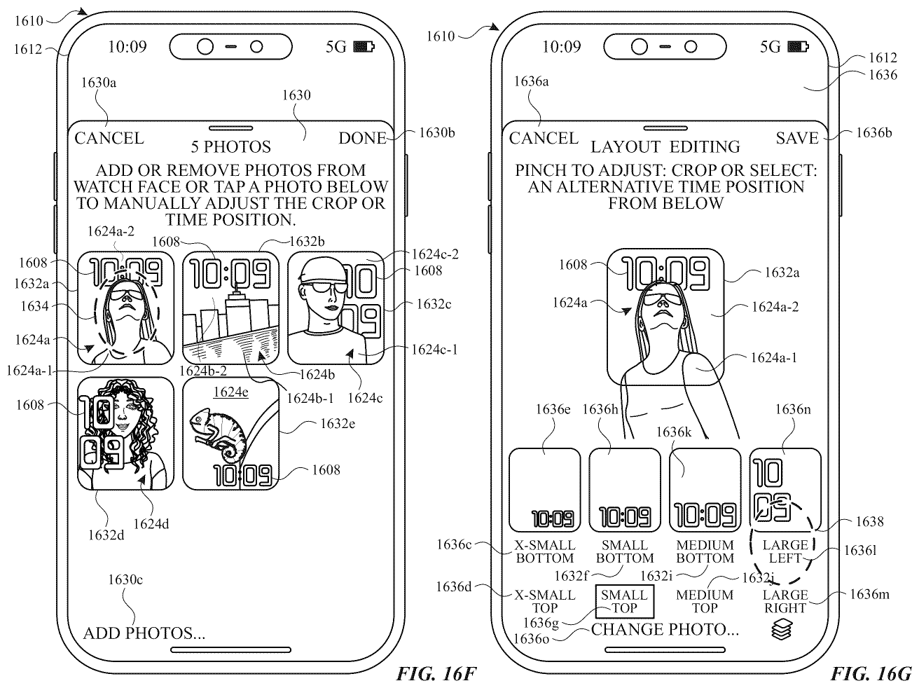

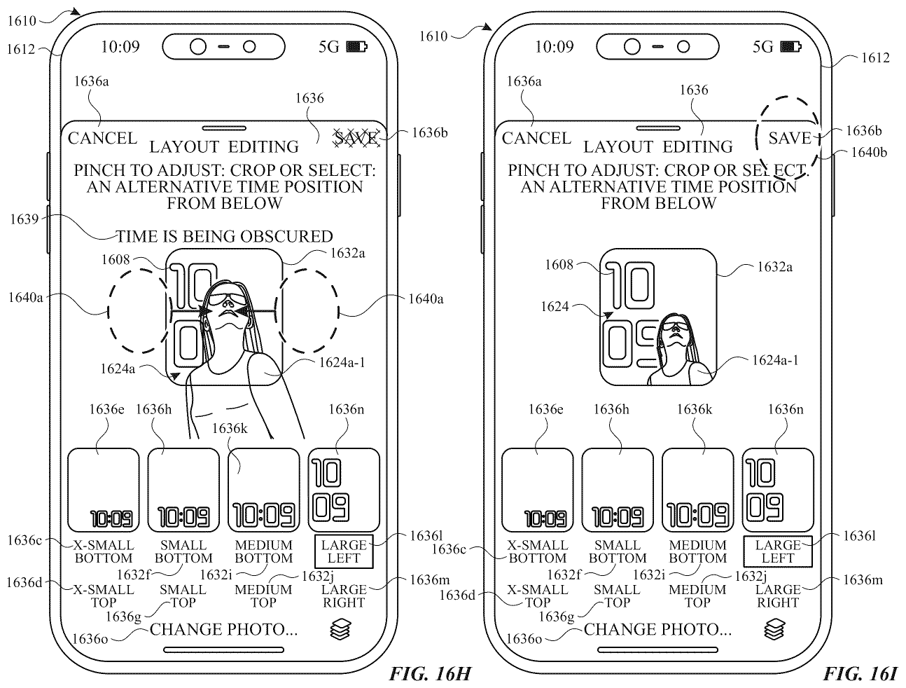

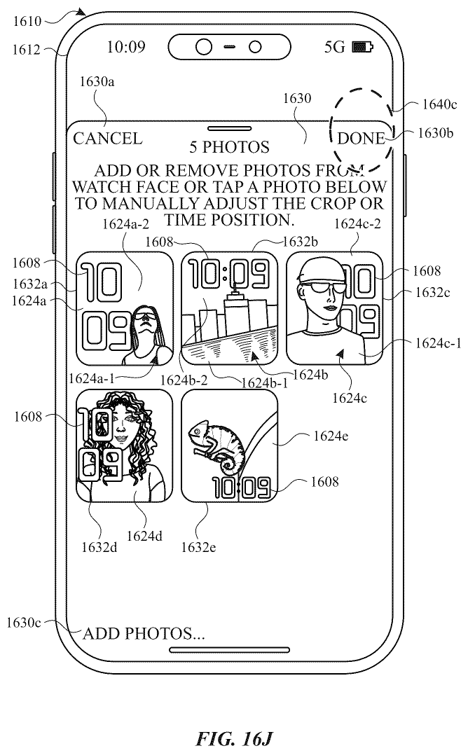

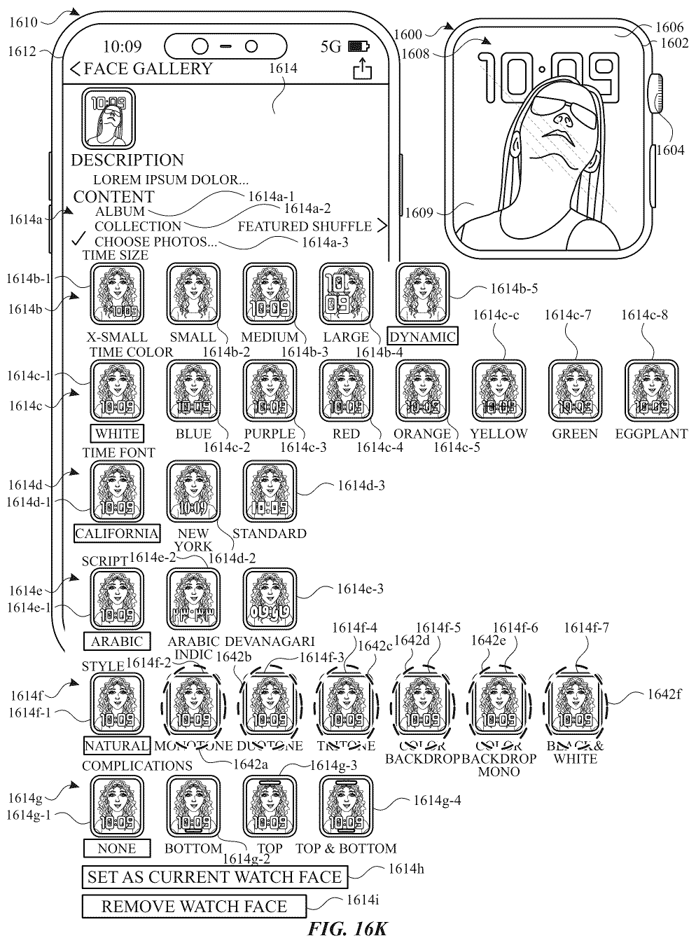

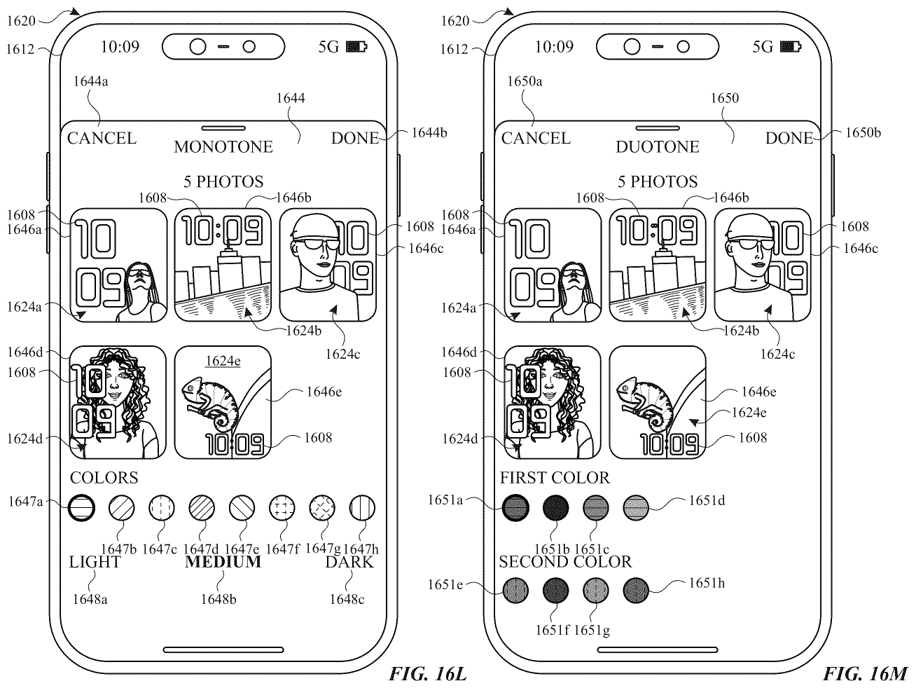

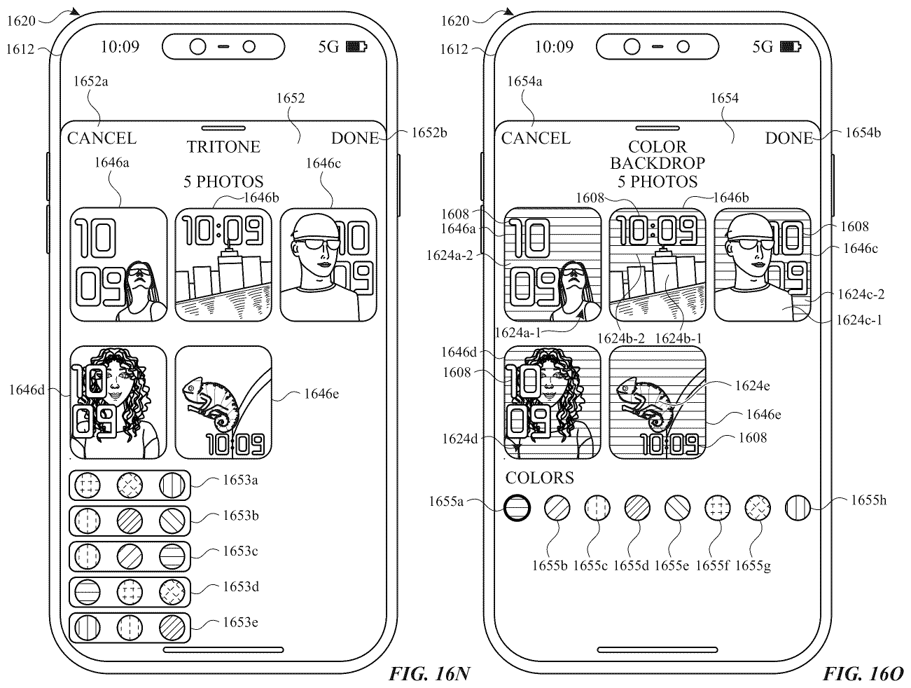

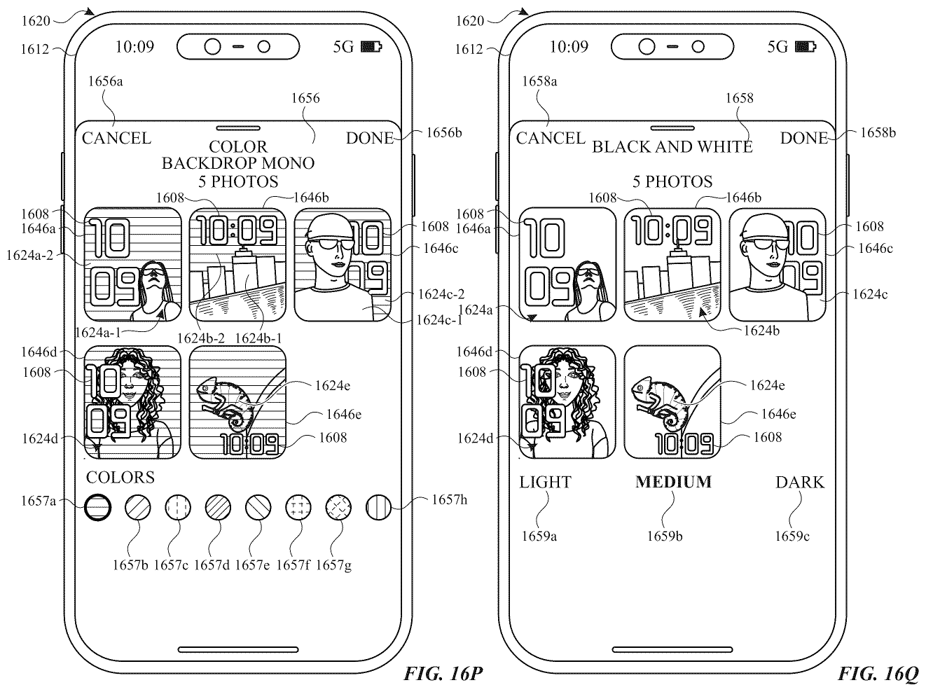

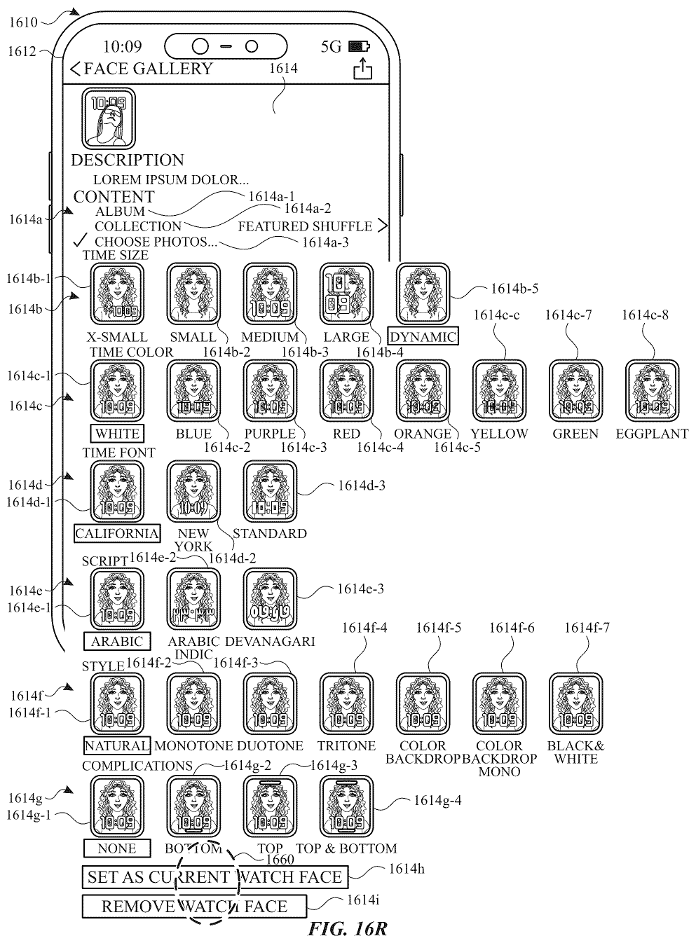

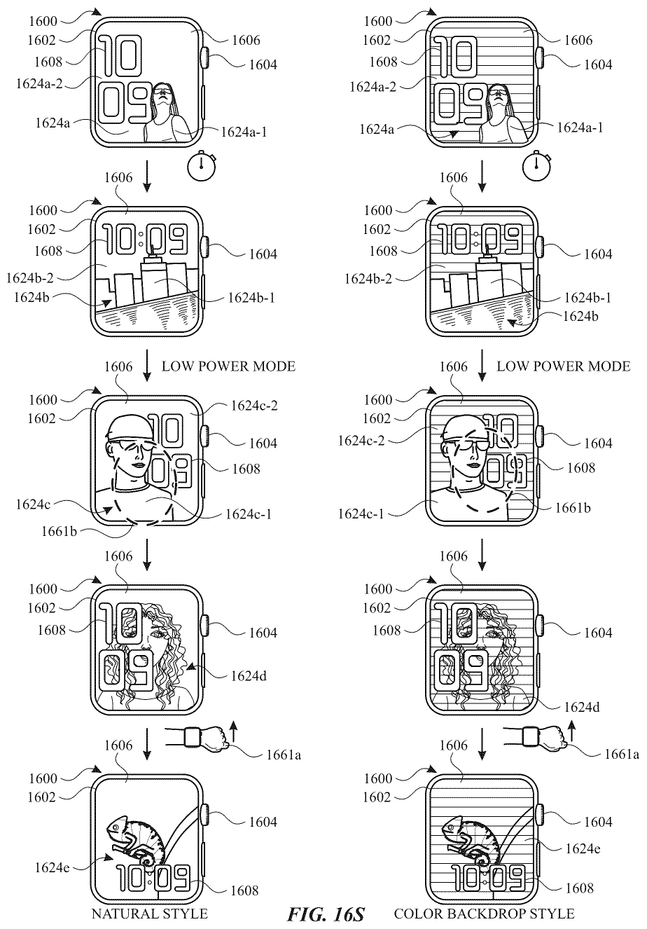

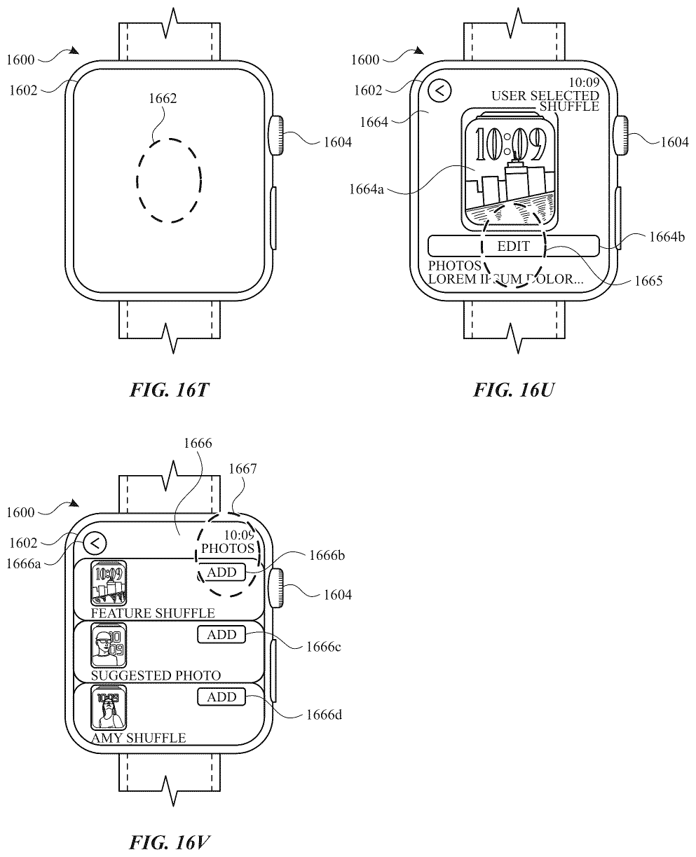

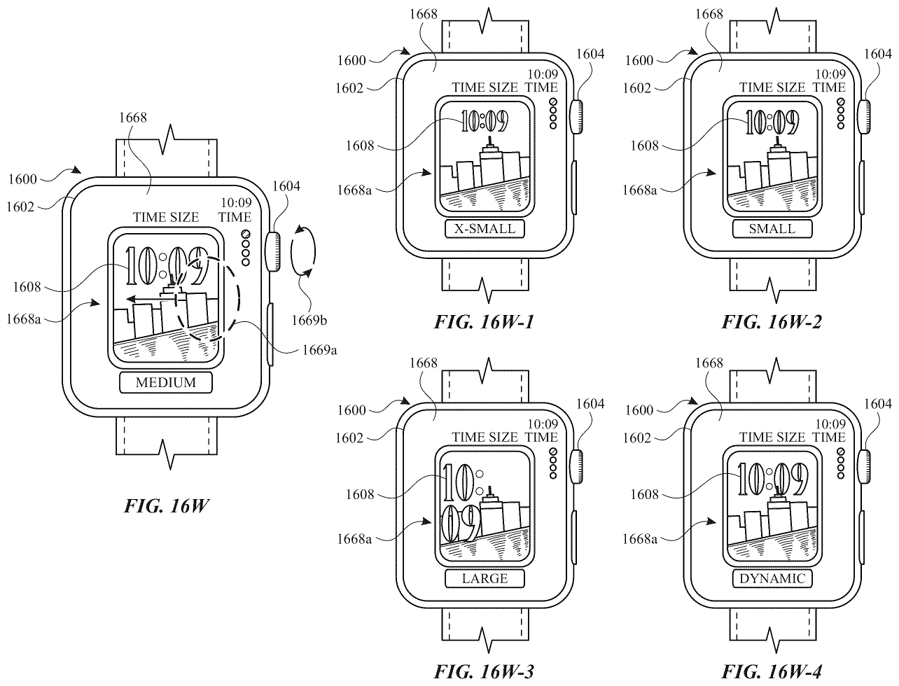

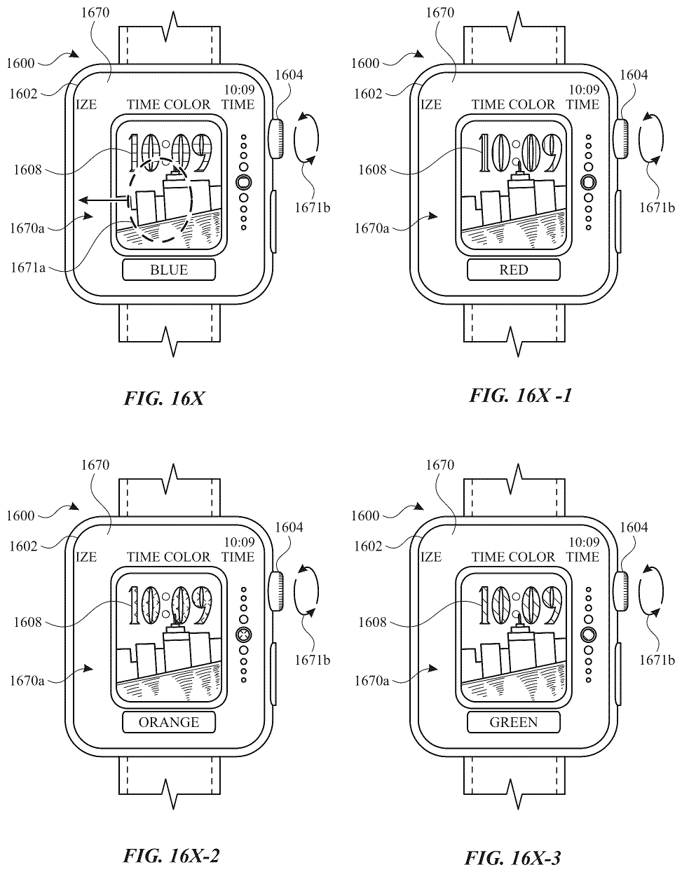

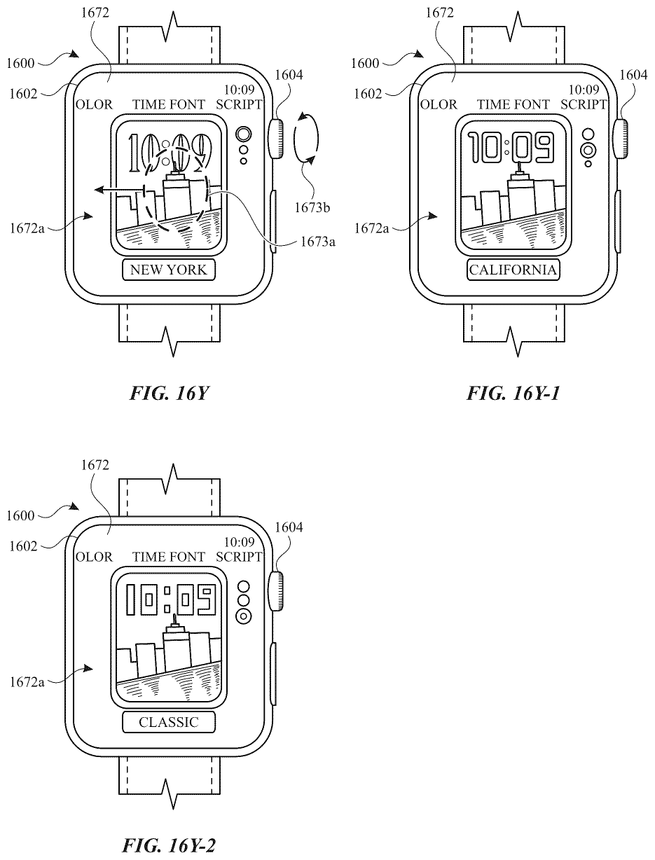

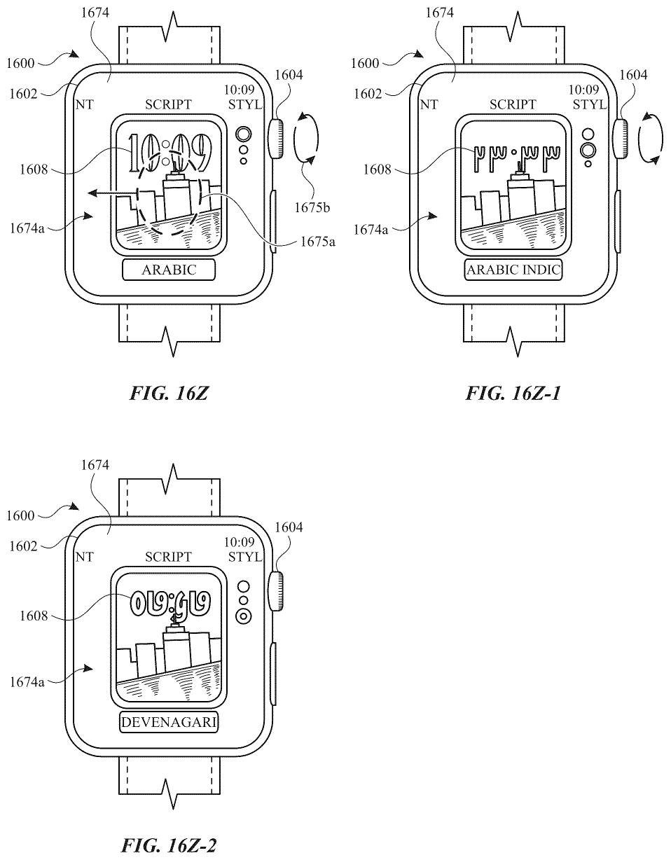

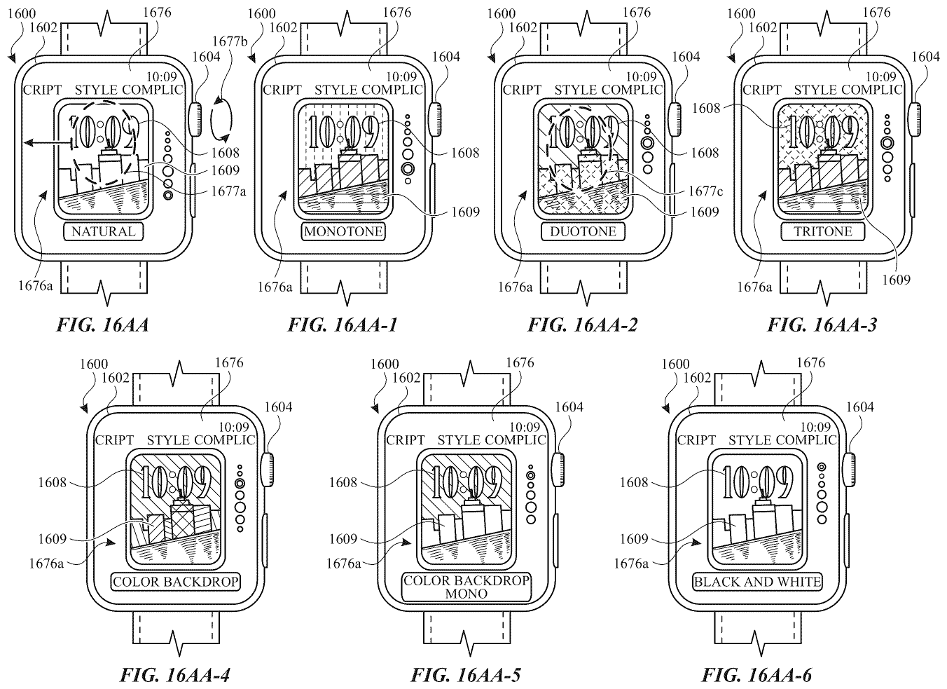

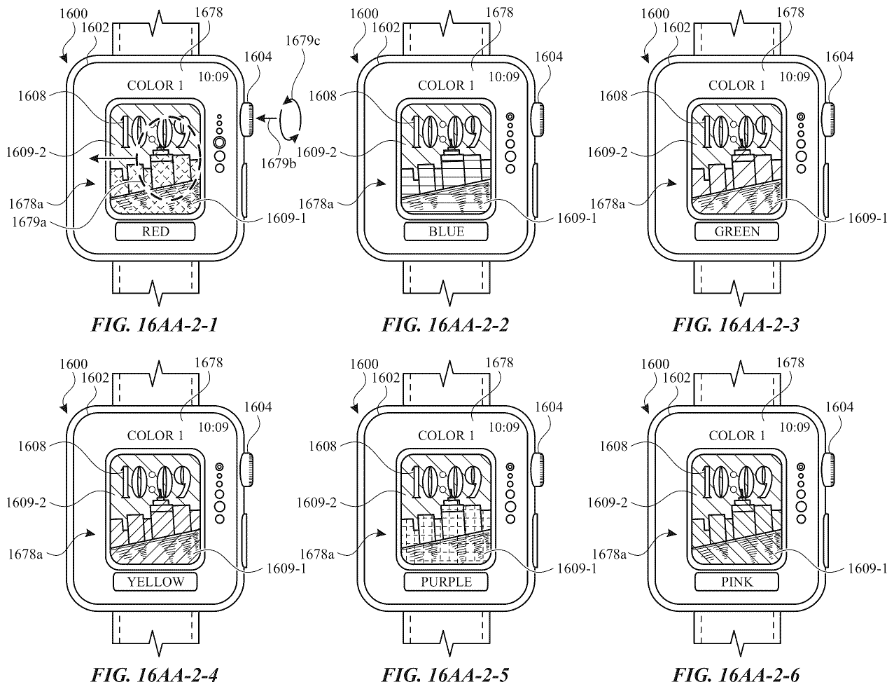

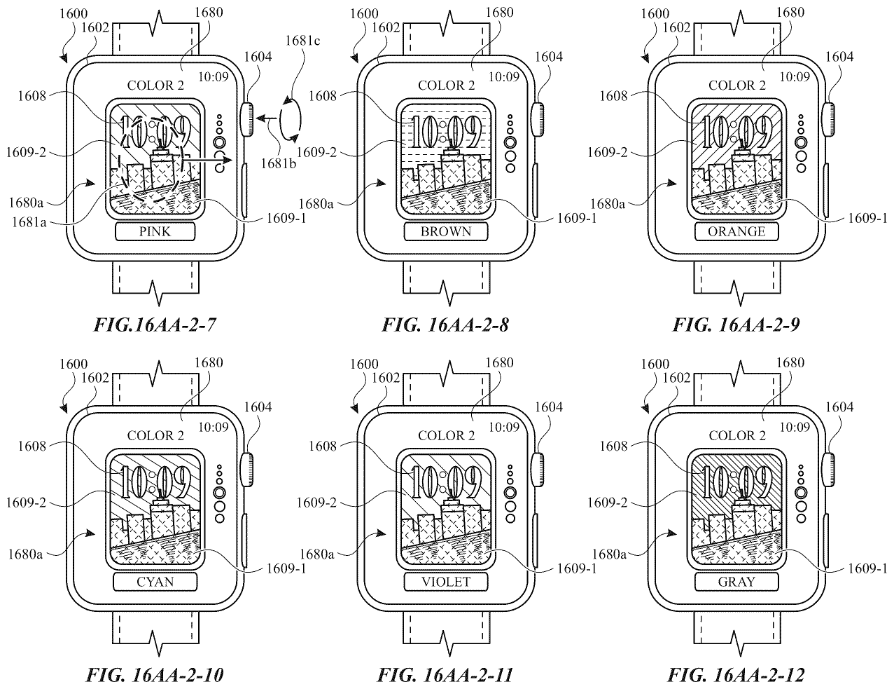

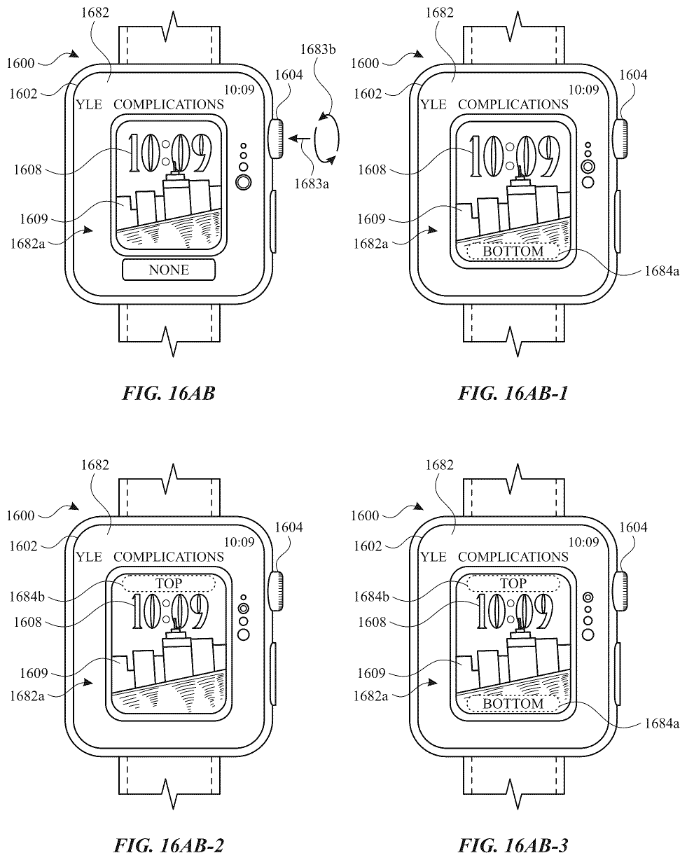

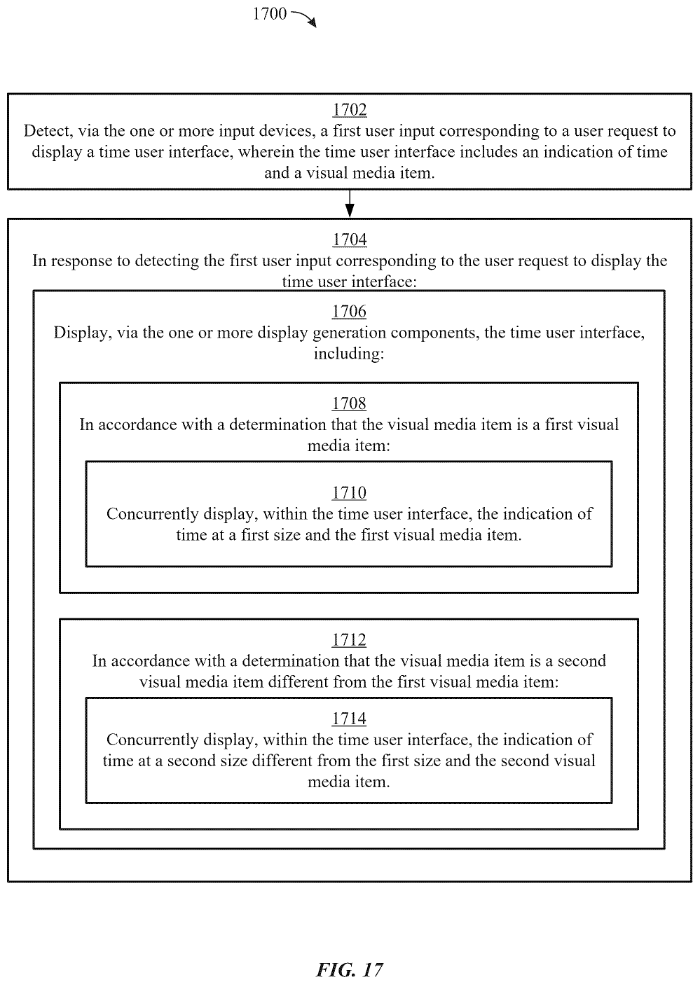

Below, FIGS. 1A-1B, 2, 3A, 4A-4B, and 5A-5B provide a description of exemplary devices for performing the techniques for managing event notifications. FIGS. 6A-6X, 8A-8N, 10A-10N, and 12A-12Q illustrate techniques for displaying background regions for time user interfaces. FIGS. 7, 9, 11, and 13 are flow diagrams illustrating methods displaying background regions for time user interfaces, in accordance with some embodiments. The user interfaces in FIGS. 6A-6X are used to illustrate the processes described below, including the processes in FIG. 7. The user interfaces in FIGS. 8A-8N are used to illustrate the processes described below, including the processes in FIG. 9. The user interfaces in FIGS. 10A-ION are used to illustrate the processes described below, including the processes in FIG. 11. The user interfaces in FIGS. 12A-12Q are used to illustrate the processes described below, including the processes in FIG. 13. FIGS. 14A-14V illustrate techniques for displaying an indication of timer progress, in accordance with some embodiments. FIG. 15 is a flow diagram illustrating methods for displaying an indication of timer progress, in accordance with some embodiments. The user interfaces in FIGS. 14A-14V are used to illustrate the processes described below, including the processes in FIG. 15. FIGS. 16A-16AB-3 illustrate techniques for displaying one or more time user interfaces that includes one or more visual media items, in accordance with some embodiments. FIG. 17 is a flow diagram illustrating methods for displaying a time user interface that includes one or more visual media items, in accordance with some embodiments. The user interfaces in FIGS. 16A-16AB-3 are used to illustrate the processes described below, including the processes in FIG. 17.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, preventing display burn-in, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

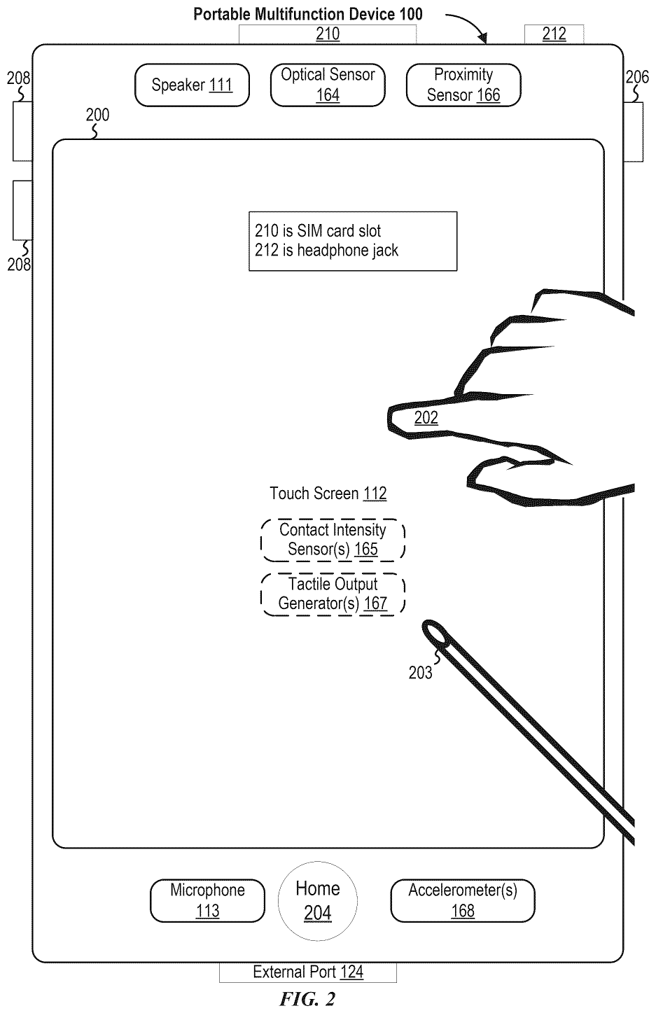

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

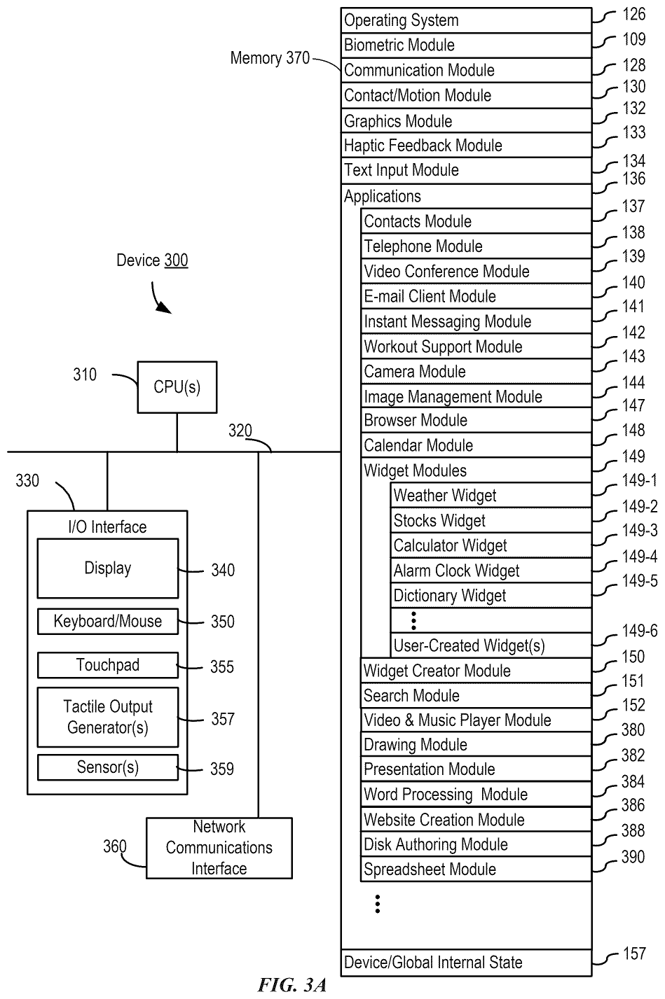

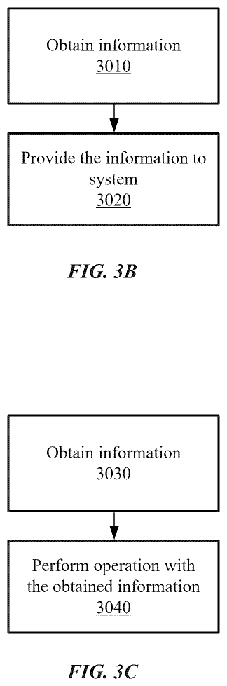

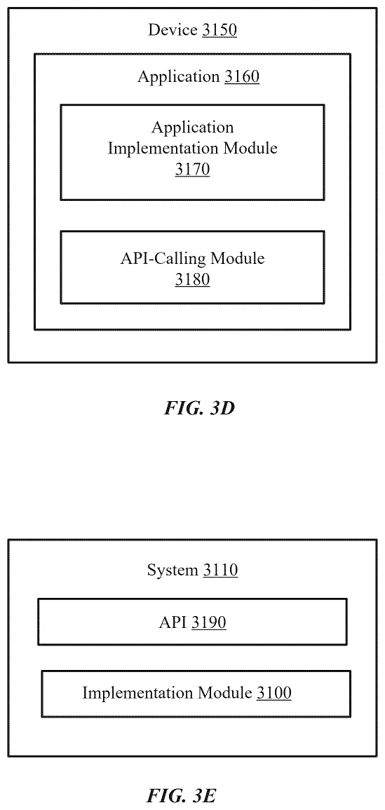

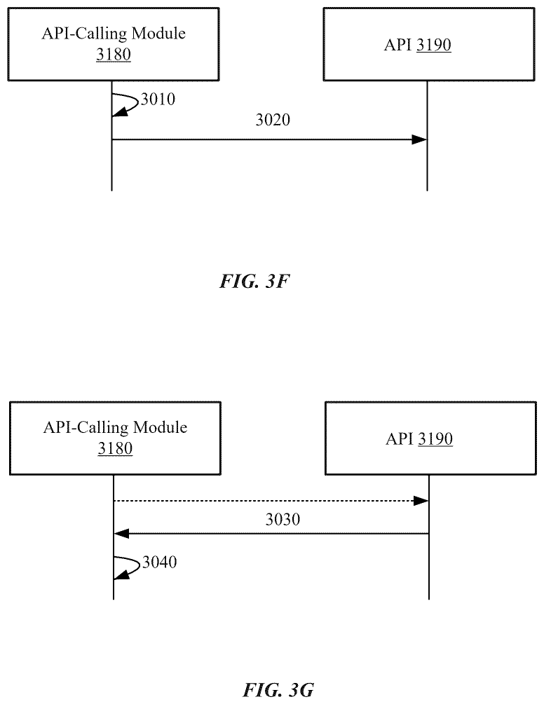

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 900, 1100, 1300, 1500 and/or 1700 (FIGS. 7, 9, 11, 13, 15, and/or 17) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

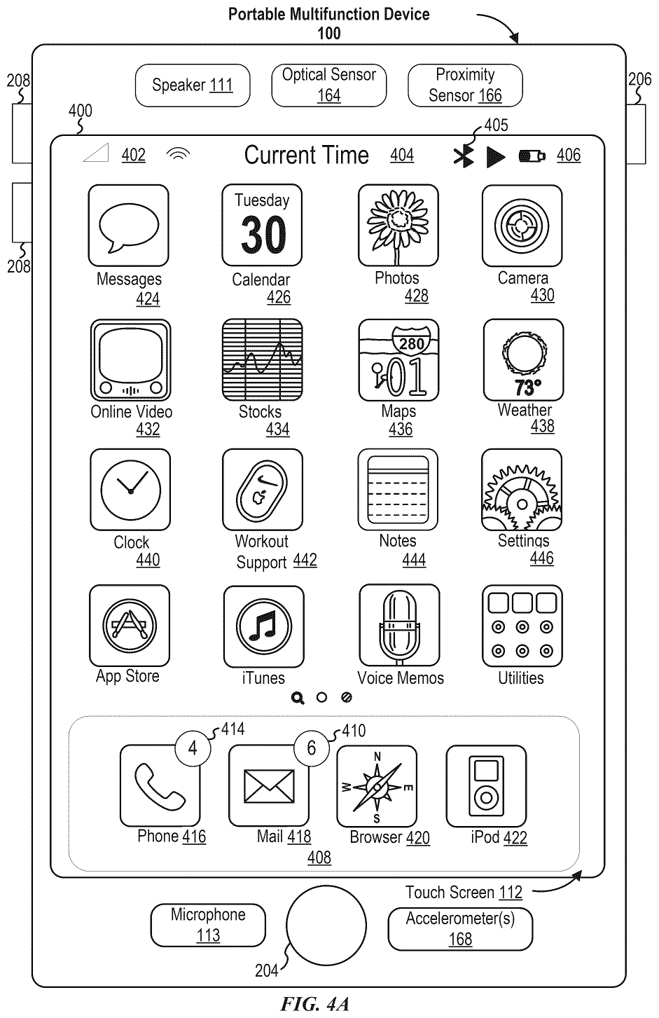

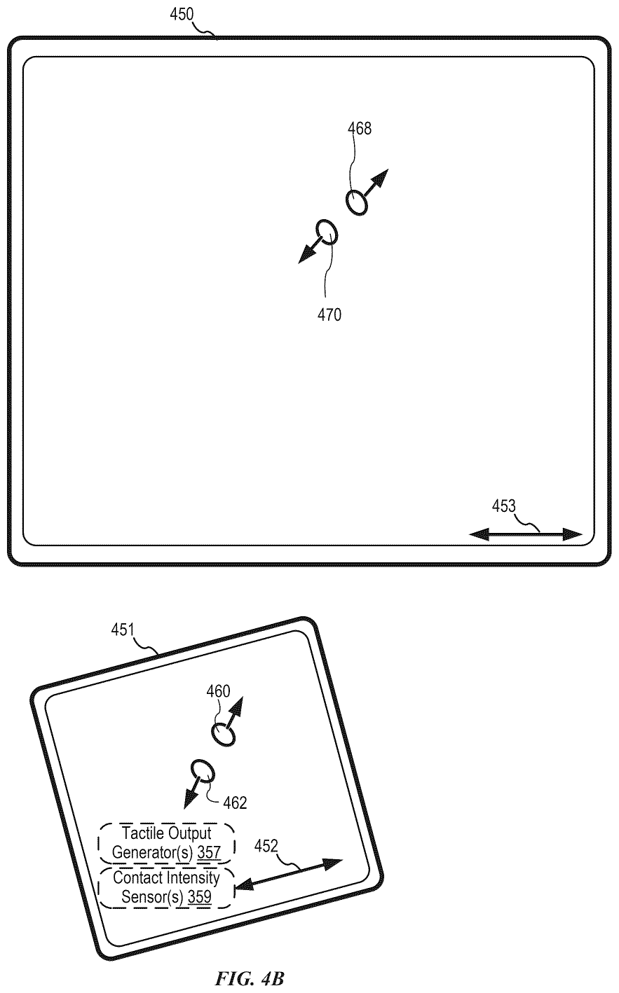

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

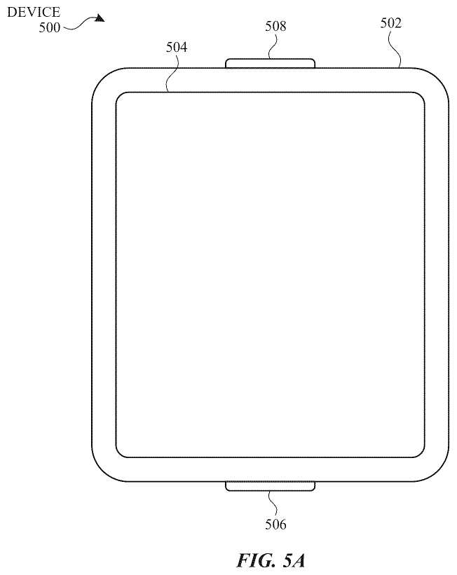

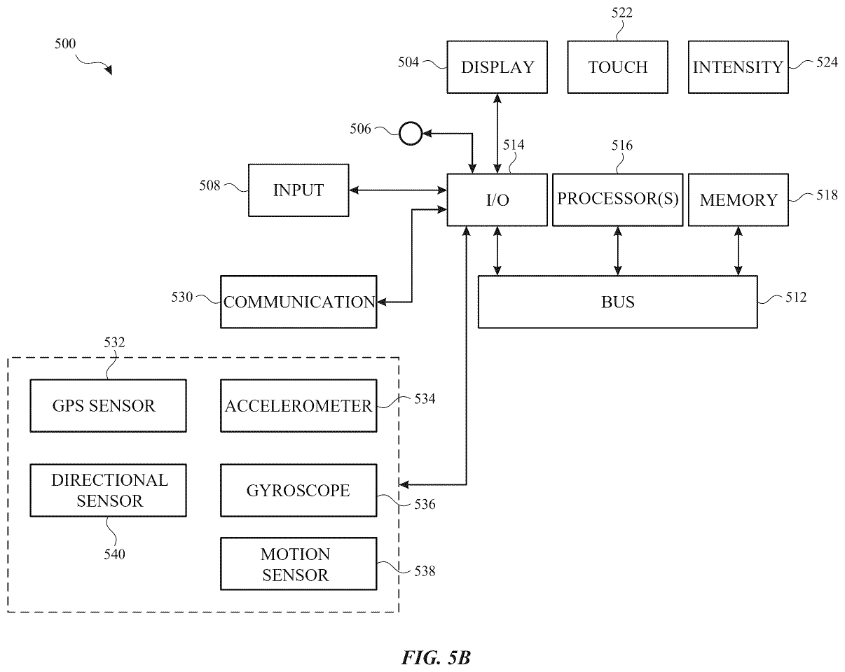

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700, 900, 1100, 1300, 1500, and 1700 (FIGS. 7, 9, 11, 13, 15, and 17). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6X illustrate techniques for displaying background regions for time user interfaces, in accordance with some embodiments. The user interfaces in these figures are used to illustrate the processes described below, including the processes in FIG. 7.

FIG. 6A illustrates computer system 600, which includes display 602 (e.g., a touch-sensitive display), rotatable and depressible input mechanism 604, and button 606. In FIG. 6A, computer system 600 is a smartwatch. In some embodiments, computer system 600 displays, on display 602, user interface 608a. User interface 608a includes an application that the user is currently using, such as messaging application 610 as shown in FIG. 6A. In some embodiments, computer system 600 receives a request to display a time user interface. The request to display the time user interface is received by way of a user input 612 (e.g., a press or a tap) to rotatable and depressible input mechanism 604. In response to receiving input 612 to rotatable and depressible input mechanism 604, computer system 600 displays user interface 608b (e.g., a time user interface, a watch face user interface, a wake screen, a lock screen, a home screen, and/or a clock user interface) that displays an indication of time, as shown in FIG. 6B. In some embodiments, user interface 608b is a wake screen (e.g., a lock screen and/or an initial user interface) that computer system 600 displays when coming out of a state in which computer system 600 does not receive user inputs or detect the occurrence of one or more conditions that keep the computer system in an active state (e.g., a low-power state, a reduced-power state, a sleep state, and/or a dimmed state). In some embodiments, user interface 608b is a home screen (e.g., user interface 400 or as shown in FIG. 6X) that includes user interface objects corresponding to respective applications and, optionally, an indication of time. A home screen corresponds to a user interface that is initially displayed when computer system 600 is unlocked, wakes from a sleep state, and/or receives a particular input (e.g., a swipe from a specific region on the display or a press of a specific button of computer system 600). The home screen includes affordances for a plurality of applications and functions of computer system 600. The plurality of applications and functions are user-customizable, such that the user of computer system 600 can configure which applications and/or device functions appear on the home screen. When a user interface object (e.g., an application icon or a complication) on the home screen is selected, computer system 600 displays the respective application corresponding to the selected user interface object. In some embodiments, computer system 600 navigates to user interface 608b in response to a variety of different inputs, for example, a press of rotatable and depressible input mechanism 604 while display 602 is displaying a main application page. User interface 608b is also displayed in response to the detection of a wrist-raise gesture or in response to a tap on display 602 (e.g., while computer system 600 is in a low-power state, off state, and/or sleep state).

FIG. 6B illustrates user interface 608b including an indication of time (e.g., hour hand 614 and minute hand 616) and a plurality of user interface elements 618a, 618b, 618c, and 618d corresponding to respective applications (e.g., selectable complications and/or icons that can be selected to open the respective applications). In some embodiments, the state of computer system 600 while displaying user interface 608b is an active state, full-power state, on state, and/or awake state. User interface 608b includes a first background region 620a and a second background region 620b. In some embodiments, first background region 620a corresponds to a representation of a first flower. Second background region 620b corresponds to a representation of a second flower that is relatively smaller and overlaid over first background region 620a. As depicted in FIG. 6B, the second background region includes multiple portions, such as an inner portion of the representation of the second flower (e.g., a pistil and/or stamen) and an outer portion of the representation of the second flower (e.g., petals and/or leaves). The first background region 620a and second background region 620b includes one or more colors. For example, first background region 620a includes the color green and second background region 620b includes the colors red (e.g., corresponding to the inner portion of the representation of the second flower or corresponding to an inner portion of the representation of the second flower) and yellow (e.g., corresponding to the outer portion of the representation of the second flower or corresponding to an outer portion of the representation of the second flower).

In some embodiments, user interface elements 618a, 618b, 618c, and 618d are displayed with one or more colors that are complimentary to the underlying background region, such as first background region 620a. For example, the color of user interface elements 618a, 618b, 618c, and 618d are displayed with the same general color as first background region 620a (e.g., green, or another color or pattern) and having a darker or lighter shade than the color of first background region 620a (e.g., dark green or light green). User interface elements 618a, 618b, 618c, and 618d are also displayed with properties that adjust based on the underlying background color, such as tint, brightness, opacity, blur, and/or saturation.

FIG. 6C illustrates computer system 600 after a first transition to a different power state. For instance, after a period in which computer system 600 does not receive user inputs or detect the occurrence of one or more conditions that keep the computer system in an active state, computer system 600 transitions from the active state, full-power state, on state, and/or awake state (e.g., as depicted in FIG. 6B) to a low-power state, off state, and/or sleep state. Computer system 600 also transitions to the low-power state, off state, and/or sleep state in response to detected events such as a wrist-lowering gesture or the covering of display 602 (e.g., by a hand of the user or other object). Accordingly, display 602 transitions to a lower power state than the state depicted in FIG. 6B. When in the lower power state, user interface 608c is displayed with the colors of first background region 620a and second background region 620b being adjusted. In some embodiments, when transitioning to the lower power state, the background regions are adjusted such that various colors of the background regions change to a grayscale color. For example, upon transitioning to the lower power state, the color of first background region 620a is adjusted from green to gray, whereas the color of second background region 620b is also adjusted from red (e.g., corresponding to the inner portion of the representation of the second flower or corresponding to an inner portion of the representation of the second flower) and yellow (e.g., corresponding to the outer portion of the representation of the second flower or corresponding to an outer portion of the representation of the second flower) to gray (e.g., corresponding to both the inner portion and the outer portion of the representation of the second flower or corresponding to a plurality of inner portions and outer portions of the representation of the second flower). While in the lower power state, outlines corresponding to the background regions are depicted. For instance, outline 622a corresponds to an outline of first background region 620a, outline 622b corresponds to an outline of a first portion of second background region 620b (e.g., the outer portion of the representation of the second flower or an outer portion of the representation of the second flower) and outline 622c corresponds to an outline of a second portion of the second background region 620b (e.g., the inner portion of the representation of the second flower or an inner portion of the representation of the second flower). In some embodiments, the displayed color of the various outlines corresponds to the respective background region color prior to computer system 600 entering the lower power state. For example, the color of outline 622a corresponds to green, the color of outline 622b corresponds to yellow, and the color of outline 622c corresponds to red.

Various visual aspects of the background regions are adjusted upon computer system 600 transitioning to the lower power state. In some embodiments, the background regions are displayed as shrinking and/or rotating upon computer system 600 transitioning to the lower power state. For instance, as shown in FIG. 6C, first background region 620a is displayed as shrinking relative to first background region 620a as shown in FIG. 6B, and similarly, second background region 620b is displayed as shrinking relative to second background region 620b as shown in FIG. 6B.

FIGS. 6D-6E illustrate a transition (e.g., an animation or other visual depiction) from user interface 608c in FIG. 6C to user interface 608f in FIG. 6F in response to detecting an update event, such as a transition to a different power state. FIG. 6D illustrates computer system 600 during an initial stage in response to detecting the update event. In particular, in response to detecting the update event, computer system 600 transitions to a higher power state than the state of computer system 600 as depicted in FIG. 6C. The update event corresponds to various events, such as a tap on display 602 while computer system 600 is in the lower power state and/or a detected raise gesture while computer system 600 is in the lower power state (e.g., the user raising computer system 600 to view display 602 or the user raising computer system 600 out of a pocket). In some embodiments, in response to detecting the update event, the color of first background region 620a is adjusted and the color of second background region 620b is adjusted. In particular, the color of second background region 620b changes to include one or more new colors. For example, an animation of a new flower (e.g., as shown in second background region 620b in FIG. 6D or in FIG. 6H) growing from the center of user interface 608d is depicted. The new flower includes one or more colors, such as the color corresponding to the inner portion of the new flower (e.g., blue, or another color or pattern) and the color corresponding to the outer portion of the new flower (e.g., orange, or another color or pattern). In addition, in response to detecting the update event, the color of first background region 620a changes to a new color corresponding to the color of second background region 620b prior to detecting the update event. Specifically, in this example, the color of first background region 620a changes to the color of the inner portion of the second representation of the flower as depicted in FIG. 6B (e.g., red, or another color or pattern). In some embodiments, first background region 620a includes multiple colors in response to the update event. For example, as first background region 620a is displayed including new flower initially growing from the center of user interface 608d, an additional color is displayed within first background region 620a (e.g., on the outer edges of user interface 608d or towards the center of user interface 608d), such as the color of the outer portion of the second representation of the flower as depicted in FIG. 6B (e.g., yellow, or another color or pattern).

In some embodiments, user interface elements 618a, 618b, 618c, and 618d are not displayed when computer system transitions to a lower power state (e.g., as shown in FIG. 6C or in FIG. 6G). In these cases, user interface elements 618a, 618b, 618c, and 618d are displayed again once computer system 600 transitions back to a higher power state, as depicted in FIG. 6D. Accordingly, the color of user interface elements 618a, 618b, 618c, and 618d are displayed with the same general color as first background region 620a (e.g., yellow, or another color or pattern) and having a darker or lighter shade than the color of first background region 620a (e.g., dark yellow or light yellow). User interface elements 618a, 618b, 618c, and 618d are displayed with properties that adjust based on the underlying background color, such as a different tint, different brightness, different opacity, different blur, and/or different saturation than the tint, brightness, different opacity, blur, and/or saturation of the user interface elements 618a, 618b, 618c, and 618d as depicted in FIG. 6B.

FIG. 6E illustrates computer system 600 during a first subsequent stage in response to detecting the update event. In particular, user interface 608e is displayed with a new flower in second background region 620b expanding from the center of user interface 608d. In some embodiments, the new flower in second background region 620b rotates as the new flower is expanding. The rotation and expansion causes portions of the new flower (e.g., edges of the flower petals or edges of other flower portions) to be momentarily not visible as the new flower is displayed as momentarily growing beyond the edges of display 602.

FIG. 6F illustrates computer system 600 during a second subsequent stage in response to detecting the update event. In some embodiments, after the new flower in second background region 620b of user interface 608f is displayed as initially growing from the center of display 602 (e.g., as depicted in FIG. 6D or in FIG. 6E) and after the new flower is displayed as expanding further outward from the center of display 602 (as depicted in FIG. 6E), the new flower is displayed as shrinking (e.g., relative to the new flower depicted in FIG. 6E) to a smaller size as depicted in FIG. 6F. Accordingly, in FIG. 6F, the color of first background region 620a includes the color (e.g., yellow, or another color or pattern) previously included in second background region 620B (e.g., as shown in FIG. 6B or in FIG. 6H), whereas the color of second background region 620b includes one or more new colors corresponding to the new flower (e.g., blue corresponding to the inner portion of the new flower and orange corresponding to the outer portion of the new flower or yellow corresponding to the inner portion of the new flower and purple corresponding to the outer portion of the new flower).

FIG. 6G illustrates computer system 600 after a second transition to a different power state. For instance, after a period in which computer system 600 does not receive user inputs or detect the occurrence of one or more conditions that keep the computer system in an active state, computer system 600 transitions from the active state, full-power state, on state, and/or awake state (as depicted in FIG. 6F) to a low-power state, off state, and/or sleep state. Computer system 600 transitions to the low-power state, off state, and/or sleep state in response to detected events such as a wrist-lowering gesture or the covering of display 602 by a hand of the user. Accordingly, display 602 transitions to a lower power state than the state depicted in FIG. 6F. When in the lower power state, user interface 608g is displayed with the colors of first background region 620a and second background region 620b changing to a grayscale color. For example, upon transitioning to the lower power state, the color of first background region 620a is adjusted from yellow to gray, whereas the color of second background region 620b are also adjusted from the color (e.g., blue, or another color or pattern) corresponding to the inner portion of the representation of the second flower and the color (e.g., orange, or another color or pattern) corresponding to the outer portion of the representation of the second flower to gray (e.g., corresponding to both the inner portion and the outer portion of the representation of the second flower or corresponding to a plurality of inner portions and outer portions).

While in the lower power state, outlines corresponding to the background regions are depicted. For instance, outline 622b corresponds to an outline of a first portion of second background region 620b (e.g., the outer portion of the representation of the new flower or an outer portion of the representation of the new flower) and outline 622c corresponds to an outline of a second portion of the second background region 620b (e.g., the inner portion of the representation of the new flower or an inner portion of the representation of the new flower). In some embodiments, the displayed color of the various outlines corresponds to the respective background region color prior to computer system 600 entering the lower power state. For example, the color of outline 622b corresponds to orange and the color of outline 622c corresponds to blue. In some embodiments, as depicted in FIG. 6G, the edges of the flower corresponding to background region 620a extend beyond the displayable area of display 602, such that outlines of background region 620a are not displayed. Outlines 622b and 622c are displayed as smaller than the corresponding outlines prior to the transition to the lower power state (e.g., as depicted in FIG. 6B or in FIG. 6F) in order to display the flower as shrinking in size upon transition to the lower power state.

FIG. 6H illustrates computer system 600 after detecting a second update event. In particular, in response to detecting an update event, first background region 620a is displayed with at least one new color relative to the color(s) previously displayed in first background region 620a (e.g., as depicted in FIGS. 7D-7G). In particular, in response to detecting events such as a user tapping on display 602 while computer system 600 is in the lower power state and/or a detected raise gesture while computer system 600 is in the lower power state (e.g., the user raising computer system 600 to view display 602 or the user moving computer system 600 out of a pocket) first background region 620a is displayed with a new color. The new color corresponds to the color of second background region 620b prior to transition to the lower power state (e.g., the color of the outer portion of the representation of the second flower a depicted in FIG. 6B or the color of the outer portion of the representation of the second flower a depicted in FIG. 6F). Second background region 620b is displayed with colors representing a new flower, such as the color corresponding to an inner portion of the newly displayed flower (e.g., green, or another color or pattern) and a color corresponding to an outer portion of the newly displayed flower (e.g., purple, or another color or pattern).

In some embodiments, the new flower is generated and displayed in response to a transition to the lower power state (e.g., as opposed to being displayed in response to a transition to a higher power state as described with respect to FIGS. 6A-6G). For example, a specific flower type is depicted when computer system 600 is in a higher power state. Once computer system 600 transitions to the lower power state, display 602 is updated to include a new flower with grayscale interior and colored outlines. When computer system 600 transitions to the higher power state, display 602 is updated to depict the new flower with interior portions filled in with the respective colors base on the colored outlines.

While computer system 600 is in the active state, the user provides an input 624 (e.g., a tap input, a press and hold input, and/or other input) to navigate to an editing user interface as depicted in FIGS. 6I-6R. FIG. 6I illustrates computer system 600 displaying an editing user interface 626a. In some embodiments, editing user interface 626 is displayed in response to input 624. Once the user has navigated to editing user interface 626, the user performs swipe left and/or swipe right gestures on display 602 to navigate through different time user interface designs to be displayed via display 602. Once the user has selected a desired display design, the user navigates to a specific time user interface editing interface by selecting edit element 628.

FIG. 6J illustrates computer system 600 displaying user interface element editing interface 626b. In some embodiments, user interface element editing interface 626b is displayed in response to the user selecting edit element 628. Once the user has reached the user interface element editing interface 626b, the user performs swipe left and/or swipe right gestures on display 602 to navigate through different editing interfaces corresponding to respective aspects of the time user interface, such as an interface for editing the user interface elements 618a, 618b, 618c, and 618d (e.g., complications and/or user interface elements that include information from an application) as depicted in FIGS. 6J-6M, a user interface for editing colors as depicted in FIGS. 6N-6P, and a user interface for editing dials as depicted in FIGS. 6Q-6R.

The user selects specific user interfaces elements for a given time user interface design. For example, the user selects (e.g., via a tap gesture and/or other selection input) a specific user interface element displayed on the specific time user interface editing interface 626b, such as user interface element 618a as shown in FIG. 6J.

FIG. 6K illustrates computer system 600 displaying user interface element editing interface 626c. In some embodiments, user interface element editing interface 626c is displayed in response to the user selecting a specific user interface element displayed in a specific time user interface editing interface, such as user interface element 618a. While displaying user interface element editing interface 626c, the user navigates through different user interface element options to be displayed with a specific time user interface design. In some embodiments, computer system 600 scrolls the user interface element options in response to detecting a swipe up and/or swipe down gestures on display 602. Rotation of the rotatable and depressible input mechanism 604 causes computer system 600 to navigate through different user interface element options to be displayed with a specific time user interface design. In some embodiments, the initially displayed user interface element option 630a is highlighted and corresponds to the user interface element currently being used for the selected user interface element 618a. In this example, user interface element option 630a corresponds to an elevation user interface element option.

FIG. 6L illustrates computer system 600 displaying user interface element editing interface 626c after computer system 600 navigates to a different user interface element option. In this example, computer system 600 navigates to user interface element option 630b, which corresponds to a calendar user interface element option. In order to select user interface element option 630b for use within the respective time user interface design, computer system 600 responds to a tap on user interface element option 630b as shown via input 632.

FIG. 6M illustrates computer system 600 displaying user interface element editing interface 626d. In some embodiments, user interface element editing interface 626d is displayed in response to detecting selection of a specific user interface element option from user interface element editing interface 626c, such as via input 632. As shown in FIG. 6M, user interface element 634 corresponding to selected user interface element option 630b (e.g., the calendar user interface element, or a user interface element associated with another application) is now displayed in place of the previously displayed user interface element 618a. While displaying user interface element editing interface 626d, computer system 600 navigates through different specific time user interface editing options in response to detecting swipe left and/or swipe right gestures, as depicted via input 636.

FIG. 6N illustrates computer system 600 displaying color editing interface 626d. In some embodiments, color editing interface 626e is displayed in response to computer system 600 detecting one or more swipe left and/or swipe right gestures on display 602. In some embodiments, color editing interface 626e includes a plurality of color options 628, including a currently selected color option 628b, and additional color options 628a, 628c, and 628d. As shown in FIG. 6N, the currently selected color option corresponds to “multicolor,” as shown via label 630a. In some embodiments, time user interface preview 632a is displayed with respective colors corresponding to the currently selected color option. In this example, time user interface preview 632a is displayed with a color scheme having a multicolor theme (e.g., varying colors for the different background regions and complications and/or varying patterns for the different background regions and complications). In response to detecting rotation of rotatable and depressible input mechanism 604, computer system 600 navigates through different color options 628a, 628b, 628, and 628d.

FIG. 6O illustrates computer system 600 displaying color editing interface 626e. In some embodiments, color editing interface 626e is displayed in response to the rotating rotatable and depressible input mechanism 604 to navigate to color option 628c. Accordingly, color option 628c is displayed as highlighted. As shown in FIG. 6N, the currently selected color option corresponds to “red,” as shown via label 630b. In some embodiments, time user interface preview 632b is displayed with respective colors corresponding to the currently selected color option. In this example, time user interface preview 632b is displayed with a color scheme having a red theme (e.g., varying shades of red for the different background regions and complications, or varying shades of a different color for the different background regions).

FIG. 6P illustrates computer system 600 displaying color editing interface 626f. In some embodiments, color editing interface 626f is displayed in response to the rotating rotatable and depressible input mechanism 604 to navigate to color option 628d. Accordingly, color option 628d is displayed as highlighted. As shown in FIG. 6P, the currently selected color option corresponds to “red,” as shown via label 630c. In some embodiments, time user interface preview 632c is displayed with respective colors corresponding to the currently selected color option. In this example, time user interface preview 632b is displayed with a color scheme having a black theme (e.g., varying shades of gray and black for the different background regions and complications, or varying shades of a different color for the different background regions).

In some embodiments, once a color option is selected, the selected color option is then used as the basis for rotating through the colors of the first background region and the second background region as discussed with respect to FIGS. 6A-6H. As an example, multicolor is selected as the color option for the time user interface, such that various colors are rotated through as discussed with respect to FIGS. 6A-6H (e.g., yellow, red, green, orange, blue, and/or purple). As another example, red is selected as the color option for the time user interface, such that various shades of red are rotated through (e.g., instead of multiple different colors as discussed with respect to FIGS. 6A-6H).

FIG. 6Q illustrates computer system 600 displaying dial editing interface 626f. In some embodiments, dial editing interface 626f is displayed in response to detection of a swipe right and/or swipe left gesture on specific time user interface editing options, such as editing user interface elements (e.g., complications and/or applications) as depicted in FIGS. 6J-6M or editing colors as depicted in FIGS. 6N-6P. While dial editing interface 626f is displayed, rotation of rotatable and depressible input mechanism 604 causes computer system 600 to navigate through different dial options for the time user interface. As shown via FIG. 6Q, a “single” dial interface is selected, as shown via label 634a, which corresponds to the time user interface discussed with respect to FIGS. 6A-6H. While the “single” dial interface is selected, the time user interface adjusts the first background region color and the second background region color as discussed with respect to FIGS. 6A-6H.

FIG. 6R illustrates computer system 600 displaying dial editing interface 626g. In some embodiments, dial editing interface 626g is displayed in response to rotation of rotatable and depressible input mechanism 604 to navigate to a “multiple” dial option, as indicated via label 634b. While the “multiple” dial interface is selected, the time user interface adjusts the first background region color and the second background region color as discussed with respect to FIGS. 6S-6U. Once the desired settings are selected via the editing user interface, computer system 600 displays the main time user interface with the selected settings in response to detecting a press of rotatable and depressible input mechanism 604 as shown in FIG. 6F.

FIG. 6S illustrates computer system 600 displaying a time user interface with a “multiple” dial option selected. The time user interface includes an indication of time (e.g., hour hand 614 and minute hand 616). The state of computer system 600 while displaying user interface 608g generally corresponds to an active state, full-power state, on state, and/or awake state. While in the active state, full-power state, on state, and/or awake state, user interface 608g includes a plurality of background objects, including background object 638a. In some embodiments, the plurality of background objects corresponds to a plurality of flowers having respective colors. Background object 638a includes a blue inner flower region and a yellow outer flower region, for example. In some embodiments, the respective colors correspond to color options selected via the editing user interface.

FIG. 6T illustrates computer system 600 after a transition to a different power state relative to FIG. 6S. For instance, after a period in which computer system 600 does not receive user inputs or detect the occurrence of one or more conditions that keep the computer system in an active state, computer system 600 transitions from the active state, full-power state, on state, and/or awake state (e.g., as depicted in FIG. 6B or FIG. 6S) to a low-power state, off state, and/or sleep state. Computer system 600 also transitions to the low-power state, off state, and/or sleep state in response to detected events such as a wrist-lowering gesture or the covering of display 602 by a hand of the user. Accordingly, display 602 transitions to a lower power state than the state depicted in FIG. 6S. When in the lower power state, user interface 608h is displayed with a plurality of background objects, including background object 638b. In some embodiments, the plurality of background objects corresponds to the plurality of background objects of FIG. 6S while depicted in a grayscale state. For instance, background object 638b includes a gray inner flower region and a gray outer flower region. In addition, the outline of the inner region of background object 638b corresponds to blue and the outline of the outer region of background object 638b corresponds to yellow. In some embodiments, the plurality of background object 638b is displayed as shrunk in size relative to the plurality of background object 638a.

FIG. 6U illustrates computer system 600 in response to a transition to a different power state. In particular, computer system 600 detects a transition to a higher power state than the state of computer system 600 as depicted in FIG. 6T. The transition is based on various events, such as detecting a tap on display 602 while computer system 600 is in the lower power state and/or a detected raise gesture while computer system 600 is in the lower power state (e.g., the user raising computer system 600 to view display 602 or the user moving computer system 600 out of a pocket). Upon transition to the higher power state, computer system 600 displays user interface 608i. User interface 608i includes a new plurality of background objects 638c relative to the plurality of background objects 638a and 638b. In particular, the new plurality of background objects 638c correspond to a plurality of flowers having respective colors. The respective colors in general include the same respective colors as depicted in the plurality of background objects 638a described with respect to FIG. 6S. For example, the respective colors described with respect to FIG. 6S and FIG. 6U are based on the same selected color options described with respect to FIGS. 6N-6P. Upon transition to the higher power state, the pattern and/or arrangement of flowers is also changed to result in the display of a new pattern or arrangement relative to the pattern and/or arrangement depicted in FIGS. 6S and 6T.

In some embodiments, the pattern and/or arrangement of background objects change in response to a transition to a lower power state (e.g., rather than changing in response to a transition to a higher power state as discussed with respect to FIGS. 6S-6U).

FIG. 6V illustrates computer system 600-1 displaying a plurality of background objects on a user interface. In some embodiments, computer system 600-1 corresponds to a smartphone or a tablet computer. In some embodiments, the state of computer system 600-1 as depicted in FIG. 6V corresponds to the display of an initial user interface after the computer system wakes (e.g., from a lower power and/or resting state) and/or unlocked (e.g., after providing authentication via facial recognition or after providing authentication via a passcode). In FIG. 6V, computer system 600-1 displays a plurality of background objects, including background object 640. In some embodiments, the plurality of background objects correspond to representations of flowers. Computer system 600-1 navigates to a home screen in response to detection of one or more inputs, such as, e.g., input 642 corresponding to a swipe up gesture near the bottom portion of display 602.

FIG. 6W illustrates an initial display state of a plurality of background objects on a home screen of computer system 600-1. For example, in response to receiving user input 642, computer system 600-1 displays a plurality of user interface objects (e.g., icons corresponding to respective applications or user interface elements corresponding to complications) appearing from corners of display 602, such as user interface objects 644. The plurality of user interface objects are displayed as overlaid on the plurality of background objects. In addition, the plurality of background objects are displayed as moving in a particular direction on display 602, such as in an upward direction. For example, in FIG. 6W, background object 640 is displayed higher on display 602 relative to background object 640 in FIG. 6V.

FIG. 6X illustrates a subsequent display state of a plurality of background objects on a home screen of computer system 600-1. In some embodiments, the state of display 602 depicted in FIG. 6X corresponds to the state of the home screen once the plurality of user interface objects and the plurality of background objects are no longer displayed as moving. For example, user interface object 644 (e.g., corresponding to an icon for a weather application or corresponding to an icon for another application) is displayed as moving to a final location on display 602. In addition, background object 640 is displayed as stationary behind one or more user interface objects of the plurality of user interface objects, such as user interface object 644.

FIG. 7 is a flow diagram illustrating a method for displaying background regions using a computer system in accordance with some embodiments. Method 700 is performed at a computer system (e.g., 100, 300, 500, 600, 600-1, a smartphone, a smartwatch, a tablet computer, a laptop computer, a desktop computer, a head mounted augmented reality device and/or a head mounted extended reality device) that is in communication with a display generation component (e.g., 602, a display controller, a display, a touch-sensitive display system, a touchscreen, a monitor, and/or a head mounted display system). In some embodiments, the computer system is in communication with one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 700 are, optionally, combined, the orders of some operations are, optionally, changed, and some operations are, optionally, omitted.

As described below, method 700 provides an intuitive way for displaying background regions for time user interfaces. The method reduces the cognitive burden on a user for displaying background regions for time user interfaces, thereby creating a more efficient human-machine interface. For battery-operated computing devices, enabling a user to modify background regions for time user interfaces faster and more efficiently conserves power and increases the time between battery charges.

The computer system displays (702) (e.g., at a first time), via the display generation component, a time user interface (e.g., 608a, 608b, 608c, 608d, 608e, 608f, 608g, 608h, 608i, 608j, a user interface that includes an analog and/or digital indication of time, a clock face user interface, a watch face user interface, a sleep screen, a wake screen, and/or a lock screen) having a first background region (e.g., 620a and/or an outer region) and a second background region (e.g., 620b and/or an inner region inside an outer region), wherein the first background region is displayed (e.g., at the first time) with a first color (e.g., red, or another color or pattern) and the second background region is displayed (e.g., at the first time) with a second color (e.g., green, or another color or pattern). In some embodiments, the first background region includes only one color. In some embodiments, the first background region includes multiple colors. In some embodiments, the first background region includes a pattern of shapes (e.g., flowers, geometric shapes, and/or as shown in FIGS. 6B-6H and/or 6S-6X) and/or a pattern of colors. In some embodiments, a sleep screen (e.g., as shown in FIGS. 6C, 6G, and/or 6T) is a user interface that is displayed when the computer system is in a reduced-power state, off state, and/or sleep state. In some embodiments, a wake screen (e.g., as shown in FIGS. 6D and/or 6H) is a user interface that is displayed when the computer system transitions from a lower power state to a higher power state (e.g., from a state in which computer system 600 has a lower brightness, a display has a slower refresh rate, a lower power processor is in use, a processor is in a lower power state, and/or one or more additional sensors are taking less frequent sensor measurements to a state in which computer system 600 has a higher brightness, a display has a faster refresh rate, a higher power processor is in use, a processor is in a higher power state, and/or one or more additional sensors are taking more frequent sensor measurements). In some embodiments, the second background region is contained within the first background region. In some embodiments, the first background region and the second background region are mutually exclusive (e.g., do not overlap). In some embodiments, the first background region corresponds to a first flower or first geometric shape and the second background region corresponds to a second flower or second geometric shape that is smaller than the first flower or first geometric shape. In some embodiments, the first flower or first geometric shape is behind the second flower or second geometric shape.

In some embodiments, the first background region and/or the second background region are displayed behind an indication of time (e.g., 614 and/or 616, a digital indication of time and/or an analog indication of time that includes one or more clock hands that indicate time by pointing in different directions) and/or one or more user interface elements associated with a corresponding application (e.g., 618a, 618b, 618c, 618d, a complication, text, and/or graphic that displays information obtained from an application). In some embodiments, in response to detecting an input (e.g., 618a) corresponding to selection of the user interface element associated with the application, the computer system launches and/or opens the corresponding application (e.g., displays a user interface of the corresponding application). In some embodiments, the indication of time and/or the one or more user interface elements are overlaid on the first background region and/or the second background region.

The computer system detects (704) an update event (e.g., a detected motion causing the computer system to transition from a low-power state, off state, and/or sleep state to an active state, full-power state, on state, and/or awake state). In some embodiments, detected motion includes change in position, rotation, and/or change in orientation of at least a portion of the computer system (e.g., motion that satisfies a set of motion criteria, such as motion that is indicative of a wrist raise gesture, picking up the computer system, an intent to view the display generation component, and/or an intent to interact with the computer system). In some embodiments, the update event is detected via one or more input devices (e.g., a touch-sensitive surface, a button, and/or a motion detector). In some embodiments, the update event is detected based on context (e.g., a predetermined time and/or location). In some embodiments, the update event is detected based on information from an application (e.g., calendar application, message application, e-mail application, and/or weather application). In some embodiments, the update event is a notification (e.g., of a calendar event, message, e-mail, and/or event associated with another application).

In response to detecting the update event, the computer system displays (706) (e.g., at a second time different from the first time), via the display generation component, the time user interface with the first background region having the second color (e.g., as shown in FIGS. 6D-6F and/or green). In some embodiments, the second background region is displayed with a new color (e.g., blue, or another color or pattern) and the first background region is displayed transitioning to the color previously included in the second background region. In some embodiments, prior to detecting the update event, the first background region and second background region are displayed as transitioning to a grayscale outline of colored regions (e.g., as shown in FIGS. 6C, 6G, and/or 6T). Displaying a time user interface having a first background region with a first color and a second background region with a second color, and displaying the time user interface with the first background region having the second color in response to detecting an update event indicates that the update event has been detected and updates the time user interface without requiring the user to provide inputs to manually edit the time user interface, thereby providing improved visual feedback to the user, reducing the number of inputs required to perform an operation, and preventing permanent discoloration (e.g., burn-in) on the display screen based on varying display patterns and/or colors.

In some embodiments, displaying the time user interface having the first background region and the second background region (e.g., at the first time and/or prior to detecting the update event) includes displaying the second background region (or, in some embodiments, a sub-region of the second background region) with a third color (e.g., the color of 620b as shown in FIG. 6D and/or the color yellow). In some embodiments, the second background region includes multiple colors (e.g., a flower with two colors, a flower with three colors, a geometric shape with two colors, or a geometric shape with three colors). In some embodiments, the second background region includes a pattern of shapes (e.g., flowers or geometric shapes) that have one or more respective colors. Displaying the time user interface including the second background region displayed with a third color varies the appearance of the time user interface without requiring the user to provide inputs to manually edit the time user interface, thereby reducing the number of inputs required to perform an operation.

In some embodiments, prior to detecting the update event, the computer system displays, via the display generation component, the time user interface with a first color pattern (e.g., as shown in FIGS. 6B and/or 6S, a flower having a specific shape and one or more colors, a geometric shape having one or more colors, an arrangement of multiple flowers having respective specific shapes and one or more colors, and/or an arrangement of multiple geometric shapes having one or more colors). In some embodiments, in response to detecting the update event, the computer system displays, via the display generation component, the time user interface with a second color pattern different from the first color pattern (e.g., as shown in FIGS. 6D, 6E, 6F, and/or 6U, a new flower having a different specific shape and one or more different colors, a new geometric shape having a different specific shape and one or more different colors, a new arrangement of multiple flowers having different respective specific shapes and one or more different colors, and/or a new arrangement of multiple geometric shapes having different respective specific shapes and one or more different colors). Displaying the time user interface having a second color pattern different from a first color pattern in response to detecting an update event provides improved visual feedback to the user, reduces the number of inputs needed to update the time user interface, and prevents permanent discoloration (e.g., burn-in) on the display screen based on varying display patterns and/or colors.

In some embodiments, the first color pattern includes one or more first shapes (e.g., as shown in FIGS. 6B and/or 6S, a first flower having a first shape, a first plurality of flowers having respective shapes, a first geometric shape having a first shape, and/or a first plurality of geometric shapes having respective shapes) and the second color pattern includes one or more second shapes different from the one or more first shapes (e.g., as shown in FIGS. 6D, 6E, 6F, and/or 6U, a second flower having a second shape, a second geometric shape having a second shape, a second plurality of flowers having respective shapes, and/or a second plurality of geometric shapes having respective shapes). Displaying the time user interface with a second color pattern having one or more second shapes which are different from one or more shapes displayed with a first color pattern in response to detecting an update event updates the appearance of the time user interface without requiring the user to provide inputs to manually edit the time user interface, thereby reducing the number of inputs required to perform an operation and preventing permanent discoloration (e.g., burn-in) on the display screen based on varying display patterns and/or colors.

In some embodiments, the computer system displays, via the display generation component, the time user interface with one or more user interface elements (e.g., 618a, 618b, 618c, 618d, selectable user interface elements, and/or complications) associated with one or more respective applications (e.g., a first user interface element associated with a first application in an upper-left corner of the time user interface, a first user interface element associated with a first application in a lower-left corner of the time user interface, a first user interface element associated with a first application in an upper-right corner of the time user interface, and/or a first user interface element associated with a first application in a lower-left corner of the time user interface), wherein the one or more user interface elements are displayed in the time user interface prior to detecting the update event and the one or more user interface elements are displayed in the time user interface after detecting the update event (e.g., as shown in FIGS. 6B and 6D). In some embodiments, the one or more user interface elements associated with the first application is not displayed during a period between a first update event (e.g., wrist down motion, hand cover gesture, and/or computer system transitions from an active state to a sleep, resting, or lower power state) and a second update event (e.g., as shown in FIGS. 6C and/or 6G, wrist up motion, tap on dimmed screen, and/or the computer system transitions from a sleep, resting, or lower power state to an active state). In some embodiments, a complication refers to a feature of a user interface (e.g., a home screen, a wake screen, a clock face and/or a watch face) other than those used to indicate the hours and minutes of a time (e.g., 614, 616, clock hands, and/or hour/minute indications). In some embodiments, complications provide data obtained from an application. In some embodiments, a complication updates the displayed data in accordance with a determination that the data obtained from the application has been updated. In some embodiments, the complication updates the displayed data over time. In some embodiments, a complication includes an affordance that when selected launches a corresponding application. In some embodiments, a complication includes an affordance that when selected causes the computer system to perform a specific task. In some embodiments, a complication is displayed at a fixed, predefined location on the display. In some embodiments, complications occupy respective locations at particular regions (e.g., lower-right, lower-left, upper-right, and/or upper-left) of a user interface (e.g., a home screen, a wake screen, a clock face and/or a watch face). In some embodiments, a user may select (e.g., 632) a type of complication to include on the display. In some embodiments, a user may select specific parameters to display for a specific type of complication. Displaying the time user interface with user interface elements both before and after detecting the update event varies the appearance of the time user interface without requiring the user to provide inputs to manually edit the time user interface, thereby providing improved visual feedback and reducing the number of inputs required to perform an operation.

In some embodiments, the computer system displays, via the display generation component, a first user interface element of the one or more user interface elements with a first element color (e.g., 618 in FIG. 6B, the first element color is based at least in part on a color surrounding the first user interface element, such as a color of a background behind the first user interface element, and/or the first element color is based at least in part on a user-selected setting), and in response to detecting the update event, the computer system displays, via the display generation component, the first user interface element of the one or more user interface elements with a second element color different from the first element color (e.g., 618a in FIG. 6F, the second element color is based at least in part on a color surrounding the user interface element, such as a color of a background behind the first user interface element, and/or the second element color is based at least in part on a user-selected setting). For example, the computer system changes a color of the first user interface element in response to detecting the update event (e.g., based on a change in color of the background behind the first user interface element). In some embodiments, the computer system changes a color of two or more of the one or more user interface elements in response to detecting the update event. Displaying a user interface element with a different color than an initial color in response to detecting the update event varies the appearance of the time user interface without requiring the user to provide inputs to manually edit the time user interface and ensures the legibility of the user interface element, thereby providing improved visual feedback to the user and reducing the number of inputs required to perform an operation.

In some embodiments, the first element color (and, in some embodiments, the second element color) of the first user interface element is based on (e.g., is selected based on, matches and/or is complementary to) a current color of the first background region (e.g., 618a relative to 620a in FIG. 6B, and/or the first color prior to detecting the update event and the second color after detecting the update event). In some embodiments, the color of the first user interface element is a lighter shade of the color of the first background region or the color of the first user interface element is a darker shade of the color of the first background region. In some embodiments, two or more of the user interface elements of the one or more user interface elements have respective element colors based on a current color of the first background region. Displaying a user interface element with a color based on a current color of a corresponding background region provides a user with consistent user interface elements blending with background region changes thus varying the appearance of the time user interface without requiring the user to provide inputs to manually edit the time user interface, thereby reducing the number of inputs required to perform an operation.

In some embodiments, an appearance (e.g., a material, a transparent region, and/or a translucent region) of the first user interface element has a property (e.g., tint, brightness, color, opacity, blur, and/or saturation) that adjusts based on a change in a current color of the first background region (e.g., 618a relative to 620a in FIGS. 6D-6E and/or based on a color underlying the first user interface element and/or a color adjacent to the first user interface element). In some embodiments, two or more of the user interface elements of the one or more user interface elements have respective properties that adjust based on a change in a current color of the first background region. Displaying a user interface element with properties that adjust based on a current color of a corresponding background region updates the appearance of the time user interface without requiring the user to provide inputs to manually edit the time user interface, thereby reducing the number of inputs required to perform an operation and providing improved visual feedback to the user.

In some embodiments, the update event includes (e.g., is) a transition from a first power state (e.g., the state shown in FIG. 6B, an active state, and/or a normal operating state) to a second power state (e.g., the state shown in FIG. 6C, a lower power state, a sleep state, a resting state, and/or a reduced power state), wherein the computer system consumes less power in the second power state than in the first power state (e.g., because in the active state, a display has a higher brightness, a display has a faster refresh rate, a higher power processor is in use, a processor is in a higher power state, and/or one or more additional sensors are taking more frequent sensor measurements). In some embodiments, the computer system transitions to the second power state in response to detecting a wrist down motion (e.g., a wrist or hand down gesture and/or motion that satisfies a set of motion criteria that indicates that a wrist or hand of a user has been lowered). In some embodiments, the computer system transitions to the second power state in response to detecting that the computer system (or, in some embodiments, a display of the computer system) is covered (e.g., in response to detecting a hand cover gesture and/or in response to detecting that the computer system has been covered for a predetermined amount of time). In some embodiments, the computer system transitions to the second power state in response to detecting that the computer system has been lowered (e.g., to a resting position, a surface, and/or a user's pocket). Modifying the display of the time user interface in response to transition to a state consuming less power varies the appearance of the time user interface without requiring the user to provide inputs to manually edit the time user interface, thereby reducing the number of inputs required to perform an operation.

In some embodiments, the update event includes (e.g., is) a transition from a first power state (e.g., the state shown in FIG. 6C, a lower power state, a sleep state, a resting state, and/or a reduced power state) to a second power state (e.g., the state shown in FIG. 6D, an active state, and/or a normal operating state), wherein the computer system consumes more power in the second power state than in the first power state (e.g., because a display has a higher brightness, a display has a faster refresh rate, a higher power processor is in use, a processor is in a higher power state, and/or one or more additional sensors are taking more frequent sensor measurements). In some embodiments, the computer system transitions to the second power state in response to detecting a wrist or hand up motion (e.g., a wrist or hand up gesture and/or motion that satisfies a set of motion criteria that indicates that a wrist or hand of a user has been raised). In some embodiments, the computer system transitions to the second power state in response to detecting that the computer system (or, in some embodiments, a display of the computer system) receives a user input (e.g., in response to detecting a finger tap gesture and/or finger swipe gesture). In some embodiments, the computer system transitions to the second power state in response to detecting that the computer system has been raised (e.g., raised from a surface and/or retrieved from the user's pocket). Modifying the display of the time user interface in response to a transition to a state consuming more power modifies the appearance of the time user interface without requiring the user to provide inputs to manually edit the time user interface, thereby reducing the number of inputs required to perform an operation.

In some embodiments, the update event is based on (e.g., includes or is) motion of the computer system (e.g., a motion that satisfies a set of motion criteria that is indicative of a user's wrist moving up and/or down and/or the computer system moving up and/or down). In some embodiments, detecting the update event includes detecting a wrist or hand raise gesture and/or detecting a wrist or hand down gesture. Modifying the display of the time user interface in response to an update event based on motion of the computer system adjusts the appearance of the time user interface without requiring the user to provide inputs to manually edit the time user interface, thereby reducing the number of inputs required to perform an operation.

In some embodiments, the update event is based on (e.g., includes or is) the computer system being covered (e.g., by a hand of a user or other object). In some embodiments, the update event includes (e.g., is) the computer system being uncovered. In some embodiments, detecting the update event includes detecting a hand cover gesture and/or detecting an uncover gesture. Modifying the display of the time user interface in response an update event based on the computer system being covered modifies the appearance of the time user interface without requiring the user to provide inputs to manually edit the time user interface, thereby reducing the number of inputs required to perform an operation.

In some embodiments, in response to detecting the update event, the computer system displays, via the display generation component, an animation (e.g., as shown in FIGS. 6D-6F, an animation of a flower or a geometric shape of the second background region growing into the first background region and/or an animation of a plurality of new flowers or a plurality of geometric shapes growing to replace existing flowers or existing geometric shapes) that includes the first background region transitioning from having a fourth color (e.g., black or the first color) to having the second color. In some embodiments, the animation includes a flower of the second background region blooming to gradually replace an existing flower of first background region (e.g., as shown in FIGS. 6D-6F). In some embodiments, the animation includes a geometric shape of the second background region expanding to gradually replace an existing geometric shape of first background region. In some embodiments, displaying the time user interface with the first background region having the second color in response to detecting the update event includes displaying the animation that includes the first background region transitioning from having the first color to having the second color. Displaying a time user interface by displaying an animation including the first background region transitioning from a default color to a new color updates the appearance of the time user interface without requiring the user to provide inputs to manually edit the time user interface, thereby providing improved visual feedback to the user, reducing the number of inputs required to perform an operation, and preventing permanent discoloration (e.g., burn-in) on the display screen based on varying display patterns and/or colors.

In some embodiments, the animation includes an animation of a shape (e.g., a flower or geometric shape) expanding (e.g., as shown in FIGS. 6D-6E and/or expanding outward from a center region of the time user interface). In some embodiments, the animation includes a flower blooming beyond the display edges (e.g., as shown in FIG. 6E) such that a portion of the flower is no longer visible. In some embodiments, the animation includes a geometric shape expanding beyond the display edges such that a portion of the geometric shape is no longer visible. Displaying a time user interface by displaying the expansion of a flower in response to the update event updates the appearance of the time user interface without requiring the user to provide inputs to manually edit the time user interface, thereby providing improved visual feedback to the user and reducing the number of inputs required to perform an operation.

In some embodiments, the animation includes an animation of the shape (e.g., the flower or geometric shape) shrinking (e.g., as shown in FIGS. 6E-6F and/or shrinking inwards towards the center region of the time user interface) after the animation of the shape (e.g., flower or geometric shape) expanding (e.g., the shape expands and then becomes smaller in size before becoming stationary). Displaying a time user interface by displaying the shrinking of a flower or geometric shape after the expansion of the flower or geometric shape updates the appearance of the time user interface without requiring the user to provide inputs to manually edit the time user interface, thereby providing improved visual feedback to the user and reducing the number of inputs required to perform an operation.

In some embodiments, the animation includes an animation of a shape (e.g., flower or geometric shape) rotating (e.g., as shown in FIGS. 6D-6E). In some embodiments, the shape rotates as the shape expands in size (e.g., as shown in FIGS. 6D-6E). In some embodiments, the shape rotates as the shape shrinks in size (e.g., as shown in FIGS. 6E-6F). Displaying a time user interface by displaying a rotation of the flower or geometric shape modifies the appearance of the time user interface without requiring the user to provide inputs to manually edit the time user interface, thereby providing improved visual feedback to the user and reducing the number of inputs required to perform an operation.

In some embodiments, displaying, via the display generation component, the time user interface having the first background region and the second background region includes displaying, via the display generation component, the first color within a first boundary having the first color (e.g., 620a in FIG. 6B, display the first flower or first geometric shape having the respective color within a boundary representing the edges of the first flower or the edges of the first geometric shape) and displaying, via the display generation component, the second color within a second boundary having the second color (e.g., 620b in FIG. 6B display the second flower or second geometric shape having the respective color within a boundary representing the edges of the second flower or the edge of the second geometric shape). In some embodiments, in response to detecting a transition from a first power state to a second power state (e.g., the computer system transitioning from an active state to a sleep, resting, or lower power state), wherein the computer system consumes a greater amount of power in the first power state than in the second power state (e.g., because in the active state: a display has a higher brightness, a display has a faster refresh rate, a higher power processor is in use, a processor is in a higher power state, and/or one or more additional sensors are taking more frequent sensor measurements): the computer system displays, via the display generation component, the first boundary having the first color, and ceases to display the first color within the first boundary (e.g., display 620a as shown in FIG. 6C and/or display the first flower or the first geometric shape with a grayscale color within a boundary representing the edges of the first flower or the edges of the first geometric shape, wherein the first boundary retains the first color), and the computer system displays, via the display generation component, the second boundary having the second color, and ceasing to display the second color within the second boundary (e.g., display 620b as shown in FIG. 6C and/or display the second flower or the second geometric shape with a grayscale color within a boundary representing the edges of the second flower or the edges of the second geometric shape, wherein the second boundary retains the second color). In some embodiments, displaying, via the display generation component, the time user interface with the first background region having the second color in response to detecting the update event includes displaying, via the display generation component, the time user interface with the second background region having a fourth color (e.g., display 620b as shown in FIGS. 6D and/or display the second background region with a new flower or a new geometric shape having a new color or multiple new colors), wherein detecting the update event includes detecting a transition from the second power state to the first power state (e.g., the computer system transitions from a sleep, resting, or lower power state to an active state). Displaying the first color within a first boundary having the first color and displaying the second color within a second boundary having the second color and displaying, in response to a transition to a lower power state, the first boundary having the first color, wherein a third color replaces the first color within the first boundary and displaying the second boundary having the second color, wherein the third color replaces second first color within the second boundary updates the appearance of the time user interface without requiring the user to provide inputs to manually edit the time user interface, thereby providing improved visual feedback to the user, reducing the number of inputs required to perform an operation, performing an operation when a set of conditions has been met without requiring further user input, reducing power consumption, and preventing permanent discoloration on the display screen based on varying display patterns and/or colors.

In some embodiments, displaying, via the display generation component, the time user interface having the first background region and the second background region includes displaying, via the display generation component, the time user interface with a first pattern including one or more shapes each having a respective color (e.g., a flower or geometric shape having a specific shape and one or more colors and/or an arrangement of multiple flowers or geometric shapes each having specific shapes and one or more colors). In some embodiments, displaying, via the display generation component, the time user interface with the first background region having the second color in response to detecting the update event includes displaying, via the display generation component, the time user interface with a second pattern different from the first pattern (e.g., a new flower or geometric shape having a different specific shape and one or more different colors and/or a new arrangement of multiple flowers or multiple geometric shapes each having different specific shapes and one or more different colors), wherein the second pattern includes an outline of a plurality of color boundaries (e.g., display colored outline of a plurality of flowers or a plurality of geometric shapes). In some embodiments, detecting the update event includes detecting a transition from a first power state to a second power state (e.g., the computer system transitions from an active state to a sleep, resting, or lower power state), wherein the computer system consumes a greater amount of power in the first power state than in the second power state (e.g., because in the active state, a display has a higher brightness, a display has a faster refresh rate, a higher power processor is in use, a processor is in a higher power state, and/or one or more additional sensors are taking more frequent sensor measurements). In some embodiments, in response to detecting a transition from the second power state to the first power state (e.g., in response to detecting the update event or in response to detecting another event) (e.g., the computer system transitions from a sleep, resting, or lower power state to an active state), the computer system displays, via the display generation component, for at least one respective color boundary (e.g., one color boundary, two color boundaries, three color boundaries, or four color boundaries) of the plurality of color boundaries, an area within the at least one respective color boundary having the color of the respective color boundary. In some embodiments, area within respective color boundary corresponds to first background region. In some embodiments, area within respective color boundary corresponds to second background region. In some embodiments, areas within additional areas maintain their color despite being surrounded by other color boundaries. Displaying the time user interface with a second pattern different from a first pattern in response to the update event and further displaying, in response to a transition to a higher power state, each respective color boundary of the plurality of color boundaries, an area within the respective color boundary having the color of the respective color boundary updates the appearance of the time user interface without requiring the user to provide inputs to manually edit the time user interface, thereby providing improved visual feedback to the user, reducing the number of inputs required to perform an operation, further performing an operation when a set of conditions has been met without requiring further user input, and preventing permanent discoloration (e.g., burn-in) on the display screen based on varying display patterns and/or colors.

In some embodiments, in response to detecting the update event, the computer system displays, via the display generation component, the time user interface with the second background region having a third color (e.g., 620b as shown in FIG. 6D). In some embodiments, the third color is the same as or different from the first color, and/or different from the second color. In some embodiments, the third color corresponds to a color of a new flower or new geometric shape displayed to replace the existing flower or existing geometric shape in a second background region. In some embodiments, in response to detecting an additional update event, the computer system displays, via the display generation component, the time user interface with the first background region having the third color (e.g., display 620a as shown in FIG. 6H and/or display the first background region transitioning to the third color previously included in the second background region). Displaying a time user interface having a first background region with a third color and a second background region with the third color in response to the update event modifies the appearance of the time user interface without requiring the user to provide inputs to manually edit the time user interface, thereby reducing the number of inputs required to perform an operation.

In some embodiments, prior to displaying, via the display generation component, the time user interface, the computer system displays, via the display generation component, an editing user interface (e.g., 632a, 632b, and/or 632c) that includes a plurality of color options (e.g., 628a, 628b, 628c, 628d, and/or small circular orbs depicting selectable options for the first background region and second background region). In some embodiments, the computer system detects a selection (e.g., 604a, 604b, crown rotation, inward press of crown, tap gesture, and/or long press gesture) of a color option of the plurality of color options (e.g., shades of red, shades of green, shades of grey and black, and/or shades of multiple colors), wherein the first color of the first background region is based on the selected color option, and the second color of the second background region is based on the selected color option (e.g., the first color is dark red and the second color is light red, first color is light green and the second color is dark green, the first color is light gray and the second color is dark gray, or the first color is orange and the second color is purple). In some embodiments, the selected colors include an ordered set of colors (e.g., lime green, emerald green, and/or forest green) to be rotated through in response to the update event (e.g., the first background region starts with lime green and the second background region starts with emerald green; in response to detecting the first update event, the first background region includes emerald green and the second background region includes forest green; and in response to detecting the second update event, the first background region includes forest green and the second background region includes lime green). Displaying an editing user interface including a plurality of color options, wherein the first color of the first background region is based on a selected color option, and the second color of the second background region is based on the selected color option provides additional control options without cluttering the user interface with additional displayed controls.

In some embodiments, the computer system detects (e.g., via one or more input devices) an input (e.g., 642, a touch input on a touch-sensitive surface, an air gesture, a voice input, a swipe up gesture at a bottom of a display, and/or a press of predetermined button) corresponding to a request to display a first user interface (e.g., a home screen and/or a user interface that includes a plurality of selectable application icons for launching respective applications) different from the time user interface (e.g., a request to navigate from the time user interface to the first user interface or a different user interface), and in response to detecting the input corresponding to the request to display the first user interface, the computer system displays, via the display generation component, the first user interface and an animation that includes a plurality of shapes (e.g., 640) moving towards a respective region (e.g., an upper region, a lower region, a right region, a left region, or a center region) of the first user interface (e.g., as shown in FIGS. 6V-6X and/or display existing flowers or existing geometric shapes moving to the top of the display). Displaying a first user interface and an animation that includes a plurality of shapes moving towards an upper region of the first user interface in response to detecting an input corresponding to a request to display the first user interface modifies the appearance of the time user interface without requiring the user to provide inputs to manually edit the time user interface, thereby reducing the number of inputs required to perform an operation and preventing permanent discoloration (e.g., burn-in) on the display screen based on varying display patterns and/or colors.

In some embodiments, the computer system displays, via the display generation component, the time user interface with a first arrangement of shapes (e.g., as shown in FIG. 6S, a first arrangement of multiple flowers or multiple geometric shapes of different shapes and/or configurations having different colors; e.g., a first arrangement of multiple flowers or multiple geometric shapes having the same shape and configuration but different colors), and in response to detecting the update event, displaying, via the display generation component, the time user interface with a second arrangement of shapes different from the first arrangement of shapes (e.g., as shown in FIG. 6U, a second arrangement of multiple flowers or multiple geometric shapes of different shapes and/or configurations having different colors, wherein the shapes and/or configurations are different from the shapes and/or configurations in the first arrangement of multiple flower or the first arrangement of multiple geometric shapes; e.g., a second arrangement of multiple flowers or multiple geometric shapes having the same shape and configuration, wherein the shape and configuration is are different from the shape and configuration of the first arrangement of multiple flowers or the first arrangement of multiple geometric shapes). In some embodiments, the second arrangement has a different number of shapes than the first arrangement. In some embodiments, the second arrangement has a different position of shapes than the first arrangement. In some embodiments, the second arrangement has a different color of shapes than the first arrangement. In some embodiments, the second arrangement has differently sized shapes than the first arrangement. In some embodiments, the second arrangement includes shapes with different geometric shapes than the first arrangement. Displaying the time user interface with a second arrangement of shapes different from a first arrangement of shapes initially updates the appearance of the time user interface without requiring the user to provide inputs to manually edit the time user interface, thereby providing improved visual feedback to the user, reducing the number of inputs required to perform an operation, and preventing permanent discoloration (e.g., burn-in) on the display screen based on varying display patterns and/or colors.

Note that details of the processes described above with respect to method 700 (e.g., FIG. 7) are also applicable in an analogous manner to the methods described below. For example, methods 900, 1100, 1300, 1500, and/or 1700 optionally include one or more of the characteristics of the various methods described above with reference to method 700. For example, in some embodiments, the same computer system performs methods 700, 900, 1100, 1300, 1500, and/or 1700 and/or the various time user interfaces recited in methods 700, 900, 1100, 1300, 1500, and/or 1700 are implemented on the same computer system.

For example, FIGS. 7A-7D illustrate an exemplary embodiment by which computer system 600 allows a user to switch between different time user interfaces based on user input. At FIG. 7A, computer system 600 displays time user interface 750. At FIG. 7A, computer system 600 detects user input 752 (e.g., a touch screen input (e.g., a press and hold input)). At FIG. 7B, in response to user input 752, computer system 600 displays editing user interface 626a. Editing user interface 626a includes a representation of time user interface 750. At FIG. 7B, computer system 600 detects user input 754, which is a swipe right input on the representation of time user interface 750. At FIG. 7C, in response to user input 754, computer system scrolls editing user interface 626a to display a representation of a different time user interface 756. At FIG. 7C, computer system 600 detects user input 758, which is a touch screen input (e.g., a tap input) corresponding to selection of the representation of time user interface 756. At FIG. 7D, in response to user input 758, computer system 600 displays time user interface 756. In various embodiments, computer system 600 allows a user to switch between different time user interfaces described herein (e.g., the various time user interfaces described herein with reference to methods 700, 900, 1100, 1300, 1500, and/or 1700) based on user input. For brevity, these details are not repeated below.

FIGS. 8A-8N illustrate techniques for displaying a simulated three-dimensional reflective object on a time user interface, in accordance with some embodiments. The user interfaces in these figures are used to illustrate the processes described below, including the processes in FIG. 9.

FIG. 8A illustrates computer system 600, which includes display 602 (e.g., a touch-sensitive display), rotatable and depressible input mechanism 604, and button 606. In FIG. 8A, computer system 600 is a smartwatch. In some embodiments, computer system 600 displays, on display 602, user interface 808a (e.g., a time user interface). User interface 808a includes an analog indication of time 810a. In some embodiments, user interface 808a includes a user interface region 808b that has an appearance that represents a view of a simulated three-dimensional reflective object 812a. The user interface region 808b also has an appearance that is based on simulated light emitted from a simulated light source at a first position relative to the simulated three-dimensional reflective object. In some embodiments, computer system 600 does not display the simulated light source on display 600. In order to generate the appearance of simulated three-dimensional reflective object 812a based on the simulated light source, a model 814 is used. Model 814 is a simulated environment corresponding to a three-dimensional sphere. Simulated light source 816 is an outer shell of the three-dimensional sphere, such that simulated light source 816 emits light, represented by light ray 818a and light ray 818b (e.g., collectively light rays 818), inward towards a center of model 814. Simulated light source 816 generally corresponds to a white light source such that light rays 818 are white light rays. Model 814 also includes a plurality of reflective spheres 820a, 820b, and 820c, and sphere 820d. Reflective sphere 820a emits light, similar to and/or the same as light source 816. For instance, reflective sphere 820a emits red light ray 822a. Reflective spheres 820b and 820c reflect light emitted from simulated light source 816, as shown via reflected light rays 822b, and 822c. In some embodiments, reflective spheres 820b and 820c do not emit light rays. Reflective sphere 820b is an orange sphere and reflective sphere 820c is a yellow sphere. Accordingly, the reflected light rays 822b and 822c correspond to the color of the sphere from which the reflected light rays originate. As a result, reflected light ray 822b is orange and reflected light ray 822c is yellow. Sphere 820d is a black or otherwise dark reflective sphere that reflects, blocks and/or absorbs a small amount of light and/or adds contrast to the other reflections within the model.

Light rays 818a, 818b, 822a and reflected light rays 822b and 822c are directed about the model such that one or more of the light rays impinge on a simulated three-dimensional reflective object representation 812a. The orientation of simulated three-dimensional reflective object 812a corresponds to an orientation of computer system 600. For instance, when a user's wrist 826 is oriented in a particular direction, such as upward (e.g., the display surface of computer system 600 is facing in the opposite direction of gravity), computer system 600 is correspondingly oriented in the upward position. When computer system 600 is oriented in the upward position, as shown in FIG. 8A, representation 812a is oriented such that the main surface of representation 812a is angled towards a center area as depicted in FIG. 8A. Accordingly, one or more light rays, such as light rays 818a, 818b, 822a and reflected light rays 822b and 822c intersect on the main surface of representation 812a and cause corresponding reflections to occur on the surface of representation 812a. Simulated light source 816, reflective spheres 820a-820c and sphere 820d thus have positions relative to the surface of representation 812a, and as a result, light rays 818a, 818b, 822a and reflected light rays 822b and 822c have a particular angle with respect to the surface of representation 812a. The collective position of simulated light source 816, reflective spheres 820a-820c, and sphere 820d relative to the surface of representation 812a creates an appearance of simulated three-dimensional reflective object 812a that corresponds to representation 812a. When the collective position of simulated light source 816, reflective spheres 820a-820c, and sphere 820d relative to the surface of representation 812a changes, the appearance of simulated three-dimensional reflective object 812 also changes. Based on the orientation of representation 812a, simulated three-dimensional reflective object 812a includes a generally bright appearance.

With reference to FIG. 8B, user's wrist 826 and computer system 600 rotates away from the user. The change in orientation of computer system 600 causes representation 812a to change orientation (e.g., rotate in one or more directions) relative to simulated light source 816, reflective spheres 820a-820c, and sphere 820d as shown in FIG. 8B. The change in orientation of representation 812a changes based on a change in speed, direction, and/or orientation of computer system 600. Accordingly, the collective position of simulated light source 816, reflective spheres 820a-820c, and sphere 820d relative to the surface of representation 812a changes with respect to the collective position prior to the change in orientation of computer system 600 (e.g., as discussed in FIG. 8A). In addition, the angles between the light rays and the surface of representation 812a change relative to the angles prior to the change in orientation of computer system 600 (e.g., as discussed in FIG. 8A). As a result, the appearance of simulated three-dimensional reflective object 812a changes relative to the appearance of simulated three-dimensional reflective object 812a prior to the change in orientation of computer system 600 (e.g., as discussed in FIG. 8A). For instance, a lower portion 828 of simulated three-dimensional reflective object 812a becomes dark or otherwise shaded based on the changed orientation of computer system 600. The remaining portion of simulated three-dimensional reflective object 812a appears generally similar to that of FIG. 8A or includes different changes in appearance than the shaded portion (e.g., the remaining portions become slightly brighter or slightly darker). Based on the changes in position of the light sources and changed angles of the light rays incident on representation 812a, various colors also change within portion 828 and/or the remaining portions. For example, the colors within the remaining portions change from yellow and red to yellow and orange.

Reflective features of simulated three-dimensional reflective object 812a create the appearance of reflections based on the light emitted and/or reflected from simulated light source 816, reflective spheres 820a-820c, and sphere 820d. For example, simulated three-dimensional reflective object 812a includes deformations that extend from a central point of time user interface 810a corresponding to a point of rotation for hands of time user interface 810a (e.g., hour, minute, and/or seconds hands). The deformations correspond to common time divisions, such as 60 deformations representing 60 seconds, 12 deformations representing 12 hours, and/or four deformations representing 12 o'clock, 3 o'clock, 6 o'clock, and 9 o'clock. Simulated three-dimensional reflective object 812a also includes an appearance corresponding to a material, such as titanium, stainless steel, or aluminum. The appearance also includes a type of external treatment of the material, such as a polished finish or a brushed finish.

Computer system 600 includes an outer housing 800-1. In some embodiments, the material depicted in the appearance of simulated three-dimensional reflective object 812a is selected (e.g., by computer system 600) and/or displayed based on the material of the housing. For example, if the housing material of computer system 600 is stainless steel, the appearance of simulated three-dimensional reflective object 812a is stainless steel.

Users can also share a respective time user interface that includes a respective simulated three-dimensional reflective object 812a with another user. In some embodiments, the appearance of simulated three-dimensional reflective object 812a is different when the shared time user interface is displayed on the second device. Specifically, simulated three-dimensional reflective object 812a is displayed on the other user's device with simulated three-dimensional reflective object 812a matching the housing material of the other user's device. For example, simulated three-dimensional reflective object 812a is displayed as stainless steel on the transferring device, whereas simulated three-dimensional reflective object 812a is displayed as aluminum on the receiving device.

With reference to FIG. 8C, user's wrist 826 and computer system 600 are rotated towards the user. The change in orientation of computer system 600 causes representation 812a to change orientation (e.g., rotate in one or more directions) relative to simulated light source 816, reflective spheres 820a-820c, and sphere 820d as shown in FIG. 8C. The change in orientation of representation 812a changes in accordance with a change in speed, direction, and/or orientation of computer system 600. Accordingly, the collective position of simulated light source 816, reflective spheres 820a-820c, and sphere 820d relative to the surface of representation 812a changes with respect to the collective position prior to the change in orientation of computer system 600 (e.g., as discussed in FIGS. 8A-8B). In addition, the particular angles between the light rays and the surface of representation 812a change relative to the particular angles prior to the change in orientation of computer system 600 (e.g., as discussed in FIGS. 8A-8B). As a result, the appearance of simulated three-dimensional reflective object 812a changes relative to the appearance of simulated three-dimensional reflective object 812a prior to the change in orientation of computer system 600 (e.g., as discussed in FIGS. 8A-8B). For example, an upper portion 830 of simulated three-dimensional reflective object 812a becomes dark or otherwise shaded based on the changed orientation of computer system 600. The appearance of the remaining portion of simulated three-dimensional reflective object 812a is similar to that in FIG. 8A or includes different changes in appearance than the shaded portion (e.g., the remaining portions become slightly brighter or slightly darker). Based on the changes in position of the light sources and changes in angles of the light rays incident on representation 812a, various colors also change within portion 828 or the remaining portions. For example, the colors within the remaining portions change from yellow and orange to red and orange.

With reference to FIG. 8D, user's wrist 826 and computer system 600 rotate in an upward direction towards the user. The change in orientation of computer system 600 causes representation 812a to change orientation (e.g., rotate in one or more directions) relative to simulated light source 816, reflective spheres 820a-820c, and sphere 820d as shown in FIG. 8D. The change in orientation of representation 812a changes in accordance with a change in speed, direction, and/or orientation of computer system 600. Accordingly, the collective position of simulated light source 816, reflective spheres 820a-820c and sphere 820d relative to the surface of representation 812a changes with respect to the collective position prior to the change in orientation of computer system 600 (e.g., as discussed in FIGS. 8A-8C). In addition, the particular angles between the light rays and the surface of representation 812a change relative to the particular angles prior to the change in orientation of computer system 600 (e.g., as discussed in FIGS. 8A-8C). As a result, the appearance of simulated three-dimensional reflective object 812a changes relative to the appearance of simulated three-dimensional reflective object 812a prior to the change in orientation of computer system 600 (e.g., as discussed in FIGS. 8A-8C). For example, a right portion 832 of simulated three-dimensional reflective object 812a becomes dark or otherwise shaded based on the changed orientation of computer system 600. The remaining portion of simulated three-dimensional reflective object 812a appears generally similar to that of FIG. 8A or includes different changes in appearance than the shaded portion (e.g., the remaining portions becomes slightly brighter or slightly darker). Based on the changes in position of the light sources and change in angles of the light rays incident on representation 812a, various colors also change within portion 828 or the remaining portions. For example, the colors within the remaining portions shift from red and orange to dark red.

With reference to FIG. 8E, user's wrist 826 and computer system 600 rotate in a downward direction away from the user. The change in orientation of computer system 600 causes representation 812a to change orientation (e.g., rotate in one or more directions) relative to simulated light source 816, reflective spheres 820a-820c, and sphere 820d as shown in FIG. 8E. The change in orientation of representation 812a changes in accordance with a change in speed, direction, and/or orientation of computer system 600. Accordingly, the position of simulated light source 816, reflective spheres 820a-820c, and sphere 820d relative to the surface of representation 812a changes with respect to the collective position prior to the change in orientation of computer system 600 (e.g., as discussed in FIG. 8A). In addition, the angles between the light rays and the surface of representation 812a change relative to the angles prior to the change in orientation of computer system 600 (e.g., as discussed in FIGS. 8A-8D). As a result, the appearance of simulated three-dimensional reflective object 812a changes relative to the appearance of simulated three-dimensional reflective object 812a prior to the change in orientation of computer system 600 (e.g., as discussed in FIGS. 8A-8D). For example, a left portion 834 of simulated three-dimensional reflective object 812a becomes dark or otherwise shaded based on the changed orientation of representation 812a. The remaining portion of simulated three-dimensional reflective object 812a appears generally similar to that of FIG. 8A or includes different changes in appearance than the shaded portion (e.g., the remaining portions become slightly brighter or slightly darker). Based on the changes in position of the light sources and changed angles of the light rays incident on representation 812a, various colors also change within portion 828 or the remaining portions. For example, the colors within the remaining portions shift from dark red to dark yellow.

With reference to FIG. 8F, user's wrist 826 and computer system 600 moves into a resting position, such as resting at the user's side or otherwise positioned in a non-viewing orientation. In some embodiments, the orientation causes computer system 600 to enter a sleep state, a resting state, and/or a reduced power state. The change in orientation of computer system 600 causes representation 812a to also tilt in a corresponding direction as depicted in FIG. 8F, such as tilting generally away from light rays emitted from simulated light source 816, light ray 822a, and reflected light rays 822b and 822c. The change in orientation of representation 812a changes consistently with a change in speed, direction, and/or orientation of computer system 600. Accordingly, the position of simulated light source 816, reflective spheres 820a-820c and sphere 820d relative to the surface of representation 814 and the angles between the light rays and the surface of representation 812a change relative to the respective positions and angles prior to the change in orientation of computer system 600 (e.g., as discussed in FIGS. 8A-8E). As a result, the appearance of simulated three-dimensional reflective object 812a changes relative to the appearance of simulated three-dimensional reflective object 812a prior to the change in orientation of computer system 600 (e.g., as discussed in FIGS. 8A-8E). For example, based on the orientation of representation 824 as generally tilted away from the light rays and the reflected light rays, the appearance of simulated three-dimensional reflective object 812a becomes generally dark or otherwise shaded.

The color scheme for simulated three-dimensional reflective object 812a includes various predefined and/or adjustable colors that are depicted based on movement of the computer system 600, as described with respect to FIGS. 8A-8F. For example, a current color scheme of simulated three-dimensional reflective object 812a is “warm,” which generally includes the colors red, orange, and yellow. Specifically, as discussed above, reflective sphere 820a emits a red light ray 822a. Reflective sphere 820b is an orange sphere and reflective sphere 820c is a yellow sphere, such that reflected light ray 822b is orange and reflected light ray 822c is yellow.

With reference to FIG. 8G, computer system 600 displays an editing user interface 834 that enables a user to modify various aspects of simulated three-dimensional reflective object 812a. In some embodiments, computer system 600 displays editing user interface 834 in response to detecting an input (e.g., press-and-hold input on display 802 and/or a press of a predefined button such as button 806). The manner in which one or more colors are reflected on simulated three-dimensional reflective object is modified via editing user interface 834. A first color scheme corresponding to color option 836a is initially selected for simulated three-dimensional reflective object 812a. As shown in FIG. 8G, a user rotates rotatable and depressible input mechanism 804 via rotation 804a to cycle through color options 836. For instance, the user navigates from the color corresponding to color option 836a to the color corresponding to color option 836b as depicted in FIG. 8G such that color option 836b is selected. Color option 836b includes shades or classifications of the color yellow, such as colors lemon, corn, and gold. Accordingly, model 814 is adjusted based on the user selection. In particular, reflective sphere 820a is adjusted to emit a “lemon” color. Reflective spheres 820b and 820c are adjusted to emit “corn” colored light and “gold” colored light, respectively. As a result, reflected light ray 822b is a “lemon” color and reflected light ray 822c is a “gold” color. The appearance of simulated three-dimensional reflective object 812a changes within editing user interface 834 to reflect the selected color scheme of “yellow.”

With reference to FIG. 8H, computer system 600 detects an input, such as a rotation 804b of rotatable and depressible input mechanism 804 to cycle through additional color options 836. The user navigates from the color corresponding to color option 836b to the color corresponding to color option 836c as depicted in FIG. 8H. Color option 836c includes shades or classifications of colors corresponding to the autumn season, such as bronze, purple, and gold. Accordingly, model 814 is adjusted based on the user selection. Reflective sphere 820a is adjusted to emit a purple colored light. Reflective sphere 820b is adjusted to emit a bronze colored light and reflective sphere 820c is adjusted to emit a gold colored light. As a result, reflected light ray 822b is a bronze color and reflected light ray 822c is a gold color. The appearance of simulated three-dimensional reflective object 812a changes within editing user interface 834 to reflect the selected color scheme of “Fall.” Once the user has selected a desired color scheme for simulated three-dimensional reflective object 812a, the user presses 804c rotatable and depressible input mechanism 804 to finalize the selection.

With reference to FIG. 8I, once user presses 804c rotatable and depressible input mechanism 804 to finalize the selection, simulated three-dimensional reflective object 812a is displayed on display 802 including the selected color scheme “Fall.” Accordingly, based on various movements of computer system 600, simulated three-dimensional reflective object 812a is displayed with varying shades of brightness and darkness, along with varying shades of the respective colors of color scheme “Fall,” including purple, gold, and bronze (e.g., as discussed with respect to FIGS. 8A-8F).

With reference to FIG. 8J, computer system 600 navigates back to editing user interface 834 in response to an input (e.g., a press-and-hold input on display 802 and/or a press of a predefined button such as button 806). While in editing user interface 834, computer system 600 detects gesture 838 (e.g., a swipe left gesture or a swipe right gesture) to switch between an analog version of time user interface and a digital version of the time user interface. Specifically, the time user interface including simulated three-dimensional reflective object 812a is an analog time user interface. Computer system 600 detects the gesture which causes computer system 600 to change the time user interface from the analog time user interface to a digital time user interface, as shown in FIG. 8K. When changing the time user interface from the analog time user interface to the digital time user interface, one or more characteristics of the time user interface remain the same, such as the color scheme. As a result, various aspects of model 814 remains the same when switching from the analog time user interface to the digital time user interface, such as the reflective sphere 820a continuing to emit a purple colored light, reflective sphere 820b continuing to reflect a bronze light ray and reflective sphere 820c continuing to reflect a gold light ray. The user provides an input, such as a press 840 of rotatable and depressible input mechanism 804 in to order to activate the digital time user interface.

With reference to FIG. 8L, a digital time user interface 810b including simulated three-dimensional reflective object 812b is depicted. While digital time user interface 810b is activated, simulated three-dimensional reflective object 812b represents an indication of time including one or more numerals indicating the current time, such as “1029” representing 10:29 AM.

Different variations in the reflections from the simulated light source are displayed depending on whether an analog time user interface or a digital time user interface is selected. For example, the change in appearance of the simulated three-dimensional reflective object includes greater variance when the time user interface is analog. While the same general model 814 is implemented when using digital time user interface 810b, the simulated three-dimensional reflective object representation includes different characteristics than when model 814 is implemented using an analog time user interface. In particular, simulated three-dimensional reflective object representation 824b has less freedom of movement when model 814 is implemented using a digital time user interface. For instance, the simulated three-dimensional reflective object representation generally represents a three-dimensional curved surface that rotates and/or tilts with a degree of rotation within the three-dimensional model. While model 814 is implemented using an analog time user interface, simulated three-dimensional reflective object representation 812a rotates and/or tilts with a 360 degree of rotation (e.g., simulated three-dimensional reflective object representation 812a is capable of rotating to face any direction within model 814). While model 814 is implemented using a digital time user interface, simulated three-dimensional reflective object representation 824b rotates and/or tilts with less than a 360 degree of rotation (e.g., simulated three-dimensional reflective object representation 812a is capable of rotating to face a predefined range of directions within model 814). Alternatively, while model 814 is implemented using a digital time user interface, simulated three-dimensional reflective object representation 812a rotates and/or tilts along one or more axes within model 814 (e.g., simulated three-dimensional reflective object representation 812a is capable of rotating only clockwise or counterclockwise within model 814).

With reference to FIG. 8M, a movement of user's wrist 826 and corresponding movement of computer system 600 is depicted while digital time user interface 810b is displayed. Here, computer system 600 tilts clockwise and away from the user. The change in orientation of computer system 600 causes representation 824b to tilt in a corresponding direction within model 814, such as tilting towards a lower portion of model 814. In some examples, the degree of tilt of representation 824b is less than the degree of tilt which would be implemented when using an analog time user interface with the same characteristic movement of computer system 600 (e.g., as discussed with respect to FIG. 8B). The change in orientation of representation 824b changes consistently with a change in speed, direction, and/or orientation of computer system 600. Accordingly, the position of simulated light source 816, reflective spheres 820a-820c, and sphere 820d relative to the surface of representation 824b and the particular angles between the light rays and the surface of representation 824b changes relative to the respective positions and angles prior to the change in orientation of computer system 600 (e.g., as discussed in FIG. 8L). As a result, the appearance of simulated three-dimensional reflective object 812b changes relative to the appearance of simulated three-dimensional reflective object 812b prior to the change in orientation of computer system 600 (e.g., as discussed in FIG. 8L). For instance, an upper portion 842 of simulated three-dimensional reflective object 812b is shown with a bright reflection based on the changed orientation of representation 824b. The remaining portion of simulated three-dimensional reflective object 812b appears generally similar to that of FIG. 8L or includes different changes in appearance than the brighter portion (e.g., the remaining portions become slightly brighter or slightly darker). Based on the changes in position of the light sources and changed angles of the light rays incident on representation 824b, various colors also change within portion 842 or the remaining portions. For example, the colors within the remaining portions shift from predominately gold and purple to predominantly purple and bronze.

With reference to FIG. 8N, an additional movement of user's wrist 826 and corresponding movement of computer system 600. Here, computer system 600 tilts counterclockwise and towards the user. The change in orientation of computer system 600 causes representation 824b to tilt in a corresponding direction within model 814, such as tilting towards an upper portion of model 814. In some examples, the degree of tilt of representation 824b is less than the degree of tilt which would be implemented when using an analog time user interface with the same characteristic movement of computer system 600 (e.g., as discussed with respect to FIG. 8C). The change in orientation of representation 824b changes consistently with a change in speed, direction, and/or orientation of computer system 600. Accordingly, the position of simulated light source 816, reflective spheres 820a-820c and sphere 820d relative to the surface of representation 814 and the particular angles between the light rays and the surface of representation 814 changes relative to the respective positions and angles prior to the change in orientation of computer system 600 (e.g., as discussed in FIG. 8L). As a result, the appearance of simulated three-dimensional reflective object 812b changes relative to the appearance of simulated three-dimensional reflective object 812b prior to the change in orientation of computer system 600 (e.g., as discussed in FIG. 8M). For instance, a lower portion 844 of simulated three-dimensional reflective object 812b is shown with a bright reflection based on the changed orientation of representation 824b. The remaining portion of simulated three-dimensional reflective object 812b appears generally similar to that of FIG. 8L or includes different changes in appearance than the brighter portion (e.g., the remaining portions become slightly brighter or slightly darker). Based on the changes in position of the light sources and changed angles of the light rays incident on representation 824b, various colors also change within portion 844 or the remaining portions. For example, the colors within the remaining portions shift from predominantly purple and bronze to predominantly gold and bronze.

FIG. 9 is a flow diagram illustrating a method for displaying background regions using a computer system in accordance with some embodiments. Method 900 is performed at a computer system (e.g., 100, 300, 500, 600, 600-1, a smartphone, a smartwatch, a tablet computer, a laptop computer, a desktop computer, a head mounted augmented reality device and/or a head mounted extended reality device) that is in communication with a display generation component (e.g., 602, a display controller, a display, a touch-sensitive display system, a touchscreen, a monitor, and/or a head mounted display system). In some embodiments, the computer system is in communication with one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 900 are, optionally, combined, the orders of some operations are, optionally, changed, and some operations are, optionally, omitted.

As described below, method 900 provides an intuitive way for displaying background regions for time user interfaces. The method reduces the cognitive burden on a user for displaying background regions for time user interfaces, thereby creating a more efficient human-machine interface. For battery-operated computing devices, enabling a user to modify background regions for time user interfaces faster and more efficiently conserves power and increases the time between battery charges.

The computer system displays (902) via the display generation component, a time user interface (e.g., 810a, a user interface that includes an analog and/or digital indication of time, a clock face user interface, a watch face user interface, a home screen, a reduced-power screen, a wake screen, and/or a lock screen) including a user interface region (e.g., 808b) that has an appearance that represents a view of a simulated (e.g., virtual) three-dimensional reflective object (e.g., 812a, a graphical representation of a three-dimensional reflective object such as a metallic object), the user interface region having a first appearance that is based on simulated light emitted from a simulated (e.g., virtual) light source (e.g., 816, 820a, a simulated light source having one or more colors that is an emissive and/or reflective light source) at a first position (e.g., location, distance, angle, and/or orientation) relative to the simulated three-dimensional reflective object (e.g., 812a) (e.g., relative to a portion, point, and/or surface of the simulated three-dimensional reflective object). In some embodiments, a home screen corresponds to a user interface that is initially displayed when the computer system is unlocked, wakes from a reduced-power state, and/or receives a particular input (e.g., a swipe from a specific region on the display or a press of a specific button of the computer system). In some embodiments, the home screen includes affordances for a plurality of applications and functions of the computer system. In some embodiments, the plurality of applications and functions are user-customizable, such that the user of the computer system can configure which applications and/or device functions appear on the home screen.

In some embodiments, the simulated light source (e.g., a graphical representation of the simulated light source) is not displayed on the time user interface (e.g., the time user interface is displayed without displaying a representation of the simulated light source). In some embodiments, simulated light (e.g. 818a) from the simulated light source (e.g., 816, 820a, 820b, and/or 820c) is displayed on the time user interface. In some embodiments, displaying the time user interface includes displaying a simulated lighting effect that is based on the simulated light source (e.g., simulated light reflecting from the simulated three-dimensional reflective object). In some embodiments, the simulated lighting effect is based on a position of the simulated light source (e.g., relative to the simulated three-dimensional reflective object, and/or as depicted in FIGS. 8A-8F), a color of the simulated light source, and/or a brightness of the simulated light source (e.g., in accordance with the simulated light source having at first position relative to the simulated three-dimensional object, the simulated three-dimensional object and/or the simulated lighting effect has a first appearance; and in accordance with the simulated light source having a second position different from the first position relative to the simulated three-dimensional object, the simulated three-dimensional object and/or the simulated lighting effect has a second appearance that is different from the first appearance). In some embodiments, a reduced-power screen is a user interface that is displayed when the computer system is in a reduced-power state, low-power state, off state, and/or reduced-power state. In some embodiments, a wake screen is a user interface that is displayed when the computer system transitions from a lower power state to a higher power state (e.g., from a state in which the computer system has a lower brightness, a display has a slower refresh rate, a lower power processor is in use, a processor is in a lower power state, and/or one or more additional sensors are taking less frequent sensor measurements to a state in which the computer system has a higher brightness, a display has a faster refresh rate, a higher power processor is in use, a processor is in a higher power state, and/or one or more additional sensors are taking more frequent sensor measurements).

The computer system detects (904) an event (e.g., a user input, movement of the computer system (e.g., or a portion of the computer system) that satisfies a set of motion criteria, an upward movement of the computer system, a downward movement of the computer system, a lateral (e.g., left and/or right) movement of the computer system, a rotation of the computer system, a wrist movement, and/or as depicted in FIGS. 8B-8F). In some embodiments, the event includes (e.g., is or is based on) the computer system being covered (e.g., for a predetermined amount of time and/or by a hand of a user and/or other object).

In response to detecting the event, the computer system displays (906) via the display generation component, the time user interface (e.g. 808a) with the user interface region (e.g. 808b) having a second appearance that is different from the first appearance (e.g., as depicted in FIGS. 8A-8F), wherein the second appearance is based on simulated light emitted from the simulated light source at a second position (e.g., location, distance, angle, orientation,) relative to the simulated three-dimensional reflective object (e.g., 812a), wherein the second position relative to the simulated three-dimensional reflective object is different from the first position relative to the simulated three-dimensional reflective object (e.g., relative to a portion, point, surface of the simulated three-dimensional reflective object, and/or as depicted in FIGS. 8A-8F). In some embodiments, the simulated light source (e.g., a graphical representation of the simulated light source) is not displayed on the time user interface (e.g., the time user interface is displayed without displaying a representation of the simulated light source). In some embodiments, simulated light from the simulated light source is displayed on the time user interface (e.g., as depicted in FIGS. 8A-8F). In some embodiments, displaying the time user interface includes displaying a simulated lighting effect that is based on the simulated light source (e.g., 816, 820a, 820b, and/or 820c) (e.g., simulated light reflecting from the simulated three-dimensional reflective object). In some embodiments, the simulated lighting effect is based on a position of the simulated light source (e.g., 816, 820a, 820b, and/or 820c) (e.g., relative to the simulated three-dimensional reflective object), a color of the simulated light source, and/or a brightness of the simulated light source (e.g., in accordance with the simulated light source having at first position relative to the simulated three-dimensional object, the simulated three-dimensional object and/or the simulated lighting effect has a first appearance; and in accordance with the simulated light source having a second position different from the first position relative to the simulated three-dimensional object, the simulated three-dimensional object and/or the simulated lighting effect has a second appearance that is different from the first appearance).

In some embodiments, when the second position is closer to the simulated three-dimensional object than the first position, the simulated lighting effect is brighter after detecting the event. In some embodiments, when the second position is closer to the simulated three-dimensional object than the first position, the appearance of the simulated three-dimensional object is brighter after detecting the event. In some embodiments, when the second position is farther from the simulated three-dimensional object than the first position, the simulated lighting effect is less bright after detecting the event (e.g., as shown in FIGS. 8B-8F relative to FIG. 8A). In some embodiments, when the second position is farther from the simulated three-dimensional object than the first position, the appearance of the simulated three-dimensional object is less bright after detecting the event (e.g., as shown in FIGS. 8B-8F relative to FIG. 8A). In some embodiments, the simulated lighting effect is relatively brighter when an angle between light incident on a surface point of the simulated three-dimensional object and a line perpendicular to the surface point (e.g., an angle of incidence and/or an illumination angle) is smaller (e.g., 2 degrees, 5 degrees, 10 degrees, or 20 degrees) than when the angle is larger (e.g., 60 degrees, 70 degrees, 80 degrees, or 85 degrees) (e.g., as shown in FIG. 8A relative to FIGS. 8B-8F). In some embodiments, the appearance of the simulated three-dimensional object is relatively brighter when an angle between light incident on a surface point of the simulated three-dimensional object and a line perpendicular to the surface point (e.g., an angle of incidence and/or an illumination angle) is smaller (e.g., 2 degrees, 5 degrees, 10 degrees, or 20 degrees) than when the angle is larger (e.g., 60 degrees, 70 degrees, 80 degrees, or 85 degrees) (e.g., as shown in FIG. 8A relative to FIGS. 8B-8F).

In some embodiments, in accordance with the detected event including a rotation of the computer system, the position of the simulated light source (e.g., 816, 820a, 820b, and/or 820c) is moved in a curved (e.g., circular) motion around the simulated three-dimensional reflective object (e.g., 812a). In some embodiments, in accordance with the detected event including a rotation of the computer system, the appearance of the simulated three-dimensional reflective object (e.g., 812a) includes light moving from a first portion on the three-dimensional reflective object to a second portion on the three-dimensional reflective object (e.g., as shown in FIGS. 8A-8E). In some embodiments, in accordance with the detected event including a first speed of movement of the computer system, the position of the simulated light source (e.g., 816, 820a, 820b, and/or 820c) is moved at a first speed, and in accordance with the detected event including a second speed of movement of the computer system, the position of the simulated light source is moved at a second speed, where the first speed of movement is greater than the second speed of movement and the first speed is greater than the second speed. In some embodiments, in accordance with the detected event including a first speed of movement of the computer system, the appearance of the simulated three-dimensional reflective object (e.g., 812a) and/or the simulated lighting effect is modified at a first speed, and in accordance with the detected event including a second speed of movement of the computer system, the appearance of the simulated three-dimensional reflective object (e.g., 812a) and/or the simulated lighting effect is modified at second speed, where the first speed of movement is greater than the second speed of movement and the first speed is greater than the second speed.

Displaying a time user interface including a user interface region (e.g., 808b) having an appearance that represents a view of a simulated three-dimensional reflective object (e.g., 812a) having a first appearance that is based on simulated light emitted from a simulated light source (e.g., 816, 820a, 820b, and/or 820c) at a first position relative to the simulated three-dimensional reflective object (e.g., 812a), and further, in response to detecting an event, displaying the time user interface with the user interface region (e.g., 808b) having a second appearance, that is different from the first appearance, wherein the second appearance is based on simulated light emitted from the simulated light source (e.g., 816, 820a, 820b, and/or 820c) at a second position relative to the simulated three-dimensional reflective object (e.g., 812a), wherein the second position relative to the simulated three-dimensional reflective object is different from the first position relative to the simulated three-dimensional reflective object updates the time user interface without requiring the user to provide inputs to manually edit the time user interface, thereby providing improved visual feedback to the user, and preventing permanent discoloration (e.g., burn-in) on the display screen based on varying display patterns and/or colors.

In some embodiments, the event includes (e.g., is or is based on) a movement of the computer system detected via one or more sensors of the computer system (e.g., one or more sensors for detecting motion such as an accelerometer, gyroscope, magnetometer and/or internal measurement unit). In some embodiments, the movement includes rotation, a change in position, and/or a change in orientation of at least a portion of the computer system (e.g., movement of a wrist to which the computer system is attached and/or motion that is determined to be indicative of a wrist movement in a particular direction and/or a wrist rotation around a particular axis). Detecting an event including movement of the computer system updates the time user interface without requiring the user to provide inputs to manually edit the time user interface, thereby reducing the number of inputs required to perform an operation.

In some embodiments, in response to detecting the event, the computer system changes the appearance of the user interface region (e.g., 808b) to the second appearance to have an updated appearance that corresponds to moving the simulated light source (e.g., 816, 820a, 820b, and/or 820c) from the first position relative to the simulated three-dimensional reflective object (e.g., 812a) (e.g., moved along an x-axis, a y-axis, and/or a z-axis) to the second position relative to the simulated three-dimensional reflective object, wherein movement of the simulated light source (e.g., 816, 820a, 820b, and/or 820c) between the first position relative to the simulated three-dimensional reflective object and the second position relative to the simulated three-dimensional reflective object is based on the movement of the computer system (e.g., if the movement includes a movement of the computer system in a first direction, the appearance corresponds to moving the light source in a corresponding direction (e.g., in the same direction as the first direction, in a direction within a threshold angle of the first direction, or in an opposite direction to the first direction); e.g., if the speed of movement of the computer system is slower, the appearance corresponds to a slower speed of movement of the light source, whereas if the speed of movement of the computer system is greater, the appearance corresponds to a greater speed of movement of the light source; e.g., if the computer system moves a lesser distance, the appearance corresponds to the light source moving a lesser distance, whereas if the computer system is moved a greater distance, the appearance corresponds to the light source moving a greater distance; e.g., if the movement includes a greater magnitude of rotation of the computer system, the appearance corresponds to the light source moving a greater amount (e.g., in the same direction of rotation, in a direction of rotation within a threshold angle of the rotation of the computer system, or in an opposite direction of rotation), whereas if the movement includes a lesser magnitude of rotation of the computer system, the appearance corresponds to the light source moving a lesser amount (e.g., in the same direction of rotation, in a direction of rotation within a threshold angle of the rotation of the computer system, or in an opposite direction of rotation)). Moving the simulated light source from the first position relative to the simulated three-dimensional reflective object to the second position relative to the three-dimensional reflective object based on movement of the computer system updates the time user interface without requiring the user to provide inputs to manually edit the time user interface, thereby reducing the number of inputs required to perform an operation.

In some embodiments, the event includes (e.g., is or is based on) a transition of the computer system from a first power state (e.g., an active state, a normal operating state, full-power state, on state, and/or awake state) to a second power state (e.g., a lower power state, a sleep state, a resting state, and/or a reduced power state) (e.g., as shown in FIG. 8F relative to FIGS. 8A-8E), wherein the computer system consumes less power in the second power state than in the first power state (e.g., because in the active state, a display has a higher brightness, a display has a faster refresh rate, a higher power processor is in use, a processor is in a higher power state, and/or one or more additional sensors are taking more frequent sensor measurements). In some embodiments, the computer system transitions to the second power state in response to detecting a wrist down motion (e.g., a wrist or hand down gesture and/or motion that satisfies a set of motion criteria that indicates that a wrist or hand of a user has been lowered) (e.g., as shown in FIG. 8F). In some embodiments, the computer system transitions to the second power state in response to detecting that the computer system (or, in some embodiments, a display of the computer system) is covered (e.g., in response to detecting a hand cover gesture and/or in response to detecting that the computer system has been covered for a predetermined amount of time). In some embodiments, the computer system transitions to the second power state in response to detecting that the computer system has been lowered (e.g., as shown in FIG. 8F) (e.g., to a resting position, a surface, and/or a user's pocket). In some embodiments, the computer system transitions to the second power state after a period in which the computer system does not receive user inputs or detect the occurrence of one or more conditions that keep the computer system in an active state, normal operating state, full-power state, on state, and/or awake state. Detecting an event including a transition of the computer system from a first power state to a second power state, wherein the computer system consumes less power in the second power state than in the first power state updates the time user interface without requiring the user to provide inputs to manually edit the time user interface, thereby reducing the number of inputs required to perform an operation.

In some embodiments, in response to detecting the event, changing the appearance of the user interface region (e.g., 808b) to the second appearance to have an updated appearance that corresponds to increasing a distance between the simulated light source (e.g., 816, 820a, 820b, and/or 820c) and the simulated three-dimensional reflective object (e.g., 812a), wherein a first distance between the simulated three-dimensional reflective object and the first position relative to the simulated three-dimensional reflective object is smaller than a second distance between the simulated three-dimensional reflective object and the second position relative to the simulated three-dimensional reflective object. In some embodiments, the distance between the simulated light source (e.g., 816, 820a, 820b, and/or 820c) and the simulated three-dimensional reflective object (e.g., 812a) is based on a specific point on the three-dimensional reflective object (e.g., a center point of the object or a point on a surface of the three-dimensional reflective object closest to the simulated light source). Increasing a distance between the simulated light source and the simulated three-dimensional reflective object updates the time user interface without requiring the user to provide inputs to manually edit the time user interface, thereby reducing the number of inputs required to perform an operation.

In some embodiments, the first appearance includes a first simulated lighting effect that corresponds to light falling on a first portion of the simulated three-dimensional reflective object (e.g., 812a) (e.g., a direct lighting effect, an indirect lighting effect, a diffused lighting effect, a form shadow effect, a core shadow effect, an occlusion shadow effect, and/or a cast shadow effect), the second appearance includes a second simulated lighting effect that corresponds to light falling on a second portion of the simulated three-dimensional reflective object (e.g., a direct lighting effect, an indirect lighting effect, a diffused lighting effect, a form shadow effect, a core shadow effect, an occlusion shadow effect, and/or a cast shadow effect), the first simulated lighting effect is based on the first position relative to the simulated three-dimensional reflective object, the second simulated lighting effect is based on the second position relative to the simulated three-dimensional reflective object, the first simulated lighting effect is different from the second simulated lighting effect (e.g., the second simulated lighting effect includes a different type of lighting effect, a different appearance of the same type of lighting effect, a different type of shadow effect, and/or a different appearance of the same type of shadow effect than the first simulated lighting effect), and the first portion of the simulated three-dimensional reflective object is different from the second portion of the simulated three-dimensional reflective object. In some embodiments, the first portion of the simulated three-dimensional reflective object and the second portion of the simulated three-dimensional reflective object include overlapping portions. In some embodiments, the first portion of the simulated three-dimensional reflective object and the second portion of the simulated three-dimensional reflective object do not include overlapping portions. Displaying different simulated lighting effects on different portions of the three-dimensional reflective object based on the first and second positions relative to the simulated three-dimensional reflective object updates the time user interface without requiring the user to provide inputs to manually edit the time user interface, providing improved visual feedback to the user and reducing the number of inputs required to perform an operation.

In some embodiments, the first position relative to the simulated three-dimensional reflective object (e.g., 812a) corresponds to a first angle (e.g., angle of incidence; e.g., the first angle changes in response to detecting the event) between a first side of the simulated three-dimensional reflective object (e.g., a point or a portion of the surface of the three-dimensional reflective object) and the simulated light source (e.g., 816, 820a, 820b, and/or 820c), the second position relative to the simulated three-dimensional reflective object corresponds to a second angle (e.g., angle of incidence; the second angle changes in response to detecting the event) between the first side of the simulated three-dimensional reflective object (e.g., a point or a portion of the surface of the three-dimensional reflective object) and the simulated light source (e.g., 816, 820a, 820b, and/or 820c), and the first angle is different than the second angle (e.g., as shown in FIGS. 8A-8F). In some embodiments, the first angle is larger than the second angle. In some embodiments, the first angle is smaller than the second angle. Changing an angle between a first side of the simulated three-dimensional reflective object and the simulated light source updates the time user interface without requiring the user to provide inputs to manually edit the time user interface, providing improved visual feedback to the user and reducing the number of inputs required to perform an operation.

In some embodiments, a color of the simulated light source (e.g., 816, 820a, 820b, and/or 820c) is selectable by a user of the computer system (e.g., as shown in FIGS. 8G-8I). In some embodiments, a user selects a color of the simulated light source (e.g., 816, 820a, 820b, and/or 820c) using an editing user interface (e.g., 834) (e.g., by rotating a depressible and rotatable input device and/or by performing one or more gestures on a surface of the computer system). In some embodiments, a color of the simulated light source (e.g., 816, 820a, 820b, and/or 820c) is based on a color selected by a user of the computer system (e.g., via a user interface). In some embodiments, in accordance with a determination that a first color has been selected, the light source has a first color; and in accordance with a determination that a second color has been selected, the light source has a second color different from the first color (e.g., as shown in FIGS. 8G-8I). Providing options to select a color of the simulated light source provides improved visual feedback to the user and prevents permanent discoloration (e.g., burn-in) on the display screen based on varying display patterns and/or colors.

In some embodiments, the simulated light source (e.g., 816, 820a, 820b, and/or 820c) includes a first simulated light source having a first property (e.g., a position, a size, a shape, and/or a color) and a second simulated light source having a second property different from the first property (e.g., a position, a size, a shape, and/or a color). For example, the user interface region (e.g., 808b) has an appearance that includes simulated reflections from the first simulated light source (e.g., 816, 820a, 820b, and/or 820c) and the second simulated light source (e.g., 816, 820a, 820b, and/or 820c), where the appearance of the user interface region (e.g., 808b) is based on the first property of the first simulated light source and the second property of the second simulated light source. Using simulated light sources with different properties updates the time user interface without requiring the user to provide inputs to manually edit the time user interface and prevents permanent discoloration (e.g., burn-in) on the display screen based on varying display patterns and/or colors.

In some embodiments, the first property includes a first color (e.g., red, orange, yellow, green, blue, purple, white, and/or grey) and the second property includes a second color different from the first color (e.g., red, orange, yellow, green, blue, purple, white, and/or grey), the simulated three-dimensional reflective object (e.g., 812a) includes: a first reflective feature (e.g., a convex surface, a concave surface, a smooth surface, a rough surface, a deformation, an indentation, and/or a protrusion) having a first reflection (e.g., a specular reflection, a diffuse reflection, and/or a multiple reflection) based on the first color and a first direction (e.g., a direction based on coordinates with respect to an x-axis, a y-axis, and/or a z-axis) of the first simulated light source (e.g., 816, 820a, 820b, and/or 820c) relative to the first reflective feature, and a second reflective feature (e.g., a convex surface, a concave surface, a smooth surface, a rough surface, a deformation, an indentation, and/or a protrusion) having a second reflection (e.g., a specular reflection, a diffuse reflection, and/or a multiple reflection) based on the second color and a second direction (e.g., a direction based on coordinates with respect to an x-axis, a y-axis, and/or a z-axis) of the second simulated light source (e.g., 816, 820a, 820b, and/or 820c) relative to the second reflective feature (e.g., as shown in FIGS. 8A-8F). In some embodiments, reflective features may include multiple overlapping reflections based on multiple simulated light sources (e.g., 816, 820a, 820b, and/or 820c) projecting different colors onto the simulated three-dimensional reflective object (e.g., 812a). Displaying reflections of different reflective features of the three-dimensional reflective object based on colors and directions of the simulated light sources updates the time user interface without requiring the user to provide inputs to manually edit the time user interface and prevents permanent discoloration (e.g., burn-in) on the display screen based on varying display patterns and/or colors.

In some embodiments, displaying the time user interface including the user interface region (e.g., 808b) includes: in accordance with a determination that the computer system is a first type of device (e.g., a wearable device including a specific device material, a mobile device including a specific device material, a tablet device including a specific device material, or a laptop device including a specific device material), displaying the user interface region (e.g., 808b) with an appearance that is based on the simulated three-dimensional reflective object (e.g., 812a) having a first set of one or more simulated properties; and in accordance with the computer system corresponding to a second type different from the first type when displaying the time user interface (e.g., a wearable device including a specific device material, a mobile device including a specific device material, a tablet device including a specific device material, or a laptop device including a specific device material), displaying the user interface region (e.g., 808b) with an appearance that is based on the simulated three-dimensional reflective having a second set of one or more simulated properties, different from the first set of one or more simulated properties. In some embodiments, a simulated property of the object is based on a physical material of the computer system (e.g., 800-1, a device housing, and/or a device casing). Varying the simulated properties that affect the appearance of the user interface region based on device type updates the time user interface without requiring the user to provide inputs to manually edit the time user interface and prevents permanent discoloration (e.g., burn-in) on the display screen based on varying display patterns and/or colors.

In some embodiments, the first set of one or more simulated properties includes a first simulated reflectivity (e.g., a reflectivity based on a material of a housing of the computer system of the first type and/or a reflectivity based on an external treatment of the material of the housing of the computer system of the first type), and the second set of one or more simulated properties includes a second simulated reflectivity (e.g., a reflectivity based on a material of a housing of the computer system of the first type and/or a reflectivity based on an external treatment of the material of the housing of the computer system of the first type) different from the first simulated reflectivity. In some embodiments, the simulated reflectivity corresponds to a reflectivity of the housing material corresponding to the computer system. In some embodiments, the simulated reflectivity corresponds to a reflectivity of an external treatment of the material of the housing of the computer system. In some embodiments, the simulated reflectivity corresponds to the reflectivity of aluminum when the computer system has an aluminum device housing. In some embodiments, the simulated reflectivity corresponds to the reflectivity of titanium when the computer system has a titanium device housing. In some embodiments, the simulated reflectivity corresponds to the reflectivity of stainless steel when the computer system has a stainless steel device housing. In some embodiments, the simulated reflectivity corresponds to the reflectivity of a polished surface when the device housing has a polished finish. In some embodiments, the simulated reflectivity corresponds to the reflectivity of a brushed surface when the device housing has a brushed finish. Varying the simulated reflectivity of the three-dimensional reflective object based on device type updates the time user interface without requiring the user to provide inputs to manually edit the time user interface and prevents permanent discoloration (e.g., burn-in) on the display screen based on varying display patterns and/or colors.

In some embodiments, the first set of one or more simulated properties includes a first color (e.g., a color based on a material of a housing of the computer system and/or a portion of the housing of the computer system), and the second set of one or more simulated properties includes a second color (e.g., a color based on a material of a housing of the computer system and/or a portion of the housing of the computer system) different from the first color. In some embodiments, the color property of the simulated three-dimensional reflective object (e.g., 812a) includes multiple colors when the housing of the computer system includes multiple colors.

Varying the color of the three-dimensional reflective object based on device type updates the time user interface without requiring the user to provide inputs to manually edit the time user interface and prevents permanent discoloration (e.g., burn-in) on the display screen based on varying display patterns and/or colors. In some embodiments, the computer system provides (e.g., sharing and/or transmitting) a representation of the time user interface to a second computer system different from the computer system (e.g., a user of the computer system shares the representation of the time user interface with a user of the second computer system and/or the representation of the time user interface is obtained by the user of the second computer system), wherein when the time user interface is displayed on the second computer system the user interface region (e.g., 808b) has an appearance that is based on a simulated three-dimensional reflective object (e.g., 812a) that is displayed with a second set of one or more simulated properties that are different from the first set of one or more simulated properties that are used when the time user interface is displayed on the computer system (e.g., a color of the simulated three-dimensional reflective object corresponds to a color of the housing of the second computer system different from a color of the housing of the first computer system, a reflectivity of the simulated three-dimensional reflective object corresponds to a reflectivity of the housing of the second computer system different from a reflectivity of the housing of the first computer system, and/or a reflectivity of the simulated three-dimensional reflective object corresponds to a reflectivity of the housing of the second computer system different from a reflectivity of the housing of the first computer system). Providing the representation of the time user interface to a second computer system and displaying the simulated three-dimensional reflective object with different simulated properties on the second computer system updates the time user interface without requiring the user to provide inputs to manually edit the time user interface and prevents permanent discoloration (e.g., burn-in) on the display screen based on varying display patterns and/or colors.

In some embodiments, the simulated three-dimensional reflective object (e.g., 812a) includes a plurality of deformations (e.g., a cavity, an indentation, a depression, a slot, and/or a notch) that are arranged into segments indicative of time divisions, and (e.g., a segment corresponds to one second, five seconds, fifteen seconds, thirty seconds, forty-five seconds, one minute, five minutes, fifteen minutes, thirty minutes, forty-five minutes, one hour, three hours, six hours, nine hours, and/or twelve hours), the plurality of deformations reflect the simulated light emitted from the simulated light source (e.g., as shown in FIGS. 8A-8F). Displaying the three-dimensional reflective object including deformations that reflect the simulated light and are arranged into segments indicative of time divisions provides improves visual feedback to the user.

In some embodiments, the plurality of deformations are positioned in a circular arrangement around a center point of the time user interface (e.g., originating at the center point and extending towards the edge of the time user interface), and the center point of the time user interface is a point of rotation for an indication of time (e.g., an analog indication of time that includes one or more clock hands that indicate time by pointing in different directions, such as a seconds hand, minute hand, and/or hour hand) (e.g., as shown in FIGS. 8A-8F). Displaying the three-dimensional reflective object including deformations positioned in a circular arrangement around a center point of rotation for the indication of time improves visual feedback to the user.

In some embodiments, the time user interface corresponds to an analog time user interface, and the time user interface includes one or more clock hands overlaid on the simulated three-dimensional reflective object (e.g., 812a) that have positions that indicate a current time (e.g., the one or more clock hands move overlaid on the simulated three-dimensional reflective object over time to indicate a current time) (e.g., as shown in FIGS. 8A-8F). Displaying clock hands overlaid on the simulated three-dimensional reflective object for an analog time user interface varies the appearance of the time user interface without requiring the user to provide inputs to manually edit the time user interface and improves visual feedback to the user.

In some embodiments, the time user interface corresponds to a digital time user interface, and displaying the time user interface includes displaying the simulated three-dimensional reflective object (e.g., 812a) as one or more numerical digits representing an indication of time (e.g., the appearance of the simulated three-dimensional reflective object changes over time based on the numerical digits changing over time to indicate a current time) (e.g., as shown in FIGS. 8K-8N). Displaying the simulated three-dimensional reflective object as one or more numerical digits for a digital time user interface varies the appearance of the time user interface without requiring the user to provide inputs to manually edit the time user interface and improves visual feedback to the user.

In some embodiments, in accordance with the time user interface corresponding to a digital time user interface (e.g., as shown in FIGS. 8K-8N), movement of the simulated light source (e.g., 816, 820a, 820b, and/or 820c) is based on a first range of movement (e.g., while displayed with respect to a digital time user interface, the simulated light source moves within in two dimensions and/or within a dimensionality lower than with respect to an analog time user interface); and in accordance with the time user interface corresponding to analog time user interface, movement of the simulated light source is based on a second range of movement greater than the first range of movement (e.g., while displayed with respect to an analog time user interface, the simulated light source moves within three dimensions and/or within a dimensionality greater than with respect to a digital time user interface). In some embodiments, the change in appearance of the user interface region (e.g., 808b) based on movement of the computer system is greater (e.g., the amount of reflections are greater, the amount of appearance changes per second are greater, and/or the amount of color changes are greater) when the time user interface corresponds to a digital time user interface than when the time user interface corresponds to an analog time user interface. In some embodiments, the device can be configured to switch the time user interface between the digital time user interface and the analog time user interface (e.g., in response to detecting one or more user inputs while editing or configuring the time user interface). Moving the simulated light source with different ranges of movement based on whether the time user interface is digital or analog varies the appearance of the time user interface without requiring the user to provide inputs to manually edit the time user interface and improves visual feedback to the user.

In some embodiments, in accordance with a determination that the computer system is in a first power state (e.g., an active state and/or a normal operating state), displaying, via the display generation component, a seconds clock hand that moves through a plurality of intermediate states during one second (e.g., a seconds hand that updates more than once per second to give the illusion of smooth movement) (e.g., two times per second, three times per second, five times per second, or 10 times per second); and in accordance with a determination that the computer system is in a second power state (e.g., a lower power state, a sleep state, a resting state, and/or a reduced power state), wherein the computer system consumes less power in the second power state than in the first power state (e.g., because in the active state, a display has a higher brightness, a display has a faster refresh rate, a higher power processor is in use, a processor is in a higher power state, and/or one or more additional sensors are taking more frequent sensor measurements), displaying, via the display generation component, the seconds clock hand that does not move through intermediate states between seconds (e.g., a seconds hand that updates once per second or less frequently to give the illusion of ticking movement). In some embodiments, when in the first power state, the movement of the seconds clock hand has a smooth movement profile. In some embodiments, when in the second power state, the movement of the seconds clock hand has a discrete movement profile. Displaying the seconds clock hand moving at varying times per second based on the power state of the computer system updates the time user interface without requiring the user to provide inputs to manually edit the time user interface and prevents permanent discoloration (e.g., burn-in) on the display screen based on varying display patterns and/or colors.

Note that details of the processes described above with respect to method 900 (e.g., FIG. 9) are also applicable in an analogous manner to the methods described above and/or below. For example, methods 700, 1100, 1300, 1500, and/or 1700 optionally include one or more of the characteristics of the various methods described above with reference to method 900. For example, in some embodiments, the same computer system performs methods 700, 900, 1100, 1300, 1500, and/or 1700 and/or the various time user interfaces recited in methods 700, 900, 1100, 1300, 1500, and/or 1700 are implemented on the same computer system. For brevity, these details are not repeated below.

FIGS. 10A-ION illustrate techniques for displaying a color boundary representing an indication of time, in accordance with some embodiments. The user interfaces in these figures are used to illustrate the processes described below, including the processes in FIG. 11.

FIG. 10A illustrates computer system 600, which includes display 602 (e.g., a touch-sensitive display), rotatable and depressible input mechanism 604, and button 606. In FIG. 10A, computer system 600 is a smartwatch. In FIG. 10A, computer system 600 displays, on display 602, digital time user interface 1010a. Time user interface 1010a includes one or more numerals representing an indication of the current time (e.g., one or more numerals 1012 representing a current time of 2:58 pm in FIG. 10A). Time user interface 1010a includes color boundary 1014 that represents a number of seconds that have elapsed in a current minute. Color boundary 1014 moves over time from a first edge (e.g., a top edge) to a second edge (e.g., a bottom edge) as the seconds within the current minute elapse. For instance, as depicted in FIG. 10A, color boundary 1014 is halfway between the top edge and the bottom edge of time user interface 1010a, which represents 30 seconds having elapsed in the current minute.

One or more numerals 1012 are overlaid on a background of time user interface 1010a. On one side of color boundary 1014 (e.g., above color boundary 1014), a first portion 1016a of the one or more numerals includes a first color and on the other side of color boundary 1014 (e.g., below the color boundary), a second portion 1016b of the one or more numerals includes a second color. Similarly, on one side of color boundary 1014 (e.g., above the color boundary), a first portion 1018a of a background of time user interface 1010a includes a third color and on the other side of color boundary 1014 (e.g., below the color boundary), a second portion 1018b of the background of time user interface 1010a includes a fourth color. In general, first portion 1016a of the one or more numerals has a different darkness than second portion 1016b of the one or more numerals. For example, first portion 1016a is white (e.g., or a relatively light color) and second portion 1016b is black (e.g., or a relatively dark color). First portion 1018a of the background has a relatively dark color and second portion 1018b of the background has a relatively light color, such that the corresponding portion of the one or more numerals has a relatively opposite brightness to that of the corresponding background. As an example, in FIG. 10A, first portion 1016a is white and first portion 1018a of the background is dark blue; and second portion 1016b of the one or more numerals is black and second portion 1018b of the background is light green.

With reference to FIG. 10B, 15 seconds have elapsed relative to FIG. 10A. As a result, color boundary 1014 downward (e.g., a 25% portion of the display area downward) on time user interface 1010a relative to the position of color boundary 1014 in FIG. 10A. Accordingly, the position of color boundary 1014 indicates that 45 seconds have elapsed in the current minute of 2:58 pm. Based on the movement of color boundary 1014 relative to FIG. 10A, first portion 1016a of the one or more numerals and first portion 1018a of the background (e.g., colored dark blue) occupy a larger proportion of time user interface 1010a relative to FIG. 10A. In addition, second portion 1016b of the one or more numerals and second portion 1018b of the background (e.g., colored light green) occupy a smaller proportion of time user interface 1010a relative to FIG. 10A based on the movement of color boundary 1014.

With reference to FIG. 10C, a change in time to a new minute is displayed. In particular, the color boundary has moved completely to the bottom edge of time user interface 1010a such that the color boundary is no longer visible. In particular, the color boundary positioned at the bottom edge of time user interface 1010a represents that 60 seconds have elapsed in the current minute resulting in a time change from 2:58 pm to 2:59 pm. Accordingly, the background of time user interface takes on the color of first portion 1018a of the background from the previous minute (e.g., dark blue) and one or more numerals 1012 take on the color of first portion 1016a of the one or more numerals from the previous minute (e.g., white). In addition, a size and/or shape of one or more numerals 1012 change in response to the time change to the new minute, and/or one or more numerals are added or removed. In some embodiments, when a change to a new minute occurs, the numerals are displayed as “morphing” and/or shifting into a new shape and/or size (e.g., a change in horizontal or vertical length), or into a new number (e.g., from a “1” to “2”). Relative to the previous minute (e.g., as depicted in FIG. 10B), the “0” has increased in vertical length and decreased in horizontal length, the “2” has increased in both vertical and horizontal length, and the “5” has decreased in vertical length and increased in horizontal length. The “8” has become a “9” based on the time change to the new minute, where the “9” has a relatively smaller horizontal and vertical length than the previously displayed “8.” As seconds begin to elapse in the new minute, color boundary 1014 begins to move in a predefined direction from a predefined edge of time user interface 1010a (e.g., move downward from the top edge of time user interface 1010a).

With reference to FIG. 10D, color boundary 1014 has moved from the top edge of time user interface 1010a downward (e.g., a 25% portion of the display area downward) on time user interface 1010a indicating that 15 seconds have elapsed relative to FIG. 10C (e.g., 25% of one minute). Accordingly, the position of color boundary 1014 indicates that 15 seconds have elapsed in the current minute of 2:59 pm. As the new minute begins, first portion 1018a of the background includes a different color from a set of predefined colors (e.g., a color not previously displayed on time user interface within a predefined number of minutes). For example, first portion 1018a of the background, which was previously dark blue (e.g., as depicted in FIGS. 10A-10C) has changed to light green. Accordingly, first portion 1016a of the one or more numerals has changed to black (e.g., or alternatively, a relatively dark color). As the new minute begins, second portion 1018b of the background maintains the same color (e.g., light green) that was displayed during the previous minute (e.g., as depicted in FIGS. 10A-10C). Accordingly, second portion 1016b of the one or more numerals maintains a white color (e.g., or, alternatively a relatively light color).

With reference to FIG. 10E, a change in time to a new hour is displayed. In particular, relative to FIG. 10D, the color boundary has moved completely to the bottom edge of time user interface 1010a such that the color boundary is no longer visible. In particular, the color boundary positioned at the bottom edge of time user interface 1010a represents that 60 seconds have elapsed in the current minute resulting in a time change from 2:59 pm to 3:00 pm. In some embodiments, when displaying the first minute of a new hour, one or more numerals representing the current minute are not displayed. For example, to represent a current time of 3:00 pm, one or more numerals 1012 include only the number three as depicted in FIG. 10E. Moreover, a crossfade animation is displayed between a previous minute and the new minute representing a new hour. For example, the numerals “0259” are displayed with a crossfade animation into the numeral “3.” When the time change to the new hour occurs, the background of time user interface takes on the color of first portion 1018a of the background from the previous minute (e.g., light green) and one or more numerals 1012 take on the color of first portion 1016a of the one or more numerals from the previous minute (e.g., black, or alternatively, a relatively dark color).

With reference to FIG. 10F, color boundary 1014 has moved from the top edge of time user interface 1010a a portion downward on time user interface 1010a indicating that 45 seconds have elapsed relative to FIG. 10E. Accordingly, the position of color boundary 1014 indicates that 45 seconds have elapsed in the current minute of 3:00 pm. As the new minute elapses, first portion 1018a of the background includes a different color from a set of predefined colors (e.g., a color not previously displayed on time user interface within a predefined number of minutes). For example, first portion 1018a of the background, which was previously light green (e.g., as depicted in FIGS. 10D-10E) has changed to a turquoise. Accordingly, first portion 1016a of the one or more numerals has changed to white (e.g., or alternatively, a relatively light color). As the new minute begins, second portion 1018b of the background maintains the same color (e.g., light green) that was displayed during the previous minute (e.g., as depicted in FIG. 10E). Accordingly, second portion 1016b of the one or more numerals maintains a black color (e.g., or alternatively, a relatively dark color).

With reference to FIG. 10G, a change in time to a new minute is displayed. In particular, the color boundary has moved completely to the bottom edge of time user interface 1010a such that the color boundary is no longer visible. In particular, the color boundary positioned at the bottom edge of time user interface 1010a represents that 60 seconds have elapsed in the current minute resulting in a time change from 3:00 pm to 3:01 pm. Accordingly, the background of time user interface takes on the color of first portion 1018a of the background from the previous minute (e.g., turquoise) and one or more numerals 1012 take on the color of first portion 1016a of the one or more numerals from the previous minute (e.g., white). In addition, a size and/or shape of one or more numerals 1012 change in response to the time change to the new minute, and/or one or more numerals are added or removed. Relative to the previous minute (e.g., as depicted in FIG. 10F), two new “0s” are displayed, a new “1” is displayed, and the previously displayed “3” shrinks in size and moves to an upper right portion of time user interface 1010a. As seconds begin to elapse in the new minute, color boundary 1014 begins to move in a predefined direction from a predefined edge of time user interface 1010a (e.g., move downward from the top edge of time user interface 1010a).

With reference to FIG. 10H, a user navigates to an editing user interface 1020 in order to modify various aspects of time user interface 1010a. For instance, a user of computer system 600 provides an input (e.g., press-and-hold input on display 1002 and/or a press of a predefined button such as button 1006). The manner in which one or more colors are displayed as time elapses on time user interface 1010a is modified via editing user interface 1020. With reference to FIG. 10I, the user performs one or more gestures (e.g., a left swipe gesture or a right swipe gesture) to arrive at a color editing user interface 1022. Within color editing user interface 1022, the user selects a color scheme from a plurality of color schemes 1024 such that changes in time (e.g., as discussed with respect to FIGS. 10A-10G) will include color changes consistent with a set of colors corresponding to the selected color scheme. For instance, a current color scheme corresponds to “Blue-Green.” The user rotates rotatable and depressible input mechanism to cycle through a variety of different color schemes to select a new color scheme, such as “Purple-Yellow.” Within a purple-yellow color scheme, the background portions of the time user interface cycles through a variety of colors as time elapses, such as lavender, magenta, fuchsia, violet, purple, indigo, gold, bright yellow, mustard yellow, dark yellow, gold, and blonde. Various color schemes are made up of one or more primary or main colors and colors similar to the primary or main colors, such as a monotone color scheme, a color scheme having two main colors, three main colors, four main colors, and/or five main colors.

With reference to FIG. 10J, as discussed more with respect to FIGS. 12A-12Q, while in editing user interface 1020, the user selects and customizes various user interface elements corresponding to respective applications (e.g., selectable complications and/or icons that can be selected to open the respective applications) to be displayed concurrently with one or more numerals 1012. Here, the user of computer system 600 has selected both a color scheme and two user interface elements 1026 and 1028 (e.g., complications) for display concurrently with time user interface 1010a. In particular, the user has selected a weather user interface element (e.g., for displaying current weather conditions in a location) and a calendar user interface element (e.g., for displaying current date information). In this example, first portion 1016a of the one or more numerals has a white color, second portion 1016b of the one or more numerals has a black color, first portion 1018a of the background has a light purple color, and second portion 1018b of the background has a dark yellow color. The current time is 4:05 pm with 15 seconds having elapsed in the current minute based on the position of color boundary 1014.

With reference to FIG. 10K, the computer system 600 transitions from an active state to a sleep, resting, and/or lower power state. For instance, the user lowers computer system 600 to a resting position (e.g., at the user's side and/or in the user's pocket) and/or performs a hand cover gesture over computer system 600. As a result, computer system enters the sleep, resting, and/or lower power state. While in the sleep, resting, and/or lower power state, the first portion 1018a of the background and second portion 1018b of the background are displayed with a black color (e.g., or alternatively, a dark color). While in the sleep, resting, and/or lower power state, color boundary 1014 is not visible on the background of time user interface 1010a, whereas color boundary 1014 is visible within the interior of numerals 1012. In particular, while in the sleep state, the color of first portion 1016a of the one or more numerals takes on the color of first portion 1018a of the background prior to entering the sleep state (e.g., as depicted in FIG. 10J). Thus, when entering the sleep state, the color of first portion 1016a of the one or more numerals becomes light purple. Likewise, the color of second portion 1016b of the one or more numerals becomes dark yellow when entering the sleep state. The position of the respective user interface elements determine the color of the user interface elements when entering the sleep state. In this example, when a user interface element (e.g., or a portion of the user interface element) is above color boundary 1014, the user interface element takes on the color of first portion 1018a of the background prior to entering the sleep state. Thus, when entering the sleep state, the color of user interface element 1028 becomes light purple. Likewise, when a user interface element (e.g., or a portion of the user interface element) is below color boundary 1014, the user interface element takes on the color takes on the color of second portion 1018b of the background prior to entering the sleep state. Thus, when entering the sleep state, the color of user interface element 1026 becomes dark yellow.

In some embodiments, the user of computer system 600 changes display modes of the time user interface. For example, with reference to FIG. 10L, the user provides a gesture input 1030 on display 1002 (e.g., a tap input and/or a swipe input) to navigate to an alternative display mode for the time user interface. With reference to FIG. 10M, the alternative display mode includes one or more numerals representing an indication of time 1032 and a background region 1034. Time user interface 1010b includes additional information and user interface elements in other portions of time user interface 1010a, such as a date object 1036 and a plurality of user interface elements 1038 corresponding to applications and/or application functions 1038 of computer system 600. For a current minute, background region 1034 includes a color gradient, such as a blue color gradient, a green color gradient, a red color gradient, an orange color gradient, a yellow color gradient, or a purple color gradient. The color gradient has a relatively dark color (e.g., dark red) or relatively light color (e.g., light red). When the color gradient has a relatively dark color, the color of one or more numerals 1032 is white (e.g., or alternatively, a relatively light color), as shown in FIG. 10M. When the color gradient has a relatively light color, the color of one or more numerals 1032 is black (e.g., or alternatively, a relatively dark color).

With reference to FIG. 10N, a time change including a change to a new minute is depicted. In particular, the time has changed from 4:05 pm to 4:06 pm. When the alternative display mode is active, the color gradient of background region 1034 changes upon the current time changing to a new minute. For example, the color gradient changes from a light blue color gradient to a dark blue color gradient, from a red gradient to an orange gradient, or from a yellow gradient to a green gradient. In general, successive minutes results in color gradient change from a dark color to a light color. Accordingly, for each successive minute, the color of one or more numerals 1032 changes from white (e.g., or alternatively, a relatively light color) to black (e.g., or alternatively, a relatively dark color).

FIG. 11 is a flow diagram illustrating a method for displaying background regions using a computer system in accordance with some embodiments. Method 1100 is performed at a computer system (e.g., a smartphone, a smartwatch, a tablet computer, a laptop computer, a desktop computer, and/or a head mounted device (e.g., a head mounted augmented reality and/or extended reality device)) that is in communication with a display generation component (e.g., a display controller, a display, a touch-sensitive display system, a touchscreen, a monitor, and/or a head mounted display system). In some embodiments, the computer system is in communication with one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1100 are, optionally, combined, the orders of some operations are, optionally, changed, and some operations are, optionally, omitted.

As described below, method 1100 provides an intuitive way for displaying background regions for time user interfaces. The method reduces the cognitive burden on a user for displaying background regions for time user interfaces, thereby creating a more efficient human-machine interface. For battery-operated computing devices, enabling a user to modify background regions for time user interfaces faster and more efficiently conserves power and increases the time between battery charges.

The computer system displays (1102), via the display generation component, a time user interface (e.g., 1010a, a user interface that includes an analog and/or digital indication of time, a clock face user interface, a watch face user interface, a home screen, a reduced-power screen, a wake screen, and/or a lock screen), the time user interface (e.g., 1010a) including (1104) an indication of time that includes one or more numerals (e.g., 1012) representing at least one of an hour and a minute (e.g., a single numeral representing an hour, two numerals representing an hour, a single numeral representing an hour and two numerals representing a minute, or two numerals representing an hour and two numerals representing a minute); and (1106) a color boundary (e.g., 1014, a horizontal boundary, a vertical boundary, a diagonal boundary, and/or a boundary between two colors or two areas with different colors) that represents a number of seconds that have elapsed in a current minute (e.g., a horizontal position of the boundary indicates a number of seconds, a vertical position of the boundary indicates a number of seconds, and/or a diagonal position of the boundary indicates a number of seconds), wherein the color boundary moves over time (e.g., in an upward direction, in a downward direction, in a left direction, and/or in a right direction) from a first edge of the time user interface (e.g., a top edge, a bottom edge, a left edge, and/or a right edge) toward a second edge (e.g., an opposite edge) of the time user interface (e.g., a top edge, a bottom edge, a left edge, and/or a right edge) as additional seconds elapse in the current minute. In some embodiments, a home screen corresponds to a user interface that is initially displayed when the computer system is unlocked, wakes from a reduced-power state, and/or receives a particular input (e.g., a swipe from a specific region on the display or a press of a specific button of the computer system). In some embodiments, the home screen includes affordances for a plurality of applications and functions of the computer system. In some embodiments, the plurality of applications and functions are user-customizable, such that the user of the computer system can configure which applications and/or device functions appear on the home screen.

In some embodiments, the indication of time represents an hour and/or minute of a current time and the position of the color boundary (e.g., 1014) represents a number of seconds of the current time represented by the indication of time. In some embodiments, the one or more numerals (e.g., 1012) are displayed as overlaid on the color boundary (e.g., 1014) (e.g., the color boundary is displayed in a background that includes two or more areas separated by the color boundary). In some embodiments, the time user interface (e.g., 1010a) is divided into 60 equal sections (e.g., horizontal sections, vertical sections, and/or diagonal sections), where the color boundary (e.g., 1014) moves through the sections sequentially over time to indicate the current second (e.g., the color boundary at the 20th section indicates the current second is the 20th second) (e.g., as shown in FIGS. 8A-8F). In some embodiments, the color boundary (e.g., 1014) moves in discrete increments over time (e.g., the color boundary moves in second increments). In some embodiments, the color boundary moves in continuous increments over (e.g., the color boundary moves in sub-second increments).

In some embodiments, a reduced-power screen is a user interface that is displayed when the computer system is in a reduced-power state, low-power state, and/or off state. In some embodiments, a wake screen is a user interface that is displayed when the computer system transitions from a lower power state to a higher power state (e.g., from a state in which the computer system has a lower brightness, a display has a slower refresh rate, a lower power processor is in use, a processor is in a lower power state, and/or one or more additional sensors are taking less frequent sensor measurements to a state in which the computer system has a higher brightness, a display has a faster refresh rate, a higher power processor is in use, a processor is in a higher power state, and/or one or more additional sensors are taking more frequent sensor measurements). Displaying the time user interface including one or more numerals representing at least one of an hour and a minute and a color boundary that represents a number of seconds that have elapsed in a current minute, wherein the color boundary moves over time from a first edge of the time user interface toward a second edge of the time user interface as additional seconds elapse in the current minute updates the time user interface without requiring the user to provide inputs to manually edit the time user interface, improves visual feedback to the user by making changes in seconds easier to view at a glance and/or at a distance, and prevents permanent discoloration (e.g., burn-in) on the display screen based on varying display patterns and/or colors.

In some embodiments, the time user interface (e.g., 1010a) includes a first portion (e.g., 1016a and/or 1018a) having a first color on a first side of the color boundary (e.g., 1014) and a second portion (e.g., 1016b and/or 1018b) having a second color on a second side of the color boundary opposite of the first side of the color boundary, and the movement of the color boundary causes a change in color (e.g., a change in color of a portion of a background and/or a change in color of a portion of one or more numerals overlaid on the background) of the first portion (e.g., 1016a and/or 1018a) from the first color to the second color, and wherein the movement of the color boundary represents seconds elapsing in a current minute (e.g., as shown in FIGS. 10A-10F). In some embodiments, the change in color corresponds to a change from a first particular second (e.g., fifth second of a minute or 19th second of a minute) to a second particular second (e.g., sixth second of a minute or 20th second of a minute). In some embodiments, the position on the time user interface (e.g., 1010a) of the change in color corresponds to a lateral position with a value corresponding to a fraction representing the current second e.g., as shown in FIGS. 10A-10F) (e.g., a horizontal line at a 5/60 lateral position when the current second is 5 or a horizontal line at a 19/60 lateral position when the current second is 19). Displaying the movement of the color boundary representing seconds elapsing as a change in color of a first portion of the time user interface from a first color to a second color updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the first portion (e.g., 1016a) having the first color includes a first portion of the one or more numerals (e.g., 1012) (e.g., an upper portion, a lower portion, a left portion, and/or a right portion), the second portion (e.g., 1016b) having the second color includes a second portion of the one or more numerals (e.g., an upper portion, a lower portion, a left portion, and/or a right portion), and the movement of the color boundary (e.g., 1014) causes a change in color of the first portion (e.g., 1016a) of the one or more numerals from the first color to the second color (e.g., a change in color at a different position on the time user interface relative to a previous change in color of the numeral; e.g., a change in color of a portion of the interior of the numeral).

Displaying movement of a color boundary causing change in color of a portion of one or more numerals updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the change in color of the first portion (e.g., 1016a) of the one or more numerals (e.g., 1012) includes a change from a first respective color to a second respective color, including: in accordance with a determination that the current minute is a first minute, the first respective color is lighter than the second respective color e.g., as shown in FIGS. 10A-10B); and in accordance with a determination that the current minute is a second minute immediately subsequent to the first minute, the first respective color is darker than the second respective color (e.g., as shown in FIGS. 10C-10D) (e.g., the first respective color has a color value below a brightness threshold and/or a color classification of dark and the second respective color has a color value above the brightness threshold and/or a color classification of light; e.g., for the first minute the time user interface (e.g., 1010a) includes numerals having a relatively light color overlaid on a relatively dark background, for the second minute the time user interface includes numerals having a relatively dark color overlaid on a relatively light background, for a third minute immediately subsequent to the second minute the time user interface includes numerals having a relatively light color overlaid on a relatively dark background, and for a fourth minute immediately subsequent to the third minute the time user interface includes numerals having a relatively dark color overlaid on a relatively light background). Displaying a change in color between light and dark colors based on a current minute updates the time user interface without requiring the user to provide inputs to manually edit the time user interface and improves visual feedback to the user.

In some embodiments, the first portion (e.g., 1018a) having the first color includes a first portion of a background of the time user interface (e.g., an upper portion, a lower portion, a left portion, and/or a right portion) the second portion (e.g., 1018b) having the second color includes a second portion of the background of the time user interface (e.g., an upper portion, a lower portion, a left portion, and/or a right portion), and the movement of the color boundary (e.g., 1014) causes a change in color of the first portion (e.g., 1018a) of the background of the time user interface from the first color to the second color (e.g., a change in color at a different position on the time user interface relative to a previous change in color of the background portion; e.g., a change in color of a portion of the background in which numerals are overlaid on the portion of the background). Displaying movement of the color boundary as change in color of a portion of the background of the time user interface updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the first portion (e.g., 1018a) having the first color includes a first portion of a background of the time user interface (e.g., an upper portion, a lower portion, a left portion, and/or a right portion) and a first portion (e.g., 1016a) of the one or more numerals (e.g., 1012) (e.g., an upper portion, a lower portion, a left portion, and/or a right portion), the second portion (e.g., 1018b) having the second color includes a second portion of a background of the time user interface (e.g., an upper portion, a lower portion, a left portion, and/or a right portion) and a second portion (e.g., 1016b) of the one or more numerals (e.g., an upper portion, a lower portion, a left portion, and/or a right portion), and the movement of the color boundary (e.g., 1014) causes a change in color of the first portion (e.g., 1018a) of the background of the time user interface from the first color to the second color concurrently with (e.g., at the same time as causing) a change in color of the first portion (e.g., 1016a) of the one or more numerals (e.g., 1012) from the first color to the second color (e.g., a change in color at a different position on the time user interface relative to a previous change in color of the background portion and a previous change in color of the one or more numerals; e.g., a change in color of the background portion and the portion of the one or more numerals in which numerals are overlaid on the background portion). In some embodiments, the position of the change in color corresponds to a position on the time user interface that corresponds to a lateral position (e.g., 1014) with a value corresponding to a fraction representing the current second (e.g., a horizontal line at a 5/60 lateral position when the current second is 5 or a horizontal line at a 19/60 lateral position when the current second is 19), wherein the lateral position extends across the background portion and the one or more numerals (e.g., 1012) overlaid on the background portion. Displaying movement of the color boundary as change in color of a portion of the background of the time user interface concurrently with a change in color of a portion of the one or more numerals updates the time user interface without requiring the user to provide inputs to manually edit the time user interface, improves visual feedback to the user, and prevents permanent discoloration (e.g., burn-in) on the display screen based on varying display patterns and/or colors.

In some embodiments, during a first minute, the time user interface (e.g., 1010a) includes the first portion (e.g., 1016a, 1018a, and/or an upper portion) having the first color (e.g., blue or green) on the first side of the color boundary (e.g., 1014) (e.g., above the color boundary) and the second portion (e.g., 1016b, 1018b, and/or a lower portion) having the second color (e.g., orange or red) on the second side of the color boundary opposite of the first side of the color boundary (e.g., below the color boundary), and during a second minute, the time user interface includes the second portion (e.g., 1016b, 1018b, and/or a lower portion) having the first color (e.g., blue or green) on the second side of the color boundary (e.g., below the color boundary). Displaying, during a first minute, the time user interface including a first portion having a first color and a second portion having a second color, and during a second minute, displaying the time user interface including the second portion having the first color updates the time user interface without requiring the user to provide inputs to manually edit the time user interface, improves visual feedback to the user, and prevents permanent discoloration (e.g., burn-in) on the display screen based on varying display patterns and/or colors.

In some embodiments, after a first minute has ended (e.g., after or in response to detecting that the first minute has ended) and a second minute has started (e.g., the current time changes from 2:58 pm to 2:59 pm or changes from 2:59 pm to 3:00 pm), a second color boundary (e.g., 1014) (e.g., a horizontal boundary, a vertical boundary, a diagonal boundary, and/or a boundary between two colors or two areas with different colors) represents a number of seconds that have elapsed in the second minute (e.g., a horizontal position of the boundary indicates a number of seconds, a vertical position of the boundary indicates a number of seconds, and/or a diagonal position of the boundary indicates a number of seconds), and the second color boundary (e.g., 1014) moves over time (e.g., in an upward direction, in a downward direction, in a left direction, and/or in a right direction) from the first edge of the time user interface toward (e.g., a top edge, a bottom edge, a left edge, and/or a right edge) the second edge of the time user interface (e.g., a top edge, a bottom edge, a left edge, and/or a right edge) as additional seconds elapse in the second minute (e.g., as shown in FIGS. 10A-10F). Displaying a second color boundary that moves over time from a first edge of the time user interface towards a second edge of the time user interface as additional seconds elapse in a next minute updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the one or more numerals (e.g., 1012) have a first configuration during a first minute. In some embodiments, the computer system detects that the first minute has ended and a second minute has started (e.g., the current time changes from 2:58 pm to 2:59 pm as shown in FIGS. 10B-10C or changes from 2:59 pm to 3:00 pm as shown in FIGS. 10D-10F). In some embodiments, the second minute is after and temporally adjacent to the first minute. In some embodiments, in response to detecting that the first minute has ended and the second minute has started, the computer system displays, via the display generation component, the time user interface (e.g., 1010a) including the one or more numerals (e.g., 1012) having a second configuration different from the first configuration (e.g., the size and/or center position of a numeral changes). In some embodiments, a numeral expands horizontally and/or vertically towards a center of the time user interface or shrinks horizontally and/or vertically towards one or more edges of the time user interface. In some embodiments, a numeral is removed. In some embodiments, a numeral is added. Displaying the one or more numerals having a second configuration different from a first configuration upon a next minute beginning updates the time user interface without requiring the user to provide inputs to manually edit the time user interface, improves visual feedback to the user, and prevents permanent discoloration (e.g., burn-in) on the display screen based on varying display patterns and/or colors.

In some embodiments, when the first minute has elapsed and the second minute begins, a color of the one or more numerals (e.g., 1012) is maintained between an end of the first minute and a beginning of the second minute (e.g., if numerals changed from black to white during current minute, numerals remain white when next minute begins; e.g., if numerals changed from white to black during current minute, numerals remain black when next minute begins). In some embodiments, the color of the numerals (e.g., 1012) is maintained during a transition from a first minute to a second minute, and the color of the numerals changes over the course of the second minute (e.g., as shown in FIGS. 10D-10F). Maintaining a color of the one or more numerals when a current minute elapses and a next minute begin updates the time user interface without requiring the user to provide inputs to manually edit the time user interface and improves visual feedback to the user.

In some embodiments, the one or more numerals (e.g., 1012) have a first configuration during the current minute. In some embodiments, when (e.g., in accordance with a determination that or in accordance with) the color boundary (e.g., 1014) reaches the second edge of the time user interface (e.g., the color boundary is positioned at a lateral position with a value corresponding to a fraction representing the current second of 59/60 and the color boundary moves to the lateral position with a value corresponding to a fraction representing the current second of 60/60), the computer system displays, via the display generation component, the time user interface (e.g., 1010a) including the one or more numerals (e.g., 1012) having a second configuration different from the first configuration (e.g., as shown in FIGS. 10B-10C) (e.g., the size and/or center position of a numeral changes). In some embodiments, a numeral expands horizontally and/or vertically towards a center of the time user interface or shrinks horizontally and/or vertically towards one or more edges of the time user interface. In some embodiments, a numeral is removed (e.g., as shown in FIGS. 10D-10E). In some embodiments, a numeral is added (e.g., as shown in FIGS. 10F-10G). Displaying the one or more numerals having a second configuration different from a first configuration when a color boundary reaches an edge of the time user interface updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the first configuration corresponds to the one or more numerals (e.g., 1012) having at least one of a first shape (e.g., a first portion of the numeral is thicker or thinner than a different portion of the numeral; e.g., a first portion of the numeral is sharper or smoother than a different portion of the numeral) and a first size, and the computer system displays, via the display generation component, the time user interface (e.g., 1010a) including the one or more numerals having a second configuration different from the first configuration includes modifying at least one of the first shape and the first size of the one or more numerals (e.g., as shown in FIGS. 10B-10C). In some embodiments, a numeral expands horizontally and/or vertically towards a center of the time user interface or shrinks horizontally and/or vertically towards one or more edges of the time user interface. In some embodiments, a numeral expands horizontally and shrinks vertically. In some embodiments, a numeral expands vertically and shrinks horizontally. In some embodiments, a numeral expands horizontally and maintains a vertical length. In some embodiments, a numeral expands vertically and maintains a horizontal length. In some embodiments, a numeral shrinks horizontally and maintains a vertical length. In some embodiments, a numeral shrinks vertically and maintains a horizontal length. In some embodiments, modifying a shape includes modifying a portion of the numeral to be thicker or thinner. In some embodiments, modifying a shape includes modifying a portion of the numeral to be straighter or rounder. Displaying the one or more numerals having a second configuration different from a first configuration, including modifying at least one of a shape and size of the numerals, when a color boundary reaches an edge of the time user interface updates the time user interface without requiring the user to provide inputs to manually edit the time user interface, improves visual feedback to the user, and prevents permanent discoloration (e.g., burn-in) on the display screen based on varying display patterns and/or colors.

In some embodiments, modifying at least one of the first shape (e.g., a first portion of the numeral is thicker or thinner than a different portion of the numeral; e.g., a first portion of the numeral is sharper or smoother than a different portion of the numeral) and the first size of the one or more numerals (e.g., 1012) includes: modifying at least one of a respective shape and a respective size of a first numeral; and modifying at least one of a respective shape and a respective size of a second numeral that is different from the first numeral (e.g., as shown in FIGS. 10B-10C) (e.g., two, three, or four numerals). In some embodiments, modifying a shape includes modifying a portion of the numeral to be thicker or thinner. In some embodiments, modifying a shape includes modifying a portion of the numeral to be straighter or rounder. Modifying at least one of a shape and size of two or more numerals when a color boundary reaches an edge of the time user interface updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the computer system detects that a first minute has ended and a second minute has started (e.g., the current time changes from 2:58 pm to 2:59 pm as shown in FIGS. 10B-10C or changes from 2:59 pm to 3:00 pm as shown in FIGS. 10D-10F). In some embodiments, the second minute is after and temporally adjacent to the first minute and in response to detecting that the first minute has ended and the second minute has started displaying, via the display generation component, the time user interface (e.g., 1010a) including a respective numeral of the one or more numerals (e.g., 1012) having the second configuration different from the first configuration, wherein the respective numeral of the one or more numerals maintains a respective value (e.g., numerals “0” “2 and “5” maintain respective values, whereas numeral “8” changes to numeral “9”). In some embodiments, a numeral expands horizontally and/or vertically towards a center of the time user interface or shrinks horizontally and/or vertically towards one or more edges of the time user interface. In some embodiments, a numeral is removed. In some embodiments, a numeral is added. Maintaining a respective value of a numeral that changes configuration when a current minute elapses and a next minute begins updates the time user interface without requiring the user to provide inputs to manually edit the time user interface, improves visual feedback to the user, and prevents permanent discoloration (e.g., burn-in) on the display screen based on varying display patterns and/or colors.

In some embodiments, while a background of the time user interface includes a solid color background (e.g., the color boundary that represents a number of seconds is no longer visible), displaying, via the display generation component, the time user interface including the one or more numerals (e.g., 1012) having the second configuration different from the first configuration (e.g., as shown in FIGS. 10C and/or 10E). Displaying the one or more numerals having a second configuration different from a first configuration while a background of the time user interface includes a solid color background improves visual feedback to the user.

In some embodiments, the computer system detects that a first minute that corresponds to a first hour has ended and that a second minute has started. In some embodiments, the second minute is after and temporally adjacent to the first minute. In some embodiments, in response to detecting that the first minute has ended and a next minute has started (e.g., the current time changes from 2:58 pm to 2:59 pm as shown in FIGS. 10B-10C or changes from 2:59 pm to 3:00 pm as shown in FIGS. 10D-10F): in accordance with a determination that the second minute corresponds to a second hour that is different from the first hour (e.g., the current time changes from 2:59 pm to 3:00 pm or changes from 3:59 pm to 4:00 pm), the computer system displays the time user interface (e.g., 1010a) including the one or more numerals (e.g., 1012) crossfading into one or more second numerals different from the one or more numerals. In some embodiments, the one or more second numerals include a single numeral (e.g., as shown in FIG. 10E) representing the new hour (e.g., “3” represents 3:00 am or 3:00 pm or “4” represents 4:00 am or 4:00 pm). In some embodiments, the one or more second numerals (e.g., 1012) include a multiple numerals representing the new hour (e.g., “03:00” represents 3:00 am or 3:00 pm or “04:00” represents 4:00 am or 4:00 pm). In some embodiments, in accordance with a determination that the second minute corresponds to the first hour (e.g., the current time changes from 2:58 pm to 2:59 pm or changes from 3:58 pm to 3:59 pm), the computer system displays the time user interface including the one or more numerals (e.g., 1012) shifting (e.g., at least one of a shape, size, and/or center position of a numeral changes) to a new orientation. Displaying the one or more numerals crossfading into one or more seconds numerals when a next minute correspond to a new hour and displaying the one or more numerals shifting to a new orientation when the next minute does not correspond to a new hour updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the computer system displays, via the display generation component, the time user interface (e.g., 1010a) with one or more user interface elements (e.g., 1026, 1028, 1038, selectable user interface elements and/or complications) associated with one or more respective applications (e.g., a first user interface element associated with a first application in an upper-left corner of the time user interface, a first user interface element associated with a first application in a lower-left corner of the time user interface, a first user interface element associated with a first application in an upper-right corner of the time user interface, and/or a first user interface element associated with a first application in a lower-left corner of the time user interface), wherein the one or more user interface elements (e.g., one or more complications) are shaped based on a corresponding shape of an adjacent numeral of the one or more numerals (e.g., 1012) (e.g., as shown in FIGS. 10J-10L). In some embodiments, a complication refers to a feature of a user interface (e.g., a home screen, a wake screen, a clock face and/or a watch face) other than those used to indicate the hours and minutes of a time (e.g., clock hands or hour/minute indications). In some embodiments, complications provide data obtained from an application. In some embodiments, a complication updates the displayed data in accordance with a determination that the data obtained from the application has been updated. In some embodiments, the complication updates the displayed data over time. In some embodiments, a complication includes an affordance that when selected launches a corresponding application. In some embodiments, a complication includes an affordance that when selected causes the computer system to perform a corresponding task. In some embodiments, a complication is displayed at a fixed, predefined location on the display. In some embodiments, complications occupy respective locations at particular regions (e.g., lower-right, lower-left, upper-right, and/or upper-left) of a user interface (e.g., a home screen, a wake screen, a clock face and/or a watch face). In some embodiments, a user may select a type of complication to include on the display. In some embodiments, a user may select parameters to display for a specific type of complication. Displaying one or more user interface elements with a shape based on a corresponding shape of an adjacent numeral updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the computer system displays the indication of time that includes one or more numerals (e.g., 1012) representing at least one of an hour and a minute with a color boundary (e.g., 1014) that represents a number of seconds that have elapsed in a current minute and moves over time toward a second edge of the time user interface as additional seconds elapse in the current minute is displaying the time user interface in a first display mode. In some embodiments, the computer system detects an event corresponding to a display mode change (e.g., 1030, a user input corresponding to a request to change the display mode or a change in device context that causes the display mode to change automatically without further user input); and in response to detecting the event, displaying, via the one or more display generation components, the time user interface in a second display mode that is different from the first display mode (e.g., as shown in FIGS. 10L-10M), wherein displaying the time user interface in the second display mode includes: displaying, via the display generation component, the indication of time (e.g., 1032) with additional information that is not available in the first display mode for the time user interface (e.g., a display mode wherein the time user interface includes and/or is displayed concurrently with additional user interface elements (e.g., 1038); e.g., a display mode that changes differently with respect to time relative to how a main display mode changes with respect to time; e.g., a display mode that includes a set of widgets that can be displayed with multiple different time user interfaces), and displaying, via the display generation component, a background of the time user interface (e.g., 1034, a background in which the indication of time, complications, and/or additional user interface elements are overlaid), wherein the background includes a color gradient (e.g., a color gradient between two or more predefined colors or a color gradient between two or more user-selected colors).

In some embodiments, the set of widgets (e.g., 1038) includes a widget that includes information that is updated over time in response to the computer system receiving updated or additional information from a respective application. In some embodiments, in response to detecting selection (e.g., via a touch input, rotational input, press input, swipe input, an input using a mouse/cursor, and/or air gestures) of a widget of the set of widgets, the computer system displays a user interface of a respective application associated with (e.g., corresponding to) the selected widget (e.g., an application from which received information is displayed by the selected widget). In some embodiments, the size, position, appearance, and/or content displayed by a widget is user-configured and/or user configurable (e.g., via user input). In some embodiments, the set of widgets (e.g., 1038) is a representation of a set of two or more widgets through which the computer system can scroll (e.g., in response to receiving a user scroll input and/or rotation of the rotatable input mechanism). In some embodiments, the set of widgets (e.g., 1038) includes content from a subset (e.g., one, two, and/or less than all) of widgets at a time (e.g., the set of widgets displays content from a single widget of available widgets without displaying content from any other available widgets while optionally displaying at least a portion of a second widget). In some embodiments, the set of widgets (e.g., 1038) is arranged in a sequence, and in response to input (e.g., user input and/or system input), the computer system changes the sequence in which the set of widgets are arranged based on the input (e.g., changes which widget is on top or first in the sequence). In some embodiments, the respective display mode is entered into based on (e.g., in response to detecting) user input. In some embodiments, the respective display mode is entered into based on a default setting. In some embodiments, in accordance with a determination that the time user interface is not displayed in the respective display mode, displaying, via the display generation component, a background of the time user interface, wherein the background does not include the color gradient. Displaying a background of the time user interface including a color gradient in a respective display mode updates the time user interface without requiring the user to provide inputs to manually edit the time user interface, improves visual feedback to the user, and prevents permanent discoloration (e.g., burn-in) on the display screen based on varying display patterns and/or colors.

In some embodiments, in accordance with a determination that a current minute has elapsed and a next minute begins, the computer system modifies (e.g., changing) at least one color of the color gradient (e.g., as shown in FIGS. 10M-10L) (e.g., modify one or more pre-defined colors of the color gradient to one or more different colors or modify one or more user-selected colors of the color gradient to one or more different user-selected colors). Modifying the color gradient when a current minute elapses and a next minute begins updates the time user interface without requiring the user to provide inputs to manually edit the time user interface and improves visual feedback to the user.

In some embodiments, the computer system detects that a first minute has ended and a second minute has started. In some embodiments, the second minute is after and temporally adjacent to the first minute. In some embodiments, in response to detecting that the first minute has ended and the second minute has started, the computer system modifies (e.g., changes) at least one color (e.g., a color that has a darkness which is defined based on a color of the color gradient and/or a predefined grayscale color) of the one or more numerals (e.g., 1032). In some embodiments, the color of the one or more numerals (e.g., 1032) changes between a light color (e.g., white and/or light gray) and a dark color (e.g., black and/or dark gray). Modifying at least one color of the one or more numerals when a current minute elapses and a next minute begins updates the time user interface without requiring the user to provide inputs to manually edit the time user interface and improves visual feedback to the user.

In some embodiments, displaying the time user interface (e.g., 1010a) includes: in accordance with a determination that the computer system is in a first power state (e.g., an active state and/or a normal operating state), displaying, via the display generation component, a background of the time user interface outside of the one or more numerals (e.g., 1012) having two colors (e.g., as shown in FIGS. 10A-10G) (e.g., display the two colors opposite a color boundary representing a number of seconds that have elapsed in a current minute and/or display the two colors as a color gradient); and in accordance with a determination that the computer system is in a second power state, (e.g., a lower power state, a sleep state, a resting state, and/or a reduced power state), wherein the computer system consumes less power in the second power state than in the first power state (e.g., because in the active state, a display has a higher brightness, a display has a faster refresh rate, a higher power processor is in use, a processor is in a higher power state, and/or one or more additional sensors are taking more frequent sensor measurements), displaying, via the display generation component, the two colors within the one or more numerals (e.g., 1012) (e.g., as shown in FIGS. 10K-10L) (e.g., display the two colors opposite a color boundary within the one or more numerals representing a number of seconds that have elapsed in a current minute and/or display the two colors as a color gradient within the two numerals). Displaying a background of the time user interface with two colors when the computer system is in a first power state and displaying the two colors within the one or more numerals when the computer system is in a second power state updates the time user interface without requiring the user to provide inputs to manually edit the time user interface, improves visual feedback to the user, and prevents permanent discoloration (e.g., burn-in) on the display screen based on varying display patterns and/or colors.

In some embodiments, at least one color of the time user interface is based on a user selection (e.g., 1018a, a crown rotation, an inward press of crown, a tap gesture, and/or a long press gesture) of a color option from a plurality of color options (e.g., bright options, neutral options, due tone options, and/or monotone options) (e.g., as shown in FIGS. 10I-10J). Displaying a color of the time user interface based on a user selection from of a plurality of color options updates the time user interface without requiring the user to provide inputs to manually edit the time user interface and improves visual feedback to the user.

In some embodiments, in accordance with a determination that the computer system is in a first power state (e.g., an active state and/or a normal operating state), the computer system displays, via the display generation component, the color boundary (e.g., 1014) moving through a plurality of intermediate states during one second (e.g., a color boundary having a position that updates more than once per second to give the illusion of smooth movement) (e.g., two times per second, three times per second, five times per second, or 10 times per second); and in accordance with a determination that the computer system is in a second power state, (e.g., a lower power state, a sleep state, a resting state, and/or a reduced power state), wherein the computer system consumes less power in the second power state than in the first power state (e.g., because in the active state, a display has a higher brightness, a display has a faster refresh rate, a higher power processor is in use, a processor is in a higher power state, and/or one or more additional sensors are taking more frequent sensor measurements), the computer system displays, via the display generation component, the color boundary (e.g., 1014) that does not move through intermediate states between seconds (e.g., a color boundary having a position that updates once per second or less frequently to give the illusion of ticking movement). In some embodiments, when in the first power state, the movement of the color boundary (e.g., 1014) has a smooth movement profile. In some embodiments, when in the second power state, the movement of the color boundary (e.g., 1014) has a discrete movement profile. Displaying the color boundary moving multiple times per second when the computer system is in a first power state and displaying the color boundary moving one time per second when the computer system is in a second power state updates the time user interface without requiring the user to provide inputs to manually edit the time user interface, improves visual feedback to the user, and prevents permanent discoloration (e.g., burn-in) on the display screen based on varying display patterns and/or colors.

In some embodiments, displaying the time user interface includes: when the color boundary (e.g., 1214) is at (e.g., reaches and/or moves to) a first boundary (e.g., 1248, a boundary corresponding to a position where the color boundary will be when a new second starts and/or a boundary corresponding to a position where the color boundary will be when a current second ends): in accordance with a determination that a distance between the first boundary (e.g., 1248) and an edge (e.g., 1240) of a numeral of the one or more numerals is less than a threshold distance (e.g., 10%, 15%, 20%, or 25% of the distance the color boundary moves when a second elapses), changing a portion (e.g., the edge) of the numeral (e.g., changing a position of the portion of the numeral) from extending along a first position (e.g., 1248, a position of a straight edge of the numeral and/or a position of a curved edge of the numeral) to extending along the first boundary. In some embodiments, the change in position of the portion of the numeral includes a straight edge (e.g., 1240) of the numeral moving upward or downward. In some embodiments, the change in position of the portion of the numeral includes a curved edge (e.g., 1252 and/or 1254) of the numeral moving towards the left, toward the right, upward, and/or downward. Changing a portion of a numeral from extending along a first position to extending along the first boundary when a distance between the first boundary and an edge of the numeral is less than a threshold distance updates the time user interface without requiring the user to provide inputs to manually edit the time user interface, improves visual feedback to the user, and prevents permanent discoloration (e.g., burn-in) on the display screen based on varying display patterns and/or colors.

In some embodiments, changing the portion of the numeral includes changing a width of at least a portion the numeral from a first width to a second width that is different from the first width. In some embodiments, the first width is smaller than the second width. In some embodiments, the second width is smaller than the first width. In some embodiments, a width corresponding to a first portion (e.g., an upper portion or a lower portion) of the numeral changes and a width corresponding to a second portion (e.g., an upper portion or a lower portion) of the numeral does not change. Changing a portion of a numeral by changing a width of the numeral improves visual feedback to the user and prevents permanent discoloration (e.g., burn-in) on the display screen based on varying display patterns and/or colors.

In some embodiments, changing the portion of the numeral includes changing a curvature (e.g., 1252 and/or 1254) of the numeral from a first curvature to a second curvature that is different from the first curvature. In some embodiments, the first curvature has a smaller degree of curvature than the second curvature. In some embodiments, the second curvature has a smaller degree of curvature than the first curvature. In some embodiments, a curvature corresponding to a first portion (e.g., an upper portion or a lower portion) of the numeral changes and a curvature corresponding to a second portion (e.g., an upper portion or a lower portion) of the numeral does not change. In some embodiments, a curvature of a portion of an edge of the numeral changes (e.g., from a first corner radius to a second corner radius). In some embodiments, the edge of the numeral is constructed with one or more spline curves and changing the curvature includes moving one or more of the control points of one or more of the spline curves. Changing a portion of a numeral by changing a curvature of the numeral improves visual feedback to the user and prevents permanent discoloration (e.g., burn-in) on the display screen based on varying display patterns and/or colors.

In some embodiments, displaying the time user interface includes: when the color boundary (e.g., 1214) is at the first boundary (e.g., 1248): in accordance with a determination that a distance between the first boundary and an edge (e.g., 1250) of a numeral of the one or more numerals is more than a second threshold distance (e.g., a distance corresponding to the movement of the color boundary when one second elapses, a distance corresponding to the movement of the color boundary when two seconds elapse, a distance corresponding to the movement of the color boundary when three seconds elapse, a distance corresponding to the movement of the color boundary when four seconds elapse, or a distance corresponding to the movement of the color boundary when five seconds elapse), forgoing changing the portion of the numeral (e.g., the computer system forgoes changing a position of the portion of the numeral and/or maintains display of the portion of the numeral extending along the first position). Forgoing changing a portion of a numeral when a distance between the first boundary and an edge of the numeral is greater than a threshold distance allows for selective updating of the time user interface without requiring the user to provide inputs to manually edit the time user interface, improves visual feedback to the user, and prevents permanent discoloration (e.g., burn-in) on the display screen based on varying display patterns and/or colors.

In some embodiments, displaying the time user interface includes: in accordance with a determination that a position of the first boundary (e.g., 1248) is at an edge (e.g., 1250) of a numeral of the one or more numerals (e.g., the first boundary and the edge of the numeral are positioned along the same horizontal line or the first boundary and the edge of the numeral are positioned along the same vertical line), forgoing changing a portion of the numeral (e.g., the computer system forgoes changing a position of the portion of the numeral and/or maintains display of the portion of the numeral extending along the first position). Forgoing changing a portion of a numeral when the first boundary is at an edge of a numeral allows for selective updating of the time user interface without requiring the user to provide inputs to manually edit the time user interface, improves visual feedback to the user, and prevents permanent discoloration (e.g., burn-in) on the display screen based on varying display patterns and/or colors.

In some embodiments, displaying the time user interface includes: in accordance with a determination that a second distance between the first boundary (e.g., 1248) and a second edge of a second numeral of the one or more numerals is less than the threshold distance (e.g., 10%, 15%, 20%, or 25% of the distance the color boundary moves when a second elapses), changing a portion (e.g., the edge) of the second numeral (e.g., changing a position of the portion of the numeral) from extending along a third position (e.g., a position of a straight edge of the numeral and/or a position of a curved edge of the numeral) to extending along the first boundary. In some embodiments, the change in position of the portion of the numeral includes a straight edge (e.g., 1240) of the numeral moving upward or downward. In some embodiments, the change in position of the portion of the numeral includes a curved edge (e.g., 1252 and/or 1254) of the numeral moving towards the left, toward the right, upward, and/or downward. Changing portions of multiple numerals to extend along the first boundary when a distance between the first boundary and an edge of the numeral is less than a threshold distance updates the time user interface without requiring the user to provide inputs to manually edit the time user interface, improves visual feedback to the user, and prevents permanent discoloration (e.g., burn-in) on the display screen based on varying display patterns and/or colors.

In some embodiments, changing the portion of the numeral includes: as the color boundary (e.g., 1214) moves towards the first boundary (e.g., 1248), changing the portion of the numeral from extending along the first position (e.g., 1246) to extending along a third position (e.g., a position between the color boundary before a second elapses and the color boundary after the second elapses), wherein the third position is between the first position and the first boundary. In some embodiments, position of the numeral changes gradually from the first position (e.g., 1246) to the third position to the first boundary. In some embodiments, the portion of the numeral is displayed as changing position from extending along the first position (e.g., 1246) to extending along a fourth position, wherein the fourth position is between the first position and the third position. In some embodiments, the portion of the numeral is displayed as changing position from extending along the third position to extending along a fifth position, wherein the fifth position is between the third position and the first boundary (e.g., 1248). Changing a portion of a numeral gradually by changing the portion of the numeral from the first position to extending along a third position between the first position and the first boundary improves visual feedback to the user, and prevents permanent discoloration (e.g., burn-in) on the display screen based on varying display patterns and/or colors.

In some embodiments, displaying the time user interface includes: in accordance with a determination that the computer system is in a first power state (e.g., an active state and/or a normal operating state), changing the portion of the numeral from extending along the first position (e.g., 1246) to extending along a third position (e.g., a position between the color boundary before a second elapses and the color boundary after the second elapses) as the color boundary (e.g., 1214) moves towards the first boundary (e.g., 1248), wherein the third position is between the first position and first boundary. In some embodiments, in the first power state, the position of the numeral changes gradually from the first position (e.g., 1246) to the third position to the first boundary (e.g., 1248). In some embodiments, in accordance with a determination that the computer system is in a second power state, (e.g., a lower power state, a sleep state, a resting state, and/or a reduced power state), wherein the computer system consumes less power in the second power state than in the first power state (e.g., because in the active state, a display has a higher brightness, a display has a faster refresh rate, a higher power processor is in use, a processor is in a higher power state, and/or one or more additional sensors are taking more frequent sensor measurements), the computer system changes the portion of the numeral from extending along a first position (e.g., 1246, a position of a straight edge of the numeral and/or a position of a curved edge of the numeral) to extending along the first boundary (e.g., 1248) without extending along the third position (e.g., a position between the color boundary (e.g., 1214) before a second elapses and the color boundary after the second elapses) as the color boundary moves towards the first boundary. In some embodiments, in the second power state, the position of the numeral changes without displaying gradual movement toward the first boundary (e.g., 1248) (e.g., immediately moving from the first position to the first boundary). Changing a portion of a numeral gradually based on whether the computer system is in a first power state or a second power state selectively updates the time user interface without requiring the user to provide inputs to manually edit the time user interface, improves visual feedback to the user, and prevents permanent discoloration (e.g., burn-in) on the display screen based on varying display patterns and/or colors.

Note that details of the processes described above with respect to method 1100 (e.g., FIG. 11) are also applicable in an analogous manner to the methods described above and/or below. For example, methods 700, 900, 1300, 1500, and/or 1700 optionally include one or more of the characteristics of the various methods described above with reference to method 1100. For example, in some embodiments, the same computer system performs methods 700, 900, 1100, 1300, 1500, and/or 1700 and/or the various time user interfaces recited in methods 700, 900, 1100, 1300, 1500, and/or 1700 are implemented on the same computer system. For brevity, these details are not repeated below.

FIGS. 12A-12Q illustrate techniques for displaying a user interface element aligned with a portion of a numeral, in accordance with some embodiments. The user interfaces in these figures are used to illustrate the processes described below, including the processes in FIG. 13.

FIG. 12A illustrates computer system 600, which includes display 602 (e.g., a touch-sensitive display), rotatable and depressible input mechanism 604, and button 606. In FIG. 12A, computer system 600 is a smartwatch. In some embodiments, computer system 600 displays, on display 602, time user interface 1210a. In some embodiments, time user interface 1210a includes one or more numerals representing an indication of the current time, such as “1009” representing a current time of 10:09 am. Time user interface 1210a also includes color boundary 1214 that represents a number of seconds that have elapsed in a current minute. Color boundary 1214 moves over time from a first edge (e.g., a top edge) to a second edge (e.g., a bottom edge) as the seconds within the current minute elapse. For instance, as depicted in FIG. 12A, color boundary 1214 is halfway between the top edge and the bottom edge of time user interface 1210a, which represents 30 seconds having elapsed in the current minute. Time user interface 1210a includes user interface element 1220, corresponding to a calendar application and indicating a current date. Time user interface 1210a further includes user interface element 1222, corresponding to a weather application and indicating current weather conditions at a location.

One or more numerals 1212 are overlaid on a background of time user interface 1210a. On one side of color boundary 1214 (e.g., above the color boundary), a first portion 1216a of the one or more numerals include a first color and on the other side of color boundary 1214 (e.g., below the color boundary), a second portion 1216b of the one or more numerals include a second color. Similarly, on one side of color boundary 1214 (e.g., above the color boundary), a first portion 1218a of a background of time user interface 1210a includes a third color and on the other side of color boundary 1214 (e.g., below the color boundary), a second portion 1218b of the background of time user interface 1210a includes a fourth color. First portion 1216a of the one or more numerals and second portions 1216b of the one or more numerals generally have either a white color or a black color, respectively (e.g., or a relatively light color and a relatively dark color, respectively). The first portion 1218a and second portion 1218b of the background have a relatively light color and a relatively dark color, such that the corresponding portion of the one or more numerals has a relatively opposite brightness to that of the corresponding background. As an example, with reference to FIG. 12A, first portion 1216a of the one or more numerals has a white color, second portion 1216b of the one or more numerals has a dark blue color, first portion 1218a of the background has a dark green color, and second portion 1218b of the background has a light pink color. In some embodiments, a color of a user interface element matches a corresponding color of a portion of a numeral on a same side of color boundary 1214. For example, user interface element 1222 includes the same color as first portion 1216a of the one or more numerals, which is white. Similarly, user interface element 1220 includes the same color as second portion 1216b of the one or more numerals, which is dark blue.

With reference to FIG. 12B, a change in time to a new minute is displayed. In particular, the color boundary has moved completely to the bottom edge of time user interface 1210a such that the color boundary is no longer visible. In particular, the color boundary positioned at the bottom edge of time user interface 1210a to represent that 60 seconds have elapsed in the current minute resulting in a time change from 10:09 am to 10:10 am. Accordingly, the background of time user interface takes on the color of first portion 1218a of the background from the previous minute (e.g., dark green) and one or more numerals 1212 take on the color of first portion 1216a of the one or more numerals from the previous minute (e.g., white). In addition, a size and/or shape of one or more numerals 1212 change in response to the time change to the new minute, and/or one or more numerals are added or removed. In some embodiments, when a change to a new minute occurs, a numeral is displayed as “morphing” and/or shifting into a new shape and/or size (e.g., a change in horizontal or vertical length), or into a new number (e.g., from a “1” to “2”). Relative to the previous minute (e.g., as depicted in FIG. 12A), the “1” in the upper left corner and the “0” in the upper right corner remain displayed. The “0” in the lower left corner becomes a “1,” and the “9” in the lower right corner becomes a “0.” In addition, a shape of user interface element 1220 changes from curved to straight. The shape change occurs in order for user interface element 1220 to become aligned with the newly displayed “1.” Based on the alignment with the newly displayed “1,” user interface element 1220 also shifts position to move closer to a center of time user interface 1210a. User interface element 1220 also changes color from dark blue to white based on color boundary moving to the bottom edge of time user interface 1210a. As seconds begin to elapse in the new minute, color boundary 1214 begins to move in a predefined direction from a predefined edge of time user interface 1210a (e.g., move downward from the top edge of time user interface 1210a).

With reference to FIG. 12C, color boundary 124 has moved from the top edge of time user interface 1210a downward (e.g., a 75% portion of the display area downward) on time user interface 1210a indicating that 45 seconds have elapsed relative to FIG. 12B (e.g., 75% of one minute). Accordingly, the position of color boundary 1214 indicates that 45 seconds have elapsed in the current minute of 10:10 am. As the new minute begins, first portion 1218a of the background includes a different color from a set of predefined colors (e.g., a color not previously displayed on time user interface within a predefined number of minutes). For example, first portion 1218a of the background, which was previously dark blue (e.g., as depicted in FIGS. 12A-12C) has changed to light orange. Accordingly, first portion of the one or more numerals 1216a has changed to dark green and user interface element 1222 changes to dark green. As the new minute begins, second portion 1218b of the background maintains the same color (e.g., dark blue) that was displayed during the previous minute (e.g., as depicted in FIGS. 12A-12C). Accordingly, second portion of the one or more numerals 1216b maintains a white color. Based on the position of color boundary 1214, an upper portion of user interface element 1220 corresponds to the color of first portion of the one or more numerals 1216a (e.g., dark green) and a lower portion of user interface element 1220 corresponds to the color of second portion of the one or more numerals 1216b (e.g., white). Accordingly, based on the position of color boundary 1214, user interface elements include either one color or two colors at a point in time.

With reference to FIG. 12D, computer system 600 transitions from an active state to a sleep, resting, and/or lower power state. For instance, the user lowers computer system 600 to a resting position (e.g., at the user's side and/or in the user's pocket) and/or performs a hand cover gesture over computer system 600. As a result, computer system enters the sleep, resting, and/or lower power state. While in the sleep, resting, and/or lower power state, the first portion 1218a of the background and second portion 1218b of the background are displayed with a black color (e.g., or alternatively, a dark color). While in the sleep, resting, and/or lower power state, color boundary 1214 is not visible on the background of time user interface 1210a, whereas color boundary 1214 is visible within the interior of numerals 1212 and within user interface elements 1220 and 1222. In particular, while in the sleep state, the color of first portion 1216a of the one or more numerals takes on the color of first portion 1218a of the background prior to entering the sleep state (e.g., as depicted in FIG. 12C). Thus, when entering the sleep state, the color of first portion 1016a of the one or more numerals and user interface element 1222 becomes light orange. Likewise, the color of second portion 1216b of the one or more numerals becomes dark blue when entering the sleep state. In this example, the upper portion of user interface element 1220 is light orange (e.g., consistent with the color of first portion 1216a of the one or more numerals) and the lower portion of user interface element 1220 is dark blue (e.g., consistent with the color of first portion 1216a of the one or more numerals).

With reference to FIG. 12E, a current time is 5:58 pm, represented by numerals “0558.” In addition, user interface element 1220 has changed positions (e.g., relative to FIGS. 12A-12D) from the lower left portion of time user interface 1210a to the lower right portion of time user interface 1210a. In particular, user interface element 1220 is aligned around a lower right portion of the numeral “8.” User interface element 1222 has changed positions (e.g., relative to FIGS. 12A-12D) from the upper right portion of time user interface 1210a to the upper left portion of time user interface 1210a. In particular, user interface element 1220 is aligned around an upper right portion of the numeral “0.” A user provides input 1226 (e.g., via a press-and-hold input on display 1202) in order to navigate to an editing user interface.

With reference to FIG. 12F, an editing user interface 1228 is displayed. The user taps “edit” affordance 1230 in order to navigate to a plurality of selectable editing options within editing user interface 1220. In particular, with reference to FIG. 12G, the user performs one or more gestures (e.g., a left swipe gesture or a right swipe gesture) to arrive at a color editing user interface 1228a. Within color editing user interface 1228a, the user selects a color scheme from a plurality of color schemes such that changes in time will include color changes consistent with a set of colors for the selected color scheme (e.g., as discussed with respect to FIGS. 12H-12I). For instance, a current color scheme corresponds to “Blue.”

With reference to FIG. 12H, the user further navigates to an editing user interface 1228b for editing various aspects of the displayed user interface elements, such as user interface elements 1220 and 1222. For instance, the user rotates rotatable and depressible input mechanism 1204 in order to modify the positions of user interface elements 1220 and 1222. In some embodiments, while the user can modify the relative positions of user interface elements 1220 and 1222 (e.g., positions such as upper left, upper right, lower left, and lower right), the user is not able to modify the positions of the user interface elements. For example, the user cannot customize the alignment and position of a user interface element along a numeral. In this example, the user rotates rotatable and depressible input mechanism 1204 in order to move user interface element 1220 from a lower right position (e.g., as shown in FIG. 12E) to a lower left position and to move user interface element 1222 from an upper left position (e.g., as shown in FIG. 12E) to an upper right position. In some embodiments, a rotation of rotatable and depressible input mechanism 1204 will cause multiple user interface elements to move. In some embodiments, a rotation of rotatable and depressible input mechanism 1204 will cause a single user interface element to move (e.g., in combination with a tap input on a desired user interface element prior to rotation).

Options are also provided for a user to change the type of user interface element displayed on time user interface 1210a. For example, while in editing user interface 1228b, a user taps on a desired user interface element, which will cause a plurality of selectable options to appear. The plurality of selectable options includes a plurality of applications and/or application functions, the selection of which will cause the selected application or application function to replace the selected user interface element within the editing user interface. For example, the user taps on user interface element 1220 and selects an activity application in order to change user interface element 1220 from a user interface element associated with a calendar application to a user interface element associated with an activity application. Similarly, the user taps on user interface element 1222 and select a stocks application in order to change user interface element 1222 from a user interface element associated with a weather application to a user interface element associated with a stocks application.

With reference to FIG. 12I, the user rotates rotatable and depressible input mechanism 1204 in order to further change the position of one or more user interface elements. In this example, a rotation of rotatable and depressible input mechanism 1204 causes user interface element 1222 to change positions from the upper right corner of time user interface 1210a to the lower right corner of time user interface 1210a.

With reference to FIG. 12J, the user rotates rotatable and depressible input mechanism 1204 in order to further change the position of one or more user interface elements. In this example, a rotation of rotatable and depressible input mechanism 1204 causes user interface element 1220 to change positions from the lower left corner of time user interface 1210a to the upper left corner of time user interface 1210a. Once the user is finished editing the placement of user interface elements, the user provides input 1232 (e.g., a tap input or a press-and-hold input) to save the changes made and exit editing user interface 1228b.

With reference to FIG. 12K, the user provides input 1234 in order to interact with user interface element 1222. For example, the user taps on user interface element 1222 which is associated with a stocks application. With reference to FIG. 12L, in response to the user tapping on user interface element 1222, a stocks application 1236 is displayed on display 1202. The user returns to the time user interface by way of one or more inputs such as pressing an affordance displayed on stocks application 1236 and/or pressing a hardware button (e.g., rotatable and depressible input mechanism 1204 and/or button 1206).

With reference to FIG. 12M, time user interface 1210a is displayed without user interface elements. In some embodiments, user interface elements are disabled based on a user preference, device setting, and/or state of computer system 600 (e.g., a display setting and/or a reduced power state). In some embodiments, when user interface elements are disabled, numerals 1212 within time user interface 1210a are displayed within a margin 1238. In general, margin 1238 is not visible on display 1202. In such cases, when the user interface elements are subsequently enabled, the user interface elements are displayed outside of the margins (e.g., as discussed with respect to FIGS. 12A-12L).

With reference to FIG. 12N, user interface elements are also disabled as in FIG. 12M. In contrast to the embodiment of FIG. 12M, when user interface elements are disabled, numerals 1212 within time user interface 1210a are displayed not displayed within a margin. In such cases, when the user interface elements are subsequently enabled, the user interface elements are displayed outside of a margin, such as margin 1238 in FIG. 12M (e.g., as discussed with respect to FIGS. 12A-12L). Accordingly, when the user interface elements are disabled, the size of numerals 1212 is enlarged such that the edges of numerals 1212 are closer to the edge of time user interface 1210a than as discussed in FIG. 12M. Likewise, when the user interface elements are enabled, the size of numerals 1212 is decreased such numerals 1212 such that the size of numerals are similar and/or the same as discussed in FIG. 12M.

The alignment, size, shape, and text direction of user interface elements along respective portions of numerals vary according to the current time and corresponding numerals being displayed. For instance, a user interface element includes a straight shape or a curved shape (e.g., convex or concave). In some embodiments, a first portion of a user interface element includes a first shape, such as straight and/or curved, and a second portion of the user interface includes a different shape, such as straight and/or curved. As time elapses and the user interface elements change shape, a text direction of the user interface elements also changes based on the particular alignment of the user interface element. FIGS. 12O-12Q provide several exemplary alignments, shapes, and positions of user interface elements.

FIG. 12O includes a current time of 2:27 pm. In this example, user interface element 1220 has a straight shape, a horizontal direction, and is aligned along a bottom edge of the minute numeral “2.” User interface element 1222 has a straight shape, a diagonal direction, and is aligned along a lower right edge of minute numeral “7.”

FIG. 12P includes a current time of 12:04 pm. In this example, user interface element 1220 has a straight shape, a diagonal direction, and is aligned along a top edge of the hour numeral “1.” User interface element 1222 has a straight shape, an upward direction, and is aligned along a right edge of minute numeral “4.”

FIG. 12Q includes a current time of 2:56 pm. In this example, user interface element 1220 has a straight shape, an upward direction, and is aligned along a left edge of the minute numeral “5.” User interface element 1222 has a curved shape, an upward curved direction, and is aligned along a middle portion of minute numeral “2.”

FIG. 12R includes current time of 10:09 pm. In this example, one or more numerals 1212 and color boundary 1214 are depicted. In this example, a numeral “0” within one or more numerals 1212 includes an internal edge 1240 and corresponding internal curves 1242 and 1244. The alignment of internal edge 1240 is highlighted via line 1246. Also shown is line 1248 representing the location that color boundary 1214 will reach when color boundary 1214 moves based on the passage of time (e.g., the passage of one second). In addition, a numeral “9” within one or more numerals 1212 includes internal edges 1250 and corresponding internal curves 1252 and 1254. In some embodiments, when a distance between color boundary 1214 and an edge of a numeral is more than a threshold distance, a portion of the numeral is not changed. For example, when a distance between color boundary 1214 and internal edge 1240 is more than the distance color boundary 1214 moves when at least one second elapses (or a percentage of the distance color boundary 1214 moves when one second elapses), a portion of the corresponding numeral “0” is not changed.

FIG. 12S illustrates a passage of time relative to FIG. 12R. In this example, one second has elapsed relative to FIG. 12R, such that color boundary 1214 has moved to align with line 1248. In some embodiments, when a distance between color boundary 1214 and an edge of a numeral is less than a threshold distance, a portion of the numeral is changed. For example, when a distance between color boundary 1214 and internal edge 1240 is less than a percentage (e.g., 10%, 15%, 20%, or 25%) of the distance color boundary 1214 moves when one second elapses, a portion of the corresponding numeral “0” is changed. Specifically, internal edge 1240 is changed from extending along a first position (e.g., as shown in FIG. 12R) to extending along color boundary 1214, as shown in FIG. 12S. In addition, internal curves 1242 and 1244 also change in curvature and/or shape (relative to FIG. 12R), as shown in FIG. 12S. In some embodiments, when color boundary 1214 is aligned with an edge of a numeral, such as edge 1250 of numeral “9,” a portion of the numeral is not changed. For example, internal edge 1250 and corresponding internal curves 1252 and 1254 are not changed.

FIG. 12T illustrates a passage of time relative to FIG. 12S. In this example, one second has elapsed relative to FIG. 12S. Based on a distance between color boundary 1214 and the original alignment of internal edge 1240 being more than a threshold distance, a portion of the numeral returns to the original alignment. Specifically, based on the distance between color boundary 1214 and internal edge 1240, extending along line 1246, being more than a threshold distance (e.g., the distance color boundary 1214 moves when one second elapses and/or a percentage of the distance color boundary 1214 moves when one second elapses), the alignment of internal edge 1240 returns to the original alignment extending along line 1246.

As seconds continue to elapse, color boundary 1214 continues to move across time user interface 1210a, such that color boundary 1214 approaches the edges of other numerals. Accordingly, when a distance between color boundary 1214 and an edge of other numeral(s) is less than the threshold distance, a portion of the corresponding numeral is changed similar, the same, and/or analogous to that of internal edge 1240 (as discussed with respect to FIGS. 12R-12T). For example, an edge of the numeral “8” (e.g., as shown in FIG. 10B) changes as color boundary 1014 approaches the edge of the numeral “8” and optionally exhibits some of the same behavior described above with reference to FIG. 12R-12T by shifting a respective edge of the “8” if the edge of the “8” would not otherwise line up with the seconds boundary. As another example, an edge of the numeral “0” (e.g., as shown in FIG. 10J) changes as color boundary 1014 approaches the edge of the numeral “0” and optionally exhibits some of the same behavior described above with reference to FIG. 12R-12T by shifting a respective edge of the “0” if the edge of the “0” would not otherwise line up with the seconds boundary. As another example, an edge of the numeral “0” (e.g., as shown in FIG. 12A) changes as color 1214 approaches the edge of the numeral “0” and optionally exhibits some of the same behavior described above with reference to FIG. 12R-12T by shifting a respective edge of the “0” if the edge of the “0” would not otherwise line up with the seconds boundary. As another example, an edge of the numeral “8” (e.g., as shown in FIGS. 12I-12K) changes as color 1214 approaches the edge of the numeral “8” and optionally exhibits some of the same behavior described above with reference to FIG. 12R-12T by shifting a respective edge of the “8” if the edge of the “8” would not otherwise line up with the seconds boundary. As another example, an edge of the numeral “0” (e.g., as shown in FIG. 12Q) changes as color 1214 approaches the edge of the numeral “0” and optionally exhibits some of the same behavior described above with reference to FIG. 12R-12T by shifting a respective edge of the “0” if the edge of the “0” would not otherwise line up with the seconds boundary.

FIG. 13 is a flow diagram illustrating a method for displaying background regions using a computer system in accordance with some embodiments. Method 1300 is performed at a computer system (e.g., a smartphone, a smartwatch, a tablet computer, a laptop computer, a desktop computer, and/or a head mounted device (e.g., a head mounted augmented reality and/or extended reality device)) that is in communication with a display generation component (e.g., a display controller, a display, a touch-sensitive display system, a touchscreen, a monitor, and/or a head mounted display system). In some embodiments, the computer system is in communication with one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1300 are, optionally, combined, the orders of some operations are, optionally, changed, and some operations are, optionally, omitted.

As described below, method 1300 provides an intuitive way for displaying background regions for time user interfaces. The method reduces the cognitive burden on a user for displaying background regions for time user interfaces, thereby creating a more efficient human-machine interface. For battery-operated computing devices, enabling a user to modify background regions for time user interfaces faster and more efficiently conserves power and increases the time between battery charges.

The computer system displays (1302), via the display generation component, a user interface element (e.g., 1220, 1222, a selectable user interface element and/or a complication) in a time user interface (e.g., 1210a) that includes a representation of time (e.g., a representation of the current time), including displaying the user interface element (e.g., 1220, 1222, and/or a complication) aligned with (e.g., aligned along, aligned with a curve of, and/or wraps around) a first portion (e.g., an outer portion, an inner portion, a boundary, a straight edge, an outwardly curved or convex edge, and/or an inwardly curved or concave edge) of a first numeral (e.g., 1212) of the representation of time (e.g., an outer portion of the first numeral, an inner portion of the first numeral, an upper portion of the first numeral, a lower portion of the first numeral, a left portion of the first numeral, and/or a right portion of the first numeral). In some embodiments, the first numeral (e.g., 1212) indicates a time (e.g., an hour and/or a minute). In some embodiments, the first numeral (e.g., 1212) is a single digit between zero and nine. In some embodiments, the first portion corresponds to a portion (e.g., a boundary) near a corner (e.g., an upper-left corner, an upper-right corner, a lower-left corner, or a lower-right corner) of the time user interface (e.g., 1210a). In some embodiments, a complication refers to a feature of a user interface (e.g., a home screen, a wake screen, a clock face and/or a watch face) other than those used to indicate the hours and minutes of a time (e.g., clock hands or hour/minute indications). In some embodiments, complications provide data obtained from an application. In some embodiments, a complication updates the displayed data in accordance with a determination that the data obtained from the application has been updated. In some embodiments, the complication updates the displayed data over time. In some embodiments, a complication includes an affordance that when selected launches a corresponding application. In some embodiments, a complication includes an affordance that when selected causes the computer system to perform a corresponding task. In some embodiments, a complication is displayed at a fixed, predefined location on the display. In some embodiments, complications occupy respective locations at particular regions (e.g., lower-right, lower-left, upper-right, and/or upper-left) of a user interface (e.g., a home screen, a wake screen, a clock face and/or a watch face). In some embodiments, a user may select a type of complication to include on the display. In some embodiments, a user may select parameters to display for a specific type of complication.

In some embodiments, the time user interface (e.g., 1210a) is a home screen, a wake screen, a reduced-power screen, a lock screen, a clock face, and/or a watch face. In some embodiments, a reduced-power screen is a user interface that is displayed when the computer system is in a reduced-power state, low-power state, and/or off state. In some embodiments, a wake screen is a user interface that is displayed when the computer system transitions from a lower power state to a higher power state (e.g., from a state in which the computer system has a lower brightness, a display has a slower refresh rate, a lower power processor is in use, a processor is in a lower power state, and/or one or more additional sensors are taking less frequent sensor measurements to a state in which the computer system has a higher brightness, a display has a faster refresh rate, a higher power processor is in use, a processor is in a higher power state, and/or one or more additional sensors are taking more frequent sensor measurements).

The computer system detects (1304) a change in time (e.g., a change in a current second, a change in a current minute, a change in a current hour, and/or change in a current day).

In response to detecting the change in time, the computer system displays (1306), via the display generation component, the user interface element (e.g., 1222, 1224, and/or a complication) aligned with (e.g., aligned along and/or wraps around) a second portion (e.g., aligned along a straight edge, aligned along an outwardly curved or convex edge, and/or aligned along an inwardly curved or concave edge) of a second numeral of the representation of time (e.g., an outer portion of the second numeral, an inner portion of the second numeral, an upper portion of the second numeral, a lower portion of the second numeral, a left portion of the second numeral, and/or a right portion of the second numeral), wherein the second numeral is different from the first numeral (e.g., as shown in FIGS. 12A-12B).

In some embodiments, the second portion corresponds to a portion near a corner (e.g., an upper-left corner, an upper-right corner, a lower-left corner, or a lower-right corner) of the time user interface (e.g., 1210a). In some embodiments, the second numeral indicates a time (e.g., an hour and/or a minute). In some embodiments, the second numeral is a single digit between zero and nine. In some embodiments, the second numeral is different from the first numeral (e.g., the second numeral represents a different number than the first numeral). In some embodiments, the second portion is different from the first portion (e.g., the first portion is a top portion and the second portion is a bottom portion). For example, in some embodiments, in response to detecting the change in time, the user interface element (e.g., 1222, 1224, and/or a complication) is moved from an upper-left corner of the first numeral to a right side of the second numeral. In some embodiments, the second numeral replaces the first numeral when the time changes. In some embodiments, the second numeral replaces a numeral that is different from the first numeral when the time changes. In some embodiments, the representation of time includes multiple locations for digits in the time, and the second numeral is located at a different location in the representation of time than the first numeral. In some embodiments, the representation of time includes multiple locations for digits in the time, and the second numeral is located at the same location in the representation of time that the first numeral was located. In some embodiments, the second numeral was displayed in response to detecting the change in time. In some embodiments, the second numeral was displayed prior to detecting the change in time. Displaying a user interface element in a time user interface that includes a representation of time, including displaying the user interface element aligned with a first portion of a first numeral of the representation of time and in response to detecting a change in time, displaying the user interface element aligned with a second portion of a second numeral of the representation of time updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the computer system displays the user interface element (e.g., 1222, 1224, and/or a complication) aligned with the first portion of the first numeral (e.g., 1212) of the representation of time includes displaying the user interface element (e.g., 1222, 1224, and/or a complication) on a first side (e.g., an upper left region or side, a lower left region or side, an upper right region or side, or a lower right region or side) of the time user interface (e.g., 1210a), and displays the user interface element (e.g., 1222, 1224, and/or a complication) aligned with the second portion of the second numeral (e.g., 1212) of the representation of time includes displaying the user interface element (e.g., 1222, 1224, and/or a complication) on a second side (e.g., an upper left region or side, a lower left region or side, an upper right region or side, or a lower right region or side) of the time user interface (e.g., 1210a) different from the first side of the time user interface (e.g., the user interface element moves lower, higher, left, and/or right). Displaying the user interface element on a first side of the time user interface when aligned with the first portion of the first numeral and displaying the time user interface element on a second side of the time user interface when aligned with the second portion of the second numeral updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the computer system displays the user interface element (e.g., 1222, 1224, and/or a complication) aligned with the first portion of the first numeral of the representation of time includes displaying the user interface element (e.g., 1222, 1224, and/or a complication) having first curvature (e.g., a curvature along a first portion of the user interface element, multiple different curvatures along multiple different portions of the user interface element, and/or a curvature of a specific degree), and displays the user interface element (e.g., a complication) aligned with the second portion of the second numeral of the representation of time includes displaying the user interface element (e.g., 1222, 1224, and/or a complication) having a second curvature different from the first curvature (e.g., a curvature along a first portion of the user interface element, multiple different curvatures along multiple different portions of the user interface element, and/or a curvature of a specific degree). In some embodiments, the degree of curvature of the first curvature or the second curvature is non-zero (e.g., as shown in FIG. 12B). In some embodiments, the degree of curvature of the first curvature or the second curvature is zero (e.g., straight as shown in FIG. 12C). Displaying the user interface element with a first curvature when aligned with the first portion of the first numeral and displaying the time user interface element with a second curvature when aligned with the second portion of the second numeral updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the computer system displays the user interface element (e.g., 1222, 1224, and/or a complication) aligned with the first portion of the first numeral of the representation of time includes displaying a text of the user interface element (e.g., 1222, 1224, and/or a complication) having a first direction (e.g., text that reads in a bottom to top direction, text that reads in a top to bottom direction, text that reads in a left to right direction, and/or text that reads in a right to left direction), and displays the user interface element (e.g., 1222, 1224, and/or a complication) aligned with the second portion of the second numeral of the representation of time includes displaying the text of the user interface element (e.g., 1222, 1224, and/or a complication) having a second direction different from the first direction (e.g., as shown in FIG. 12O relative to FIG. 12P, text that reads in a top to bottom direction, text that reads in a top to bottom direction, text that reads in a left to right direction, and/or text that reads in a right to left direction). In some embodiments, the text of the user interface element is aligned along a degree of curvature. In some embodiments, the text of the user interface element is aligned in a straight direction. In some embodiments, a portion of the text of the user interface element is aligned along a degree of curvature (e.g., as shown in FIG. 12Q). In some embodiments, a portion of the text of the user interface element is aligned in a straight direction (e.g., as shown in FIG. 12O). Displaying the user interface element with a text in a first direction when aligned with the first portion of the first numeral and displaying the time user interface element with text in a second direction when aligned with the second portion of the second numeral updates the time user interface without requiring the user to provide inputs to manually edit the time user interface, improves visual feedback to the user, and prevents permanent discoloration (e.g., burn-in) on the display screen based on varying display patterns and/or colors.

In some embodiments, at a first time, the computer system displays, via the display generation component, the user interface element (e.g., 1222, 1224, and/or a complication) having a first color (e.g., the user interface element includes one color at the first time or the user interface includes two colors at the first time); and at a second time different from the first time, the computer system displays, via the display generation component, the user interface element (e.g., 1222, 1224, and/or a complication) having a second color different from the first color (e.g., the user interface element includes one color at the first time or the user interface includes two colors at the first time) (e.g., as shown in FIGS. 12A-12B). Displaying the user interface element having different colors at different times updates the time user interface without requiring the user to provide inputs to manually edit the time user interface, improves visual feedback to the user, and prevents permanent discoloration (e.g., burn-in) on the display screen based on varying display patterns and/or colors.

In some embodiments, at a first time: a color of the first numeral of the representation of time corresponds to a first color, and a color of the user interface element (e.g., 1222, 1224, and/or a complication) corresponds to the first color, and at a second time different from the first time: the color of the first numeral of the representation of time (e.g., the color of the first numeral changes at the second time; e.g., the color changes along a linear boundary and/or the color changes along a boundary within the numeral) has a second color different from the first color, and the color of the user interface element (e.g., 1222, 1224, and/or a complication) has the second color (e.g., the color of the user interface element changes at the second time). In some embodiments, portions of the user interface element change color in conjunction with adjacent portions of the numeral changing color (e.g., concurrently with or at a time that is near to a time when the adjacent portions of the numeral change). In some embodiments, the color of the user interface element and the color of the numeral change concurrently while in the computer system is in an active and/or normal operating state (e.g., as shown in FIGS. 12A-12C). In some embodiments, the color of the user interface element and the color of the numeral change concurrently while the computer system is in a sleep state, a resting state, and/or a reduced power state (e.g., as shown in FIG. 12D). Changing the color of the first numeral and the color of the user interface element as time changes updates the time user interface without requiring the user to provide inputs to manually edit the time user interface, improves visual feedback to the user, and prevents permanent discoloration (e.g., burn-in) on the display screen based on varying display patterns and/or colors.

In some embodiments, at a first time: a color of a background of the time user interface (e.g., 1210a) corresponds to first color, and a color of the user interface element (e.g., 1222, 1224, and/or a complication) corresponds to the first color, and at a second time different from the first time: the color of the background of the time user interface (e.g., the color of the background changes at the second time; e.g., the color changes along a linear boundary and/or the color changes along a boundary outside the numeral within the background region) has a second color different from the first color, and the color of the user interface element (e.g., 1222, 1224, and/or a complication) has the second color (e.g., the color of the user interface element changes at the second time). In some embodiments, portions of the user interface element change color concurrently with adjacent portions of the background changing color. In some embodiments, the color of the user interface element and the color of the background change concurrently while in the computer system is in an active and/or normal operating state (e.g., as shown in FIGS. 12A-12C). In some embodiments, the color of the user interface element and the color of the background change concurrently while the computer system is in a sleep state, a resting state, and/or a reduced power state (e.g., as shown in FIG. 12D). Changing the color of a background of the time user interface and the color of the user interface element as time changes updates the time user interface without requiring the user to provide inputs to manually edit the time user interface, improves visual feedback to the user, and prevents permanent discoloration (e.g., burn-in) on the display screen based on varying display patterns and/or colors.

In some embodiments, at a first time: a first portion (e.g., an upper portion and/or a left portion) of the user interface element (e.g., 1222, 1224, and/or a complication) includes a first value for a respective characteristic (e.g., a first color and/or a first appearance), and a second portion (e.g., a lower portion and/or a right portion) of the user interface element (e.g., 1222, 1224, and/or a complication) includes the first value for the respective characteristic (e.g., a first color and/or a first appearance); and at a second time that is after the first time: the first portion (e.g., an upper portion and/or a left portion) of the user interface element (e.g., 1222, 1224, and/or a complication) includes a second value for the first characteristic different from the first value for the respective characteristic (e.g., a second color and/or a second appearance), and the second portion (e.g., a lower portion and/or a right portion) of the user interface element (e.g., 1222, 1224, and/or a complication) includes the first value for the first characteristic (e.g., as shown in FIGS. 12C and/or 12O) (e.g., a first color and/or a first appearance). In some embodiments, at a third time that is after the second time, the second portion of the user interface element includes the second value for the first characteristic. In some embodiments, as a boundary representing a change in time moves in a first direction, first respective portions of the user interface element (e.g., upper portions and/or portions above the boundary representing a change in time) change from having the first value for the respective characteristic to having the second value for the respective characteristic, whereas second respective portions of the user interface element (e.g., lower portions and/or portions below the boundary representing the change in time) maintain the first respective value for the respective characteristic. Changing the color of different portions of the user interface element as time changes updates the time user interface without requiring the user to provide inputs to manually edit the time user interface, improves visual feedback to the user, and prevents permanent discoloration (e.g., burn-in) on the display screen based on varying display patterns and/or colors.

In some embodiments, while the computer system is in a first power state (e.g., an active state and/or a normal operating state), the computer system displays, via the display generation component, a background of the time user interface (e.g., 1210a) having a first color (e.g., the background includes one color or more than one color). In some embodiments, the computer system detects an event. In some embodiments, the computer system detects a wrist down motion (e.g., a wrist or hand down gesture and/or motion that satisfies a set of motion criteria that indicates that a wrist or hand of a user has been lowered). In some embodiments, the computer system detects that the computer system (e.g., or, in some embodiments, a display of the computer system) is covered (e.g., in response to detecting a hand cover gesture and/or in response to detecting that the computer system has been covered for a predetermined amount of time). In some embodiments, the computer system detects that the computer system has been lowered (e.g., to a resting position, a surface, and/or a user's pocket). In some embodiments, the computer system detects the passage of a period of time in which the computer system does not receive user inputs or detect the occurrence of one or more conditions that keep the computer system in an active state, normal operating state, full-power state, on state, and/or awake state. In some embodiments, in response to detecting the event, the computer system transitions the computer system to a second power state (e.g., a lower power state, a sleep state, a resting state, and/or a reduced power state), wherein the computer system consumes less power in the second power state than in the first power state (e.g., because in the active state, a display has a higher brightness, a display has a faster refresh rate, a higher power processor is in use, a processor is in a higher power state, and/or one or more additional sensors are taking more frequent sensor measurements); and the computer system displays, via the display generation component, the user interface element (e.g., 1222, 1224, and/or a complication) having the first color and the background of the time user interface (e.g., 1210a) having a color that is darker than the first color (e.g., black or dark gray). In some embodiments, the background transitions from the first color to the color darker than the first color at the same rate as the user interface element transitions to the first color (e.g., within a period of 0.2 seconds, 0.5 seconds, or 1 second).

Displaying a background with a first color in a first power state and displaying the user interface element with the first color and the background with a darker color in a second power state conserves device power by using less illumination, updates the time user interface without requiring the user to provide inputs to manually edit the time user interface, improves visual feedback to the user, and prevents permanent discoloration (e.g., burn-in) on the display screen based on varying display patterns and/or colors.

In some embodiments, displaying the user interface element (e.g., 1222, 1224, and/or a complication) includes: in accordance with a determination that a first region of the time user interface (e.g., 1210a) (e.g., an upper corner, a lower corner, a right side, and/or a left side) has been selected for displaying the user interface element (e.g., 1222, 1224, and/or a complication) and a first numeral is displayed in the first region (e.g., a first hour numeral or a first minute numeral), the user interface element (e.g., 1222, 1224, and/or a complication) is displayed at a first location in the first region (e.g., a location that is determined based on a shape of the first numeral); in accordance with a determination that the first region of the time user interface (e.g., 1210a) (e.g., an upper corner, a lower corner, a right side, and/or a left side) has been selected for displaying the user interface element (e.g., 1222, 1224, and/or a complication) and a second numeral, different from the first numeral, is displayed in the first region (e.g., a second hour numeral or a second minute numeral), the user interface element (e.g., 1222, 1224, and/or a complication) is displayed at a second location in the first region (e.g., a location that is determined based on a shape of the first numeral) wherein the second location in the first region is different from the first location in the first region (e.g., as shown in FIGS. 12H-12K); in accordance with a determination that a second region of the time user interface (e.g., an upper corner, a lower corner, a right side, and/or a left side), different from the first region of the time user interface, has been selected for displaying the user interface element (e.g., 1222, 1224, and/or a complication) and a third numeral is displayed in the first region (e.g., a third hour numeral or a third minute numeral) (e.g., a numeral that is the same as the first numeral, different from the first numeral, the same as the second numeral or different from the second numeral), the user interface element (e.g., 1222, 1224, and/or a complication) is displayed at a first location in the second region (e.g., a location that is determined based on a shape of the third numeral); and in accordance with a determination that the second region of the time user interface (e.g., an upper corner, a lower corner, a right side, and/or a left side) has been selected for displaying the user interface element (e.g., 1222, 1224, and/or a complication) and a fourth numeral, different from the third numeral, is displayed in the first region (e.g., a fourth hour numeral or a fourth minute numeral) (e.g., a numeral that is the same as the first numeral, different from the first numeral, the same as the second numeral or different from the second numeral), the user interface element (e.g., 1222, 1224, and/or a complication) is displayed at a second location in the second region (e.g., a location that is determined based on a shape of the fourth numeral) wherein the second location in the second region is different from the first location in the second region (e.g., as shown in FIGS. 12H-12K). Displaying the user interface element positioned within a predefined location selectable by the user and including a plurality of locations within which the user interface element changes position over time updates the time user interface without requiring the user to provide inputs to manually edit the time user interface, improves visual feedback to the user, and prevents permanent discoloration (e.g., burn-in) on the display screen based on varying display patterns and/or colors.

In some embodiments, while displaying the user interface element (e.g., 1222, 1224, and/or a complication) aligned with the first portion of the first numeral of the representation of time: the computer system displays, via the display generation component, the user interface element (e.g., a complication) having a first characteristic (e.g., a curvature, a text direction, a shape, a color, and/or a general location). In some embodiments, the computer system displays, via the display generation component, a second user interface element (e.g., 1222, 1224, and/or a complication) different from the user interface element (e.g., 1222, 1224, a selectable user interface element and/or a complication) in the time user interface (e.g., 1210a), including displaying the second user interface element (e.g., 1222, 1224, and/or a complication) aligned with (e.g., aligned along, aligned with a curve of, and/or wraps around) a third portion (e.g., an outer portion, an inner portion, a boundary, a straight edge, an outwardly curved or convex edge, and/or an inwardly curved or concave edge) of a third numeral of the representation of time; (e.g., an outer portion of the third numeral, an inner portion of the third numeral, an upper portion of the third numeral, a lower portion of the third numeral, a left portion of the third numeral, and/or a right portion of the third numeral), wherein the second user interface element (e.g., 1222, 1224, and/or a complication) is displayed having a second characteristic (e.g., a curvature, a text direction, a shape, a color and/or a general location). In some embodiments, in response to detecting the change in time: while displaying the user interface element (e.g., a complication) aligned with the second portion of the second numeral of the representation of time: the computer system displays, via the display generation component, the user interface element (e.g., 1222, 1224, and/or a complication) having a third characteristic different from the first characteristic (e.g., a curvature, a text direction, a shape, a color, and/or a general location); and the computer system displays, via the display generation component, the second user interface element (e.g., 1222, 1224, and/or a complication) aligned with (e.g., aligned along and/or wraps around) a fourth portion (e.g., aligned along a straight edge, aligned along an outwardly curved or convex edge, and/or aligned along an inwardly curved or concave edge) of a fourth numeral of the representation of time (e.g., an outer portion of the fourth numeral, an inner portion of the fourth numeral, an upper portion of the fourth numeral, a lower portion of the fourth numeral, a left portion of the fourth numeral, and/or a right portion of the fourth numeral), wherein the fourth numeral is different from the third numeral, and wherein the second user interface element (e.g., a complication) is displayed having a fourth characteristic different from the second characteristic (e.g., a curvature, a text direction, a shape, a color and/or a general location) (e.g., as shown in FIGS. 12A-12D and/or 120-12Q). Displaying a second user interface element in a time user interface that includes a representation of time, including displaying the user interface element aligned with a third portion of a third numeral of the representation of time and in response to detecting a change in time, displaying the second user interface element aligned with a fourth portion of a fourth numeral of the representation of time updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the user interface element (e.g., 1222, 1224, and/or a complication) has a first shape (e.g., a straight shape, a circular shape, a rectangular shape, a triangular shape, an outwardly curved or convex shape, and/or an inwardly curved or concave shape), and the second user interface element (e.g., 1222, 1224, and/or a complication) has a second shape different from the first shape (e.g., a straight shape, a circular shape, a rectangular shape, a triangular shape, an outwardly curved or convex shape, and/or an inwardly curved or concave shape). In some embodiments, the first shape is based on a configuration of the first numeral (e.g., the boundaries of the numeral and/or the size of the numeral) of the representation of time. In some embodiments, the second shape is based on a configuration (e.g., the boundaries of the numeral and/or the size of the numeral) of the third numeral of the representation of time. In some embodiments, as the first numeral changes to the second numeral, the first shape changes to a third shape which is based on a configuration (e.g., the boundaries of the numeral and/or the size of the numeral) of the second numeral. In some embodiments, as the third numeral changes to the fourth numeral, the second shape changes to a fourth shape which is based on a configuration (e.g., the boundaries of the numeral and/or the size of the numeral) of the fourth numeral (e.g., as shown in FIGS. 12A-12D and/or 12Q). Displaying the user interface element with a first shape and the second user interface element with a different shape updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the user interface element (e.g., 1222, 1224, and/or a complication) has a first curvature (e.g., an outwardly curved or convex curvature, and/or an inwardly curved or concave curvature, or a first radius of curvature, or no curvature), and the second user interface element (e.g., 1222, 1224, and/or a complication) has a second curvature different from the first curvature (e.g., an outwardly curved or convex curvature, and/or an inwardly curved or concave curvature, or a second radius of curvature, or no curvature). In some embodiments, first curvature is based on a curvature of the first numeral of the representation of time. In some embodiments, second curvature is based on a curvature of the third numeral of the representation of time. In some embodiments, as the first numeral changes to the second numeral, the first curvature changes to a third curvature which is based on a curvature of the second numeral. In some embodiments, as the third numeral changes to the fourth numeral, the second curvature changes to a fourth curvature which is based on a curvature of the fourth numeral (e.g., as shown in FIGS. 12A-12D and/or 12Q). Displaying the user interface element with a first curvature and the second user interface element with a different curvature updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the user interface element includes (e.g., 1222, 1224, and/or a complication) first text in a first direction (e.g., text in an upward direction, text in a downward direction, text in a right direction, and/or text in a left direction), and the second user interface element (e.g., 1222, 1224, and/or a complication) includes second text in a second direction different from the first direction (e.g., text in an upward direction, text in a downward direction, text in a right direction, and/or text in a left direction). In some embodiments, the first text is based on a configuration of the first numeral (e.g., the boundaries of the numeral and/or the location of the numeral on the time user interface) of the representation of time. In some embodiments, the second text is based on a configuration (e.g., the boundaries of the numeral and/or the location of the numeral on the time user interface) of the third numeral of the representation of time. In some embodiments, as the first numeral changes to the second numeral, the first text changes to a third text in a third direction different from the first direction which is based on a configuration (e.g., the boundaries of the numeral and/or the location of the numeral on the time user interface) of the second numeral. In some embodiments, as the third numeral changes to the fourth numeral, the second text changes to a fourth text in a fourth direction which is based on a configuration (e.g., the boundaries of the numeral and/or the location of the numeral on the time user interface) of the fourth numeral (e.g., as shown in FIGS. 12A-12D and/or 120-12Q). Displaying the user interface element with a first text direction and the second user interface element with a different text direction updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the user interface element (e.g., 1222, 1224, and/or a complication) is displayed in a first portion (e.g., quadrant, segment, and/or corner) of the time user interface (e.g., 1210a) (e.g., an upper-left portion, an upper-right portion, a lower-left portion, or a lower-right portion), and the second user interface element (e.g., 1222, 1224, and/or a complication) is displayed in a second portion (e.g., quadrant, segment, and/or corner) of the time user interface diagonally opposite from the first portion of the time user interface (e.g., an upper-left portion, an upper-right portion, a lower-left portion, or a lower-right portion) (e.g., as shown in FIGS. 12A-12D). Displaying the second user interface element diagonally opposite from the user interface element improves visual feedback to the user.

In some embodiments, at a first time: the user interface element (e.g., 1222, 1224, and/or a complication) is positioned on a first side of the time user interface (e.g., 1210a) (e.g., an upper side, a left side, a right lower, and/or a lower side), and the second user interface element (e.g., 1222, 1224, and/or a complication) is positioned on a second side of the time user interface different from the first side of the time user interface (e.g., an upper side, a left side, a right lower, and/or a lower side); and at a second time: the user interface element (e.g., 1222, 1224, and/or a complication) is positioned on the second side of the time user interface (e.g., an upper side, a left side, a right lower, and/or a lower side), and the second user interface element (e.g., 1222, 1224, and/or a complication) is positioned on the first side of the time user interface (e.g., an upper side, a left side, a right lower, and/or a lower side). In some embodiments, the user interface element and the second user interface element are on opposite sides before changing position and are on opposite sides after changing position. In some embodiments, the user interface element and the second user interface element are on opposite sides before changing position and are on the same side after changing position. In some embodiments, the user interface element and the second user interface element are on the same side before changing position and are on opposite sides after changing position. In some embodiments, the user interface element and the second user interface element are on the same side before changing position and are on the same side after changing position. Displaying the user interface element on a first or second side of the time user interface and displaying the second user interface element on an opposite side from the first or second side of the time user interface updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the time user interface (e.g., 1210a) includes a first user interface element that includes first status information (e.g., 1222, 1224, and/or a first complication) and a second user interface element that includes second status information (e.g., 1222, 1224, and/or a second complication) that is different from the first status information; and displaying the time user interface includes: at a first time: displaying a respective portion of the representation of time (e.g., one or more numerals that represent a current time) with the first color, and displaying the first user interface element (e.g., 1222, 1224, and/or a complication) with the first color; displaying the second user interface element (e.g., 1222, 1224, and/or a complication) with the first color (e.g., the color of the user interface element and the second user interface element is the same at the first time); and at a second time different from the first time: displaying a respective portion of the representation of time (e.g., one or more numerals that represent a current time) with a combination of the first color and a second color that is different from the first color (the color of the representation of time optionally changes over time (e.g., as discussed with respect to FIGS. 12A-12C), and displaying the first user interface element (e.g., 1222, 1224, and/or a complication) with the first color; and displaying second user interface element (e.g., 1222, 1224, and/or a complication) with the second color (e.g., the color of the user interface element and the second user interface element is the same at the first time). In some embodiments, as time elapses, the first user interface element and the second user interface element change from having the same first color to having the same second color. In some embodiments, as time elapses, the first user interface element and the second user interface element change from having the same color to having different colors. In some embodiments, as time elapses, the first user interface element and the second user interface element change from having different colors to having the same color. In some embodiments, as time elapses, the first user interface element and the second user interface element change from having different first and second colors to having different third and fourth colors (e.g., at the same time, the first user interface element changes from green to blue and the second user interface element changes from yellow to orange). In some embodiments, the first user interface element changes color at a first time and the second user interface element changes color at a second time different from the first time (e.g., as shown in FIGS. 12B-12C). Displaying the user interface element and second user interface element having a first color at a first time and different colors at a second time updates the time user interface without requiring the user to provide inputs to manually edit the time user interface, improves visual feedback to the user, and prevents permanent discoloration (e.g., burn-in) on the display screen based on varying display patterns and/or colors.

In some embodiments, displaying the time user interface (e.g., 1210a) includes: in accordance with a determination that the user interface element (e.g., 1222, 1224, and/or a complication) is enabled (e.g., when the user interface elements are enabled by a user and/or based on a device state change): displaying, via the display generation component, the first numeral and the second numeral with a margin (e.g., 1238) relative to an edge of the time user interface (e.g., a margin relative to an edge of the time user interface, a margin relative to an edge of the display, and/or a margin relative to an outer edge of the first numeral and an outer edge of the second numeral); and displaying, via the display generation component, the user interface element (e.g., 1222, 1224, and/or a complication); and in accordance with a determination that the user interface element (e.g., 1222, 1224, and/or a complication) is no longer displayed (e.g., when the user interface elements are disabled by a user and/or based on a device state change): displaying, via the display generation component, the first numeral and the second numeral with the margin relative to the edge of the time user interface (e.g., as shown in FIG. 12M) (e.g., the margin is maintained along the edge of the time user interface and/or the margin is maintained on the outer edge of the first numeral and the outer edge of the second numeral). Displaying the first and second numeral within a margin when the user interface element is enabled or disabled improves visual feedback to the user.

In some embodiments, displaying the time user interface (e.g., 1210a) includes: in accordance with a determination that the user interface element (e.g., 1222, 1224, and/or a complication) is enabled (e.g., displayed), displaying, via the display generation component, the first numeral and the second numeral with a first margin relative to an edge of the time user interface; (e.g., the margin size is increased; e.g., the margin is moved towards the edge of the time user interface and/or the margin is moved away from a center of the time user interface; e.g., a margin relative to an edge of the time user interface, a margin relative to an edge of the display, and/or a margin relative to outer edge of the first numeral and an outer edge of the second numeral) and in accordance with a determination that the user interface element (e.g., 1222, 1224, and/or a complication) is no longer displayed (e.g., not displayed), displaying, via the display generation component, the first numeral and the second numeral with a second margin relative to the edge of the time user interface, wherein the second margin is smaller than the first margin (e.g., as shown in FIG. 12N) (e.g., the margin size is decreased; e.g., the margin is moved away from the edge of the time user interface and/or the margin is moved towards the center of the time user interface).

Displaying the first numeral and the second numeral within a margin when the user interface element is enabled and displaying the first and second numeral within a smaller margin when the user interface element is disabled updates the time user interface without requiring the user to provide inputs to manually edit the time user interface, improves visual feedback to the user, and prevents permanent discoloration (e.g., burn-in) on the display screen based on varying display patterns and/or colors.

In some embodiments, the user interface element (e.g., 1222, 1224, and/or a complication) includes content corresponding to a data source. In some embodiments, complications provide data obtained from an application. In some embodiments, a complication updates the displayed data in accordance with a determination that the data obtained from the application has been updated. In some embodiments, the complication updates the displayed data over time. In some embodiments, a complication includes an affordance that when selected (e.g., 1234) launches a corresponding application (e.g., 1236). In some embodiments, a complication includes an affordance that when selected causes the computer system to perform a corresponding task (e.g., as shown in FIGS. 12O-12Q). Displaying the user interface elements including content corresponding to a data source updates the time user interface without requiring the user to provide inputs to manually edit the time user interface and improves visual feedback to the user.

In some embodiments, the user interface element (e.g., 1222, 1224, and/or a complication) is updated over time as updated information from the data source (e.g., updated calendar information, updated weather information, updated message information, updated stock information, updated activity/workout information, and/or updated news information) is detected (e.g., as shown in FIG. 12I-12J). Displaying the user interface elements including updates over time based on updated information from the data source updates the time user interface without requiring the user to provide inputs to manually edit the time user interface and improves visual feedback to the user.

In some embodiments, the user interface element (e.g., 1222, 1224, and/or a complication) includes content corresponding to a type of information selected by a user for display in the time user interface (e.g., 1210a) (e.g., calendar information, weather information, message information, stock information, activity/workout information, and/or news information). Displaying the user interface elements including content selected by a user updates the time user interface without requiring the user to provide inputs to manually edit the time user interface and improves visual feedback to the user.

In some embodiments, the user interface element (e.g., 1222, 1224, and/or a complication) consists of text having a maximum threshold length of characters. In some embodiments, the text has a minimum threshold length of character (e.g., two characters, three characters, four characters, and/or five characters). Displaying the user interface elements including text having a predefined maximum threshold length of characters improves visual feedback to the user.

Note that details of the processes described above with respect to method 1300 (e.g., FIG. 13) are also applicable in an analogous manner to the methods described above and/or below. For example, methods 700, 900, 1100, 1500, and/or 1700 optionally include one or more of the characteristics of the various methods described above with reference to method 1300. For example, in some embodiments, the same computer system performs methods 700, 900, 1100, 1300, 1500, and/or 1700 and/or the various time user interfaces recited in methods 700, 900, 1100, 1300, 1500, and/or 1700 are implemented on the same computer system. For brevity, these details are not repeated below.

FIGS. 14A-14V illustrate techniques for displaying an indication of timer progress, in accordance with some embodiments. At FIG. 14A, computer system 1400 includes display 1402, which optionally includes a touch-sensitive surface (e.g., to form a touch display), rotatable input mechanism 1404, first button 1408 (e.g., a first physical button and/or a first mechanical button), and second button 1406 (e.g., a second physical button and/or a second mechanical button). In some embodiments, computer system 1400 is the same computer system as electronic devices 100, 300, and/or 500. In some embodiments, computer system 1400 includes some or all the features of electronic devices 100, 300, and/or 500. At FIG. 12A, computer system 1400 is displaying time user interface 1412 while computer system 1400 is not in a low-power mode. In some embodiments, computer system 1400 is a wearable device (e.g., a wrist-worn device and/or a headset), such as a smart watch, and time user interface 1412 is a watch face that includes the current time and, optionally, one or more complications that display information from applications running on computer system 1400. Time user interface 1412 includes an indication of the current time, including hour and minute indicators 1412A and seconds indicator 1410. Seconds indicator 1410 includes a path (e.g., around the perimeter of display 1402 and/or along an edge of display 1402) that represents 60 seconds (e.g., the full length of the path corresponds to 60 seconds). In FIG. 14A, computer system 600 displays seconds progress indicator 1410A advancing along (e.g., filling and/or moving along) the path of seconds indicator 1410 in a clockwise direction as time progresses. Seconds progress indicator 1410A advancing indicates the passage of time in seconds. Time user interface 1412 also includes visual object 1414 in the path of seconds indicator 1410. In some embodiments, visual object 1414 indicates the current day and/or date. In some embodiments, the visual object in the path of seconds indicator 1410 is a complication, a logo, text, and/or other information. In some embodiments, as seconds progress indicator 1410A advances and passes through the location of visual object 1414, the visual appearance (e.g., color, size, boldness, and/or height) of visual object 1414 changes.

At FIG. 14B, time has progressed as compared to FIG. 14A, as indicated by seconds progress indicator 1410A having advanced. Computer system 1400 detects a first type of input (e.g., tap input 1450A directed at time user interface 1412 (e.g., directed to hour and minute indicators 1412A and/or a different part of time user interface 1412), a double tap input directed at time user interface 1412, a touch input directed at time user interface 1412, and/or single press 1450B of first button 1408) and, in response, replaces display of time user interface 1412 with timer user interface 1426, including replacing seconds indicator 1410 with progression indicator 1420, as shown in FIG. 14C, without automatically starting the countdown timer. In some embodiments, in response to computer system 1400 detecting a type of input (e.g., a tap-and-hold input and/or a triple-tap input) that is different from the first type and directed at time user interface 1412, computer system 1400 displays a user interface that is different from timer user interface 1426, such as a user interface for selecting a time user interface (e.g., a watch face) that is different from time user interface 1412.

At FIG. 14C, computer system 1400 is displaying timer user interface 1426 while computer system 1400 optionally continues to detect single press 1450B of first button 1408. As shown in FIG. 14C, visual object 1414 is animated during the transition between time user interface 1412 and timer user interface 1426, such as changing in color, size, height, font, and/or boldness as shown by the visual changes in visual object 1414 in FIGS. 14B-14D, thereby indicating to the user that computer system 1400 has detected an input (e.g., the first type of input) at first button 1408. Timer user interface 1426 includes current time 1412B, countdown time 1426A (e.g., indicating minutes and seconds and/or numerically indicating a countdown duration), accept option 1426B, start option 1426C, and progression indicator 1420. In some embodiments, during the transition between time user interface 1412 and timer user interface 1426, hour and minute indicators 1412A transform into current time 1412B, such as by an animated reduction in size and movement towards the top of display 1402.

At FIG. 14C, progression indicator 1420 includes a path (e.g., around the perimeter of display 1402 and/or along an edge of display 1402) that corresponds to the initial countdown time (e.g., the current value of the initial countdown time 1426A). For example, at FIG. 14C, the full length of the path (e.g., one revolution around the perimeter of display 1402) of progression indicator 1420 corresponds to 5 minutes (e.g., the same as the initial countdown time, as shown in FIG. 14C). The path of progression indicator 1420 is divided into segments (e.g., 1420A-1420D), with each segment corresponding to one minute. The number of segments is based on the value of the initial countdown time 1426A (e.g., one segment for each minute and/or one segment for each minute and fraction of minute). The segments boundaries are indicated by time unit boundaries 1422A-1422E. While the timer is running, timer progress indicator 1430A advances along (e.g., emptying, vacating, filling, and/or moving along) the path of progression indicator 1420 and provides the user with feedback about how much time has passed.

At FIG. 14D, computer system 1400 has ceased detecting input 1450B and the animation of visual object 1414 has completed. In some embodiments, visual object 1414 has a different appearance at FIG. 14D as compared to FIG. 14B. In some embodiments, such as when seconds progress indicator 1410A completely overlaps visual object 1414 at FIG. 14B (e.g., when indicating 55 seconds or 59 seconds), visual object 1414 has the same appearance at FIGS. 14B and 14D, but has a different appearance at FIG. 14C, thereby indicating to the user at FIG. 14C that computer system 1400 has detected an input at first button 1408.

At FIG. 14E, computer system 600 detects an input (e.g., 1450C, 1450D, 1450E, and/or 1450F). In response to detecting the input and in accordance with a determination that the input (e.g., 1450C) is directed to start option 1426C, computer system 600 starts the countdown timer, as shown in FIG. 14G. In response to detecting the input and in accordance with a determination that the input (e.g., 1450F) is directed to a press (e.g., a single press or a press-and-hold) of first button 1408, computer system 600 starts the countdown timer, as shown in FIG. 14G. In response to detecting the input and in accordance with a determination that the input (e.g., 1450E) is directed to a rotation (e.g., clockwise or counterclockwise) of rotatable input mechanism 1404, computer system 600 changes (e.g., based on a direction and/or magnitude of input) the initial countdown time 1426A and optionally displays timer entry user interface 1434, as shown in FIG. 14Q. In some embodiments, rotation of rotatable input mechanism 1404 in a first direction (e.g., counterclockwise) decreases the initial countdown time 1426A, as shown in FIG. 14R. In some embodiments, rotation of rotatable input mechanism 1404 in a second direction (e.g., clockwise) increases the initial countdown time 1426A, as shown in FIG. 14S. In response to detecting the input and in accordance with a determination that the input (e.g., 1450D) is directed to the initial countdown time 1426A, computer system 600 displays timer entry user interface 1434, as shown in FIG. 14Q, for modifying the initial countdown time 1426A.

At FIG. 14F, computer system 1400 is displaying time user interface 1412 in the same or similar state as that in FIG. 14B. At FIG. 14F, computer system 1400 detects a second type of input (e.g., double-press 1450G) directed to first button 1408 and, in response, replaces display of time user interface 1412 with timer user interface 1426, including replacing seconds indicator 1410 with progression indicator 1420 and automatically starts the countdown timer without requiring additional user input, as shown in FIG. 14G. Thus, while displaying time user interface 1412, computer system 1400 receives an input and, in accordance with a determination that the input is a first type of input (e.g., 1450A and/or 1450B), displays timer user interface 1426 without starting the countdown timer (e.g., to allow for modification of the initial countdown time) and in accordance with a determination that the input is a second type of input (e.g., 1450G) displays timer user interface 1426 and starts the countdown timer (e.g., to allow for quick starting of the countdown).

At FIG. 14G, computer system 1400 has started the countdown timer (e.g., in response to detecting input 1450C, 1450F, and/or 1450G). In conjunction with starting the countdown timer, computer system 1400 outputs one or more non-visual outputs to indicate that the countdown has started, such as tactile output 1460A and/or audio output 1460B. At FIG. 14G, because the countdown timer has started, timer progress indicator 1430A advances along (e.g., emptying, vacating, and/or moving along) the path of progression indicator 1420. As shown in FIG. 14F, in some embodiments, timer progress indicator 1430A starts at first time unit boundary 1422A and advances along the path of progression indicator 1420 in a counterclockwise direction at a rate the corresponds to one segment (e.g., 1420A-1420D) per minute. In some embodiments, as the countdown timer reaches each minute and/or as timer progress indicator 1430A reaches and/or crosses each time unit boundary 1422B-1422E, computer system 1400 outputs one or more non-visual outputs (e.g., tactile output and/or audio output) to indicate that the countdown timer has reached a time boundary. As shown in FIG. 14G, timer progress indicator 1430A indicates (e.g., based on a location of timer progress indicator 1430A along the path) how much time has elapsed since the countdown timer started and how much time is remaining in the countdown timer. As shown in FIG. 14G, countdown time 1426A indicates (e.g., textually and/or numerically) how much time is remaining in the countdown timer. Current time 1412B has shifted towards the bottom of display 142 while the countdown timer advances.

At FIG. 14H, time has progressed (e.g., as indicated by current time 1412B) and the countdown timer has advanced, as indicated by countdown time 1426A and timer progress indicator 1430A (e.g., advancing in the counterclockwise direction). As timer progress indicator 1430A advances in the counterclockwise direction along the path of progression indicator 1420 and passes through the location of visual object 1414, one or more visual characteristics (e.g., color, font, height, and/or boldness) of visual object 1414 changes based on the location of timer progress indicator 1430A, as shown in FIG. 14H. At FIG. 14H, computer system 1400 detects an input (e.g., 1450H). In response to detecting the input and in accordance with a determination that the input (e.g., 1450H) is directed at (e.g., the first type of input, the second type of input, a single press, and/or a double-press) first button 1408, computer system 1400 updates the countdown timer to synchronize to a respective minute boundary and continues counting down. In some embodiments, synchronizing to a respective minute boundary includes synchronizing the countdown timer down to the next minute boundary (e.g., changing the remaining time on the countdown timer from 3:40 to 3:00). In some embodiments, synchronizing to a respective minute boundary includes synchronizing the countdown timer to the nearest minute boundary (e.g., changing the remaining time on the countdown timer from 3:40 to 4:00 because 3:40 is closer to 4:00 than it is to 3:00). Updating the countdown timer to synchronize to a respective minute boundary includes updating countdown time 1426A and timer progress indicator 1430A to reflect the updated remaining time. In some embodiments, in response to detecting the input and in accordance with a determination that the input (e.g., 1450I) is directed at (e.g., tap input, tap-and-hold input, and/or touch input) option 1426D, computer system 1400 pauses the countdown timer (e.g., including ceasing updating countdown time 1426A and timer progress indicator 1430A). In some embodiments, activation of first button 1408 while the countdown timer is paused restarts the countdown timer (e.g., and updating of countdown time 1426A and timer progress indicator 1430A). In some embodiments, activation of option 1426D while the countdown timer is paused restarts the countdown timer. In some embodiments, in response to detecting the input and in accordance with a determination that the input (e.g., 1450I) is directed at (e.g., tap input, tap-and-hold input, and/or touch input) option 1426D, computer system 1400 stops the countdown timer and, optionally, displays timer user interface 1426 with the initial countdown time, as shown in FIG. 14D.

At FIG. 14I, time has progressed (e.g., as indicated by current time 1412B) and the countdown timer has advanced, as indicated by countdown time 1426A and timer progress indicator 1430A (e.g., advancing in the counterclockwise direction). As timer progress indicator 1430A advances in the counterclockwise direction along the path of progression indicator 1420 and passes through the location of visual object 1414, one or more visual characteristics (e.g., color, font, height, and/or boldness) of visual object 1414 changes based on the location of timer progress indicator 1430A, as shown in FIG. 14I. At FIG. 14I, computer system 1400 detects an input (e.g., 1450J and/or 1450K). In response to detecting the input and in accordance with a determination that the input (e.g., 1450J without 1450K) is directed at (e.g., the first type of input, the second type of input, a single press, and/or a double-press) first button 1408 (e.g., only first button 1408 is pressed), computer system 1400 updates the countdown timer to synchronize to a respective minute boundary and to continue counting down. In some embodiments, synchronizing to a respective minute boundary includes synchronizing the countdown timer down to the next minute boundary (e.g., changing the remaining time on the countdown timer from 3:20 to 3:00). In some embodiments, synchronizing to a respective minute boundary includes synchronizing the countdown timer to the nearest minute boundary (e.g., changing the remaining time on the countdown timer from 3:20 to 3:00 because 3:20 is closer to 3:00 than it is to 4:00). Updating the countdown timer to synchronize to a respective minute boundary includes updating countdown time 1426A and timer progress indicator 1430A to reflect the updated remaining time. In some embodiments, in response to detecting the input and in accordance with a determination that the input (e.g., 1450J and 1450K) is directed at (e.g., tap input, tap-and-hold input, and/or touch input) first button 1408 and second button 1406 (e.g., both buttons are concurrently pressed), computer system 1400 resets the countdown timer and displays timer user interface 1426 with the initial countdown time, as shown in FIG. 14D.

At FIG. 14J, time has progressed (e.g., as indicated by current time 1412B) and the countdown timer has advanced, as indicated by countdown time 1426A and timer progress indicator 1430A (e.g., advancing in the counterclockwise direction). In some embodiments, as the countdown timer reaches one minute left and/or timer progress indicator 1430A reaches and/or crosses time unit boundary 1422E, computer system 1400 outputs one or more non-visual outputs (e.g., tactile output 1460C and/or audio output 1460D) to indicate that the countdown timer has reached one minute remaining, thereby providing the user with feedback that the countdown timer is nearing the end of the countdown time. In some embodiments, as the countdown timer reaches one minute left and/or timer progress indicator 1430A reaches and/or crosses time unit boundary 1422E, computer system 1400 updates one or more visual characteristics of time user interface 1426, such as by changing a color of timer progress indicator 1430A and/or countdown time 1426A, as shown in FIG. 14J, thereby providing the user with visual feedback that the countdown timer is nearing the end of the countdown time.

At FIG. 14K, time has progressed (e.g., as indicated by current time 1412B) and the countdown timer has advanced, as indicated by countdown time 1426A and timer progress indicator 1430A (e.g., advancing in the counterclockwise direction). In some embodiments, once the countdown timer has reached one minute left and/or timer progress indicator 1430A reaches and/or crosses time unit boundary 1422E, computer system 1400 outputs one or more non-visual outputs (e.g., tactile output 1460E and/or audio output 1460F) at a respective interval (e.g., every 10 seconds and/or every 15 seconds) to indicate how much time is remaining, thereby providing the user with feedback that the countdown timer is nearing the end of the countdown time.

At FIG. 14L, time has progressed (e.g., as indicated by current time 1412B) and the countdown timer has advanced, as indicated by countdown time 1426A (e.g., reaching the end of the countdown timer at 00:00) and timer progress indicator 1430A (e.g., advancing in the counterclockwise direction to reach time unit boundary 1422A). In some embodiments, once the countdown timer has reached the end of the countdown (e.g., 00:00 time remaining), computer system 1400 outputs one or more non-visual outputs (e.g., tactile output 1460F and/or audio output 1460H) to indicate that there is no time remaining on the countdown timer. In some embodiments, computer system 1600 outputs audio output 1460H using a speaker mode that is different from speaker modes used for music playback (e.g., so that audio output 1460H is louder and/or can be heard more easily). After the countdown timer has reached the end of the countdown (e.g., 00:00 time remaining), computer system 1400 automatically begins a count-up timer, as shown in FIG. 14M.

At FIG. 14M, time has progressed (e.g., as indicated by current time 1412B) and the count-up timer has advanced, as indicated by count-up time 1428A (e.g., indicating 15 seconds and 5 milliseconds have elapsed) and timer progress indicator 1430A (e.g., advancing in the clockwise direction). In some embodiments, count-up time 1428A has a higher resolution of time (e.g., has higher precision) than countdown time 1426A. Count-up time 1428A and timer progress indicator 1430A indicate how much time have elapsed since the end of the countdown timer was reached (e.g., the countdown timer expired). At FIG. 14M, the full length of the path (e.g., one revolution around the perimeter of display 1402) of progression indicator 1420 has changed and now corresponds to one minute. While counting up, the path of progression indicator 1420 is not divided into segments. While the timer is running, timer progress indicator 1430A advances along (e.g., filling and/or moving along) the path of progression indicator 1420. At FIG. 14M, computer system 1400 detects an input (e.g., activation 1450L of second button 1406 and/or activation 1450M of first button 1408) and, in response, computer system 1400 pauses the count-up timer, as shown in FIG. 14N.

At FIG. 14N, time has progressed (e.g., as indicated by current time 1412B) and the count-up timer has not advanced (e.g., because the count-up timer is paused), as indicated by count-up time 1428A (e.g., continuing to indicate 15 seconds and 5 milliseconds have elapsed) and timer progress indicator 1430A (e.g., not advancing in the clockwise direction). At FIG. 14N, computer system 1400 displays indication 1428B that the count-up timer is paused, along with option 1426C to resume the count-up timer and end option 1426D to end the count-up timer and return to the user interface of FIG. 14D. At FIG. 14N, while the count-up timer is paused, computer system 1400 detects an input (e.g., activation 1450O of second button 1406, activation 1450P of first button 1408, and/or activation 1450N (e.g., tap input and/or touch input) of option 1426C) and, in response, computer system 1400 resumes the count-up timer (e.g., computer system 1400 detects concurrent press on buttons 1406 and 1408 and, in response, resumes the count-up timer).

At FIG. 14O, time has progressed (e.g., as indicated by current time 1412B) and the count-up timer has advanced, as indicated by count-up time 1428A (e.g., indicating 50 seconds and 1 millisecond have elapsed while the count-up timer has been running) and timer progress indicator 1430A (e.g., advancing in the clockwise direction). As timer progress indicator 1430A advances in the clockwise direction along the path of progression indicator 1420 and passes through the location of visual object 1414, one or more visual characteristics (e.g., color, font, height, and/or boldness) of visual object 1414 changes based on the location of timer progress indicator 1430A, as shown in FIG. 14O.

At FIG. 14P, time has progressed (e.g., as indicated by current time 1412B) and the count-up timer has advanced, as indicated by count-up time 1428A (e.g., indicating 1 minute, 45 seconds, and 10 milliseconds have elapsed while the count-up timer has been running) and timer progress indicator 1430A (e.g., advancing in the clockwise direction). At FIG. 14P, timer progress indicator 1430A has completed a full revolution of the path of progression indicator 1420 (e.g., reached/passed through time unit boundary 1422A) and continues advancing in the clockwise direction to indicate the number of seconds (e.g., not the number of minutes) that has elapsed while the count-up timer has been running.

At FIG. 14Q, computer system 1600 displays time entry user interface 1434 for receiving user input to select a duration of time. In some embodiments, time entry user interface 1434 is displayed in response to computer system 1600 detecting a rotation (e.g., 1450E, clockwise or counterclockwise) of rotatable input mechanism 1404, such as at FIG. 14E. In some embodiments, time entry user interface 1434 is displayed in response to computer system 1600 detecting input (e.g., 1450D) directed to the initial countdown time 1426A, such as at FIG. 14E. At FIG. 14Q, computer system 1600 detects an input (e.g., 1450Q, 1450R, and/or 1450Q). In response to detecting the input and in accordance with a determination that the input (e.g., 1450Q) is directed to minutes unit 1434B, computer system 1600 modifies the minutes for the countdown timer based on the magnitude (e.g., direction and/or distance) of the input. In response to detecting the input and in accordance with a determination that the input (e.g., 1450R) is directed to seconds unit 1434C, computer system 1600 modifies the seconds for the countdown timer based on the magnitude (e.g., direction and/or distance) of the input. In response to detecting the input and in accordance with a determination that the input (e.g., 1450S) is directed to hours unit 1434A, computer system 1600 modifies the hours for the countdown timer based on the magnitude (e.g., direction and/or distance) of the input. In some embodiments, computer system 1600 detects activation of option 1434D and/or option 1434E and, in response, returns to displaying timer user interface 1426 based on the newly selected initial time value, such as 4 minutes in FIG. 14R, 5 minutes in FIG. 14D, or 6 minutes in FIG. 14S.

At FIGS. 14R and 14S, the path of progression indicator 1420 is divided into segments (e.g., 1420A-1420E), with each segment corresponding to one minute. The number of segments is based on the value of the initial countdown time 1426A (e.g., one segment for each minute and/or one segment for each minute or fraction of minute). The segments boundaries are indicated by time unit boundaries 1422A-1422F. At FIG. 14R, the path of progression indicator 1420 is divided into 4 segments to correspond to the 4 minutes for the countdown timer. At FIG. 14S, the path of progression indicator 1420 is divided into 6 segments to correspond to the 6 minutes for the countdown timer.

At FIG. 14T, computer system 1600 has received one or more inputs to change a style of time user interface 1412 (e.g., to include lines), and in response, computer system 1600 updates the style of timer user interface 1426 to correspond to the style of time user interface 1412, as shown in FIG. 14U. Accordingly, computer system 1600 can coordinate the styles of the two user interfaces while reducing the number of inputs required to do so.

At FIG. 14V, computer system 1600 detects that a set of one or more low power criteria are met and, in response, transitions to a low power state. In some embodiments, in the low power state display 1402 is dimmed, time user interface 1462 is displayed with a lower frequency of update and/or without displaying seconds progress indicator 1410A (e.g., or any indication of seconds), and/or two or more numerals of hour and minute indicators 1412A are linked (e.g., linking two hour numerals, such as the 0 and 2, and linking two minute numerals, such the 6 and 8).

FIG. 15 is a flow diagram illustrating methods for displaying an indication of timer progress using a computer system, in accordance with some embodiments. Method 1500 is performed at a computer system (e.g., 100, 300, 500, and/or 1400) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 1402) (e.g., one or more display controllers, displays, touch-sensitive display systems, touchscreens, monitors, and/or a head mounted display system) and with one or more one or more input devices (e.g., 1404, 1406, and/or 1408) (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1500 are, optionally, combined, the orders of some operations are, optionally, changed, and some operations are, optionally, omitted.

As described below, method 1500 provides an intuitive way for displaying an indication of timer progress. The method reduces the cognitive burden on a user for tracking the passage of time, thereby creating a more efficient human-machine interface. For battery-operated computing devices, enabling a user to track the passage of time faster, more accurately, and more efficiently conserves power and increases the time between battery charges.

The computer system (e.g., 1400) displays (1502), via the one or more display generation components, a time user interface (e.g., 1412) (e.g., a user interface that includes an analog and/or digital indication of time, a clock face user interface, a watch face user interface, a reduced-power screen, a wake screen, and/or a lock screen).

While displaying the time user interface (e.g., 1412) with a seconds indicator (e.g., 1410 and/or 1410A) (e.g., a seconds hand and/or seconds numerals), the computer system (e.g., 1400) detects (1504), via the one or more input devices, a request (e.g., 1450A, 1450B, and/or 1450G) to initiate (e.g., display and/or start) a timer.

In response to detecting the request (e.g., 1450A, 1450B, and/or 1450G) to initiate the timer, the computer system (e.g., 1400) replaces (1506), via the one or more display generation components (e.g., 1402), the seconds indicator (e.g., 1410 and/or 1410A) of the time user interface (e.g., 1412) with an indication of timer progress (e.g., 1420 and/or 1430A) (e.g., a stationary indication of timer progress that does not automatically start progressing and/or advancing or a dynamic indication of timer progress that automatically starts progressing and/or advancing). In some embodiments, in response to detecting the request to initiate the timer, the computer system maintains display of an hours indicator and a minutes indicator (e.g., continues to display the current time in hours and minutes) without displaying an indication of seconds of the current time. In some embodiments, before detecting the request to initiate the timer, the computer system displays an hours indicator, a minutes indicator, and a seconds indicator, and after (e.g., in response to detecting) the request to initiate the timer the computer system displays an hours indicator and a minutes indicator without displaying any seconds indicator of the current time. Replacing the seconds indicator with an indication of timer progress provides the user with visual feedback that the timer has been activated, thereby providing improved visual feedback. Further, the replacement optionally helps to avoid user confusion by avoiding having two indicators (one for the timer and one for the seconds) following respective paths at the same time, thereby improving the man-machine interface.

In some embodiments, detecting the request to initiate (e.g., display and/or start) the timer includes detecting activation (e.g., 1450B and/or 1450G) of a hardware button (e.g., 1408) (e.g., a mechanical button, a depressible button, and/or a capacitive button). In some embodiments, the hardware button is separate from a display of the computer system. In some embodiments, the computer system determines whether the request to initiate the timer is based on activation of the hardware button and/or based on a touch input detected via a touch-sensitive surface and, optionally, performs varying operations in response. Initiating the timer in response to detecting activation of a hardware button enables the computer system to provide the user with visual feedback that the activation of the hardware button was detected. Initiating the timer in response to detecting activation of the hardware button also enables the computer system to activate the timer in response to a user input regardless of the user interface currently being displayed on a display of the computer system, thereby improving the man-machine interface.

In some embodiments, in response to detecting the request to initiate the timer and in accordance with a determination that the activation of the hardware button is a first type of activation (e.g., 1450B) of the hardware button (e.g., 1408) (e.g., a single press of the button (e.g., a press-and-release and/or a press-and-hold, and not a double-press)), the computer system (e.g., 1400) operates in a first timer mode (e.g., an edit mode and/or a mode in which the timer is not running) during which the indication of timer progress is not advancing (e.g., the indication of timer progress is stationary and/or the indication of timer progress is static) (e.g., as in FIG. 14C). In some embodiments, while operating in the first timer mode, the computer system is configured to detect user inputs to modify settings of the timer (e.g., change a duration of the timer and/or change one or more visual characteristics of the indication of timer progress). In some embodiments, while operating in the first timer mode, the computer system detects a first input (e.g., rotation via a rotatable input mechanism of the computer system, rotation via a crown of the computer system, and/or touch input via a touch-sensitive surface of the computer system) and, in response to detecting the first input, the computer system modifies one or more settings (e.g., a duration of the timer) of the timer (e.g., based on a type of the first input and/or a magnitude (e.g., a distance, a speed, and/or a duration) of the first input). Operating in the first timer mode when the first type of activation of the hardware button is detected provides the user with feedback that the first type of activation was detected and enables the computer system to display the timer in the first timer mode regardless of what content is currently displayed on the display of the computer system, thereby improving the man-machine interface.

In some embodiments, in response to detecting the request to initiate the timer and in accordance with a determination that the activation of the hardware button is a second type of activation (e.g., 1450G) of the hardware button (e.g., 1408) (e.g., a double press of the button (e.g., a double-press-and-release and/or a double-press-and-hold, and not a single press)) (e.g., different from the first type of activation), the computer system (e.g., 1400) operates in a second timer mode (e.g., a mode in which the timer is running) during which the indication of timer progress is advancing (e.g., the indication of timer progress moves and/or the indication of timer progress varies over time) (e.g., as in FIG. 14G). Operating in the second timer mode when the second type of activation of the hardware button is detected provides the user with feedback that the second type of activation was detected and enables the computer system to display the timer in the second timer mode regardless of what content is currently displayed on the display of the computer system, thereby improving the man-machine interface.

In some embodiments, in response to detecting the request (e.g., 1450A, 1450B, and/or 1450G) to initiate the timer, the computer system (e.g., 1400) displays, via the one or more display generation components (e.g., 1402), an animation of a user interface element (e.g., 1414) (e.g., a logo and/or character (e.g., with arms and/or legs)) that is included in the time user interface (e.g., 1412) (e.g., as in FIGS. 14B-14D). In some embodiments, the user interface element is being display, but is not animated, when the request to initiate the timer is detected. In some embodiments, the user interface element is not being displayed when the request to initiate the timer is detected. Animating a user interface element of the time user interface in response to detecting the request to initiate the timer provides the user with visual feedback about the state of the computer system and, in particular, that the request to initiate the timer was detected and that the timer is being activated, thereby providing improved visual feedback.

In some embodiments, while displaying the indication of timer progress (e.g., 1420 and/or 1430A) and while the timer progress is not at a minute boundary, the computer system (e.g., 1400) detects, via the one or more input devices (e.g., 1408), a second activation (e.g., 1450H and/or 1450J) of (e.g., a single press and/or a double press) the hardware button (e.g., 1408) (e.g., a mechanical button, a depressible button, and/or a capacitive button). In response to detecting the second activation of the hardware button (e.g., 1408), the computer system (e.g., 1400) updates the indication of timer progress (e.g., 1420 and/or 1430A) by advancing the indication of timer progress (e.g., 1420 and/or 1430A) to a respective (e.g., next or previous) minute boundary (e.g., as described with respect to FIGS. 14H and 14I). In some embodiments, updating the indication of progress by advancing the indication of timer progress to a respective minute boundary includes advancing the advancing the indication of timer progress down to a minute boundary (e.g., reducing the amount of time until the timer is complete and/or when the timer indicates 4 minutes and 43 seconds when the second activation is detected, the timer will advance to indicate 4 minutes and 0 seconds and when the timer indicates 4 minutes and 3 seconds when the second activation is detected, the timer will advance to indicate 4 minutes and 0 seconds when the second activation is detected). In some embodiments, updating the indication of progress by advancing the indication of timer progress to a respective minute boundary includes advancing the advancing the indication of timer progress up to a minute boundary (e.g., increasing the amount of time until the timer is complete and/or when the timer indicates 4 minutes and 43 seconds when the second activation is detected, the timer will advance to indicate 5 minutes and 0 seconds and when the timer indicates 4 minutes and 3 seconds when the second activation is detected, the timer will advance to indicate 5 minutes and 0 seconds when the second activation is detected). In some embodiments, updating the indication of progress by advancing the indication of timer progress to a respective minute boundary includes advancing the advancing the indication of timer progress to a nearest minute boundary (e.g., when the timer indicates 4 minutes and 43 seconds when the second activation is detected, the timer will advance to indicate 5 minutes and 0 seconds and when the timer indicates 4 minutes and 3 seconds when the second activation is detected, the timer will advance to indicate 4 minutes and 0 seconds when the second activation is detected). Updating the timer to progress to respective minute when the second activation of the hardware button is detected enables the computer system to allow quickly synchronizing the timer with an external event (e.g., an announcement of time remaining at a race such as a regatta), thereby reducing the number of inputs required to perform the operation and improving the accuracy of the manual synchronization (as compared to requiring multiple user inputs).

In some embodiments, while displaying the indication of timer progress (e.g., 1420 and/or 1430A), the computer system (e.g., 1400) detects, via the one or more input devices, concurrent activation of (e.g., a single press and/or a double press) the hardware button (e.g., 1408) (e.g., a mechanical button, a depressible button, and/or a capacitive button) and a second hardware button (e.g., 1406) (e.g., a mechanical button, a depressible button, and/or a capacitive button) that is different from the hardware button (e.g., as in FIG. 14I). In response to detecting the concurrent activation of the hardware button (e.g., 1408) and the second hardware button (e.g., 1406), the computer system (e.g., 1400) performs an operation (e.g., a timer operation, a system operation, and/or a non-timer operation) that is different from updating the indication of timer progress by advancing the indication of timer progress to a respective minute boundary. In some embodiments, performing the operation that is different from updating the indication of timer progress includes: resetting the indication of timer progress, changing an operational state of advancement of the indication of timer progress, pausing tracking of an active workout session, and/or restarting the computer system. Performing a different operation when the hardware button is activated along with a second hardware button enables the computer system to provide the user with quick access to the different operation, thereby reducing the number of inputs required to perform the different operation and improving the man-machine interface.

In some embodiments, performing the operation includes resetting the indication of timer progress (e.g., 1420 and/or 1430A) to a respective setting (e.g., as shown in FIG. 14D) (e.g., resetting the indication of timer progress to zero for a count up timer or resetting the indication of timer progress to a starting value for a count down timer). In some embodiments, performing the operation includes resetting the timer (e.g., to a preset value and/or to an initial value) and updating the indication of timer progress to reflect that the timer has been reset. Resetting the timer when the hardware button is activated along with a second hardware button enables the computer system to provide the user with quick access to the reset operation, thereby reducing the number of inputs required to perform the reset operation and improving the man-machine interface.

In some embodiments, performing the operation includes changing an operational state of advancement of the indication of timer progress (e.g., 1420 and/or 1430A) (e.g., pausing and/or resuming the timer). In some embodiments, performing the operation includes pausing the timer, which causes the indication of timer progress to stop advancing. In some embodiments, performing the operation includes resuming the timer, which causes the indication of timer progress to start advancing. In some embodiments, performing the operation includes: in accordance with a determination that the indication of timer progress is advancing (e.g., the count up timer is running and/or the count down timer is running), stopping the time, pausing the timer, and/or ceasing advancing the indication of timer progress; and in accordance with a determination that the indication of timer progress is not advancing (e.g., the count up timer is not running and/or the count down timer is not running), starting the timer, restarting the timer, and/or starting/restarting advancing the indication of timer progress. Pausing and/or resuming the timer when the hardware button is activated along with a second hardware button enables the computer system to provide the user with quick access to the pause/resume operations, thereby reducing the number of inputs required to perform the operations, increasing the accuracy of the user's ability to synchronize the timer with external events, and improving the man-machine interface.

In some embodiments, detecting the request to initiate (e.g., display and/or start) the timer includes detecting a first set of one or more touch inputs (e.g., 1450A) that are detected by a touch-sensitive surface (e.g., a touchscreen and/or a trackpad). In some embodiments, the touch-sensitive surface and a display of the computer system form a touchscreen. In some embodiments, the computer system determines whether the request to initiate the timer is based on touch inputs detected via a touch-sensitive surface and/or based on activation of the hardware button and, optionally, performs varying operations in response. In some embodiments, the computer system detects activation of the hardware button to display the indication of timer progress (e.g., that does not automatically progress) and (while displaying the indication of timer progress) the computer system detects a set of one or more touch inputs to cause the indication of timer progress to progress over time. Initiating the timer in response to detecting touch inputs enables the computer system to provide the user with visual feedback that the touch inputs were detected, thereby providing improved visual feedback.

In some embodiments, while displaying the indication of timer progress (e.g., 1420 and/or 1430A), the computer system (e.g., 1400) detects, via a touch-sensitive surface of the one or more input devices, a second set of one or more touch inputs (e.g., 1450I, 1450C, 1450N). In response to detecting the second set of one or more touch inputs, the computer system (e.g., 1400) stops (ending the timer and/or pausing the timer) and/or resumes the timer. Stopping/resuming the timer based on touch inputs provides the user with visual feedback that the touch inputs were detected, thereby providing improved visual feedback. Detecting touch inputs to stop/resume the timer also enables the computer system to provide the user with a graphical user interface for interacting with the timer, thereby improving the man-machine inter user interface.

In some embodiments, in response to detecting the request to initiate the timer, the computer system (e.g., 1400) advances the indication of timer progress (e.g., 1430A) to indicate counting down from an initial time value (e.g., 4 minutes, 5 minutes, and/or 1 hour) towards a first time value (e.g., to 0 seconds, 1 minute, and/or 3 minutes) (e.g., as in FIGS. 14G-14L). In response to the indication of timer progress (e.g., 1420 and/or 1430A) reaching the first time value (e.g., as in FIG. 14L), the computer system (e.g., 1400) advances the indication of timer progress (e.g., 1420 and/or 1430A) to indicate counting up from a second time value (e.g., as in FIGS. 14M and/or 140-14P). In some embodiments, the first time value is the same as the second time value. In some embodiments, the first time value is different from the second time value. In some embodiments, the timer counts down from the initial time value until no timing is remaining (0 minutes and 0 seconds) and then automatically starts counting up (e.g., the same as or similar to a stopwatch). In some embodiments, the computer system receives user input (e.g., prior to detecting the request to initiate the timer) to modify and/or set the initial time value. Counting down until a first time value is reached and then automatically counting up provides the user with visual feedback about how much time is left until the first time value (e.g., how much of a 5-minute timer is remaining) and also how much time has elapsed after the timer expired (e.g., how much time has passed since the 5-minute timer has elapsed), thereby providing improved visual feedback and reducing the number of inputs required (as compared to requiring manual input to start the count-up timer after expiration of the count-down timer).

In some embodiments, a direction of movement of the indication of timer progress changes (e.g., 1430A) (e.g., from counterclockwise to clockwise and/or from right to left) when the indication of timer progress (e.g., 1430A) reaches the first time value (e.g., as in FIG. 14L). In some embodiments, while advancing the indication of timer progress down from the initial time value, the indication of timer progress moves in a first direction (e.g., counterclockwise and/or to the right) and while advancing the indication of timer progress up from the second time value, the indication of timer progress moves in a second direction (e.g., clockwise and/or to the left) that is different from (e.g., opposite of and/or orthogonal to) the first direction. In some embodiments, a speed of the indication of timer progress also changes (e.g., increases or decreases) when the indication of timer progress reaches the first time value. Changing a direction of the indication of timer progress when the first time value is reached provides the user with a visual indication that the first time value has been reached (e.g., any time the user looks at the indication of timer progress, the user can know if the timer is counting down or up based on (or, optionally based only on) the direction of the indication of timer progress), thereby providing improved visual feedback.

In some embodiments, a path along which the indication of timer progress progresses corresponds to: a first duration (e.g., 5 minutes, 8 minutes, or 1 hour) while the indication of timer progress (e.g., 1430A) counts down to the first time value (e.g., the indication of timer progress progresses at a first speed along the path) (e.g., as in FIGS. 14D, 14R, and/or 14S); and a second duration (e.g., 30 seconds, 1 minute, or 3 minutes), that is different from the first duration, while the indication of timer progress (e.g., 1430A) counts up from the second time value (e.g., the indication of timer progress progresses at a second speed, different from the first speed, along the path) (e.g., as in FIG. 14M). Changing the duration indicated by the path of the indication of timer progress progresses enables the computer system to show different events (counting down and counting up) with different visual fidelities, thereby improving the man-machine interface. For example, counting down is for a finite amount of time while counting up can go on indefinitely or for an extended period of time, making use of the same time scale for the two different events difficult for user consumption.

In some embodiments, in accordance with a determination that a first set of conditions is met, the computer system (e.g., 1400) displays, via the one or more display generation components (e.g., 1402) and concurrently with the indication of timer progress (e.g., 1420 and/or 1430A), a plurality of regions (e.g., 1420A-1420E) that correspond to (e.g., indicate) respective time unit boundaries (e.g., 30-second boundaries, minute boundaries, and/or hour boundaries), wherein the indication of timer progress (e.g., 1430A) advances relative to (e.g., along, over, and/or next to) the plurality of regions (e.g., 1420A-1420E). In some embodiments, the first of conditions includes a first threshold condition that is met when the initial time value is less than a respective value (e.g., less than 8 minutes, less than 15 minutes, or less than 5 hours). Displaying regions to show time boundaries (e.g., minute boundaries) provides the user with visual feedback about how much time has elapsed (as the indication of timer progress passes by the time boundaries), thereby providing the user with improved visual feedback.

In some embodiments, in accordance with a determination that the first set of conditions is not met, wherein the first set of conditions includes a condition that is met when the initial time value (e.g., 1426A) of the timer is more than a respective value, the computer system (e.g., 1400) forgoes concurrently displaying, with the indication of timer progress (e.g., 1430A), the plurality of regions (e.g., 1420A-1420E) that correspond to the respective time unit boundaries. Not displaying the time boundaries when the initial time value is greater than the respective value enables the computer system to not clutter the user interface when many boundaries would need to be displayed that would not be helpful for the user's ability to track time, thereby improving the man-machine interface.

In some embodiments, the computer system (e.g., 1400) detects, via the one or more input devices (e.g., 1402 and/or 1404) (e.g., voice input via a microphone, touch input via a touch-sensitive surface, and/or rotational input via a rotatable input mechanism), user input (e.g., 1450E and/or 1450Q-1450S) corresponding to a time value (e.g., 1 minutes, 3 minutes, 5 minutes, and/or 2 hours) for the initial time value (e.g., 1426A) of the timer. In response to receiving the user input (e.g., 1450E and/or 1450Q-1450S) corresponding to the time value, the computer system (e.g., 1400) sets the initial time value (e.g., 1426A) of the timer to the time value (e.g., as in FIGS. 14R and 14S). In some embodiments, the user input corresponding to the initial time value is received prior to detecting the request to initiate the timer (e.g., the user sets a default value). In some embodiments, the user input corresponding to the initial time value is received after detecting the request to initiate the timer (e.g., the user sets the initial time value for the current use of the timer). Receiving user input to set the initial time value enables the computer system to track the duration that the user is interested in, thereby improving the utility of the timer and improving the man-machine interface.

In some embodiments, while displaying, via the one or more display generation components (e.g., 1402), the indication of timer progress (e.g., 1430A) with a first value (e.g., green, blue, and/or orange) for a visual parameter of indication of timer progress (e.g., color, fill pattern, brightness, or other variable visual parameter) (e.g., as in FIG. 14I), the computer system (e.g., 1400) detects that the indication of timer progress has reached a third time value (e.g., 1 minute, 2 minutes, and/or 1 hour) (e.g., while counting down to indicate limited time remaining and/or while counting up to indicate that a duration of time has elapsed) (e.g., as in FIG. 14J). In response to detecting that the indication of timer progress (e.g., 1430A) has reached the third time value, the computer system update, via the one or more display generation components (e.g., 1402), display of the indication of timer progress (e.g., 1430A) from the first value for the visual parameter to a second value (e.g., yellow, red, and/or purple) for the visual parameter (e.g., as in FIG. 14J) that is different from the first value for the visual parameter. Changing a value of the visual parameter (e.g., color, fill pattern, brightness, or other variable visual parameter) of the indication of timer progress when the timer reaches the third time value provides the user with visual feedback that the third time value has been reached (e.g., the user can know based on (e.g., based just on) the visual parameter (e.g., color, fill pattern, brightness, or other variable visual parameter) of the indication of timer progress whether the third time value has been reached), thereby providing the user with improved visual feedback.

In some embodiments, the request (e.g., 1450A, 1450B, and/or 1450G) to initiate the timer is detected while the computer system displays a current time indicator (e.g., of the hour and/or minute of the current time) at a first size (e.g., 1412A) (e.g., as part of the time user interface) concurrently with the seconds indicator (e.g., 1410 and/or 1410A) and wherein the current time indicator is different from the seconds indicator. In response to detecting the request (e.g., 1450A, 1450B, and/or 1450G) to initiate the timer, the computer system (e.g., 1400) changes (e.g., via an animation over a period of time), via the one or more display generation components (e.g., 1402), a size of the current time indicator from the first size (e.g., 1412A) to a second size (e.g., 1412B) that is smaller than the first size. Reducing the size of an indication of the current time when initiating the timer provides the user with visual feedback that the timer has been initiated, thereby providing improved visual feedback, and visually deprioritizes the current time, thereby enabling the computer system to use more display space for the timer and improving the man-machine interface.

In some embodiments, the request (e.g., 1450A, 1450B, and/or 1450G) to initiate the timer is detected while the computer system (e.g., 1400) displays a current time indicator (e.g., of the hour and/or minute of the current time) at a first location (e.g., 1412A) (e.g., as part of the time user interface) concurrently with the seconds indicator (e.g., 1410 and/or 1410A) and wherein the current time indicator is different from the seconds indicator. In response to detecting the request (e.g., 1450A, 1450B, and/or 1450G) to initiate the timer, the computer system (e.g., 1400) moves (e.g., via an animation over a period of time), via the one or more display generation components (e.g., 1402), the current time indicator from the first location (e.g., 1412A) to a second location (e.g., 1412B) that is different from the first location. In some embodiments, in response to detecting the request to initiate the timer, the computer system displays an animation over a period of time (e.g., 1 second, 3 seconds, 7 seconds) that concurrently changes a size and location of the current time indicator. Moving the indication of the current time when initiating the timer provides the user with visual feedback that the timer has been initiated, thereby providing improved visual feedback.

In some embodiments, a visual style of the indication of timer progress is based on a visual style of text (e.g., a numeric indication of minutes and/or hours of the current time, a textual indication of the current day of the week, and/or an alpha-numeric indication of the current date) (e.g., style of 1430A in FIG. 14G is based on style of 1412A in FIG. 14A and style of 1430A in FIG. 14U is based on style of 1412A in FIG. 14T) that is displayed as part of the time user interface (e.g., 1412 at FIGS. 14A and 14T). In some embodiments, the computer system receives user input to set and/or change the visual style of the text and the visual style of the indication of timer progress changes accordingly. Displaying a visual style for the indication of timer progress that is based on the visual style of currently displayed text that is part of the time user interface provides the user with visual feedback that the indication of timer progress is also part of the time user interface, thereby providing improved visual feedback. Automatically synchronizing the visual style of the indication of time progress based on the visual style of the text that is displayed as part of the time user interfaces also reduces the number of user inputs required to customize the indication of the timer progress.

In some embodiments, the visual style of the text (e.g., 1412A in FIG. 14T) and the indication of timer progress (e.g., 1430A in FIG. 14U) includes one or more (e.g., 1, 2, 3, 4, or 6) lines (e.g., perpendicular lines and/or parallel lines). In some embodiments, a single number or letter of the text includes a first quantity (e.g., 1, 2, or 5) of parallel lines and the indication of timer progress includes the first quantity of parallel lines. Displaying a visual style with one or more lines for the indication of timer progress that is based on a visual style with one or more lines of the text that is part of the time user interface provides the user with visual feedback that the indication of timer progress is also part of the time user interface, thereby providing improved visual feedback. Automatically synchronizing the visual style of the indication of time progress to include a number of lines that is based on the number of lines of the visual style of the text that is displayed as part of the time user interfaces reduces the number of user inputs required to customize the indication of the timer progress.

In some embodiments, the visual style of the text (e.g., 1412A in FIGS. 14A and/or 14T) includes one or more (e.g., 1, 2, 5, or 8) colors and the visual style of the indication of timer progress (e.g., 1430A in FIGS. 14C and/or 14U) includes the one or more colors. In some embodiments, the indication of timer progress and the text use the same color scheme (e.g., changing a color scheme changes the colors of both the indication of timer progress and the text). Displaying the indication of timer progress and the text using the same colors provides the user with visual feedback that the indication of timer progress is also part of the time user interface, thereby providing improved visual feedback. Automatically synchronizing the visual style of the indication of time progress to include a color that is based on a color of the visual style of the text that is displayed as part of the time user interfaces reduces the number of user inputs required to customize the indication of the timer progress.

In some embodiments, the computer system (e.g., 1400) detects that a set of one or more low power criteria are met. In some embodiments, the one or more low power criteria includes a criterion that is met when a hand gesture (e.g., a wrist down gesture, such as when a wrist of a user is detected by the user's side, and/or a cover gesture, such as when a hand of a user covers a display or touch-sensitive surface of the computer system) is detected. In some embodiments, the one or more low power criteria includes a criterion that is met when a hand of the user is within a range of orientations (e.g., by their side and/or wrist down) (e.g., for a non-zero threshold duration of time). In some embodiments, the one or more low power criteria includes a criterion that is met when no input of certain types (e.g., touch inputs and/or button presses) are detected for a threshold duration of time (e.g., 10 seconds, 15 seconds, or 45 seconds). In some embodiments, the one or more low power criteria includes a criterion that is met when the computer system is within a range of orientations (e.g., by the user's side and/or display facing down) (e.g., for a non-zero threshold duration of time). In response to detecting that the set of one or more low power criteria are met: in accordance with a determination that the timer is not active while the time user interface is displayed and the set of one or more low power criteria are met, the computer system (e.g., 1400) enters a low power state (e.g., as in FIG. 14V) (e.g., dimming a display of the computer system, reducing a frequency at which an indication of current time is updated, reducing a refresh rate of the display of the computer system, and/or reducing a processor speed of the computer system). In some embodiments, the low power mode is a mode in which the computer system conserves battery power while continuing to display some information on a display (e.g., of the computer system). In some embodiments, the display of the computer system uses a brightness (e.g., average pixel luminance) while in the low power state that is less than a brightness of the display while not in the low power state. In some embodiments, animations use a reduced frame rate while the computer system is in the low power state as compared to while not in the low power state. In some embodiments, a display of the computer system updates less frequently (e.g., update of values on the display and/or a display refresh rate) while in the low power state as compared to while not in the low power state. In some embodiments, a processor speed and/or power usage of a processor of the computer system is reduced while in the low power state as compared to while not in the low power state. In response to detecting that the set of one or more low power criteria are met: in accordance with a determination that the timer is active while the time user interface is displayed and the set of one or more low power criteria are met, forgoing entering the low power state (e.g., as in FIG. 14A). In some embodiments, the computer system does not enter the low power state when the timer is active (e.g., running, counting down, and/or counting up). In some embodiments, in accordance with a determination that the set of one or more low power criteria are met while displaying a different user interface (e.g., a different time user interface or a different interface that is not the time interface), the computer system enters the low power state. Forgoing entering the low power state when the time is active provides the user with visual feedback that the timer is active and enables the computer system to provide the user with accurate and easily viewable feedback about the state of the timer, thereby providing improved visual feedback.

In some embodiments, the time user interface (e.g., 1412 at FIG. 14A), when not displayed in the low power state, includes a plurality of numerals (e.g., one or more numerals that are part of a current time indicator such as numerals that make up an hour and/or minute of the current time) that are not interlinked (e.g., 1412A at FIG. 14A). In some embodiments, displaying the time user interface in the low power state includes displaying the plurality of numerals interlinked (e.g., 1412A at FIG. 14V). In some embodiments, a most significant digit of the current hour is interlinked with a most significant digit of the current minute (e.g., interlinking 0 and 3 while displaying a time of 12:34 such that the 0 and the 3 appear to pass through each other) and/or a least significant digit of the current house is interlinked with a least significant digit of the current minute (e.g., interlinking 2 and 4 while displaying a time of 12:34 such that the 2 and 4 appear to pass through each other). Interlinking one or more numerals of the current time indicator provides the user with visual feedback that the set of low power criteria is met and/or that the computer has entered into the low power state, thereby providing the user with improved visual feedback.

In some embodiments, the computer system (e.g., 1400) detects a change in a state of the timer. In response to detecting the change in the state of the timer, the computer system (e.g., 1400) outputs a non-visual output (e.g., 1460A-1460H) indicative of the change in state of the timer (e.g., an audio output and/or a tactile output). In some embodiments, the computer system provides non-visual feedback when the state of the timer changes. Providing non-visual feedback that a state of the timer has changed provides the user with improved feedback about the state of the timer.

In some embodiments, the change in the state of the timer includes the timer starting (e.g., as in FIG. 14G), the timer stopping, and/or the timer being canceled. Providing non-visual feedback that the timer has started, the timer has stopped, and/or that the timer has been canceled provides the user with improved feedback about the state of the timer.

In some embodiments, while the timer is running, the computer system (e.g., 1400) detects the occurrence of a condition associated with a state of the timer. In response to detecting the occurrence of the condition associated with the state of the timer, the computer system (e.g., 1400) outputs a non-visual output (e.g., an audio output and/or a tactile output) based on the state of the timer (e.g., as in FIGS. 14G, 14J, and 14K). In some embodiments, the timing, the frequency, the duration, and/or the contents of the non-visual output are based on the state of the timer. Providing non-visual feedback based on the state of the timer provides the user with improved feedback about the state of the timer.

In some embodiments, the condition associated with the state of the timer includes a first threshold amount of time having elapsed on the timer (e.g., 1, 5, 10, 30, seconds, or 1, 5, or 10 minutes) (e.g., as the indication of timer progress advances) (e.g., as in FIG. 14J). In some embodiments, the computer system outputs a non-visual output once per minute while the timer is running. In some embodiments, the computer system outputs a non-visual output at each minute demarcation of the timer. Outputting non-visual outputs at a plurality of one-minute increments of the timer provides the user with feedback about the timer reaching those one-minute increments, thereby providing improved user feedback about the state of the computer system and the timer.

In some embodiments, outputting the non-visual output includes: outputting a sequence of non-visual outputs with a first temporal spacing between sequential outputs in the sequence of non-visual outputs while the timer is in a first state (e.g., more than 3 minutes from completion or more than 1 minute from completion); and outputting the sequence of non-visual outputs (e.g., as in FIG. 14K) with a second temporal spacing between sequential outputs in the sequence of non-visual outputs, different from the first temporal spacing between sequential outputs in the sequence of non-visual outputs, while the timer is in a second state (e.g., less than 3 minutes from completion or less than 1 minute from completion) that is different from the first state. In some embodiments, the computer system varies the temporal spacing between sequential outputs of the non-visual output based on the state of the timer. In some embodiments, the computer system increases the temporal spacing between sequential outputs of the non-visual outputs as the timer gets closer to completion (e.g., closer to 0 seconds). Outputting the non-visual outputs with variable temporal spacing between sequential outputs based on the state of the timer provides the user with feedback about the state of the timer, thereby providing improved user feedback.

In some embodiments, the computer system (e.g., 1400) is configured to use (e.g., communicate with (e.g., is in wireless communication with and/or includes)) a first speaker mode with a first maximum volume and a second speaker mode, different from the first speaker mode, with a second maximum volume that is higher than the first maximum volume. The computer system (e.g., 1400) detects, via the one or more input devices, a request to play an audio-video file (e.g., a movie and/or a video clip) and in response to receiving the request to play the audio-video file, the computer system (e.g., 1400) plays the audio-video file, including outputting, via the first speaker mode, audio of the audio-video file. In some embodiments, outputting the non-visual output includes outputting, via the second speaker mode, an audio alert (e.g., 1460H) (e.g., outputting an audio alert using an emergency alert speaker). In some embodiments, the computer system is configured to use the second speaker for emergency alerts. In some embodiments, the first speaker mode uses a first speaker (e.g., without using the second speaker) and the second speaker mode uses a second speaker (e.g., with or without using the first speaker) that is different from the first speaker. In some embodiments, the first speaker mode and the second speaker mode are different modes of the same speaker. In some embodiments, outputting the audio alert using the second speaker mode includes outputting a sequence of audio output bursts and/or continuous audio output above a volume level (e.g., above 60 decibels, above 70 decibels, above 80 decibels, and/or above 85 decibels) that is, optionally, designed to provide an audible indication of a location of a user in need of assistance. In some embodiments, outputting the audio alert using the second speaker mode includes outputting two (or more) distinct, high-pitched (e.g., about a threshold frequency) sounds, not generally heard in nature or the environment, that optionally alternate and repeat. Providing audio feedback about the state of the timer using the second speaker mode (e.g., an extra loud speaker) enables the computer system to provide the user with audio feedback that can be heard in louder environments, thereby providing the user with improved feedback.

In some embodiments, the seconds indicator and the indication of timer progress are configured to traverse a path (e.g., 1410 and/or 1420) and wherein a visual element (e.g., 1414) (e.g., a symbol, a text, and/or a logo) is displayed at a location on the path. The computer system (e.g., 1400) displays, via the one or more display generation components (e.g., 1402), the seconds indicator (e.g., 1410A) traversing the path (e.g., a path around a perimeter of the time user interface). The computer system (e.g., 1400) changes, via the one or more display generation components (e.g., 1402), a color of the visual element (e.g., 1414) as the seconds indicator traverses the location on the path. The computer system (e.g., 1400) displays (e.g., while the timer runs, counts down, and/or counts up), via the one or more display generation components (e.g., 1402), the indication of timer progress (e.g., 1430A) traversing the path (e.g., advancing along the path) (e.g., a path around a perimeter of the time user interface). The computer system (e.g., 1400) changes, via the one or more display generation components (e.g., 1402), a color of the visual element (e.g., 1414) as the indication of timer progress traverses the location on the path (e.g., as in FIG. 14I). In some embodiments, a first portion of the visual element changes color with a second portion of the visual element changing color when the seconds indicator and/or the indication of timer progress passes through the first portion without passing through the second portion, and then the second portion changes color as the seconds indicator and/or the indication of timer progress passes through the second portion. Changing the color of the visual element as the seconds indicator and/or the indication of timer progress passes through the visual element provides the user with visual feedback that the seconds indicator and/or the indication of timer progress has reached the location of the visual element, thereby providing the user with improved visual feedback about the state of the computer system and the timer.

Note that details of the processes described above with respect to method 1500 (e.g., FIG. 15) are also applicable in an analogous manner to the methods described below and/or above. For example, methods 700, 900, 1100, 1300, and/or 1700 optionally include one or more of the characteristics of the various methods described above and below with reference to methods 700, 900, 1100, 1300, and/or 1700. For example, in some embodiments, the same computer system performs methods 700, 900, 1100, 1300, 1500, and/or 1700 and/or the various time user interfaces recited in methods 700, 900, 1100, 1300, 1500, and/or 1700 are implemented on the same computer system. For brevity, these details are not repeated below.

FIGS. 16A-16AB-3 illustrate techniques for displaying timer user interfaces that include one or more visual media items, in accordance with some embodiments. At FIG. 16A, computer system 1600 includes display 1602, which optionally includes a touch-sensitive surface (e.g., to form a touch display), and rotatable input mechanism 1604. In some embodiments, computer system 1600 is the same computer system as electronic devices 100, 300, and/or 500. In some embodiments, computer system 1600 includes some or all the features of electronic devices 100, 300, and/or 500. At FIG. 16A, computer system 1600 is displaying time user interface 1606 while computer system 1600. In some embodiments, computer system 1600 is a wearable device (e.g., a wrist-worn device and/or a headset), such as a smart watch, and time user interface 1606 is a watch face that includes the current time, a visual media item (e.g., a photograph and/or a video) and, optionally, one or more complications that display information from applications running on computer system 1600. Time user interface 1606 includes time indication 1608 which is an indication of the current time. Time user interface 1606 also includes visual media item 1609 (e.g., a photograph, an image, and/or a video) that is displayed concurrently with time indication 1608. As will be described in greater detail below, in some embodiments, visual media item 1609 changes from one media item to another based on various criteria. Furthermore, as will also be described in greater detail below, in some embodiments, one or more visual characteristics of time indication 1608 change as visual media item 1609 changes from one visual media item to another.

In FIG. 16A, computer system 1600 is associated with and/or corresponds with second computer system 1610. For example, in some embodiments, computer system 1600 and computer system 1610 are associated with the same user and/or are logged into the same user account. In some embodiments, computer system 1600 is paired with computer system 1610 and/or registered on computer system 1610, and/or computer system 1610 is paired with computer system 1600 and/or registered on computer system 1600. In some embodiments, computer system 1600 includes some or all of the features of electronic devices 100, 300, and/or 500. At FIG. 16A, computer system 1610 includes display 1612, which optionally includes a touch-sensitive surface (e.g., to form a touch display). At FIG. 16A, computer system 1610 displays user interface 1614. User interface 1614 includes various options for modifying one or more visual characteristics of time user interface 1606 displayed on computer system 1600. In FIG. 16A, user interface 1614 is shown extending beyond the bounds of display 1612 to indicate that various options and/or components of user interface 1614 can be accessed by scrolling within user interface 1614 (e.g., via one or more user inputs).

In FIG. 16A, user interface 1606 includes regions 1616a-1616g. Region 1616a includes options 1614a-1, 1614a-2, and 1614a-3. Options 1614a-1, 1614a-2, and 1614a-3 allow a user to select which visual media items will be displayed within time user interface 1608. Options 1614a-1, 1614a-2, and 1614a-3, when selected, cause computer system 1600 to display user interfaces that display options for a user to select media items to be displayed within time user interface 1608, as will be described in greater detail below with reference to FIGS. 16B-16D.

Region 1616b includes options 1614b-1, 1614b-2, 1614b-3, 1614b-4, and 1614b-5. Option 1614b-1, when selected, causes computer system 1610 and/or computer system 1600 to modify the size at which time indication 1608 is displayed within time user interface 1606 such that time indication 1608 is displayed in an “extra small” size. Option 1614b-2, when selected, causes computer system 1610 and/or computer system 1600 to modify the size at which time indication 1608 is displayed within time user interface 1606 such that time indication 1608 is displayed in a “small” size that is larger than the “extra small” size. Option 1614b-3, when selected, causes computer system 1610 and/or computer system 1600 to modify the size at which time indication 1608 is displayed within time user interface 1606 such that time indication 1608 is displayed in a “medium” size that is larger than the “small” and “extra small” sizes. Option 1614b-4, when selected, causes computer system 1610 and/or computer system 1600 to modify the size at which time indication 1608 is displayed within time user interface 1606 such that time indication 1608 is displayed in a “large” size that is larger than the “medium,” “small,” and “extra small” sizes. Option 1614b-5, when selected, is indicative of a user request to have computer system 1610 and/or computer system 1600 automatically select the size at which time indication 1608 is displayed within time user interface 1606. In some embodiments, when option 1614b-5 is selected, time indication 1608 is displayed at different sizes within time user interface 1606 for different visual media items, such that as visual media item 1609 changes from one visual media item to another, time indication 1608 changes from a first size to a second size.

Region 1614c includes options 1614c-1, 1614c-2, 1614c-3, 1614c-4, 1614c-5, 1614c-6, 1614c-7, and 1614c-8. The different options in region 1614c correspond to different colors, and selection of a respective option 1614c-1 through 1614c-8 causes computer system 1610 and/or computer system 1600 to display time indication 1608 in the corresponding selected color within time user interface 1606.

Region 1614d includes options 1614d-1, 1614d-2, and 1614d-3. The different options in region 1614d correspond to different fonts, and selection of a respective option 1614d-1, 1614d-2, 1614d-3 causes computer system 1610 and/or computer system 1600 to display time indication 1608 in the corresponding selected font within time user interface 1606.

Region 1614e includes options 1614e-1, 1614e-2, and 1614e-3. The different options in region 1614e correspond to different scripts, and selection of a respective option 1614e-1, 1614e-2, 1614e-3 causes computer system 1610 and/or computer system 1600 to display time indication 1608 in the corresponding selected script within time user interface 1606.

Region 1614f includes options 1614f-1, 1614f-2, 1614f-3, 1614f-4, 1614f-5, 1614f-6, and 1614f-7. The different options in region 1614f corresponds to different visual styles, and selection of a respective option 1614f-1 through 1614f-7 causes computer system 1610 and/or computer system 1600 to display time user interface 1606 with a particular visual style applied to time user interface 1606. The different visual styles will be described in greater detail below, for example, with reference to FIGS. 16K-16Q.

Region 1614g includes options 1614g-1, 1614g-2, 1614g-3, and 1614g-4. Option 1614g-1 corresponds to a no complications setting in which time user interface 1606 is displayed (e.g., by computer system 1600) without any complications. Option 1614g-2 corresponds to a bottom complications setting in which time user interface 1606 is displayed (e.g., by computer system 1600) with one or more complications in a bottom region of time user interface 1606 and without complications at the top of time user interface 1606. Option 1614g-3 corresponds to a top complications setting in which time user interface 1606 is displayed (e.g., by computer system 1600) with one or more complications in a top region of time user interface 1606 and without complications at the bottom of time user interface 1606. Option 1614g-4 corresponds to a top and bottom complications setting in which time user interface 1606 is displayed (e.g., by computer system 1600) with one or more complications both at the top of time user interface 1606 and at the bottom of time user interface 1606. In some embodiments, complications include visual information that is provided by one or more applications of computer system 1600, and is periodically updated (e.g., visually modified and/or visually refreshed) based on updated information provided by the one or more applications of computer system 1600.

User interface 1606 also includes option 1614h which, when selected, causes time user interface 1608 to be applied as the watch face for computer system 1600; and option 1616i which, when selected, deletes and/or removes time user interface 1608.

FIG. 16A depicts three different example scenarios in which computer system 1610 detects three different user inputs: user input 1616a corresponding to selection of option 1614a-1, user input 1616b corresponding to selection of option 1614a-2, and user input 1616c corresponding to selection of option 1614a-3. Each of these user inputs will be described below.

At FIG. 16B, in response to user input 1616a in FIG. 16A, computer system 1610 displays user interface 1618. User interface 1618 includes options 1618a through 1618f. Options 1618a through 1618f correspond to different collections of visual media items. For example, option 1618a corresponds to a “People” collection that includes visual media items that depict one or more specific people. Option 1618b corresponds to a “Pets” collection that includes visual media items that depict one or more pets. Option 1618c corresponds to a “Nature” collection that includes visual media items that are determined to depict nature. Option 1618d corresponds to a “Cities” collection that includes visual media items that are determined to depict one or more cities and/or that were captured in specific cities. Option 1618e corresponds to a collection labeled “Collection 1.” Option 1618f corresponds to a “Featured Photos” collection that includes one or more photos that are automatically selected without user input (e.g., by computer system 1600, computer system 1610, or a different computer system). In some embodiments, the “Features Photos” collection changes over time (e.g., changes each day). In some embodiments, different collections include different sets of visual media items, such that user selection of a respective option 1618a-1618f causes computer system 1600 and/or computer system 1610 to display different sets of visual media items within time user interface 1606 based on the user selection. In some embodiments, collections of visual media items are specified and/or created by a user. In some embodiments, collections of visual media items are automatically generated without user input. User interface 1618 also includes option 1618g which, when selected, causes computer system 1610 to display user interface 1622 shown in FIG. 16D so that a user can manually selected visual media items to be displayed within time user interface 1606.

At FIG. 16C, in response to user input 1616b in FIG. 16A, computer system 1610 displays user interface 1620. User interface 1620 includes option 1620a-1620f, which correspond to different albums. For example option 1620a corresponds to a first album entitled “Vacation Photos,” option 1620b corresponds to a second album entitled “Favorites,” option 1620c corresponds to a third album entitled “Ski Trip,” option 1620d corresponds to a fourth album entitled “Food,” option 1620e corresponds to a fifth album entitled “Recipes,” and option 1620f corresponds to a sixth album entitled “Art.” In some embodiments, different albums contain different sets of visual media items such that user selection of a respective option 120a-1620f causes computer system 1600 and/or computer system 1610 to display different sets of visual media items within time user interface 1606 based on the user selection.

At FIG. 16D, in response to user input 1616b in FIG. 16A, computer system 1610 displays user interface 1622. User interface 1622 displays visual media items from a media library (e.g., a media library that is stored on and/or is accessible on computer system 1610; and/or a media library that is associated with a user of computer system 1610). For example, in FIG. 16D, user interface 1622 includes, among others, visual media items 1624a-1624e. User interface 1622 enables a user to manually select visual media items to be displayed within time user interface 1606. User interface 1622 includes search bar 1622a which enables a user to enter search terms to search for media items that are responsive to the entered search terms. User interface 1622 includes filter option 1622c, 1622d which, when selected, cause computer system 1600 to filter the visual media items shown in user interface 1622 according to the selected filter option. User interface 1622 also includes option 1622b which, when selected, causes computer system 1600 to remove any applied filters. User interface 1622 includes option 1622e which, when selected, causes computer system 1600 to cease display of user interface 1622 (e.g., and in some embodiments, return to and/or re-display user interface 1614) without applying user-selected visual media items to time user interface 1606. User interface 1622 also includes option 1622f which, when selected, causes computer system 1600 to cease display of user interface 1622 and causes computer system 1600 and/or computer system 1610 to apply one or more user-selected visual media items to time user interface 1606. At FIG. 16D, computer system 1600 detects user inputs 1625a-1625e corresponding to selection of representations 1624a-1624e.

At FIG. 16E, in response to user inputs 1625a-1625e, computer system 1610 displays representations 1624a-1624e with corresponding selection indications 1624a-1, 1624b-2, 1624c-1, 1624d-1, 1624e-1 to indicate that visual media items 1624a-1624e have been selected for display within time user interface 1606. At FIG. 16E, computer system 1600 detects user input 1628 corresponding to selection of option 1622f.

At FIG. 16F, in response to user input 1628, computer system 1610 displays user interface 1630. User interface 1630 includes options 1630a, 1630b, and 1630c. Option 1630a, when selected, causes computer system 1610 to cease display of user interface 1630 and, optionally, re-display user interface 1614, without saving the visual media item selections made by the user. Option 1630b, when selected, causes computer system 1610 to ceases display of user interface 1630 and, optionally, re-display user interface 1614 with the visual media item selections made by the user saved. Option 1630c, when selected, causes computer system 1610 to re-display user interface 1622 so that the user can select additional visual media items. User interface also includes time user interface representations 1632a-1632e. Time user interface representations 1632a-1632e show representations of time user interface 1606 using the visual media items selected by the user in FIGS. 16D-16E. Time user interface representation 1632a includes time indication 1608 with visual media item 1624a. Additionally, in time user interface representation 1632a, time indication 1608 is displayed at a small size setting aligned to the top of the user interface. Time user interface representation 1632b includes time indication 1608 with visual media item 1624b, and time indication 1608 is displayed at a medium size setting aligned to the top. Time user interface representation 1632c includes time indication 1608 with visual media item 1624c, and time indication 1608 is displayed at a large size setting aligned to the right. Time user interface representation 1632d includes time indication 1608 with visual media item 1624d, and time indication 1608 is displayed at the large size setting aligned to the left. Time user interface representation 1632e includes time indication 1608 with visual media item 1624e, and time indication 1608 is displayed at an extra small size setting aligned to the bottom.

In some embodiments, computer system 1610 automatically selects the size and/or position of time indication 1608 for different visual media items based on the content depicted in the visual media items. For example, computer system 1610 automatically selects the size and/or position of time indication 1608 in order to fit time indication 1608 into a detected empty area of the visual media item and/or so as not to obscure a detected subject of the visual media item. In some embodiments, in FIG. 16F, computer system 1610 selects different sizes for time indication 1608 for different visual media items based on option 1614b-5 (e.g., a “dynamic” time size setting) being selected in FIG. 16A. In some embodiments, when a different option 1614b-1, 1614b-2, 1614b-3, 1614b-4 is selected for the time size setting, each time user interface representation 1632a-1632e displays time indication 1608 at the same, selected size setting. In some embodiments, in such scenarios, computer system 1610 still determines different positions and/or alignments for time indication 1608 (e.g., based on content depicted in each visual media item).

It can be seen that in time user interface representation 1632a, a foreground portion 1624a-1 of visual media item 1624a overlays time indication 1608, while a background portion 1624a-2 of visual media item 1624a is positioned behind time indication 1608. In some embodiments, when a visual media item includes depth segmentation information (e.g., as metadata associated with the visual media item) that distinguishes between one or more foreground objects and one or more background objects, one or more foreground objects are positioned in front of time indication 1608 and/or layered on top of time indication 1608 while one or more background objects are positioned behind time indication 1608. In some embodiments, depth segmentation information for a visual media item is captured and/or acquired at the time of capturing the visual media item. In some embodiments, depth segmentation information for a visual media item is calculated after capturing the visual media item (e.g., using one or more machine learning models and/or automated processes to identify foreground objects and background objects in a visual media item). However, in some embodiments, when a visual media item does not include depth segmentation information, the entirety of the visual media item is displayed behind time indication 1608. In FIG. 16F, visual media items 1624a, 1624b, 1624c include depth segmentation information, while visual media items 1624d and 1624e do not include depth segmentation information. Accordingly, in time user interface representations 1632a, 1632b, and 1632c, foreground portions 1624a-1, 1624b-1, and 1624c-1 are overlaid on time indication 1608 and background portions 1624a-2, 1624b-2, and 1624c-2 are positioned behind time indication 1608; and in time user interface representations 1632d, 1632e, the entirety of visual media items 1624d, 1624e are positioned behind time indication 1608. At FIG. 16F, computer system 1610 detects user input 1634 corresponding to selection of time user interface representation 1632a.

At FIG. 16G, in response to user input 1634, computer system 1610 displays layout editing user interface 1636. Layout editing user interface 1636 includes options 1636a and 1636b. Option 1636a, when selected, causes computer system 1610 to cease display of layout editing user interface 1636 and re-display user interface 1630 without modifying the layout of time user interface representation 1632a. Option 1636b, when selected, causes computer system 1610 to cease display of layout editing user interface 1636 and re-display user interface 1630 with modifications to time user interface representation 1632a applied if modifications have been made within layout editing user interface 1636. Layout editing user interface 1636 also includes option 1636o that, when selected, causes computer system 1610 to display a media item picker user interface (e.g., user interface 1622) that allows the user to replace visual media item 1624a with a different visual media item.

Layout editing user interface 1636 also includes options 1636c, 1636d, 1636f, 1636g, 1632i, 1632j, 1636l, 1636m that correspond to different time indication sizes and alignments. Previews 1636e, 1636h, 1636k, 1636n displays time indication 1608 at four different sizes (extra small, small, medium, and large). In FIG. 16G, option 1636g is selected (small size, top alignment). At FIG. 16G, computer system 1610 detects user input 1638 corresponding to selection of option 1636l.

At FIG. 16H, in response to user input 1638, computer system 1610 displays, with time user interface representation 1632a, time indication 1608 changing from the small size and top alignment (corresponding to previously-selected option 1636g) to a large size and left alignment corresponding to newly-selected option 1636l. However, at FIG. 16H, computer system 1610 determines that at the new time indication size and alignment, foreground portion 1624a-1 obscures greater than a threshold portion of time indication 1608. Based on this determination, computer system 1610 displays warning 1639, and also disables save option 1636b such that the user is not able to save this new layout for time user interface 1606. In some embodiments, while save option 1636b is displayed, it is displayed with one or more visual characteristics (e.g., in a different color and/or with a visual indication) indicating that it is disabled. At FIG. 16H, computer system 1610 detects user input 1640a, which, in the depicted embodiment, is a pinching gesture on time user interface 1632a and/or visual media item 1624a.

At FIG. 16I, in response to user input 1640a, computer system 1610 displays visual media item 1624a at a smaller size such that foreground portions 1624a-1 of visual media item 1624a no longer obscure greater than a threshold amount of time indication 1608. Based on this determination, computer system 1610 ceases display of warning 1639, and ceases disabling save option 1636b (e.g., ceases displaying save option 1636b in a manner indicating that save option 1636b is displayed). At FIG. 16I, computer system 1610 detects user input 1640b corresponding to selection of save option 1636b.

At FIG. 16J, in response to user input 1640b, computer system 1610 ceases display of user interface 1636 and re-displays user interface 1630. In user interface 1630, time user interface representation 1632a has been modified based on the changes made by the user in FIGS. 16G-16I, such that time indication 1608 is now larger and aligned to the left, and visual media item 1624a has been made smaller and shifted in position towards the bottom right. In the manner shown in FIGS. 16G-16I, a user is able to select any time user interface representation 1632a-1632e to modify the size and alignment of time indication 1608 as well as the size and alignment of visual media items 1624a-1624e with layout editing user interface 1636. At FIG. 16J, computer system 1610 detects user input 1640c corresponding to selection of option 1630b.

At FIG. 16K, in response to user input 1640c, computer system 1610 ceases display of user interface 1630 and re-displays user interface 1616. Furthermore, computer system 1610 has saved and/or stored the changes to the visual media items and the size and layout choices made by the user in FIGS. 16D-16J. As mentioned above, user interface 1614 includes style region 1614f, which includes different options 1614f-1 through 1614f-7 for applying different visual style options to time user interface 1606. Option 1614f-1 corresponds to a natural style option in which the visual media items (e.g., 1609, and/or 1624a-1624e) displayed in time user interface 1606 are displayed with unmodified and/or unchanged colors (e.g., with their original colors). Option 1614f-2 corresponds to a monotone style in which the visual media items (e.g., 1609, and/or 1624a-1624e) displayed in time user interface 1606 are modified such that it they are displayed in varying shades of a single color. Option 1614f-3 corresponds to a duotone style in which the visual media items (e.g., 1609 and/or 1624a-1624e) displayed in time user interface 1606 are modified such that they are displayed in varying shades of two different colors. Option 1614f-4 corresponds to a tritone style in which the visual media items (e.g., 1609 and/or 1624a-1624e) displayed in time user interface 1606 are modified such that they are displayed in varying shades of three different colors. Option 1614f-5 corresponds to a color backdrop style in which the visual media items (e.g., 1609 and/or 1624a-1624e) displayed in time user interface 1606 are modified such that a background portion of the visual media item is displayed in a single color, and a foreground portion of the visual media item is displayed in the visual media item's original colors. Option 1614f-6 corresponds to a color backdrop mono style in which the visual items (e.g., 1609 and/or 1624a-1624e) displayed in time user interface 1606 are modified such that a background portion of the visual media item is displayed in a single color and a foreground portion of visual media item is displayed in black and white and/or grayscale. Option 1614f-7 corresponds to a black and white style in which the visual items (e.g., 1609 and/or 1624a-1624e) displayed in time user interface 1606 are modified such that they are displayed in black and white and/or grayscale. FIG. 16K depicts six example scenarios in which computer system 1610 detects six different user inputs: (1) user input 1642a correspond to selection of style option 1614f-2; (2) user input 1642b corresponding to selection of style option 1614f-3; user input 1642c corresponding to selection of style option 1614f-4; user input 1642d corresponding to selection of style option 1614f-5; user input 1642e corresponding to selection of style option 1614f-6; and user input 1642f corresponding to selection of style option 1614f-7. Different scenarios and user inputs will be discussed below.

At FIG. 16L, in response to user input 1642a in FIG. 16K, computer system 1610 displays monotone style user interface 1644. Monotone style user interface 1644 includes cancel option 1644a and save option 1644b. Cancel option 1644a, when selected, causes computer system 1610 to cease display of monotone style user interface 1644 and re-display user interface 1614 without applying any changes made within monotone style user interface 1644. Save option 1644b, when selected, causes computer system 1610 to cease display of monotone style user interface 1644 and re-display user interface 1614 while saving any changes made within monotone style user interface 1644. Monotone style user interface 1644 corresponds to a monotone visual style. Monotone visual style user interface 1644 includes time user interface representations 1646a-1646e that display previews of what time user interface 1606 would look like with the selected visual style applied for the five selected visual media items 1624a-1624e and the various layouts and arrangements that were specified previously in FIGS. 16D-16J. As discussed above, selection and/or application of the monotone visual style causes visual media items (e.g., 1609 and/or 1624a-1624e) displayed in time user interface 1606 to be modified such that they are displayed in different shades of a single color. Monotone style user interface 1644 includes color options 1647a-1647h that correspond to different colors. Selection of a respective color option 1647a-1647h modifies the monotone color to be applied to time user interface 1606, and also causes computer system 1610 to revise time user interface representations 1646a-1646e with the selected color. Monotone style user interface 1644 also includes brightness options 1648a-1648c. Option 1648a corresponds to a “light” brightness setting and, when selected, causes time user interface 1606 to be displayed with a first set of shades of the selected color; option 1648b corresponds to a “medium” brightness setting and, when selected, causes time user interface 1606 to be displayed with a second set of shades of the selected color, wherein the second set of shades is different from the first set of shades and is darker than the first set of shades; and option 1648c corresponds to a “dark” brightness setting and, when selected, causes time user interface 1606 to be displayed with a third set of shades of the selected color, wherein the third set of shades is different from the first and second sets of shades and is darker than the first and second sets of shades.

At FIG. 16M, in response to user input 1642b in FIG. 16K, computer system 1610 displays duotone style user interface 1650. Duotone style user interface 1650 includes cancel option 1650a and save option 1650b. Cancel option 1650a, when selected, causes computer system 1610 to cease display of duotone style user interface 1650 and re-display user interface 1614 without applying any changes made within duotone style user interface 1650. Save option 1650b, when selected, causes computer system 1610 to cease display of duotone style user interface 1650 and re-display user interface 1614 while saving any changes made within duotone style user interface 1650. Duotone style user interface 1650 corresponds to a duotone visual style. Duotone style user interface 1650 includes time user interface representations 1646a-1646e that display previews of what time user interface 1606 would look like with the selected visual style applied for the five selected visual media items 1624a-1624e and the various layouts and arrangements that were specified previously in FIGS. 16D-16J. As discussed above, selection and/or application of the duotone visual style causes visual media items (e.g., 1609 and/or 1624a-1624e) displayed in time user interface 1606 to be modified such that they are displayed in various shades of two colors. Accordingly, duotone style user interface 1650 includes a first set of color options 1651a-1651d that are selectable to define the first color to be applied to time user interface 1606, and a second set of color options 1651e-1651h that are selectable to define a second color to be applied to time user interface 1606. In some embodiments, a foreground portion of visual media items displayed in time user interface 1606 are displayed in the first color, and a background portion of visual media items displayed in time user interface 1606 are displayed in the second color.

At FIG. 16N, in response to user input 1642c in FIG. 16K, computer system 1610 displays tritone style user interface 1652. Tritone style user interface 1652 includes cancel option 1652a and save option 1652b. Cancel option 1652a, when selected, causes computer system 1610 to cease display of tritone style user interface 1652 and re-display user interface 1614 without applying any changes made within tritone style user interface 1652. Save option 1652b, when selected, causes computer system 1610 to cease display of tritone style user interface 1652 and re-display user interface 1614 while saving any changes made within tritone style user interface 1652. Tritone style user interface 1652 corresponds to a tritone visual style. Tritone style user interface 1652 includes time user interface representations 1646a-1646e that display previews of what time user interface 1606 would look like with the selected visual style applied for the five selected visual media items 1624a-1624e and the various layouts and arrangements that were specified previously in FIGS. 16D-16J. As discussed above, selection and/or application of the tritone visual style causes visual media items (e.g., 1609 and/or 1624a-1624e) displayed in time user interface 1606 to be modified such that they are displayed in various shades of three different colors. Accordingly, tritone style user interface 1652 includes options 1653a-1653e. Option 1653a corresponds to a first predefined set of three colors, option 1653b corresponds to a second predefined set of three colors (e.g., different from the first predefined set), option 1653c corresponds to a third predefined set of three colors (e.g., different from the first and second sets), option 1653d corresponds to a fourth predefined set of three colors (e.g., different from the first, second, and third sets), and option 1654e corresponds to fifth predefined set of three colors (e.g., different from the first through fourth sets).

At FIG. 16O, in response to user input 1642d in FIG. 16K, computer system 1610 displays color backdrop style user interface 1654. Color backdrop style user interface 1654 includes cancel option 1654a and save option 1654b. Cancel option 1654a, when selected, causes computer system 1610 to cease display of color backdrop style user interface 1654 and re-display user interface 1614 without applying any changes made within color backdrop style user interface 1654. Save option 1654b, when selected, causes computer system 1610 to cease display of color backdrop style user interface 1654 and re-display user interface 1614 while saving any changes made within color backdrop style user interface 1654. Color backdrop style user interface 1654 corresponds to a color backdrop visual style. Color backdrop style user interface 1654 includes time user interface representations 1646a-1646e that display previews of what time user interface 1606 would look like with the selected visual style applied for the five selected visual media items 1624a-1624e and the various layouts and arrangements that were specified previously in FIGS. 16D-16J. As discussed above, selection and/or application of the color backdrop visual style causes visual media items (e.g., 1609 and/or 1624a-1624e) displayed in time user interface 1606 to be modified such that they are displayed with a background portion of the visual media item displayed in a single color, and a foreground portion of the visual media item displayed in the visual media item's original and/or native colors. Accordingly, color backdrop style user interface 1654 includes color options 1655a-1655h that allow a user to select the color to be applied to the background portion of visual media items displayed within time user interface 1606. In some embodiments, for visual media items that do not have depth segmentation information (e.g., visual media items 1624d and 1624e in FIG. 16O), the selected background color is applied to the entirety of the visual media item.

At FIG. 16P, in response to user input 1642e in FIG. 16K, computer system 1610 displays color backdrop mono style user interface 1656. Color backdrop mono style user interface 1656 includes cancel option 1656a and save option 1656b. Cancel option 1656a, when selected, causes computer system 1610 to cease display of color backdrop mono style user interface 1656 and re-display user interface 1614 without applying any changes made within color backdrop mono style user interface 1656. Save option 1656b, when selected, causes computer system 1610 to cease display of color backdrop mono style user interface 1656 and re-display user interface 1614 while saving any changes made within color backdrop mono style user interface 1656. Color backdrop mono style user interface 1656 corresponds to a color backdrop mono visual style. Color backdrop mono style user interface 1656 includes time user interface representations 1646a-1646e that display previews of what time user interface 1606 would look like with the selected visual style applied for the five selected visual media items 1624a-1624e and the various layouts and arrangements that were specified previously in FIGS. 16D-16J. As discussed above, selection and/or application of the color backdrop mono visual style causes visual media items (e.g., 1609 and/or 1624a-1624e) displayed in time user interface 1606 to be modified such that they are displayed with a background portion of the visual media item displayed in a single color, and a foreground portion of the visual media item displayed in black and white. Accordingly, color backdrop mono style user interface 1656 includes color options 1657a-1657h that allow a user to select the color to be applied to the background portion of visual media items displayed within time user interface 1606. In some embodiments, for visual media items that do not have depth segmentation information (e.g., visual media items 1624d and 1624e in FIG. 16P), the selected background color is applied to the entirety of the visual media item.

At FIG. 16Q, in response to user input 1642f in FIG. 16K, computer system 1610 displays black and white style user interface 1658. Black and white style user interface 1658 includes cancel option 1658a and save option 1658b. Cancel option 1658a, when selected, causes computer system 1610 to cease display of black and white style user interface 1658 and re-display user interface 1614 without applying any changes made within black and white style user interface 1658. Save option 1658b, when selected, causes computer system 1610 to cease display of black and white style user interface 1658 and re-display user interface 1614 while saving any changes made within black and white style user interface 1658. Black and white style user interface 1658 corresponds to a black and white visual style. Black and white style user interface 1658 includes time user interface representations 1646a-1646e that display previews of what time user interface 1606 would look like with the selected visual style applied for the five selected visual media items 1624a-1624e and the various layouts and arrangements that were specified previously in FIGS. 16D-16J. As discussed above, selection and/or application of the black and white visual style causes visual media items (e.g., 1609 and/or 1624a-1624e) displayed in time user interface 1606 to be modified such that they are displayed in black and white and/or gray scale. Black and white style user interface 1658 includes options 1659a-1659c. Option 1659a corresponds to a light brightness setting that, when selected, causes the black and white visual media items to be displayed and/or modified to have a first brightness level. Option 1659b corresponds to a medium brightness setting that, when selected, causes the black and white visual media items to be displayed and/or modified to have a second brightness level that is darker than the first brightness level. Option 1659c corresponds to a dark brightness setting that, when selected, causes the black and white visual media items to be displayed and/or modified to have a third brightness level that is darker than the first and second brightness levels.

At FIG. 16R, computer system 1610 displays user interface 1614. At FIG. 16R, computer system 1610 detects user input 1660 corresponding to selection of option 1614h. At FIG. 16S, in response to user input 1660, computer system 1610 causes computer system 1600 to display and/or apply time user interface 1606 using the settings specified by the user within user interface 1614 on computer system 1600. The left side of FIG. 16S depicts a first scenario in which the user has selected the natural visual style (e.g., option 1614f-1) and the right side of FIG. 16S depicts a second scenario in which the user has selected the color backdrop visual style (e.g., option 1614f-5). FIG. 16S depicts various embodiments and/or circumstances in which computer system 1600 transitions from one visual media item to another within time user interface 1608. At the top row, computer system 1600 displays time user interface 1608 with visual media item 1624a and time indication 1608 large and to the left. From the top row to the second row, computer system 1600 determines that a threshold duration of time has elapsed and, based on this determination, computer system 1600 transitions from the time user interface 1606 shown in the top row to the time user interface 1606 shown in the second row. In the second row, computer system 1600 displays time user interface 1606 with visual media item 1624b and time indication 1608 at a medium size and aligned to the top. From the second row to the third row, computer system 1600 transitions from a higher power state to a lower power state (e.g., based on a determination that computer system 1600 has not detected user input for a threshold duration of time), and also transitions from the time user interface 1606 shown in the second row to the time user interface 1606 shown in the third row. In the third row, computer system 1600 displays time user interface 1606 with visual media item 1624c and time indication 1608 at a large size and aligned to the right. From the third row to the fourth row, computer system 1600 detects touch input 1661b, and in response to user input 1661b, computer system 1600 transitions from the time user interface 1606 shown in the third row to the time user interface 1606 shown in the fourth row. In the fourth row, computer system 1600 displays time user interface 1606 with visual media item 1624d and time indication 1608 at a large size and aligned to the left. From the fourth row to the fifth row, computer system 1600 detects a wrist up gesture 1661a in which the user of computer system 1600 raises his or her wrist, and in response to detecting gesture 1661a, computer system 1600 transitions from the time user interface 1606 shown in the fourth row to the time user interface 1606 shown in the fifth row. In the fifth row, computer system 1600 displays time user interface 1606 with visual media item 1624e and time indication 1608 at a small size aligned to the bottom. As such, it can be seen that based on various different criteria being met, computer system 1600 transitions from displaying a first version of time user interface 1606 (e.g., with a first media item and a first time indication size and arrangement) to displaying a second version of time user interface 1606 (e.g., with a second media item and a second time indication size and arrangement).

While FIGS. 16A-16S depicted example scenarios and embodiments in which a user is able to modify time user interface 1606 via one or more user inputs on computer system 1610, FIGS. 16T-16AB-3 depict example scenarios and embodiments in which a user is able to modify time user interface 1606 via one or more user input on computer system 1600. At FIG. 16T, computer system 1600 detects user input 1662. At FIG. 16U, in response to user input 1662, computer system 1600 displays user interface 1664. User interface 1664 displays representation 1664a that is representative of time user interface 1606, and edit option 1664b. At FIG. 16T, computer system 1600 detects user input 1665 corresponding to selection of option 1664b.

At FIG. 16V, in response to user input 1665, computer system 1600 displays user interface 1666. User interface 1666 includes option 1666a that, when selected, causes computer system 1600 to cease display of user interface 1666 and re-display user interface 1664. User interface 1666 also includes options 1666b, 1666c, 1666d. Option 1666b corresponds to a first collection of visual media items and, when selected, selects the first collection of visual media items for use in time user interface 1606. Option 1666c corresponds to a first visual media item and, when selected, selects the first visual media item for use in time user interface 1606. Option 1666d corresponds to a second collection of visual media items and, when selected, selects the second collection of visual media items for use in time user interface 1606. In some embodiments, whereas computer system 1610 allowed a user to specify which visual media items to use in time user interface 1606 (e.g., FIGS. 16B-16F) with greater granularity (e.g., allowing a user to specify and/or select the exact visual media items to be used in time user interface 1606), computer system 1600 allows a user to select visual media items with less granularity such that a user is limited to the visual media items and/or pre-defined sets of visual media items. At FIG. 16V, computer system 1600 detects user input 1667 corresponding to selection of option 1666b.

At FIG. 16W, in response to user input 1667, computer system 1600 displays time size user interface 1668. Time size user interface 1668 allows a user to modify the size of time indication 1608, similar to options 1614b-1 through 1614b-5 discussed above with reference to FIG. 16A. Time size user interface 1668 includes preview 1668a which displays a preview of time user interface 1606 with the currently-selected time size setting applied. In FIG. 16W, the medium size setting is selected, and preview 1668a shows time user interface 1606 with the time indication 1608 at a medium size. FIG. 16W depicts example scenarios in which computer system 1600 detects two different types of user input: (1) user input 1669b which includes rotation of rotatable input mechanism 1604; and (2) user input 1669a, which is a swipe left input on display 1602. In some embodiments, while displaying user interface 1668, computer system 1600 scrolls through different time size options in response to rotation of rotatable input mechanism 1604 (e.g., user input 1669b). At FIG. 16W-1, in response to user input 1669b (e.g. rotation of rotatable input mechanism 1604 by a first amount and/or in a first direction), computer system 1600 transitions from the medium size setting to the extra small size setting, and updates preview 1668a to preview the selected time size setting. At FIG. 16W-2, in response to user input 1669b (e.g. rotation of rotatable input mechanism 1604 by a second amount and/or in a first or second direction), computer system 1600 transitions from the medium size setting to the small size setting, and updates preview 1668a to preview the selected time size setting. At FIG. 16W-3, in response to user input 1669b (e.g. rotation of rotatable input mechanism 1604 by a third amount and/or in a first or second direction), computer system 1600 transitions from the medium size setting to the large size setting, and updates preview 1668a to preview the selected time size setting. At FIG. 16W-4, in response to user input 1669b (e.g. rotation of rotatable input mechanism 1604 by a fourth amount and/or in a first or second direction), computer system 1600 transitions from the medium size setting to the dynamic size setting. In some embodiments, once the user has selected (e.g., scrolled to) his or her desired time size setting, the user provides a swipe left input (e.g., user input 1669a) to move to a next setting.

At FIG. 16X, in response to user input 1669a, computer system 1600 ceases display of time size user interface 1668 and displays time color user interface 1670. Time color user interface 1670 allows a user to modify the color of time indication 1608, similar to options 1614c-1 through 1614c-8 discussed above with reference to FIG. 16A. Time color user interface 1670 includes preview 1670a which displays a preview of time user interface 1606 with the currently-selected time color setting applied. In FIG. 16X, the blue color setting is selected, and preview 1670a shows time user interface 1606 with the time indication in blue. FIG. 16X depicts example scenarios in which computer system 1600 detects two different types of user input: (1) user input 1671b which includes rotation of rotatable input mechanism 1604; and (2) user input 1671a, which is a swipe left input on display 1602. In some embodiments, while displaying user interface 1670, computer system 1600 scrolls through different time color options in response to rotation of rotatable input mechanism 1604 (e.g., user input 1671b). At FIG. 16X-1, in response to user input 1671b (e.g. rotation of rotatable input mechanism 1604 by a first amount and/or in a first direction), computer system 1600 transitions from the blue color setting to the red color setting, and updates preview 1670a to preview the selected time color setting. At FIG. 16X-2, in response to user input 1671b (e.g. rotation of rotatable input mechanism 1604 by a second amount and/or in a first or second direction), computer system 1600 transitions from the blue color setting to an orange color setting, and updates preview 1670a to preview the selected time color setting. At FIG. 16X-3, in response to user input 1671b (e.g. rotation of rotatable input mechanism 1604 by a third amount and/or in a first or second direction), computer system 1600 transitions from the blue color setting to the green color setting, and updates preview 1670a to preview the selected time color setting. In some embodiments, once the user has selected (e.g., scrolled to) his or her desired time color setting, the user provides a swipe left input (e.g., user input 1671a) to move to a next setting. In some embodiments, a swipe right input moves to a previous setting (e.g., time size user interface 1668).

At FIG. 16Y, in response to user input 1671a, computer system 1600 ceases display of time color user interface 1670 and displays time font user interface 1672. Time font user interface 1672 allows a user to modify the font of time indication 1608, similar to options 1614d-1 through 1614d-3 discussed above with reference to FIG. 16A. Time font user interface 1672 includes preview 1672a which displays a preview of time user interface 1606 with the currently-selected time font setting applied. In FIG. 16Y, the New York font setting is selected, and preview 1672a shows time user interface 1606 with the time indication in the New York font. FIG. 16Y depicts example scenarios in which computer system 1600 detects two different types of user input: (1) user input 1673b which includes rotation of rotatable input mechanism 1604; and (2) user input 1673a, which is a swipe left input on display 1602. In some embodiments, while displaying user interface 1672, computer system 1600 scrolls through different time font options in response to rotation of rotatable input mechanism 1604 (e.g., user input 1673b). At FIG. 16Y-1, in response to user input 1673b (e.g. rotation of rotatable input mechanism 1604 by a first amount and/or in a first direction), computer system 1600 transitions from the New York font setting to a California font setting, and updates preview 1672a to preview the selected time font setting. At FIG. 16Y-2, in response to user input 1673b (e.g. rotation of rotatable input mechanism 1604 by a second amount and/or in a first or second direction), computer system 1600 transitions from the New York font setting to a Classic font setting, and updates preview 1672a to preview the selected time font setting. In some embodiments, once the user has selected (e.g., scrolled to) his or her desired time font setting, the user provides a swipe left input (e.g., user input 1673a) to move to a next setting. In some embodiments, a swipe right input moves to a previous setting (e.g., time color user interface 1670).

At FIG. 16Z, in response to user input 1673a, computer system 1600 ceases display of time font user interface 1672 and displays time script user interface 1674. Time script user interface 1674 allows a user to modify the script of time indication 1608, similar to options 1614e-1 through 1614e-3 discussed above with reference to FIG. 16A. Time script user interface 1674 includes preview 1674a which displays a preview of time user interface 1606 with the currently-selected time script setting applied. In FIG. 16Z, the Arabic script setting is selected, and preview 1674a shows time user interface 1606 with the time indication in the Arabic script. FIG. 16Z depicts example scenarios in which computer system 1600 detects two different types of user input: (1) user input 1675b which includes rotation of rotatable input mechanism 1604; and (2) user input 1675a, which is a swipe left input on display 1602. In some embodiments, while displaying user interface 1674, computer system 1600 scrolls through different time script options in response to rotation of rotatable input mechanism 1604 (e.g., user input 1675b). At FIG. 16Z-1, in response to user input 1675b (e.g. rotation of rotatable input mechanism 1604 by a first amount and/or in a first direction), computer system 1600 transitions from the Arabic script setting to a Arabic Indic script setting, and updates preview 1674a to preview the selected time script setting. At FIG. 16Z-2, in response to user input 1675b (e.g. rotation of rotatable input mechanism 1604 by a second amount and/or in a first or second direction), computer system 1600 transitions from the Arabic script setting to a Devanagari script setting, and updates preview 1674a to preview the selected time script setting. In some embodiments, once the user has selected (e.g., scrolled to) his or her desired time script setting, the user provides a swipe left input (e.g., user input 1675a) to move to a next setting. In some embodiments, a swipe right input moves to a previous setting (e.g., time font user interface 1672).

At FIG. 16AA, in response to user input 1675a, computer system 1600 ceases display of time script interface 1674 and displays style user interface 1676. Style user interface 1676 allows a user to modify the visual style applied to time user interface 1606, similar to options 1614f-1 through 1614f-7 discussed above with reference to FIG. 16A. Style user interface 1676 includes preview 1676a which displays a preview of time user interface 1606 with the currently-selected style setting applied. In FIG. 16AA, the natural style setting is selected, and preview 1676a shows time user interface 1606 with the natural style setting applied. FIG. 16AA depicts example scenarios in which computer system 1600 detects two different types of user input: (1) user input 1677b which includes rotation of rotatable input mechanism 1604; and (2) user input 1677a, which is a swipe left input on display 1602. In some embodiments, while displaying user interface 1676, computer system 1600 scrolls through different visual style options in response to rotation of rotatable input mechanism 1604 (e.g., user input 1677b). At FIG. 16AA-1, in response to user input 1677b (e.g. rotation of rotatable input mechanism 1604 by a first amount and/or in a first direction), computer system 1600 transitions from the natural style setting to the monotone style setting, and updates preview 1676a to preview the selected style setting. At FIG. 16AA-2, in response to user input 1677b (e.g. rotation of rotatable input mechanism 1604 by a second amount and/or in a first or second direction), computer system 1600 transitions from the natural style setting to the duotone style setting, and updates preview 1676a to preview the selected style setting. At FIG. 16AA-3, in response to user input 1677b (e.g. rotation of rotatable input mechanism 1604 by a third amount and/or in a first or second direction), computer system 1600 transitions from the natural style setting to the tritone style setting, and updates preview 1676a to preview the selected style setting. At FIG. 16AA-4, in response to user input 1677b (e.g. rotation of rotatable input mechanism 1604 by a fourth amount and/or in a first or second direction), computer system 1600 transitions from the natural style setting to the color backdrop style setting, and updates preview 1676a to preview the selected style setting. At FIG. 16AA-5, in response to user input 1677b (e.g. rotation of rotatable input mechanism 1604 by a fifth amount and/or in a first or second direction), computer system 1600 transitions from the natural style setting to the color backdrop mono style setting, and updates preview 1676a to preview the selected style setting. At FIG. 16AA-6, in response to user input 1677b (e.g. rotation of rotatable input mechanism 1604 by a sixth amount and/or in a first or second direction), computer system 1600 transitions from the natural style setting to the black and white style setting, and updates preview 1676a to preview the selected style setting. In some embodiments, once the user has selected (e.g., scrolled to) his or her desired time script setting, the user is able to provide a tap input (e.g., input 1677c in FIG. 16AA-2) to select and/or modify one or more options for the selected style setting. In FIG. 16AA-2, while the duotone style setting is displayed and/or selected, computer system 1600 detects user input 1677c (e.g., a tap input).

At FIG. 16AA-2-1, in response to user input 1677c in FIG. 16AA-2, computer system 1600 ceases display of style user interface 1676 and displays first color user interface 1678. First color user interface 1678 allows a user to select the first color to be used in the duotone style setting, similar to options 1651a-1651d in FIG. 16M. First color user interface 1678 includes preview 1678a which displays a preview of time user interface 1606 with the currently-selected first color applied to the duotone style setting. In FIG. 16AA-2-1, red is selected, and preview 1678a shows a first portion of visual media item 1609 (e.g., foreground portion 1609-1) in red. FIG. 16AA-2-1 depicts example scenarios in which computer system 1600 detects three different types of user input: (1) user input 1679c which includes rotation of rotatable input mechanism 1604; (2) user input 1679b, which is a press of rotatable and depressible input mechanism 1604; and user input 1679a, which is a swipe left input on display 1602. As discussed above, the duotone style applies two colors to the visual media item within time user interface 1606. As such, a user is able to select a first color and a second color to be used in the duotone style (e.g., options 1651a-1651d in FIG. 16M, and options 1651e-1651h in FIG. 16M). A user can select the first color by rotating rotatable input mechanism 1604 while computer system 1600 displays first color user interface 1678. A user can select a second color by providing a swipe left input (e.g., user input 1679a) to display a second color user interface 1680 (e.g., FIG. 16AA-2-7), and rotating rotatable input mechanism 1604 while computer system 1600 displays second color user interface 1680. Once the user is done selecting the first and second colors, the user can provide a user input (e.g., user input 1679b and/or user input 1681b) to saved the selected colors and re-display style user interface 1676 (FIG. 16AA).

At FIG. 16AA-2-2, in response to user input 1679c (e.g., rotation of rotatable input mechanism 1604 by a first amount and/or in a first direction), computer system 1600 transitions from the red setting for the first color to the blue setting for the first color, and updates preview 1678a to preview the selected first color (e.g., changing the color of foreground portion 1609-1 from red to blue). At FIG. 16AA-2-3, in response to user input 1679c (e.g., rotation of rotatable input mechanism 1604 by a second amount and/or in a first or second direction), computer system 1600 transitions from the red setting for the first color to the green setting for the first color, and updates preview 1678a to preview the selected first color (e.g., changing the color of foreground portion 1609-1 from red to green). At FIG. 16AA-2-4, in response to user input 1679c (e.g., rotation of rotatable input mechanism 1604 by a third amount and/or in a first or second direction), computer system 1600 transitions from the red setting for the first color to the yellow setting for the first color, and updates preview 1678a to preview the selected first color (e.g., changing the color of foreground portion 1609-1 from red to yellow). At FIG. 16AA-2-5, in response to user input 1679c (e.g., rotation of rotatable input mechanism 1604 by a fourth amount and/or in a first or second direction), computer system 1600 transitions from the red setting for the first color to the purple setting for the first color, and updates preview 1678a to preview the selected first color (e.g., changing the color of foreground portion 1609-1 from red to purple). At FIG. 16AA-2-6, in response to user input 1679c (e.g., rotation of rotatable input mechanism 1604 by a fifth amount and/or in a first or second direction), computer system 1600 transitions from the red setting for the first color to the pink setting for the first color, and updates preview 1678a to preview the selected first color (e.g., changing the color of foreground portion 1609-1 from red to pink).

At FIG. 16AA-2-7, in response to user input 1679a in FIG. 16AA-2-1 (e.g., a swipe left input), computer system 1600 ceases display of first color user interface 1678 and displays second color user interface 1680. Second color user interface 1680 allows a user to select the second color to be used in the duotone style setting, similar to options 1651e-1651h in FIG. 16M. Second color user interface 1680 includes preview 1680a which displays a preview of time user interface 1606 with the currently-selected second color applied to the duotone style setting. In FIG. 16AA-2-7, pink is selected, and preview 1680a shows a second portion of visual media item 1609 (e.g., background portion 1609-2) in pink. FIG. 16AA-2-7 depicts example scenarios in which computer system 1600 detects three different types of user input: (1) user input 1681c which includes rotation of rotatable input mechanism 1604; (2) user input 1681b, which is a press of rotatable and depressible input mechanism 1604; and user input 1681a, which is a swipe right input on display 1602. User input 1681b causes computer system 1600 to cease display of second color user interface 1680 and re-display style user interface 1676. User input 1681a causes computer system 1600 to cease display of second color user interface 1680 and re-display first color user interface 1678.

At FIG. 16AA-2-8, in response to user input 1681c (e.g., rotation of rotatable input mechanism 1604 by a first amount and/or in a first direction), computer system 1600 transitions from the pink setting for the second color to the brown setting for the second color, and updates preview 1680a to preview the selected second color (e.g., changing the color of background portion 1609-2 from pink to brown). At FIG. 16AA-2-9, in response to user input 1681c (e.g., rotation of rotatable input mechanism 1604 by a second amount and/or in a first or second direction), computer system 1600 transitions from the pink setting for the second color to the orange setting for the second color, and updates preview 1680a to preview the selected second color (e.g., changing the color of background portion 1609-2 from pink to orange). At FIG. 16AA-2-10, in response to user input 1681c (e.g., rotation of rotatable input mechanism 1604 by a third amount and/or in a first or second direction), computer system 1600 transitions from the pink setting for the second color to the cyan setting for the second color, and updates preview 1680a to preview the selected second color (e.g., changing the color of background portion 1609-2 from pink to cyan). At FIG. 16AA-2-11, in response to user input 1681c (e.g., rotation of rotatable input mechanism 1604 by a fourth amount and/or in a first or second direction), computer system 1600 transitions from the pink setting for the second color to the violet setting for the second color, and updates preview 1680a to preview the selected second color (e.g., changing the color of background portion 1609-2 from pink to violet). At FIG. 16AA-2-12, in response to user input 1681c (e.g., rotation of rotatable input mechanism 1604 by a fifth amount and/or in a first or second direction), computer system 1600 transitions from the pink setting for the second color to the gray setting for the second color, and updates preview 1680a to preview the selected second color (e.g., changing the color of background portion 1609-2 from pink to gray).

While FIGS. 16AA-2-1 through 16AA-2-12 display an example scenario in which a user selects two different colors to be applied for the duotone style setting, it can be seen that similar user interfaces and user inputs can be used for the user to select various settings for the other style settings (e.g., monotone, tritone, color backdrop, color backdrop mono, and/or black and white). For example, for the monotone style setting, a first user interface (e.g., similar to first color user interface 1678) can be used for the user to select a color (e.g., similar to options 1647a-1647h in FIG. 16L), and a second user interface (e.g., similar to second color user interface 1680) can be used for the user to select a shade setting (e.g., similar to options 1648a-1648c in FIG. 16L). For the color backdrop and color backdrop style settings, a single user interface (e.g., similar to first color user interface 1678) can be used for the user to select the backdrop color (e.g., similar to options 1655a-1655h in FIG. 16O and options 1657a-1657h in FIG. 16P). For the tritone style setting, a single user interface (e.g., similar to first color user interface 1678) can be used for the user to select between predefined sets of three colors (e.g., similar to options 1653a-1653e in FIG. 16N). For the black and white style setting, a single user interface (e.g., similar to first color user interface 1678) can be used for a user to select between different brightness settings (e.g., similar to options 1659a-1659c in FIG. 16Q).

Returning to FIG. 16AA, computer system 1600 detects user input 1677a (e.g., a swipe left input). At FIG. 16AB, in response to user input 1677a in FIG. 16AA, computer system 1600 ceases display of style user interface 1676 and displays complications user interface 1682. Complications user interface 1682 allows a user to modify the complications in time user interface 1606, similar to options 1614g-1 through 1614g-4 discussed above with reference to FIG. 16A. Complications user interface 1682 includes preview 1682a which displays a preview of time user interface 1606 with the currently-selected complications setting applied. In FIG. 16AB, the no complications setting is selected, and preview 1682a shows time user interface 1606 with no complications. FIG. 16AB depicts example scenarios in which computer system 1600 detects two different types of user input: (1) user input 1683b which includes rotation of rotatable and depressible input mechanism 1604; and (2) user input 1683a, which is a press input of rotatable and depressible input mechanism 1604. In some embodiments, while displaying user interface 1682, computer system 1600 scrolls through different complications options in response to rotation of rotatable input mechanism 1604 (e.g., user input 1683b). At FIG. 16AB-1, in response to user input 1683b (e.g. rotation of rotatable input mechanism 1604 by a first amount and/or in a first direction), computer system 1600 transitions from a no complications setting to a bottom complications setting, and updates preview 1682a to preview the selected complications setting (e.g., to display a bottom complication region 1684a). At FIG. 16AB-2, in response to user input 1683b (e.g. rotation of rotatable input mechanism 1604 by a second amount and/or in a first or second direction), computer system 1600 transitions from the no complications setting to a top complications setting, and updates preview 1682a to preview the selected complications setting (e.g., to display a top complication region 1684b). In FIG. 16AB-2, top complication region 1684b causes time indication 1608, which is aligned to a top portion of time user interface 1606, to be displayed at a smaller size. At FIG. 16AB-3, in response to user input 1683b (e.g. rotation of rotatable input mechanism 1604 by a third amount and/or in a first or second direction), computer system 1600 transitions from the no complications setting to a top and bottom complications setting, and updates preview 1682a to preview the selected complications setting (e.g., to display bottom complication region 1684a and top complication region 1684b). In FIG. 16AB-3, top complication region 1684b causes time indication 1608, which is aligned to a top portion of time user interface 1606, to be displayed at a smaller size.

In some embodiments, once a user has completed making selections for time user interface 1606, the user can cause computer system 1600 to save and apply the user-selected options by providing a user input (e.g., user input 1683a). For example, in some embodiments, in response to user input 1683a, computer system 1600 applies the user-selected options to time user interface 1606 and displays time user interface 1606, as was shown and described in FIG. 16S above.

FIG. 17 is a flow diagram illustrating methods for displaying a timer user interface that includes one or more visual media items, in accordance with some embodiments. Method 1700 is performed at a computer system (e.g., 100, 300, 500, 1600, and/or 1610) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 1602 and/or 1612) (e.g., one or more display controllers, displays, touch-sensitive display systems, touchscreens, monitors, and/or a head mounted display system) and with one or more one or more input devices (e.g., 1602, 1604, and/or 1612) (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1700 are, optionally, combined, the orders of some operations are, optionally, changed, and some operations are, optionally, omitted.

As described below, method 1700 provides an intuitive way for displaying time user interfaces that include one or more visual media items. The method reduces the cognitive burden on a user for displaying timer user interface that include one or more visual media items, thereby creating a more efficient human-machine interface. For battery-operated computing devices, enabling a user to access time user interfaces faster, more accurately, and more efficiently conserves power and increases the time between battery charges.

The computer system (e.g., 1600 and/or 1610) detects (1702), via the one or more input devices, a first user input (e.g., 1662, 1683a, 1661a, 1661b, and/or 1628) corresponding to a user request to display a time user interface (e.g., 1606, 1632a, 1632b, 1632c, 1632d, and/or 1632e) (e.g., a user interface that includes an analog and/or digital indication of time, a clock face user interface, a watch face user interface, a reduced-power screen, a wake screen, and/or a lock screen), wherein the time user interface includes an indication of time (e.g., 1608) (e.g., an analog and/or digital indication of time) and a visual media item (e.g., 1609, 1624a, 1624b, 1624c, 1624d, and/or 1624e) (e.g., a photograph, a video, and/or other visual media item) (e.g., a visual media item that is part of a media library (e.g., a media library that is associated with the computer system, a user of the computer system, and/or a user account that is logged into the computer system); a visual media item that is associated with and/or stored on the computer system; a visual media item that is associated with a user of the computer system and/or associated with a user account that is logged into the computer system; and/or a visual media item that was captured by the computer system). In response to detecting the first user input corresponding to the user request to display the time user interface (1704), the computer system (e.g., 1600) displays (1706), via the one or more display generation components (e.g., 1602), the time user interface (e.g., 1606, 1632a, 1632b, 1632c, 1632d, and/or 1632e), including: in accordance with a determination that the visual media item is a first visual media item (1708) (e.g., in accordance with a determination that the time user interface is displayed with the first visual media item and/or includes the first visual media item) (and, in some embodiments, does not include a second visual media item), concurrently displaying (1710), within the time user interface (e.g., 1606), the indication of time (e.g., 1608) at a first size (e.g., displaying the indication of time at a first display size; and/or displaying the indication of time such that it occupies a first display area of the time user interface and/or the one or more display generation components) and the first visual media item (e.g., in FIG. 16S, in the top row, indication of time 1608 is displayed at a first size and with a first visual media item 1624a) (e.g., 1632a); and in accordance with a determination that the visual media item is a second visual media item different from the first visual media item (e.g., in accordance with a determination that the time user interface is displayed with the second visual media item and/or includes the second visual media item) (and, in some embodiments, does not include the first visual media item), concurrently displaying, within the time user interface, the indication of time at a second size different from the first size (e.g., in FIG. 16S, in the second row, indication of time 1608 is displayed at a second size and with a second visual media item 1624b) (e.g., 1632b) (e.g., displaying the indication of time at a second display size different from the first display size; and/or displaying the indication of time such that it occupies a second display area of the time user interface and/or the one or more display generation components that is different from the first display area) (e.g., a second size that is smaller than the first size (e.g., occupies less display area than the first size) or a second size that is larger than the first size (e.g., occupies more display area than the first size)) and the second visual media item (e.g., 1609, 1624a, 1624b, 1624c, 1624d, and/or 1624e). Automatically adjusting the size of the indication of time when different visual media items are displayed allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the time user interface (e.g., 1606) (e.g., first user input corresponding to a user request to display a time user interface) further comprises: in accordance with the determination that the visual media item is the first visual media item (e.g., 1609, 1624a, 1624b, 1624c, 1624d, and/or 1624e), displaying, within the time user interface (e.g., 1606), the indication of time (e.g., 1608) at a first display position (e.g., displaying the indication of time within a first display region; and/or displaying the indication of time such that it occupies a first display region) (e.g., in FIG. 16S in the top row, time indication 1608 is displayed at a first display position); and in accordance with the determination that the visual media item is the second visual media item different from the first visual media item, displaying, within the time user interface, the indication of time at a second display position (e.g., displaying the indication of time within a second display region; and/or displaying the indication of time such that it occupies a second display region) different from the first display position (e.g., in FIG. 16S in the second row, time indication 1608 is displayed at a second display position). In some embodiments, in accordance with the determination that the visual media item is the first visual media item, the computer system concurrently displays, within the time user interface, the first visual media item and the indication of time, wherein the indication of time (e.g., 1608) is displayed at the first size and at the first display position (e.g., FIG. 16S top row). In some embodiments, in accordance with the determination that the visual media item is the second visual media item, the computer system concurrently displays, within the time user interface, the second visual media item and the indication of time, wherein the indication of time (e.g., 1608) is displayed at the second size and at the second display position (e.g., FIG. 16S second row). Automatically adjusting the position of the indication of time when different visual media items are displayed allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the indication of time (e.g., 1608) includes a plurality of digits (e.g., a plurality of numeral digits and/or a plurality of numbers). In some embodiments, displaying the time user interface (e.g., 1606) (e.g., first user input corresponding to a user request to display a time user interface) further comprises: in accordance with the determination that the visual media item is the first visual media item, displaying, within the time user interface, the indication of time with the plurality of digits in a first arrangement (e.g., a horizontal arrangement (e.g., all digits aligned in a horizontal row); a vertical arrangement (e.g., all digits aligned in a vertical column); and/or a mixed arrangement (e.g., the plurality of digits arranged in two or more rows and two or more columns)) (e.g., 1608 in the top row of FIG. 16S); and in accordance with the determination that the visual media item is the second visual media item different from the first visual media item, displaying, within the time user interface, the indication of time with the plurality of digits in a second arrangement (e.g., a horizontal arrangement (e.g., all digits aligned in a horizontal row); a vertical arrangement (e.g., all digits aligned in a vertical column); and/or a mixed arrangement (e.g., the plurality of digits arranged in two or more rows and two or more columns)) different from the first arrangement (e.g., 1608 in the second row of FIG. 16S). In some embodiments, in accordance with the determination that the visual media item is the first visual media item, the computer system concurrently displays, within the time user interface, the first visual media item and the indication of time, wherein the indication of time is displayed at the first size and in the first arrangement (e.g., 1608 in the top row of FIG. 16S). In some embodiments, in accordance with the determination that the visual media item is the second visual media item, the computer system concurrently displays, within the time user interface, the second visual media item and the indication of time, wherein the indication of time is displayed at the second size and in the second arrangement (e.g., 1608 in the second row of FIG. 16S). Automatically adjusting the arrangement of digits in the indication of time when different visual media items are displayed allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the time user interface (e.g., 1606) (e.g., first user input corresponding to a user request to display a time user interface) further comprises: in accordance with the determination that the visual media item is the first visual media item, displaying, within the time user interface, the indication of time (e.g., 1608) with a first alignment within the time user interface (e.g., displaying the indication of time aligned to and/or adjacent to a top edge, a bottom edge, a right edge, or a left edge of the time user interface) (e.g., 1608 in the top row of FIG. 16S is aligned left); and in accordance with the determination that the visual media item is the second visual media item different from the first visual media item, displaying, within the time user interface, the indication of time with a second alignment within the time user interface (e.g., displaying the indication of time aligned to and/or adjacent to a top edge, a bottom edge, a right edge, or a left edge of the time user interface) that is different from the first alignment (e.g., 1608 in the second row of FIG. 16S is aligned to the top). In some embodiments, in accordance with the determination that the visual media item is the first visual media item, the computer system concurrently displays, within the time user interface, the first visual media item and the indication of time, wherein the indication of time is displayed at the first size and with the first alignment within the time user interface (e.g., 1608 in the top row of FIG. 16S). In some embodiments, in accordance with the determination that the visual media item is the second visual media item, the computer system concurrently displays, within the time user interface, the second visual media item and the indication of time, wherein the indication of time is displayed at the second size and with the second alignment within the time user interface (e.g., 1608 in the second row of FIG. 16S). Automatically adjusting the alignment of the indication of time when different visual media items are displayed allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first size of the indication of time (e.g., 1608) is selected for the first visual media item (e.g., 1624a) based on one or more user inputs (e.g., the first size of the indication of time is a user-selected setting) (e.g., user input 1638 and/or user input 1669b). In some embodiments, the second size of the indication of time is selected for the second visual media item based on one or more user inputs (e.g., user input 16389 and/or user input 1669b). In some embodiments, the computer system receives, via the one or more input devices, a first set of user inputs (e.g., 1638 and/or 1669b) corresponding to a user request to display the indication of time at the first size when the first visual media item (e.g., 1609, 1624a, 1624b, 1624c, 1624d, and/or 1624e) is displayed within the time user interface. In some embodiments, displaying the indication of time (e.g., 1608) at the first size includes: in accordance with a determination that one or more user inputs have caused selection of the indication of time to be displayed at a first respective size when the first visual media item is displayed within the time user interface, displaying the indication of time at the first respective size; and in accordance with a determination that one or more user inputs have caused selection of the indication of time to be displayed at a second respective size different from the first respective size when the first visual media item is displayed within the time user interface, displaying the indication of time at the second respective size. In some embodiments, displaying the indication of time (e.g., 1608) at the second size includes: in accordance with a determination that the one or more user inputs have caused selection of the indication of time to be displayed at a third respective size when the second visual media item is displayed within the time user interface, displaying the indication of time at the third respective size; and in accordance with a determination that the one or more user inputs have caused selection of the indication of time to be displayed at a fourth respective size when the second visual media item is displayed within the time user interface, displaying the indication of time at the fourth respective size. Allowing a user to specify the size at which the indication of time is displayed when certain visual media items are displayed enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, concurrently displaying, within the time user interface (e.g., 1606), the indication of time (e.g., 1608) at a first size and the first visual media item (e.g., 1609, 1624a, 1624b, 1624c, 1624d, and/or 1624e) comprises displaying the first visual media item at a first display position relative to the indication of time. In some embodiments, the first display position is selected based on one or more user inputs (e.g., 1640a and/or based on a drag input in FIG. 16H) (e.g., the first display position at which the first visual media item is displayed is a user-selected setting). In some embodiments, concurrently displaying, within the time user interface (e.g., 1606), the indication of time (e.g., 1608) at the second size and the second visual media item (e.g., 1609, 1624a, 1624b, 1624c, 1624d, and/or 1624e) comprises displaying the second visual media item at a second display position relative to the indication of time (e.g., a second display position different from the first display position); and the second display position is selected based on one or more user inputs (e.g., 1640a and/or based on a drag input in FIG. 16H) (e.g., the second display position at which the second visual media item is displayed is a user-selected setting). In some embodiments, the computer system receives, via the one or more input devices, a first set of user inputs corresponding to a user request to display the first visual media item at a first zoom level (e.g., with a first amount of cropping) and/or at a first display position relative to the indication of time when the first visual media item is displayed within the time user interface. In some embodiments, concurrently displaying the first visual media (e.g., 1609, 1624a, 1624b, 1624c, 1624d, and/or 1624e) and the indication of time (e.g., 1608) at the first size includes: in accordance with a determination that the one or more user inputs (e.g., 1640a) have caused selection of the first visual media item to be displayed at a first respective display position when the first visual media item is displayed within the time user interface, displaying the first media item at the first respective display position; and in accordance with a determination that one or more user inputs have caused selection of the first visual media item to be displayed at a second respective display position different from the first respective display position when the first visual media item is displayed within the time user interface, displaying the indication of time at the second respective display position. Allowing a user to specify the display position of visual media items when different visual media items are displayed enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first size of the indication of time (e.g., 1608) is automatically selected for the first visual media item (e.g., 1609, 1624a, 1624b, 1624c, 1624d, and/or 1624e) (e.g., by the computer system and/or one or more external computer systems) without user input (e.g., the first size of the indication of time is an automatically-applied setting); and the second size of the indication of time is automatically selected for the second visual media item (e.g., 1609, 1624a, 1624b, 1624c, 1624d, and/or 1624e) (e.g., by the computer system and/or one or more external computer systems) without user input (e.g., the second size of the indication of time is an automatically-applied setting). Automatically adjusting the size of the indication of time when different visual media items are displayed allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the time user interface (e.g., 1606) (e.g., first user input corresponding to a user request to display a time user interface) further includes: in accordance with a determination that a first color has been selected for the indication of time based on one or more user inputs (e.g., user input selecting one or options 1614c-1 through 1614c-8 and/or user input 1671b), displaying the indication of time (e.g., 1608) in the first color; and in accordance with a determination that a second color has been selected for the indication of time based on one or more user inputs (e.g., user input selecting one or options 1614c-1 through 1614c-8 and/or user input 1671b), wherein the second color is different from the first color, displaying the indication of time (e.g., 1608) in the second color. In some embodiments, the indication of time (e.g., 1608) is displayed with the same color for a plurality of (or, optionally, all) visual media items displayed within the time user interface (e.g., the color of the indication of time remains consistent even as the visual media item changes within the time user interface; and/or as the size and/or display position of the indication of time changes within the time user interface) (e.g., for all rows in FIG. 16S). In some embodiments, a single color is applied to the indication of time for all visual media items based on one or more user inputs. In some embodiments, different colors are applied for the indication of time for different visual media items based on one or more user inputs. For example, in some embodiments, the computer system receives user input corresponding to selection of a first color for the indication of time when the first visual media item is displayed (e.g., top row of FIG. 16S), and user input corresponding to selection of a second color for the indication of time when the second visual media item is displayed (e.g., second row of FIG. 16S). In some embodiments, concurrently displaying the indication of time and the first visual media item includes concurrently displaying the indication of time in the first color and the first visual media item (e.g., top row of FIG. 16S); and concurrently displaying the indication of time and the second visual media item includes concurrently displaying the indication of time in the second color and the second visual media item (e.g., second row of FIG. 16S). Allowing a user to select the color of the indication of time enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the time user interface (e.g., 1606) (e.g., first user input corresponding to a user request to display a time user interface) includes: in accordance with a determination that a first color style (e.g., FIGS. 16AA through 16AA-6 and/or options 1614f-1 through 1614f-7) (e.g., a first color treatment; and/or a first color effect) (e.g., natural; black and white; monotone; duotone; tritone; color backdrop; and/or color backdrop mono) has been selected for the time user interface (e.g., 1606) based on one or more user inputs (e.g., user input selecting one of options 1614f-1 through 1614f-7, 1677b, 1677c, 1679a, 1679b, 1679c, 1681, 168b, and/or 1681c), displaying the time user interface with the first color style applied; and in accordance with a determination that a second color style different from the first color style has been selected for the time user interface based on one or more user inputs (e.g., user input selecting one of options 1614f-1 through 1614f-7, 1677b, 1677c, 1679a, 1679b, 1679c, 1681, 168b, and/or 1681c), displaying the time user interface with the second color style applied (and, optionally, without the first color style applied). In some embodiments, a single color style is applied for all visual media items within the time user interface based on one or more user inputs (e.g., the color style of the time user interface remains consistent even as the visual media item changes within the time user interface) (e.g., all rows of FIG. 16S). In some embodiments, different color styles are applied for the time user interface for different visual media items based on one or more user inputs. For example, in some embodiments, the computer system receives user input corresponding to selection of a first color style for the time user interface for when the first visual media item is displayed (e.g., top row of FIG. 16S), and user input corresponding to selection of a second color style for the time user interface for when the second visual media item is displayed (e.g., second row of FIG. 16S). Allowing a user to select the color style of the time user interface enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the time user interface (e.g., 1606) (e.g., first user input corresponding to a user request to display a time user interface) includes: in accordance with a determination that a first number character system (e.g., Arabic, Roman, Devanagari, and/or Indic) has been selected for the indication of time based on the one or more user inputs (e.g., user input selecting one of options 1614e-1 through 1614e-3 and/or user input 1675b), displaying the indication of time in the first number character system (e.g., without displaying the indication of time in other number character systems); and in accordance with a determination that a second number character system different from the first number character system has been selected for the indication of time based on one or more user inputs (e.g., user input selecting one of options 1614e-1 through 1614e-3 and/or user input 1675b), displaying the indication of time in the second number character system (e.g., without displaying the indication in the first number character system). In some embodiments, the indication of time (e.g., 1608) is displayed in the same number character system for all visual media items displayed within the time user interface (e.g., the number character system of the indication of time remains consistent even as the visual media item changes within the time user interface; and/or as the size and/or display position of the indication of time changes within the time user interface) (e.g., all rows in FIG. 16S). In some embodiments, a single number character system is selected to be applied to the indication of time for all visual media items based on one or more user inputs. In some embodiments different number character systems are applied for the indication of time for different visual media items based one or more user inputs. For example, in some embodiments, the computer system receives user input corresponding to selection of a first number character system for the indication of time when the first visual media item is displayed (e.g., top row of FIG. 16S), and user input corresponding to selection of a second number character system for the indication of time when the second visual media item is displayed (e.g., second row of FIG. 16S). In some embodiments, concurrently displaying the indication of time and the first visual media item includes concurrently displaying the indication of time in the first number character system and the first visual media item; and concurrently displaying the indication of time and the second visual media item includes concurrently displaying the indication of time in the second number character system and the second visual media item. Allowing a user to select the number character system of the indication of time enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the time user interface (e.g., 1606) (e.g., first user input corresponding to a user request to display a time user interface) further comprises: in accordance with a determination that the visual media item includes depth segmentation information (e.g., 1624a, 1624b, and/or 1624c), concurrently displaying, within the time user interface (e.g., 1606), the indication of time (e.g., 1608) (e.g., at the first size) and the visual media item (e.g., 1624a, 1624b, and/or 1624c) with a first visual effect applied to the time user interface (e.g., in FIG. 16S, visual media items 1624a-1624c are displayed with at least a portion of the visual media item overlapping time indication 1608); and in accordance with a determination that the visual media item does not include depth segmentation information (e.g., 1624d and/or 1624e), concurrently displaying, within the time user interface, the indication of time (e.g., 1608) (e.g., at the second size) and the visual media item (e.g., 1624d and/or 1624e) without the first visual effect applied to the time user interface (e.g., in FIG. 16S, visual media items 1624d and 1624e are displayed with no portion of the visual media item overlapping time indication 1608). In some embodiments, the first visual media item includes depth segmentation information (e.g., information and/or metadata indicating the depths of one or more objects depicted within the first visual media item; and/or first information indicating that a first object depicted within the first visual media item corresponds to a first depth and second information indicating that a second object depicted within the first visual media item corresponds to a second depth different from the first depth). In some embodiments, the depth segmentation information is based on information captured while the first visual media item was captured and/or based on information that is calculated after the first visual media item was captured. In some embodiments, the second visual media item does not include depth segmentation information (e.g., the second media item does not include corresponding information and/or metadata indicating different depths of different objects depicted within the second visual media item). Automatically displaying the time user interface with different visual effects based on whether the currently displayed visual media item includes or does not include depth segmentation information allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, concurrently displaying, within the time user interface (e.g., 1606), the indication of time (e.g., 1608) (e.g., at the first size) and the visual media item (e.g., 1624a, 1624b, and/or 1624c) with the first visual effect applied to the time user interface includes displaying at least a first object of the visual media item (e.g., 1624a-1, 1624b-1, and/or 1624b-1) (e.g., one or more objects; one or more foreground objects; and/one or more foreground objects that have a first depth that is in front of one or more background objects that have a second depth that is further back than the first depth) overlaid on top of the indication of time (e.g., 1608) (e.g., at least partially obscuring the indication of time) (e.g., top three rows of FIG. 16S). In some embodiments, concurrently displaying, within the time user interface, the indication of time (e.g., 1608) (e.g., at the second size) and the visual media item (e.g., 1624d and/or 1624e) without the first visual effect applied to the time user interface includes displaying the indication of time (e.g., 1608) without the visual media item (e.g., 1624d and/or 1624e) (e.g., without any portion of the visual media item) overlaid on top of the indication of time (e.g., bottom two rows of FIG. 16S) (e.g., displaying the indication of time overlaid on top of the visual media item such that the indication of time is not obstructed or obscured by the visual media item). Automatically displaying the time user interface with different visual effects based on whether the currently displayed visual media item includes or does not include depth segmentation information allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, concurrently displaying, within the time user interface (e.g., 1606), the indication of time (e.g., 1608) (e.g., at the first size) and the visual media item (e.g., 1624a, 1624b, and/or 1624c) with the first visual effect applied to the time user interface includes visually de-emphasizing a background portion (e.g., 1624a-2, 1624b-2, and/or 1624c-2) of the visual media item (e.g., one or more background items and/or one or more background objects; and/or a background portion that has a second depth (e.g., as indicated by the depth segmentation information) that is further back than a foreground portion that has a first depth (e.g., as indicated by the depth segmentation information)) by a first amount (e.g., blurring, obscuring, desaturating, and/or darkening the background portion by a first amount) (e.g., top three rows of FIG. 16S). In some embodiments, concurrently displaying, within the time user interface (e.g., 1606), the indication of time (e.g., 1608) (e.g., at the second size) and the visual media item (e.g., 1624d and/or 1624e) without the first visual effect applied to the time user interface includes visually de-emphasizing a background portion of the visual media item by a second amount (e.g., blurring, obscuring, desaturating, and/or darkening the background portion by a first amount) that is less than the first amount (e.g., bottom two rows of FIG. 16S). In some embodiments, visually de-emphasizing a background portion of the visual media item by the second amount that is less than the first amount comprises forgoing visually de-emphasizing any portion of the visual media item. In some embodiments, when the visual media item does not include depth segmentation information, the visual media item does not distinguish between a background portion and a foreground portion (e.g., based on lack of depth segmentation information), and visually de-emphasizing the background portion of the visual media item comprises visually de-emphasizing the entirety of the visual media item by the second amount that is less than the first amount and/or forgoing visually de-emphasizing any portion of the visual media item. In some embodiments, a background portion of the visual media item and/or a foreground portion of the visual media item is estimated and/or determined based on one or more machine learning algorithms. Automatically displaying the time user interface with different visual effects based on whether the currently displayed visual media item includes or does not include depth segmentation information allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, visually de-emphasizing the background portion (e.g., 1624a-2, 1624b-2, and/or 1624c-2) of the visual media item by the first amount includes removing the background portion of the visual media item (e.g., displaying the visual media item without displaying the background portion of the visual media item) (e.g., in some embodiments, in the top three rows of FIG. 16S (e.g., on the right side), background portions 1624a-2, 1624b-2, and/or 1624c-2 are removed and replaced with a single color). In some embodiments, visually de-emphasizing the background portion of the visual media item by the second amount that is less than the first amount includes forgoing removing the background portion of the visual media item (e.g., forgoing removing any portion of the visual media item and/or displaying the entirety of the visual media item) (e.g., in the bottom two rows of FIG. 16S, in some embodiments, the background portions of visual media items 1624d, 1624e are not removed). Automatically displaying the time user interface with different visual effects based on whether the currently displayed visual media item includes or does not include depth segmentation information allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system concurrently displays, via the one or more display generation components (e.g., 1602) and within the time user interface (e.g., 1606), the indication of time (e.g., 1608) at the first size and the first visual media item (e.g., 1609, 1624a, 1624b, 1624c, 1624d, and/or 1624e). While concurrently displaying, within the time user interface, the indication of time at the first size and the first visual media item, the computer system detects, via the one or more input devices, movement of a wrist of the user of the computer system (e.g., a wrist up movement and/or a wrist down movement) (e.g., user input 1661a). In response to detecting movement of the wrist of the user of the computer system: the computer system concurrently displays, within the time user interface, the indication of time at the second size and the second visual media item without displaying the first visual media item (e.g., from the fourth row of FIG. 16S to the fifth row of FIG. 16S, in response to detecting wrist raise gesture 1661a and/or a wrist drop gesture, computer system 1600 transitions from displaying time indication 1608 at a first size and with visual media item 1624d, to displaying time indication 1608 at a second size and with visual media item 1624e). In some embodiments, the computer system changes the visual media item that is displayed within the time user interface in response to a wrist up and/or a wrist down gesture by the user. Automatically switching the visual media item that is displayed within the time user interface in response to a wrist up and/or a wrist down gesture by the user allows the user to perform these operations with fewer user inputs and without cluttering limited display space with additional controls. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system (e.g., 1600 and/or 1610) concurrently displays, via the one or more display generation components (e.g., 1602 and/or 1612) and within the time user interface (e.g., 1606), the indication of time at the first size and the first visual media item (e.g., 1609, 1624a, 1624b, 1624c, 1624d, and/or 1624e). While concurrently displaying, within the time user interface, the indication of time at the first size and the first visual media item, the computer system determines that one or more criteria for transitioning the computer system from a higher power state to a lower power state (e.g., second row of FIG. 16S to third row of FIG. 16S) (e.g., a lower power state in which the computer system consumes less power than in the higher power state; a lower power state in which the computer system displays content at a darker brightness than in the higher power state; and/or a lower power state in which the computer system updates the one or more display generation components at a lower frequency than in the higher power state) are satisfied. In response to determining that the one or more criteria for transitioning the computer system from the higher power state to the lower power state are satisfied: the computer system transitions the computer system from the higher power state to the lower power state; and concurrently displays, within the time user interface, the indication of time at the second size and the second visual media item without displaying the first visual media item (e.g., from the second row of FIG. 16S to the third row of FIG. 16S, computer system 1600 transitions from a higher power state to a lower power state, and also changes from displaying time indication 1608 at a first size and with visual media item 1624b to displaying time indication 1608 at a second size and with visual media item 1624c). In some embodiments, the computer system changes the visual media item that is displayed within the time user interface when the computer system transitions from a higher power state to a lower power state. In some embodiments, the determination that the one or more criteria for transitioning the computer system from the higher power state to the lower power state are satisfied includes a determination that the computer system has not received user input for greater than a threshold duration of time (e.g., 10 seconds, 20 seconds, 30 seconds, one minute, two minutes, or five minutes). In some embodiments, the determination that the one or more criteria for transitioning the computer system from the higher power state to the lower power state are satisfied includes a determination that the computer system has not moved, has not been moved, and/or has not detected movement for greater than a threshold duration of time (e.g., 10 seconds, 20 seconds, 30 seconds, one minute, two minutes, or five minutes). In some embodiments, the determination that the one or more criteria for transitioning the computer system from the higher power state to the lower power state are satisfied includes detecting a user input corresponding to a user request to transition the computer system from the higher power state to the lower power state (e.g., one or more user inputs) (e.g., one or more gestures (e.g., a hand cover gesture covering one or more light sensors and/or one or more display generation components and/or a wrist down gesture in which the computer system detects that the wrist of the user has been moved downward and/or that the computer system has been moved downward and/or away from the face of the user), one or more air gestures, one or more presses of one or more buttons, and/or one or more touch-screen inputs). Automatically switching the visual media item that is displayed within the time user interface in response to a wrist up and/or a wrist down gesture by the user allows the user to perform these operations with fewer user inputs and without cluttering limited display space with additional controls. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system concurrently displays, via the one or more display generation components and within the time user interface, the indication of time (e.g., 1608) and a third visual media item (e.g., 1609 in FIGS. 16AB-16AB-3), including: in accordance with a determination that the time user interface includes a first complication (e.g., in accordance with a determination that the user has enabled the first complication and/or a setting for displaying the first complication is enabled) (e.g., FIG. 16AB-2 and/or complication region 1684b), displaying the indication of time (e.g., 1608) at a first position within the time user interface (e.g., 1608 in FIG. 16AB-2); and in accordance with a determination that the time user interface does not include the first complication (e.g., FIG. 16AB) (e.g., does not include any complication) (e.g., in accordance with a determination that the user has not enabled the first complication and/or a setting for displaying the first complication is not enabled), displaying the indication of time at a second position within the time user interface that is different from the first position (e.g., in FIG. 16AB, time indication 1608 is displayed at a second size and a second position that is different from the size and position of time indication 1608 in FIG. 16AB-2). In some embodiments, adding a complication to the time user interface causes the indication of time to be moved. In some embodiments, a complication (e.g., the first complication) displays visual information provided by a first application. In some embodiments, the time user interface includes multiple complications, including a first complication that corresponds to a first application (e.g., that displays information provided by and/or corresponding to a first application) and a second complication that corresponds to a second application different from the first application (e.g., that displays information provided by and/or corresponding to the second application). In some embodiments, one or more complications are displayed as part of the time user interface and concurrently with an indication of time. Automatically adjusting the position of the indication of time based on whether a complication is displayed or is not displayed allows for these operations to be performed without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while a first color treatment setting is applied (e.g., in some embodiments, in accordance with a determination that the first color treatment setting is applied) (e.g., monotone, duotone, tritone, color backdrop, color backdrop mono, and/or black and white), the computer system (e.g., 1600 and/or 1610) concurrently displays, via the one or more display generation components (e.g., 1602 and/or 1612), the first visual media item (e.g., 1609, 1624a, 1624b, 1624c, 1624d, and/or 1624e) and the indication of time (e.g., 1608), including concurrently displaying: a first portion of the first visual media item (e.g., 1624a-1, 1624b-1, and/or 1624c-1) in a first shade of a first color; and a second portion of the first visual media item (e.g., 1624a-2, 1624b-2, and/or 1624c-2) in a second shade of the first color that is different from the first shade (e.g., a darker shade of the first color or a lighter shade of the first color) (e.g., FIG. 16L). While the first color treatment setting is applied, the computer system receives, via the one or more input devices, a sequence of one or more inputs corresponding to a request to apply a second color treatment setting different from the first color treatment setting (e.g., one or more touch screen inputs, one or more rotations of a rotatable input mechanism, one or more gesture inputs, and/or one or more presses of one or more buttons) (e.g., in some embodiments, selection of a “light” setting, a “medium” setting, or a “dark” setting) (e.g., user input selecting one of options 1648a, 1648b, and/or 1648c and/or analogous options displayed on computer system 1600). In response to receiving the sequence of one or more inputs corresponding to the request to apply the second color treatment setting: the computer system applies the second color treatment setting (e.g., applies the light, medium, or dark setting in FIG. 16L); and concurrently displays, via the one or more display generation components: the first portion of the first visual media item (e.g., 1624a-1, 1624b-1, and/or 1624c-1) in a third shade of the first color different from the first shade of the first color (e.g., a darker shade of the first color or a lighter shade of the first color); and the second portion of the first visual media item (e.g., 1624a-2, 1624b-2, and/or 1624c-2) in a fourth shade of the first color different from the third shade of the first color and the second shade of the first color. In some embodiments, in FIG. 16L, while color 1647a is selected and the medium setting 1648b is selected, representation 1646a shows a first portion of first media item 1624a (e.g., a foreground portion 1624a-1) in a first shade of color 1647a and a second portion of first media item 1624b (e.g., a background portion 1624b-1) in a second shade of color 1647a. In some embodiments, in FIG. 16L, if light setting 1648a is selected while color 1647a remains selected, representation 1646a shows the first portion of first media item 1624a (e.g., a foreground portion 1624a-1) in a third shade of color 1647a and a second portion of first media item 1624b (e.g., a background portion 1624b-1) in a second shade of color 1647a. In some embodiments, user interface 1680 in FIGS. 16AA-2-7 through 16AA-2-12 can be adapted to allow a user to select a shade option 1648a-1648c (rather than a second color as is currently shown in the figures). In some embodiments, changing from shade option 1648a to shade option 1648b (e.g., in response to user input 1681c) causes a first portion of media item 1609 (e.g., foreground portion 1609-1) to change from a first shade of a first color to a second shade of the first color, and a second portion of media item 1609 (e.g., background portion 1609-2) to change from a third shade of the first color to a fourth shade of the first color. Providing the user with different color treatment setting options for adjusting the colors of displayed visual media items allows the user to perform these operations with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system (e.g., 1600 and/or 1610) concurrently displays, via the one or more display generation components (e.g., 1602 and/or 1612), within an editing user interface (e.g., 1630, 1644, 1650, 1652, 1654, 1656, and/or 1658) associated with editing the time user interface (e.g., 1606) (e.g., an editing user interface that includes one or more options that, when selected, cause modification of one or more visual elements of the time user interface (e.g., font size, font color, font, font style, time indication display position, and/or color style)): a representation of a first time user interface (e.g., 1632a, 1632b, 1632c, 1632d, 1632e, 1646a, 1646b, 1646c, 1646d, and/or 1646e), wherein the representation of the first time user interface includes: the first visual media item (e.g., 1609, 1624a, 1624b, 1624c, 1624d, and/or 1624e) and a first indication of time (e.g., 1608), wherein the first indication of time is displayed in a first visual arrangement (e.g., a first size, a first display position, and/or a first display orientation) (e.g., 1608 in 1632a, 1632b, 1632c, 1632d, 1632e, 1646a, 1646b, 1646c, 1646d, and/or 1646e); and a representation of a second time user interface (e.g., 1632a, 1632b, 1632c, 1632d, 1632e, 1646a, 1646b, 1646c, 1646d, and/or 1646e) different from the representation of the first time user interface, wherein the representation of the second time user interface includes: the second visual media item (e.g., 1609, 1624a, 1624b, 1624c, 1624d, and/or 1624e) and a second indication of time (e.g., 1608), wherein the second indication of time is displayed in a second visual arrangement (e.g., a second size, a second display position, and/or a second display orientation) different from the first visual arrangement (e.g., 1608 in 1632a, 1632b, 1632c, 1632d, 1632e, 1646a, 1646b, 1646c, 1646d, and/or 1646e). In some embodiments, the computer system concurrently displays, with the representation of a the first time user interface and the representation of the second time user interface, a representation of a third time user interface that is different from the representation of the first time user interface and the representation of the second time user interface, wherein the representation of the third time user interface includes: a third visual media item different from the first and second visual media items and a third indication of time, wherein the third indication of time is displayed in a third visual arrangement (e.g., a third size, a third display position, and/or a third display orientation) different from the first and second visual arrangements. Concurrently displaying representations of different time user interface layouts with different visual media items provides the user with visual feedback about a state of the system (e.g., providing the user with visual feedback about the different time user interface layouts that will be displayed). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1700 (e.g., FIG. 17) are also applicable in an analogous manner to the methods described above. For example, methods 700, 900, 1100, 1300, and/or 1500 optionally include one or more of the characteristics of the various methods described above with reference to method 1700. For example, in some embodiments, the same computer system performs methods 700, 900, 1100, 1300, 1500, and/or 1700 and/or the various time user interfaces recited in methods 700, 900, 1100, 1300, 1500, and/or 1700 are implemented on the same computer system. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve displaying background regions for time user interfaces. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide customized background region arrangements.

Accordingly, use of such personal information data enables users to have control their device background design. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of displaying background regions for time user interfaces, the present technology can be configured to allow users to select to “opt in” or “opt out” of participation in the collection of personal information data during registration for services or anytime thereafter. In another example, users can select not to provide customized background region designs. In yet another example, users can select to limit the information provided for displaying background regions. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, background region designs can be inferred based on non-personal information data or a bare minimum amount of personal information, such as the content being requested by the device associated with a user, other non-personal information available to the background modification system, or publicly available information.

1-195. (canceled)

196. A computer system configured to communicate with a display generation component, comprising:
one or more processors; and
memory storing one or more programs configured to be executed by the one or more processors, the one or more programs including instructions for:
displaying, via the display generation component, a time user interface, the time user interface including:
an indication of time that includes one or more numerals representing at least one of an hour and a minute; and
a color boundary that represents a number of seconds that have elapsed in a current minute, wherein the color boundary moves over time from a first edge of the time user interface toward a second edge of the time user interface as additional seconds elapse in the current minute.

197. The computer system of claim 196, wherein:
the time user interface includes a first portion having a first color on a first side of the color boundary and a second portion having a second color on a second side of the color boundary opposite of the first side of the color boundary, and
the movement of the color boundary causes a change in color of the first portion from the first color to the second color, and wherein the movement of the color boundary represents seconds elapsing in a current minute.

198. The computer system of claim 197, wherein:
the first portion having the first color includes a first portion of the one or more numerals,
the second portion having the second color includes a second portion of the one or more numerals, and
the movement of the color boundary causes a change in color of the first portion of the one or more numerals from the first color to the second color.

199. The computer system of claim 198, wherein the change in color of the first portion of the one or more numerals includes a change from a first respective color to a second respective color, including:
in accordance with a determination that the current minute is a first minute, the first respective color is lighter than the second respective color; and
in accordance with a determination that the current minute is a second minute immediately subsequent to the first minute, the first respective color is darker than the second respective color.

200. The computer system of claim 197, wherein:
the first portion having the first color includes a first portion of a background of the time user interface,
the second portion having the second color includes a second portion of the background of the time user interface, and
the movement of the color boundary causes a change in color of the first portion of the background of the time user interface from the first color to the second color.

201. The computer system of claim 197, wherein:
the first portion having the first color includes a first portion of a background of the time user interface and a first portion of the one or more numerals,
the second portion having the second color includes a second portion of a background of the time user interface and a second portion of the one or more numerals, and
the movement of the color boundary causes a change in color of the first portion of the background of the time user interface from the first color to the second color concurrently with a change in color of the first portion of the one or more numerals from the first color to the second color.

202. The computer system of claim 197, wherein:
during a first minute, the time user interface includes the first portion having the first color on the first side of the color boundary and the second portion having the second color on the second side of the color boundary opposite of the first side of the color boundary, and
during a second minute, the time user interface includes the second portion having the first color on the second side of the color boundary.

203. The computer system of claim 196, wherein:
after a first minute has ended and a second minute has started, a second color boundary represents a number of seconds that have elapsed in the second minute, and
the second color boundary moves over time from the first edge of the time user interface toward the second edge of the time user interface as additional seconds elapse in the second minute.

204. The computer system of claim 196, wherein:
the one or more numerals have a first configuration during a first minute, and
the one or more programs include instructions for:
detecting that the first minute has ended and a second minute has started; and
in response to detecting that the first minute has ended and the second minute has started, displaying, via the display generation component, the time user interface including the one or more numerals having a second configuration different from the first configuration.

205. The computer system of claim 204, wherein when the first minute has elapsed and the second minute begins, a color of the one or more numerals is maintained between an end of the first minute and a beginning of the second minute.

206. The computer system of claim 196, wherein:
the one or more numerals have a first configuration during the current minute, and
the one or more programs include instructions for, when the color boundary reaches the second edge of the time user interface, displaying, via the display generation component, the time user interface including the one or more numerals having a second configuration different from the first.

207. The computer system of claim 204, wherein:
the first configuration corresponds to the one or more numerals having at least one of a first shape and a first size, and
displaying, via the display generation component, the time user interface including the one or more numerals having a second configuration different from the first configuration includes modifying at least one of the first shape and the first size of the one or more numerals.

208. The computer system of claim 207, wherein modifying at least one of the first shape and the first size of the one or more numerals includes:
modifying at least one of a respective shape and a respective size of a first numeral; and
modifying at least one of a respective shape and a respective size of a second numeral that is different from the first numeral.

209. The computer system of claim 204, the one or more programs including instructions for:
detecting that a first minute has ended and a second minute has started; and
in response to detecting that the first minute has ended and the second minute has started displaying, via the display generation component, the time user interface including a respective numeral of the one or more numerals having the second configuration different from the first configuration, wherein the respective numeral of the one or more numerals maintains a respective value.

210. The computer system of claim 204, the one or more programs including instructions for:
while a background of the time user interface includes a solid color background, displaying, via the display generation component, the time user interface including the one or more numerals having the second configuration different from the first configuration.

211. The computer system of claim 196, the one or more programs including instructions for:
detecting that a first minute that corresponds to a first hour has ended and that a second minute has started; and
in response to detecting that the first minute has ended and a next minute has started:
in accordance with a determination that the second minute corresponds to a second hour that is different from the first hour, displaying the time user interface including the one or more numerals crossfading into one or more second numerals different from the one or more numerals; and
in accordance with a determination that the second minute corresponds to the first hour, displaying the time user interface including the one or more numerals shifting to a new orientation.

212. The computer system of claim 196, the one or more programs including instructions for:
displaying, via the display generation component, the time user interface with one or more user interface elements associated with one or more respective applications, wherein the one or more user interface elements are shaped based on a corresponding shape of an adjacent numeral of the one or more numerals.

213. The computer system of claim 196, wherein:
displaying the indication of time that includes one or more numerals representing at least one of an hour and a minute with a color boundary that represents a number of seconds that have elapsed in a current minute and moves over time toward a second edge of the time user interface as additional seconds elapse in the current minute is displaying the time user interface in a first display mode, and
the one or more programs include instructions for:
detecting an event corresponding to a display mode change; and
in response to detecting the event, displaying, via the one or more display generation components, the time user interface in a second display mode that is different from the first display mode, wherein displaying the time user interface in the second display mode includes:
displaying, via the display generation component, the indication of time with additional information that is not available in the first display mode for the time user interface; and
displaying, via the display generation component, a background of the time user interface, wherein the background includes a color gradient.

214. The computer system of claim 213, the one or more programs including instructions for:
in accordance with a determination that a current minute has elapsed and a next minute begins, modifying at least one color of the color gradient.

215. The computer system of claim 213, the one or more programs including instructions for:
detecting that a first minute has ended and a second minute has started; and
in response to detecting that the first minute has ended and the second minute has started, modifying at least one color of the one or more numerals.

216. The computer system of claim 196, wherein displaying the time user interface includes:
in accordance with a determination that the computer system is in a first power state, displaying, via the display generation component, a background of the time user interface outside of the one or more numerals having two colors; and
in accordance with a determination that the computer system is in a second power state, wherein the computer system consumes less power in the second power state than in the first power state, displaying, via the display generation component, the two colors within the one or more numerals.

217. The computer system of claim 196, wherein at least one color of the time user interface is based on a user selection of a color option from a plurality of color options.

218. The computer system of claim 196, the one or more programs including instructions for:
in accordance with a determination that the computer system is in a first power state, displaying, via the display generation component, the color boundary moving through a plurality of intermediate states during one second; and
in accordance with a determination that the computer system is in a second power state, wherein the computer system consumes less power in the second power state than in the first power state, displaying, via the display generation component, the color boundary that does not move through intermediate states between seconds.

219. The computer system of claim 196, wherein displaying the time user interface includes:
when the color boundary is at a first boundary:
in accordance with a determination that a distance between the first boundary and an edge of a numeral of the one or more numerals is less than a threshold distance, changing a portion of the numeral from extending along a first position to extending along the first boundary.

220. The computer system of claim 219, wherein changing the portion of the numeral includes changing a width of at least a portion the numeral from a first width to a second width that is different from the first width.

221. The computer system of claim 219, wherein changing the portion of the numeral includes changing a curvature of the numeral from a first curvature to a second curvature that is different from the first curvature.

222. The computer system of claim 219, wherein displaying the time user interface includes:
when the color boundary is at the first boundary:
in accordance with a determination that a distance between the first boundary and an edge of a numeral of the one or more numerals is more than a second threshold distance, forgoing changing the portion of the numeral.

223. The computer system of claim 219, wherein displaying the time user interface includes:
in accordance with a determination that a position of the first boundary is at an edge of a numeral of the one or more numerals, forgoing changing a portion of the numeral.

224. The computer system of claim 219, wherein displaying the time user interface includes:
in accordance with a determination that a second distance between the first boundary and a second edge of a second numeral of the one or more numerals is less than the threshold distance, changing a portion of the second numeral from extending along a third position to extending along the first boundary.

225. The computer system of claim 219, wherein changing the portion of the numeral includes:
as the color boundary moves towards the first boundary, changing the portion of the numeral from extending along the first position to extending along a third position, wherein the third position is between the first position and the first boundary.

226. The computer system of claim 219, wherein displaying the time user interface includes:
in accordance with a determination that the computer system is in a first power state, changing the portion of the numeral from extending along the first position to extending along a third position as the color boundary moves towards the first boundary, wherein the third position is between the first position and first boundary; and
in accordance with a determination that the computer system is in a second power state, wherein the computer system consumes less power in the second power state than in the first power state, changing the portion of the numeral from extending along a first position to extending along the first boundary without extending along the third position as the color boundary moves towards the first boundary.

227. A method, comprising:
at a computer system that is in communication with a display generation component:
displaying, via the display generation component, a time user interface, the time user interface including:
an indication of time that includes one or more numerals representing at least one of an hour and a minute; and
a color boundary that represents a number of seconds that have elapsed in a current minute, wherein the color boundary moves over time from a first edge of the time user interface toward a second edge of the time user interface as additional seconds elapse in the current minute.

228. A non-transitory computer-readable storage medium storing one or more programs configured to be executed by one or more processors of a computer system that is in communication with a display generation component, the one or more programs including instructions for:
displaying, via the display generation component, a time user interface, the time user interface including:
an indication of time that includes one or more numerals representing at least one of an hour and a minute; and
a color boundary that represents a number of seconds that have elapsed in a current minute, wherein the color boundary moves over time from a first edge of the time user interface toward a second edge of the time user interface as additional seconds elapse in the current minute.
